(19) United States
(12) Patent Application Publication
(10) Pub. No.: US 2007/0038610 A1
(43) Pub. Date: Feb. 15, 2007

(54) System and method for knowledge retrieval, management, delivery and presentation

(76) Inventor: Nosa Omoigui, Redmond, WA (US)

Correspondence Address: BLACK LOWE & GRAHAM, PLLC, 701 FIFTH AVENUE, SUITE 4800, SEATTLE, WA, 98104, US

(21) Appl. No.: 11/505,261

(22) Filed: Aug. 15, 2006

Related U.S. Application Data
(63) Continuation of application No. 10/179,651, filed on Jun. 24, 2002.
(60) Provisional application No. 60/300,385, filed on Jun. 22, 2001.
(60) Provisional application No. 60/360,610, filed on Feb. 28, 2002.

(51) Int. Cl. G06F 17/30

(52) U.S. Cl. 707/3

(57) ABSTRACT

The present invention is directed to an integrated implementation framework and resulting medium for knowledge retrieval, management, delivery and presentation. The system includes a first server component that is responsible for adding and maintaining domain-specific semantic information and a second server component that hosts semantic and other knowledge for use by the first server component that work together to provide context and time-sensitive semantic information retrieval services to clients operating a presentation platform via a communication medium. Within the system, all objects or events in a given hierarchy are active Agents semantically related to each other and representing queries (comprised of underlying action code) that return data objects for presentation to the client according to a predetermined and customizable theme or “Skin.” This system provides various means for the client to customize and “blend” Agents and the underlying related queries to optimize the presentation of the resulting information.

### PRIORITY CLAIM

This application is a continuation of U.S. patent application Ser. No. 10/179,651 filed Jun. 24, 2002; which application claims priority from earlier filed U.S. Provisional Patent Application Ser. No. 60/300,385 filed Jun. 22, 2001 and U.S. Provisional Patent Application Ser. No. 60/360,610 filed Feb. 28, 2002. All of the foregoing applications are hereby incorporated by reference in their entirety as if fully set forth herein.

### COPYRIGHT NOTICE

This disclosure is protected under United States and International Copyright Laws. © 2002-2006 Nosa Omoigui. All Rights Reserved. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention relates generally to information management systems and, more specifically, to an integrated and seamless implementation framework and resulting medium for knowledge retrieval, management, delivery and presentation.

### BACKGROUND OF THE INVENTION

Knowledge is now widely recognized as a core asset for organizations around the world, and as a tool for competitive advantage. In today's connected, information-based world, knowledge-workers must have access to the knowledge and the tools they need to make better, faster, and more-informed decisions to improve their productivity, enhance customer relationships, and to make their businesses more competitive. In addition, industry observers have touted “agility” and the “real-time enterprise” as important business goals to have in the information economy.

Many organizations have begun to realize the value of disseminating knowledge within their organizations in order to improve products and customer service, and the value of having a well-trained workforce. The investments businesses are making in e-Learning and corporate training provides some evidence of this. Companies have also invested in tools for content management, search, collaboration, and business intelligence. Companies are also spending significant resources on digitizing their business processes, particularly with respect to acquiring and retaining customers.

However, many knowledge/learning and customer-relationship assets are still stored in a diverse set of repositories that do not understand each other's language, and as a result are managed and interacted with as independent islands of information. As such, what many organizations call “knowledge” is merely data and information. The information economy in large part is a struggle to find a way to provide context, meaning and efficient access to this ever increasing body of data and information. Or, stated differently, to turn the mass of available data and information into usable knowledge.

Information has been long accessible in a variety of forms, such as in newspapers, books, radio and television media, and in electronic form, with varying degrees of proliferation. Information management and access changed dramatically with the use of computers and computer networks. Networked computer systems provide access throughout the system to information maintained at any point along the system. Users need only establish the requisite connection to the network, provide proper authorization and identify the desired information to obtain access.

Information access further improved with the advent of the Internet, which connects a large number of computers across diverse geography to provide access to a vast body of information. The most wide spread method of providing information over the Internet is via the World Wide Web. The Web consists of a subset of the computers or Web servers connected to the Internet that typically run Hypertext Transfer Protocol (HTTP), File Transfer Protocol (FTP), GOPHER or other servers. Web servers host Web pages at Web sites. Web pages are encoded using one or more languages, such as the original Hypertext Markup Language (HTML) or the more current extensible Markup Language (XML) or the Standard Generic Markup Language (SGML). The published specifications for these languages are incorporated by reference herein. Web pages in these formatting languages may be accessed by Internet users via web browsing software such as Microsoft's Internet Explorer or Netscape's Navigator.

The Web has largely been organized based on syntax and structure, rather than context and semantics. As a result, information is typically accessed via search engines and Web directories. Current search engines use keyword and corresponding search techniques that rely on textual or basic subject matter information and indices without associated context and semantic information. Unfortunately, such searching methods produce thousands of largely unresponsive results; documents as opposed to actionable knowledge. Advanced searching techniques have been developed to focus queries and improve the relevance of search results. Many such techniques rely on historical user search trends to make basic assumptions as to desired information. Alternatively, other search techniques rely on categorization of Web sites to further focus the search results to areas anticipated to be most relevant. Regardless of the search technique, the underlying organization of searchable information is index-driven rather than context-driven. The frequency or type of textual information associated the document determines the search results, as opposed to the attributes of the subject matter of the document and how those attributes relate to the user's context. The result is continued ambiguity and inefficiency surrounding the use of the Web as a tool for acquiring actionable knowledge.

In enterprises around the world today, the Web is the information platform for knowledge-workers. And there lies the problem. The Web as we know it is a platform for data and information while its users operate at the level of “knowledge.” This disconnect is a very fundamental one and cannot be understated. The Web, in large measure, has fulfilled the dream of “information at your fingertips.” However, knowledge-workers demand “knowledge at your fingertips” as opposed to mere “information at your fingertips.” Unfortunately, today's knowledge-workers use the Web to browse and search for documents—compilations of data and information—rather than actual knowledge relevant to their inquiry. To achieve improved knowledge requires providing proper context, meaning and efficient access to data and information, all of which are missing with the traditional Web.

Efforts have been made to achieve the goal of “knowledge at your fingertips.” One example is a new concept for information organization and distribution referred to as the Semantic Web. The Semantic Web is an extension of the current Web in which information is given well-defined meaning, better enabling computers and people to work in cooperation. While conceptually a significant step forward in supporting improved context, meaning and access of information on the Internet, the Semantic Web has yet to find successful implementation that lives up to its stated potential.

Both the current Web and the Semantic Web fail to provide proper context, meaning and efficient access to data and information to allow users to acquire actionable knowledge. This is partially a problem related to the ways in which Today's Web and the contemplated Semantic Web are structured or, in other words, related to their technology layers. As shown in FIG. 1, Today's Web, for example, which is a hypertext medium, provides the three technology layers, which include “dumb” links, or links having no context-sensitivity, time-sensitivity, etc. Present conceptualizations of the Semantic Web, also referred to as a “semantic hypermedia,” provide for five technology layers, as shown in FIG. 2. As explained in greater detail below, there are serious limitations associated with each of the technology layer structures.

In addition, various properties must be present in a comprehensive information management system to provide an integrated and seamless implementation framework and resulting medium for knowledge retrieval, management and delivery. A non-exhaustive list of these properties include: Semantics/Meaning; Context-Sensitivity; Time-Sensitivity; Automatic and intelligent Discoverability; Dynamic Linking; User-Controlled Navigation and Browsing; Non-HTML and Local Document Participation in the Network; Flexible Presentation that Smartly Conveys the Semantics of the Information being Displayed; Logic, Inference, and Reasoning; Flexible User-Driven Information Analysis; Flexible Semantic Queries; Read/Write Support; Annotations; “Web of Trust”; Information Packages (“Blenders”); Context Templates, and User-Oriented Information Aggregation. Each of these properties will be discussed below in the context of their application to both Today's Web and the Semantic Web.

Semantics/Meaning

Today's Web lacks semantics as an intrinsic part of the platform and user experience. Web pages convey only textual and graphical data rather than the semantics of the data they contain. As a result, users cannot issue semantic queries such as those that one might expect with natural language—for example, “find me all books less than hundred pages long, about Latin Jazz, and published in the last five years.” To be able to process such a query, a Web site or search engine must “know” it contains books and must be able to intelligently filter its contents based on the semantics of the query request. Such a query is not possible on the Web today. Instead, users are forced to rely on text-based searches. These searches usually result in information overload or information loss because the user is forced to pick search terms that might not match the text in the information base. In the aforementioned example, a user might pick the search term “Books Latin Jazz” and hope that the search engine can make the connection. The user is usually then left to independently filter the search results. This sort of text-based search also implies that terms that might convey the same meaning. In the above example, results from search terms such as “Books on South or Central American Jazz” or “Publications on Jazz from Latino Lands” might be ignored during the processing of the search query.

The lack of semantics also implies that Today's Web does not allow users to navigate based on they way humans think. For example, one might want to navigate a corporate intranet using the organizational structure. For example, from people to the documents they create to the experts on that documents to the direct reports of those experts to the distribution lists the direct reports are members of to the members of the distribution lists to the documents those members created, etc. This “web” is semantic and is based on actual information classification (“things”) and not just “pages” as Today's Web is.

The lack of semantics also has other implications. First, it means that the Web is not programmable. With semantics, the Web can be consumed by Smart Agents that can make sense of the pages and the links and then make inferences, recommendations, etc. With Today's Web, the only “Agent” that can make inferences is the human brain. As such, the Web does not employ the enormous processing power that computers are capable of—because it is not represented in a way that computers can understand.

The lack of semantics also implies that information is not actionable. A search engine does not “understand” the results it spits out. As such, once a user receives search results, he or she is “on his or her own.” Also, a web browser does not “understand” the information it is displaying and as such cannot do smart things with the information. With semantics in place, a smart display, for example, will “know” that an event is an event and might do interesting things like check if the event is already in the user's calendar, display free/busy information, or allow the user to automatically insert the event into his/her calendar thereby making the information actionable. Information presented without semantics is not actionable or might require that the semantics be inferred, which might result in an unpleasant user experience.

The Semantic Web seeks to address semantics/meaning limitations with Today's Web by encoding information with well-defined semantics. Web pages on the Semantic Web include metadata and semantic links to other metadata, thereby allowing search engines to perform more intelligent and accurate searches. In addition, the Semantic Web includes ontologies that will be employed for knowledge representation, thereby allowing a semantic search engine to interpret terms based on meaning and not merely on text. For example, in the previous example, Latin Jazz ontology might be employed on a Semantic Web site and would allow a search engine on the site to “know” that the terms “Books on South or Central American Jazz” or “Publications on Jazz from Latino Lands” have the same meaning as the term “Books on Latin Jazz.” While conceptually overcoming many of the deficiencies with Today's Web, there has not to date been a successful implementation of a well-defined data model providing context and meaning, including in particular the necessary semantic links, ontologies, etc. to provide for additional characteristics such as context-sensitivity and time-sensitivity.

Context-Sensitivity

Today's Web lacks context-sensitivity. The implication of a lack of context is that Today's Web is not personal. For example, documents in accessible storage are independently static and therefore stupid. Information relevant to the subject matter of the document has already been published, is being newly published, or will soon be published. Because the document in storage is static, however, there is no way to dynamically associate its subject matter with this relevant information in real-time. Stated differently, users have no way to dynamically connect their private context with external information in real-time. Information sources (such as the document) that form context sit in their own islands, totally isolated from other relevant information sources. This results in information and productivity losses.

The primary reason for this is that Today's Web is a presentation-oriented medium designed to present views of information to a dumb client (e.g., remote computer). The client has virtually no role to play in the user experience, aside from merely displaying what the server tells it to display. Even in cases where there is client-side code (like Java applets and ActiveX controls), the controls usually do one specific thing and do not have coordinated action with the remote server such that code on the client is being orchestrated with code on the server.

From a productivity standpoint, the implication of this is that knowledge-workers and information consumers are totally at the mercy of information authors. Today, knowledge-workers have portals that are maintained and updated to provide custom views of corporate information, external data, etc. However, this is still very limiting because knowledge-workers are completely helpless if nothing dynamically and intelligently connects relevant information in the context of their task with information that users have access to.

If a knowledge-worker does not see a link to a relevant piece of information on his of her portal, of if a friend or colleague does not email him or her the link, the information gets dropped; information does not connect with or adapt to the user context or the context in which it is displayed. Likewise, it is not enough to just notify a user that new data for an entire portal is available and shove it down to their local hard drive. It lacks a customizable presentation with context sensitive alert notifications.

The Semantic Web suffers from the same limitations as Today's Web when it comes to context-sensitivity. On the Semantic Web, users are likewise at the mercy of information authors. The Semantic Web itself will be authored, but the authoring will include semantics. As a result, users are still largely on their own to locate and evaluate the relevance of available information. The Semantic Web, as a standalone entity, will not be able to make these dynamic connections with other information sources.

Time-Sensitivity

Today's Web lacks time-sensitivity. The Web platform (e.g., browser) is a dumb piece of software that merely presents information, without any regard to the time-sensitivity of the information. The user is left to infer time sensitivity or do without it. This results in a huge loss in productivity because the Web platform cannot make time-sensitive connections in real-time. While some Web sites focus on presenting time-sensitive information, for example, by indexing information past a predetermined date, the Web browser itself has no notion of time-sensitivity. Instead, it is left to individual Web sites to include time-sensitivity in the information they display in their own island. In other words, there is no axis of time on a Web link.

The Semantic Web, like Today's Web, also does not address time-sensitivity. A Semantic Web can have semantic links that do not internalize time. This is largely because the Semantic Web implicitly has no notion of software Web services that address context and time-sensitivity.

Automatic and Intelligent Discoverability

Today's Web lacks automatic and intelligent discoverability of newly created information. There is currently no way to know what Web sites started anew today or yesterday. Unless the user is notified or the user serendipitously discovers a new site when he or she does a search, he or she might not have any clue as to whether there are any new Web sites or pages. The same problem exists in enterprises. On Intranets, knowledge-workers have no way of knowing when new Web sites come up unless informed via some external means. The Web platform itself has no notion of announcements or discovery. In addition, there is no context-sensitive discovery to determine new sites or pages within the context of the user's task or current information space.

The Semantic Web, like Today's Web, does not address the lack of automatic discoverability. Semantic Web sites suffer from the same problem—users either will have to find out about the existence of new information sources from external sources or through personal discovery when they perform a search.

Dynamic Linking

Today's Web employs a pure network or graph “data structure” for its information model. Each Web page represents a node in the network and each page can contain links to other nodes in the network. Each link is manually authored into each page. This has several problems. First, it means that the network needs to be maintained for it to have continuous value. If Web pages are not updated or if Web page or site authors do not have the discipline to add links to their pages based on relevance, the network loses value. Today's Web is essentially prone to having dead links, old links, etc. Another problem with a pure network or graph information model is that the information consumer is at the mercy of—rather than in control of—the presentation of the Web page or site. In other words, if a Web page or site does not contain any links, the user has no recourse to find relevant information. Search engines are of little help because they merely return pages or nodes into the network. The network itself does not have any independent or dynamic linking ability. Thus, a search engine can easily return links to Web pages that themselves have no links or dead, stale or irrelevant links. Once users obtain search results, they are on their own and are completely at the mercy of whether the author of the returned pages inserted relevant, time-sensitive links into the page.

The Semantic Web suffers from the same problem as Today's Web because the Semantic Web is merely Today's Web plus semantics. Even though users will be able to navigate the network semantically (which they cannot currently do with the Web), they will still be at the mercy of how the information has been authored. In other words, the Semantic Web is also dependent on the discipline of the authors and hence suffers from the same aforementioned problems of Today's Web. If the Semantic Web includes pages with ontologies and metadata, but those pages are not well maintained or do not include links to other relevant sources, the user will still be unable to obtain current links and other information. The Semantic Web, as currently contemplated, will not be a smart, dynamic, self-authoring, self-healing network.

User-Controlled Navigation and Browsing

With Today's Web, the user has no control over the navigation and browsing experience, but rather is completely at the mercy of a Web page and how it is authored with links (if any). As shown with reference to prior art FIG. 3, Today's Web consists of “dumb links,” or statically authored generic links that are wholly dependent on continuous maintenance to be navigable.

The Semantic Web suffers from a similar problem as Today's Web in that there is no user-controlled browsing. Instead, as shown with reference to prior art FIG. 4, the Semantic Web consists of “dumb links,” further including semantic information and metadata. However, the Semantic Web links remain equally dependent on continuous maintenance to be navigable.

Non-HTML and Local Document Participation in the Network

Another problem with Today's Web is the requirement that only documents that are authored as HTML can participate in the Web, in addition to the fact that those documents have to contain links. The implication is that other information objects like non-HTML documents (e.g., PDF, Microsoft Word, PowerPoint, and Excel documents, etc.)—especially those on users” hard drives—are excluded from the benefits of linking to other objects in the network. This is very limiting, especially since there might be semantic relevance between information objects that are not HTML and which do not contain links.

Furthermore, search engines do not return results for the entire universe of information since vast amount of content available on the web is inaccessible to standard web crawlers. This includes, for example, content stored in databases, unindexed file repositories, subscription sites, local machines and devices, proprietary file formats (such as Microsoft Office documents and email), and non-text multimedia files. These form a vast constellation of inaccessible matter on the Internet, referred to as “the invisible Intranet” inside corporations. Today's Web servers do not provide web crawler tools that address this problem.

The Semantic Web also suffers from this limitation. It does not address the millions of non-HTML documents that are already out there, especially those on users” hard drives. The implication is that documents that do not have RDF metadata equivalents or proxies cannot be dynamically linked to the network.

Flexible Presentation that Smartly Conveys the Semantics of the Information Being Displayed

Today's Web does not allow users to customize or “skin” a Web site or page. This is because Today's Web servers return information that is already formatted for presentation by the browser. The end user has no flexibility in choosing the best means of displaying the information—based on different criteria (e.g., the type of information, the available amount of real estate, etc.)

The Semantic Web does not address the issue of flexible presentation. While a semantic Web site conceptually employs RDF and ontologies, it still sends HTML to the browser. Essentially, the Semantic Web does not provide for specific user empowerment for presentation. As such, a Semantic Web site, viewed by Today's Web platform, will still not empower the user with flexible presentation. Moreover, despite industry movement towards XML, only a new platform can dictate that data will be separated from presentation and define guidelines for making the data programmable. Authors building content for the Semantic Web either return XML and avoid issues with presentation entirely, or focus their efforts on a single presentation style (vertical industry scenario) for rendering. Neither approach allows the Semantic Web to achieve an optimum degree of knowledge distribution.

Logic, Inference and Reasoning

Because Today's Web does not have any semantics, metadata, or knowledge representation, computers cannot process Web pages using logic and inference to infer new links, issue notifications, etc. Today's Web was designed and built for human consumption, not for computer consumption. As such, Today's Web cannot operate on the information fabric without resorting to brittle, unreliable techniques such as screen scraping to try to extract metadata and apply logic and inference.

While the Semantic Web conceptually uses metadata and meaning to provide Web pages and sites with encoded information that can be processed by computers, there is no current implementation that is able to successfully achieve this computer processing and which illustrates new or improved scenarios that benefit the information consumer or producer.

Flexible User-Driven Information Analysis

Today's Web lacks user-driven information analysis. Today's Web does not allow users to display different “views” of the links, using different filters and conditions. For example, Web search engines do not allow users to test the results of searches under different scenarios. Users cannot view results using different pivots such as information type (e.g., documents, email, etc.), context (e.g., “Headlines,” “Best Bets,” etc.), category (e.g., “wireless,” “technology,” etc.) etc.

While providing a greater degree of flexible information analysis, the Semantic Web does not describe how the presentation layer can interact with the Web itself in an interactive fashion to provide flexible analysis.

Flexible Semantic Queries

Today's Web only allows text-based queries or queries that are tied to the schema of a particular Web site. These queries lack flexibility. Today's Web does not allow a user to issue queries that approximate natural language or incorporate semantics and local context. For example, a query such as “Find me all email messages written by my boss or anyone in research and which relate to this specification on my hard disk” is not possible with Today's Web.

By employing metadata and ontologies, the conceptual Semantic Web allows a user to issue more flexible queries than Today's Web. For example, users will be able to issue a query such as “Find me all email messages written by my boss or anyone in research.” However, users will not be able to incorporate local context. In addition, the Semantic Web does not define an easy manner with which users will query the Web without using natural language. Natural language technology is an option but is far from being a reliable technology. As such, a query user interface that approximates natural language yet does not rely on natural language is required. The Semantic Web does not address this.

Read/Write Support

Today's Web is a read-only Web. For example, if users encounter a dead link (e.g., via the “404” error), they cannot “fix” the link by pointing it to an updated target that might be known to the user. This can be limiting, especially in cases where users might have important knowledge to be shared with others and where users might want to have input as to how the network should be represented and evolve.

While the Semantic Web conceptually allows for read/write scenarios as provided by independent participating applications, there is no current implementation that provides this ability.

Annotations

Today's Web has no implicit support for annotations. And while some specific Web sites support annotations, they do so in a very restricted and self-contained way. Today's Web medium itself does not address annotations. In other words, it is not possible for users to annotate any link with their comments or additional information that they have access to. This results in potential information loss.

While the Semantic Web conceptually allows for annotations to be built into the system subject to security constraints, there is no current implementation that provides this ability.

“Web of Trust”

Today's Web lacks seamless integration of authentication, access control, and authorization into the Web, or what has been referred to as a “Web of Trust.” With a Web of Trust, for example, users are able to make assertions, fix and update links to the Web and have access control restrictions built in for such operations. On Today's Web, this lack of trust also means that Web services remain independent islands that must implement a proprietary user subscription authorization, access control or payment system. Grand schemes for centralizing this information on 3^{rd} party servers meet with consumer and vendor distrust because of privacy concerns. To gain access to rich content, asset users must log in individually and provide identity information at each site.

While the Semantic Web conceptually allows for a Web of Trust, there is no current implementation that provides for this ability.

Information Packages (Blenders)

Neither Today's Web nor the Semantic Web allows users to deal with related semantic information as a whole unit by combining characteristics of potentially divergent semantic information to produce overlapping results (for example, like creating a custom, personal newspaper or TV channel).

Context Templates

Neither Today's Web nor the Semantic Web allows users to independently create and map to specific and familiar semantic models for information access and retrieval.

User-Oriented Information Aggregation

Today's Web lacks support for user-oriented information aggregation. The user can only access one Web site or one search engine at a time, within the context of one browsing session. As such, even if there is context or time-sensitive information on other information sources that relate to the information that the user is currently viewing, those sources cannot be presented in a holistic fashion in the current context of the user's task.

The Semantic Web also suffers from a lack of user-oriented information aggregation. The medium itself is an extension of Today's Web. As such, users will still access one site or one search engine at a time and will not be able to aggregate information across information repositories in a context or time-sensitive manner.

Given the growing demand for “knowledge at your fingertips” as well as the deficiencies in Today's Web and the conceptual Semantic Web, many of which are noted above, there is a need for a new and comprehensive system and method of knowledge retrieval, management and delivery.

### SUMMARY OF THE INVENTION

The present invention is directed in part to an integrated and seamless implementation framework and resulting medium for knowledge retrieval, management, delivery and presentation. The system includes a server comprised of several components that work together to provide context and time-sensitive semantic information retrieval services to clients operating a presentation platform via a communication medium. The server includes a first server component that is responsible for adding and maintaining domain-specific semantic information or intelligence. The first server component preferably includes structure or methodology directed to providing the following: a Semantic Network, a Semantic Data Gatherer, a Semantic Network Consistency Checker, an Inference Engine, a Semantic Query Processor, a Natural Language Parser, an Email Knowledge Agent and a Knowledge Domain Manager. The server includes a second server component that hosts domain-specific information that is used to classify and categorize semantic information. The first and second server components work together and may be physically integrated or separate.

Within the system, all objects or events in a given hierarchy are active Agents semantically related to each other and representing queries (comprised of underlying action code) that return data objects for presentation to the client according to a predetermined and customizable theme or “Skin.” This system provides various means for the client to customize and “blend” Agents and the underlying related queries to optimize the presentation of the resulting information.

The end-to-end system architecture of the present invention provides multiple client access means of communication between diverse knowledge information sources via an independent Semantic Web platform or via a traditional Web portal (e.g., Today's Web access browser) as modified by the present invention providing additional SDK layers that enable programmatic integration with a custom client.

The methodology of the present invention is directed in part to the operational aspects of the entire system, including the retrieval, management, delivery and presentation of knowledge. This preferably includes securing information from information sources, semantically linking the information from the information sources, maintaining the semantic attributes of the body of semantically linked information, delivering requested semantic information based upon user queries and presenting semantic information according to customizable user preferences. Alternative embodiments of the methodology of the present invention are directed to the operation of Agents representing queries that are used with server-side and client-side applications to enable efficient, inferential-based queries producing semantically relevant information.

### BRIEF DESCRIPTION OF THE DRAWINGS

The preferred and alternative embodiments of the present invention are described in detail below with reference to the following drawings.

FIG. 1 is a table showing the technology layers of Today's Web.

FIG. 2 is a table showing the technology layers of the conceptual Semantic Web.

FIG. 3 is a diagram showing user navigation to links in Today's Web.

FIG. 4 is a diagram showing user navigation to links in the conceptual Semantic Web.

FIG. 5 is a screenshot showing a sample Information Agent Results Pane in accordance with the present invention.

FIG. 6 shows the technology platform stacks of Today's Web and the Information Nervous System of the present invention.

FIG. 7 is a diagram showing an overview of the system of the present invention.

FIG. 8 is a diagram showing the end-to-end system architecture for the Information Nervous System of the present invention.

FIG. 9 is a diagram showing the system architecture for the Knowledge Integration Server (KIS) of the Information Nervous System of the present invention.

FIG. 10 is a comparison between the high-level descriptive platform layers of Today's Web and the equivalents (where applicable) in the Information Nervous System of the present invention.

FIG. 11 illustrates the preferred embodiment of the Information Nervous System and illustrates the heterogeneous, cross-platform context for the present invention.

FIGS. 12-14 show exemplar screenshots of aspects of the Blender Wizard user interface according to a preferred embodiment of the present invention.

FIG. 15 is an exemplar pane of a Breaking News Agent user interface.

FIG. 16 illustrates a preferred embodiment showing the Open Agent dialog of the present invention.

FIGS. 17-19 illustrate the Tree View of a sample Semantic Environment involving the Open Agent dialog.

FIG. 20 shows the Agent schema of the preferred embodiment of the present invention.

FIG. 21 shows the AgentTypeIDs of the preferred embodiment of the present invention.

FIG. 22 shows the AgentQueryTypeIDs of the preferred embodiment of the present invention.

FIG. 23 illustrates sample semantic queries that correspond to Agent names showing how server-side Agents are preferably configured on the KIS of the present invention.

FIG. 24 is a diagram showing an overview of the KIS of the present invention.

FIG. 25 is a diagram showing a sample Semantic Network directed towards an enterprise situation in accordance with the present invention.

FIG. 26 is a table showing the preferred schema of the Object type in accordance with the present invention.

FIG. 27 shows the SemanticLinks table of the present invention.

FIG. 28 is a table showing predicate type IDs of the preferred embodiment of the present invention.

FIG. 29 is a table showing the preferred user object schema made in accordance with the present invention.

FIG. 30 is a table showing MailingAddressTypeIDs preferably associated with the User (person) object schema.

FIG. 31 is a table of the preferred category object schema made in accordance with the present invention.

FIG. 32 is a table of the preferred document object schema made in accordance with the present invention.

FIG. 33 shows the Print Media Type IDs of the preferred embodiment.

FIG. 34 shows the preferred FORMATTYPEID.

FIG. 35 shows the preferred email message list object schema made in accordance with the present invention.

FIGS. 36 and 37 are exemplar tables showing the email distribution list and email public folder object schemas, respectively, of a preferred embodiment of the present invention.

FIG. 38 shows the preferred PublicFolderTypeID of the present invention.

FIG. 39 shows the preferred event object schema message list object schema made in accordance with the present invention.

FIG. 40 shows the events types of a preferred embodiment of the present invention.

FIG. 41 shows the preferred media object schema message list object schema made in accordance with the present invention.

FIG. 42 shows the media types of a preferred embodiment of the present invention.

FIGS. 43-45 illustrate additional samples showing how objects are categorized and utilized in the preferred embodiment of the present invention.

FIG. 46 is an object graph showing mapping of raw email XML metadata to the Semantic Network according to the present invention.

FIGS. 47-53 are exemplar screenshots showing aspects of Agent management by the KIS.

FIG. 54 shows a sample user interface illustrating an information object displayed in the Information Agent Results Pane.

FIG. 55 shows an example of a balloon popup associated with an Intrinsic Semantic Link showing an email sample according to the present invention.

FIG. 56 shows an example of a balloon popup associated with a Verb user interface according to the present invention.

FIG. 57 shows an example of a balloon popup associated with a Deep Information Mode user interface according to the present invention.

FIGS. 58 and 59 are illustrations showing an exemplar Semantic Environment according to the present invention.

FIGS. 60-68 provide exemplar screenshots of an Information Agent according to a preferred embodiment of the present invention.

FIGS. 69-71 provide exemplar balloon popup menus associated with the Smart Lens feature of an Information Agent according to the present invention.

FIG. 72 shows a sample of a variant of the balloon popup menu of FIG. 71 showing the relatedness measure of the two objects.

FIGS. 73-75 show sample tables illustrating the behaviors and relational contains objects types predicates when using Smart Lenses.

FIG. 76 is a user interface sample illustrating semantic results Player/Preview Control according to the present invention.

FIG. 77 is a user interface sample showing the semantic results of a Blender.

FIGS. 78 and 79 illustrate exemplar functionality mappings of the present invention.

FIG. 80 illustrates a user interface showing Agent results and corresponding Context Palettes according to the present invention.

FIG. 81 shows a sample Smart Recommendations popup context Results Pane according to the present invention.

FIG. 82 is a table showing the technology layers of the Information Nervous System of the present invention.

FIG. 83 illustrates dynamic linking and user-controlled navigation and browsing according to a preferred embodiment of the present invention.

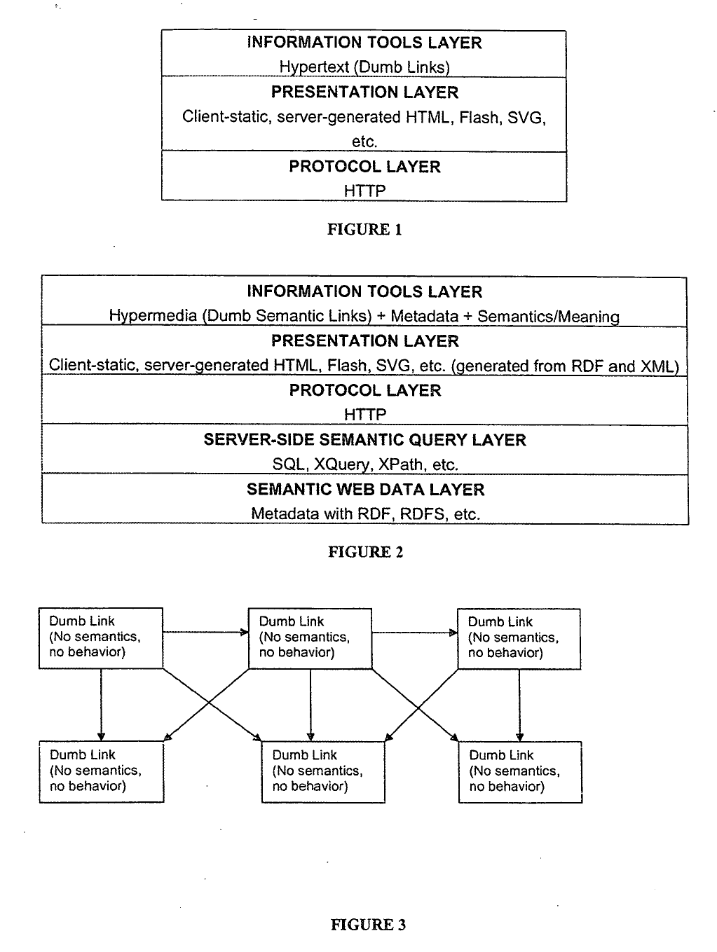

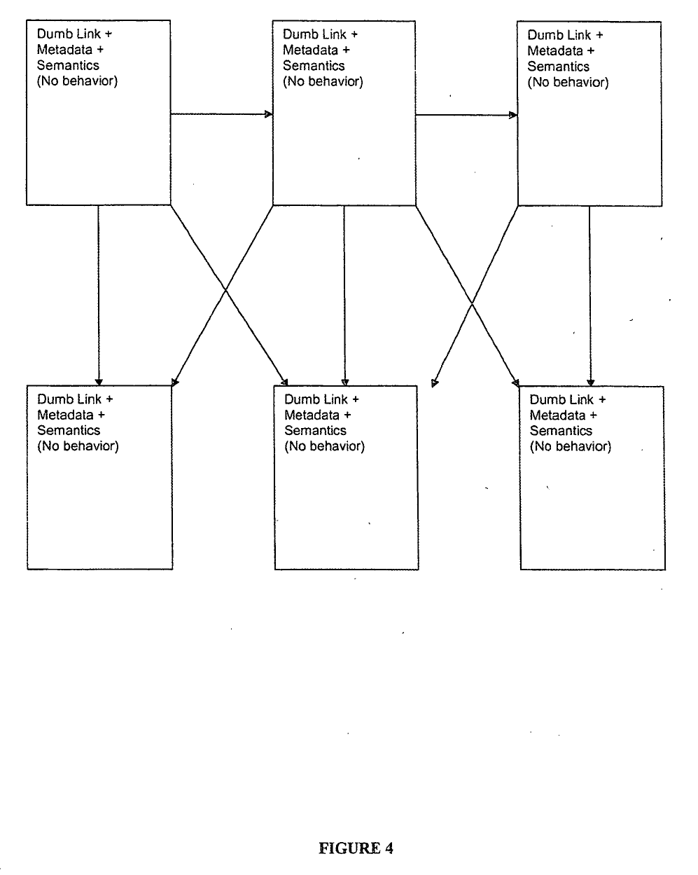

### DOCUMENTS INCORPORATED BY REFERENCE

The Appendix attached hereto and referenced herein is incorporated by reference. This Appendix includes exemplar code illustrating a preferred embodiment of the present invention.

### CONTENTS OF DETAILED DESCRIPTION OF THE INVENTION

A. DEFINITIONS

B. OVERVIEW

1. INVENTION CONTEXT
2. VALUE PROPOSITIONS
3. TODAY'S “INFORMATION” WEB VS. THE INFORMATION NERVOUS SYSTEM OF THE PRESENT INVENTION
   C. SYSTEM ARCHITECTURE AND TECHNOLOGY CONSIDERATIONS
1. SYSTEM OVERVIEW
2. SYSTEM ARCHITECTURE
3. TECHNOLOGY STACKS
4. SYSTEM HETEROGENEITY
5. SECURITY
6. EFFICIENCY CONSIDERATIONS
   D. SYSTEM COMPONENTS AND OPERATION
1. AGENCIES AND AGENTS
   a. Agencies
   b. Agents
2. KNOWLEDGE INTEGRATION SERVER
   a. Semantic Network
   b. Semantic Data Gatherer
   c. Semantic Network Consistency Checker
   d. Inference Engine
   e. Semantic Query Processor
   f. Natural Language Parser
   g. Email Knowledge Agent
   h. Knowledge Domain Manager
   i. Other Components
3. KNOWLEDGE BASE SERVER
4. INFORMATION AGENT (SEMANTIC BROWSER PLATFORM)
   a. Overview
   b. Client Configuration
   c. Client Framework Specification
   d. Client Framework
   e. Semantic Query Document
   f. Semantic Environment
   g. Semantic Environment Manager
   h. Environment Browser (Semantic Browser or Information Agent™)
   i. Additional Application Features
5. PROVIDING CONTEXT IN THE PRESENT INVENTION
   a. Context Templates
   b. Context Skins
   c. Skin Templates
   d. Default Predicates
   e. Context Predicates
   f. Context Attributes
   g. Context Palettes
   h. Intrinsic Alerts
   i. Smart Recommendations
6. PROPERTY BENEFITS OF THE PRESENT INVENTION
   E. SCENARIOS
1. EXAMPLES OF SEMANTIC QUERIES UTILIZING THE PRESENT INVENTION
2. BUSINESS PROBLEMS
3. SITUATIONS

### DETAILED DESCRIPTION OF THE INVENTION

A. Definitions

ActionScript. Scripting language of Macromedia Flash. This two-way communication assists users in creating interactive movies. See http://www.macromedia.com/support/flash/action_scripts/actionscript_tutorial/.

Agency. A named instance of a Knowledge Integration Server (KIS) that is the semantic equivalent of a website.

Agency Directory. A directory that stores metadata information for Agencies and allows clients to add, remove, search, and browse Agencies stored within. Agencies can be published on directories like LDAP or the Microsoft Active Directory. Agencies can also be published on a proprietary directory built specifically for Agencies.

Agent. A semantic filter query that returns XML information for a particular semantic object type (e.g., documents, email, people, etc.), context (e.g., Headlines, Conversations, etc.) or Blender.
Blender™ or Compound Agent™. Trademarked name for an Agent that contains other Agents and allows the user (in the case of client-side blenders) or the Agency administrator (in the case of server-side blenders) to create queries that generate results that are the union or intersection of the results of their contained Agents. In the case of client-side blenders, the results can be generated using different views (showing each Agent in the blender in a different frame, showing all the objects of a particular object type across the contained Agents, etc.)
Breaking News Agent™. Trademarked name for a Smart Agent that users specially tag as being indicative of time-criticality. Users can tag any Smart Agent as a Breaking News Agent. This attribute is then stored in users' Semantic Environment. A Breaking News Agent preferably shows an alert if there is breaking news related to any information being displayed.
Default Agent™. Trademarked name for standardized, non-user modifiable Agents presented to the user.
Domain Agent™. Trademarked name for an Agent that belongs to a semantic domain. It is initialized with an Agent query that includes reference to the “categories” table.
Dumb Agent™. Trademarked name for an Agent that does not have an Agency and which refers to local information (on a local hard drive), on a network share or on a Web link or URL. Dumb Agents are used to essentially load information items (e.g., documents) from a non-smart sandbox (e.g., the file-system or the Internet) to a smart sandbox (the Information Nervous System via the Information Agent (semantic browser)).
Email Agent™ (or Email Knowledge Agent™). Trademarked names for a Public Agent used to publish or annotate information and share knowledge on an Agency.
Favorite Agent™. Trademarked name for Agents that users indicate they like and access often.
Public Agent™. Trademarked name for Agents that are created and managed by the system administrator.
Private or Local Agents™. Trademarked names for Agents that are created and managed by users.
Search Agent™. Trademarked name for a Smart Agent that is created by searching the semantic environment with keywords or by searching an existing Smart Agent, in order to invoke an additional, text-based query filter on the Smart Agent.
Simple or Standard Agent™. Trademarked names for Standalone Agents that encapsulate structured, non-semantic queries (e.g., from the local file system or data source).
Smart Agent™. Trademarked name for a standalone Agent that encapsulates structured, semantic queries that refers to an Agency via its XML Web Service.
Special Agent™. Trademarked name for a Smart Agent that is created based on a Context Template.

Agent Discovery. The property of the information medium of the present invention that allows users to easily and automatically discover new server-side Agents or client-side Agents created by others (friends or colleagues). Also see “Discoverability.”

Annotations. Notes, comments, or explanations that are used to add personal context to an information object. In the preferred embodiment, annotations are email messages that are linked to the object they qualify, and which can have attachments (just like regular email messages). In addition, annotations are first class information objects in the system and as such can be annotated themselves, thereby resulting in threaded annotations or a tree of annotations with the initial object as the root.

Application Programming Interface (API). Defines how software programmers utilize a particular computer feature. APIs exist for windowing systems, file systems, database systems, networking systems, and other systems.

Calendar Access Protocol (CAP). Internet protocol that permits users to digitally access a calendar store based on the iCalendar standard.

Compound Agent Manager™. Trademarked name for an Agency component that programmatically allows the user to create and delete Compound Agents and to manage them by adding and deleting Agents.

Context. Information surrounding a particular item that provides meaning and otherwise assists the information consumer in interpreting the item as well as finding other relevant information related to the item.

Context Results Pane. A Results Pane that displays results for context-based queries. These include results for Context Palettes, Smart Lenses, Deep Information, etc. See “Results Pane.”

Context-Sensitivity. The property of an information medium that enables it to intelligently and dynamically perceive the context of all the information it presents and to present additional, relevant information given that context. A context-sensitive system or medium understands the semantics of the information it presents and provide appropriate behaviors (proactive and reactive based on the user's actions) in order to present information in its proper context (both intrinsically and relationally).

Context Template™. Trademarked name for scenario-driven information query templates that map to specific and familiar semantic models for information access and retrieval. For example, a “Headlines” template in the preferred embodiment has parameters that are consistent with the delivery of “Headlines” (where freshness and the likelihood of a high interest level are the primary axes for retrieval). An “Upcoming Events” template has parameters that are consistent with the delivery of “Upcoming Events.” And so on. Essentially, Context Templates can be analogized to personal, digital semantic information retrieval “channels” that deliver information to the user by employing a well-known semantic template.

Deep Information™. Trademarked name for a feature of the present invention that enables the Information Agent to display intrinsic, contextual information relating to an information object. The contextual information that includes information that is mined from the Semantic Network of the Agency from whence the object came.

Discoverability. The ability of the information medium of the present invention to intelligently and proactively make information known or visible to the user without the user having to explicitly look for the information.

Domain Agent Wizard™. Trademarked name for a system component and its user interface for allowing the Agency administrator to create and manage Domain Agents.

DOTNET (.NET). Microsoft® .NET is a set of Microsoft software technologies for connecting information, people, systems, and devices. It enables software integration through the use of XML Web Services: small, discrete, building-block applications that connect to each other, as well as to other, larger applications, via the Internet. .NET-connected software facilitates the creation and integration of XML Web Services. See http://www.microsoft.com/net/defined/default.asp).

Dynamic Linking™. Trademarked name for the ability of the Information Nervous System of the present invention to allow users to link information dynamically, semantically, and at the speed of thought, even if those information items do not contain links themselves. By virtue of employing smart objects that have intrinsic behavior and using recursive intelligence embedded in the Information Agency's XML Web Service, each node in the Semantic Network is much smarter than a regular link or node on Today's Web or the conceptual Semantic Web. In other words, each node in the Smart Virtual Network or Web of the present invention can link to other nodes, independent of authoring. Each node has behavior that can dynamically link to Agencies and Smart Agents via drag and drop and smart copy and paste, create links to Agencies in the Semantic Environment, respond to lens requests from Smart Agents to create new links, include intrinsic alerts that will dynamically create links to context and time-sensitive information on its Agency, include presentation hints for breaking news (wherein the node can automatically link to breaking news Agents in the namespace), form the basis for deep info that can allow the user to find new links, etc. A user of the present invention is therefore not at the mercy of the author of the metadata. Once the user reaches a node in the network, the user has many semantic means of navigating dynamically and automatically—using context, time, relatedness to Smart Agencies and Agents, etc.

Email XML Object. An information object with the “Email” information object type. The XML object has the “Email” SRML schema (which uses XML).

Environment Browser. See Information Agent.

Favorite Agents Manager™. Trademarked name for a system component and user interface element that allows the Agency administrator to manage server-side Favorite Agents.

Flash. Macromedia Flash user interface platform that enables developers and content authors to embed sophisticated graphics and animations in their content. See http://www.macromedia.com/flash.

Flash MX. Macromedia Flash MX is a text, graphics, and animation design and development environment for creating a broad range of high-impact content and rich applications for the Internet. See http://www.macromedia.com/software/flash/productinfo/product_overview/.

Global Agency Directory™. Trademarked name for an instance of an Agency Directory that runs on the Internet (or other global network). The Global Agency Directory allows users to find, search, and browse Internet-based Agencies using their Information Agent (directly in their semantic environment). Also, see “Agency Directory.”

HTTP. Hypertext Transfer Protocol (HTTP) is an application-level protocol for distributed, collaborative, hypermedia information systems. It is a generic, stateless, protocol that can be used for many tasks beyond its use for hypertext, such as name servers and distributed object management systems, through extension of its request methods, error codes and headers. A feature of HTTP is the typing and negotiation of data representation, allowing systems to be built independently of the data being transferred. See http://www.w3.org/Protocols/ and http://www.w3.org/Protocols/Specs.html.

Inference Engine™. Trademarked name for the methodology of the present invention that observes patterns and data to arrive at relevant and logically sound conclusions by reasoning. Preferably utilizes Inference Rules (a predetermined set of heuristics) to add semantic links to the Semantic Network of the present invention.

Information. A quantitative or qualitative measure of the relevance and intelligence of content or data and which conveys knowledge.

Information Agent™. Trademarked name for the semantic client or browser of the present invention that provides context and time-sensitive delivery and presentment of actionable information (or knowledge) from multiple sources, information types, and templates, and which allows dynamic linking of information across various repositories.

Information Nervous System™. Trademarked name for the dynamic, self-authoring, context and time-sensitive information system of the present invention that enables users to intelligently and dynamically link information at the speed of thought, and with context and time-sensitivity, in order to maximize the acquisition and use of knowledge for the task at hand.

Information Object™ (or Item or Packet). Trademarked name for a unit of information of a particular type and which conveys knowledge in a given context.

Information Object Pivot™. Trademarked name for an information object that users employ as a navigational pivot to find other relevant information in the same context.

Information Object Type. See Object Type.

Intelligent Agent. Software Agents that act on behalf of the user to find and filter information, negotiate for services, easily automate complex tasks, or collaborate with other software Agents to solve complex problems. By definition, Intelligent Agents must be autonomous or, in other words, freely able to execute without user intervention. Additionally, Intelligent Agents must be able to communicate with other software or human Agents and must have the ability to perceive and monitor the environment in which they reside. See http://www.findarticles.com/cf_dls/m0FWE/7_{—}4/64694222/p1/article.jhtml).

Internet Calendaring and Scheduling (iCalendar). Protocol that enables the deployment of interoperable calendaring and scheduling services for the Internet. The protocol provides the definition of a common format for openly exchanging calendaring and scheduling information across the Internet.

Internet Message Access Protocol (IMAP). Communications mechanism for mail clients to interact with mail servers, and manipulate mailboxes thereon. Perhaps the most popular mail access protocol currently is the Post Office Protocol (POP), which also addresses remote mail access needs. IMAP offers a superset of POP features, which allow much more complex interactions and provides for much more efficient access than the POP model. See http://www-smi.stanford.edu/projects/imap/ml/imap.html.

Intrinsic Semantic Link™. Trademarked name for semantic links that are intrinsic to the schema of a particular information object. For instance, an email information object has intrinsic links like “from,” “to,” “cc,” “bcc,” and “attachments” that are native to the object itself and are defined in the schema for the email information object type.

Island. An information repository that is isolated from other repositories which may contain relevant, semantically related, context and time-sensitive information but which are disconnected from other contexts in which such information might be relevant.

J2EE. The Java™ 2 Platform, Enterprise Edition (J2EE) used for developing multi-tier enterprise applications. J2EE bases enterprise applications on standardized, modular components by providing a set of services to those components and by handling many details of application behavior automatically. See http://java.sun.com/j2ee/overview.html.

Knowledge. Information presented in a context and time-sensitive manner that enables the information consumer to learn from the information and apply the information in order to make smarter and more timely decisions for relevant tasks.

Knowledge Agent™. See Information Agent.

Knowledge Base Server™ (KBS). Trademarked name for a server that hosts knowledge for the Knowledge Integration Server (KIS).

Knowledge Domain Manager™ (KDM). Trademarked name for a component of the Knowledge Integration Server that is responsible for adding and maintaining domain-specific intelligence on the Semantic Network.

Knowledge Integration Server™ (KIS). Trademarked name for a server that semantically integrates data from multiple diverse sources into a Semantic Network, which can also host server-side Agents that provide access to the network and which hosts XML Web Services that provide context and time-sensitive access to knowledge on the server.

Knowledge Web™. See Information Nervous System.

Liberty Alliance. The vision of the Liberty Alliance is to enable a networked world in which individuals and businesses can more easily conduct transactions while protecting the privacy and security of vital identity information. To accomplish its vision, the Liberty Alliance seeks to establish an open standard for federated network identity through open technical specifications. See http://www.projectliberty.org/index.html.

Lightweight Directory Access Protocol (LDAP). Technology for accessing common directory information. LDAP has been embraced and implemented in most network-oriented middleware. As an open, vendor-neutral standard, LDAP provides an extendable architecture for centralized storage and management of information that needs to be available for today's distributed systems and services. LDAP is currently supported in most network operating systems, groupware and even shrink-wrapped network applications. See http://publib-b.boulder.ibm.com/Redbooks.nsf/RedbookAbstracts/sg244986.html?Open.

Link Template™. See Context Template.

Local Context. Local Context refers to client-side information objects and Agents accessible to the users. This includes Agents in the Semantic Environment, local files, folders, email items in users' email inboxes, users' favorite and recent Web pages, the current Web page(s), currently opened documents, and other information objects that represent users' current task, location, time, or condition.

Meaning. The attributes of behavior of information that allows the consumer of the information to locate and navigate to it based on its relevant information content (as opposed to its text or data) and to act on it in a context and time-sensitive manner, in order to maximize the utility of the information.

Metadata. “Data about data.” It includes those data fields, links, and attributes that fully describe an information object.

Natural Language Parser. Parsing and interpreting software component that understands natural language queries and can translate them to structured semantic information queries.

Nervana™. Trademarked name for a proprietary, end-to-end implementation of the Information Nervous System information medium/platform. The name also defines a proprietary namespace for resource type and predicate name qualifiers.

.NET Passport. Microsoft .NET Passport is a suite of Web-based services directed towards the Internet and online purchasing. .NET Passport provides users with single sign-in (SSI) and fast purchasing capability at a growing number of participating sites, reducing the amount of information users must remember or retype. .NET Passport provide a high-quality online experience for a large user base and uses powerful encryption technologies—such as Secure Sockets Layer (SSL) and the Triple Data Encryption Standard (3DES) algorithm—for data protection. Privacy is a key priority as well, and all participating sites sign a contract in which they agree to post and follow a privacy policy that adheres to industry-accepted guidelines.

Network Effects. This exists when the number of other users affects the value of a product or service to a particular user. Telephone service provides a clear example. The value of telephone service to users is a function of the number of other subscribers. Few would be interested in telephones that were not connected to anyone, and most would assess higher value to a phone service linked to a national network rather than just a local network. Similarly, many computer users prize a computer system that allows them to exchange information readily with other users.

Network Effects are thus demand-side externalities that generate a positive feedback effect in which successful products become more successful. In this way, Network Effects are analogous to supply-side economies of scale and scope. As a firm increases output, economies of scale lead to lower average costs, permitting the firm to lower prices and gain additional business from rivals. Continued expansion results in even lower average costs, justifying even lower prices. Similarly, the positive feedback from Network Effects builds upon previous successes. In the computer industry, for example, users pay more for a more popular computer system, all else equal, or opt for a system with a larger installed base if the prices and other features of two competing systems are equivalent. See http://www.ei.com/publications/1996/fall1.htm.

Network News Transfer Protocol (NNTP). Protocol for the distribution, inquiry, retrieval, and posting of news articles using a reliable stream-based transmission of news among the ARPA-Internet community. NNTP is designed so that news articles are stored in a central database allowing subscribers to select only those items they wish to read. Indexing, cross-referencing, and expiration of aged messages are also provided.

Notifications. Notifications are alerts that are sent by the Information Agent or an Agency to indicate to a user that there is new information on an Agent (either a client-side Agent or a server-side Agent). Users can request notifications from Agents in their Semantic Environment. Users can indicate that they have received the notification. The notification source (the client or server) stores information for the user and the Agent indicating the last time the user acknowledged a notification for the Agent. The notification source polls the Agent to check if there is new information since the last acknowledge time. If there is, the notification source alerts the user. Alerts can be sent via email, pager, voice, or a custom alert mechanism such as Microsoft's .NET Alerts service. Users have the option of indicating their preferred notification mechanism for the entire notification source (client or server)—which applies to all Agents on the notification source—on a per-Agent basis (which overrides the indicated preference on the notification source.

Object. See Information Object.

Object Type. Identification data associated with information that allows the consumer to understand the nature of the information, to interpret its contents, to predict how the information can be acted upon, and to link it to other relevant information items based on how the object types typically relate in the real world. Examples include documents, events, email messages, people, etc.

Ontology. Hierarchical structuring of knowledge according to essential qualities. Ontology is an explicit specification of a conceptualization. The term is borrowed from philosophy, where “Ontology” is a systematic account of Existence. For artificial intelligence systems, what “exists” is that which can be represented. When the knowledge of a domain is represented in a declarative formalism, the set of objects that can be represented is called the universe of discourse. This set of objects, and the describable relationships among them, are reflected in the representational vocabulary with which a knowledge-based program represents knowledge. Thus, in the context of artificial intelligence, the ontology of a program is described by defining a set of representational terms. In such ontology, definitions associate the names of entities in the universe of discourse (e.g., classes, relations, functions, or other objects) with human-readable text describing what the names mean, and formal axioms that constrain the interpretation and well-formed use of these terms. Formally, ontology is the statement of a logical theory.

The subject of ontology is the study of the categories of things that exist or may exist in some domain. The product of such a study, called ontology, is a catalog of the types of things that are assumed to exist in a domain of interest D from the perspective of a person who uses a language L for the purpose of talking about D. The types in the ontology represent the predicates, word senses, or concept and relation types of the language L when used to discuss topics in the domain D. See, generally, http://www-ksl.stanford.edu/kst/what-is-an-ontology.html and http://users.bestweb.net/˜sowa/ontology/).

Predicates. A Predicate is an attribute or link whose result represents the truth or falsehood of some condition. For example, the predicate “authored by” links a person with an information object and indicates whether a person authored the object.

Presenter™. System component in the Information Agent (semantic browser) of the present invention that handles the aggregation and presentation of results from the semantic query processor (that preferably interprets SQML). The Presenter handles layout management, aggregation, navigation, Skin management, the presentation of Context Palettes, interactivity, animations, etc.

RDF. Resource Description Framework (RDF) is a foundation for processing metadata; it provides interoperability between applications that exchange machine-understandable information on the Web. RDF emphasizes facilities to enable automated processing of Web resources. RDF defines a simple model for describing relationships among resources in terms of named properties and values. RDF properties may be thought of as attributes of resources and in this sense correspond to traditional attribute-value pairs. RDF properties also represent relationships between resources. As such, the RDF data model can therefore resemble an entity-relationship diagram.

RDF can be used in a variety of application areas including, for example: in resource discovery to provide better search engine capabilities, in cataloging for describing the content and content relationships available at a particular Web site, page, or digital library, by intelligent software Agents to facilitate knowledge sharing and exchange, in content rating, in describing collections of pages that represent a single logical “document”, for describing intellectual property rights of Web pages, and for expressing the privacy preferences of a user as well as the privacy policies of a Web site. RDF with digital signatures is preferably a component of building the “Web of Trust” for electronic commerce, collaboration, and other applications. See, generally, http://www.w3.org/TR/PR-rdf-syntax/ and http://www.w3.org/TR/rdf-schema/.

RDFS. Acronym for RDF Schema. Resource description communities require the ability to say certain things about certain kinds of resources. For describing bibliographic resources, for example, descriptive attributes including “author”, “title”, and “subject” are common. For digital certification, attributes such as “checksum” and “authorization” are often required. The declaration of these properties (attributes) and their corresponding semantics are defined in the context of RDF as an RDF schema. A schema defines not only the properties of the resource (e.g., title, author, subject, size, color, etc.) but may also define the kinds of resources being described (books, Web pages, people, companies, etc.). See http://www.w3.org/TR/rdf-schema/).

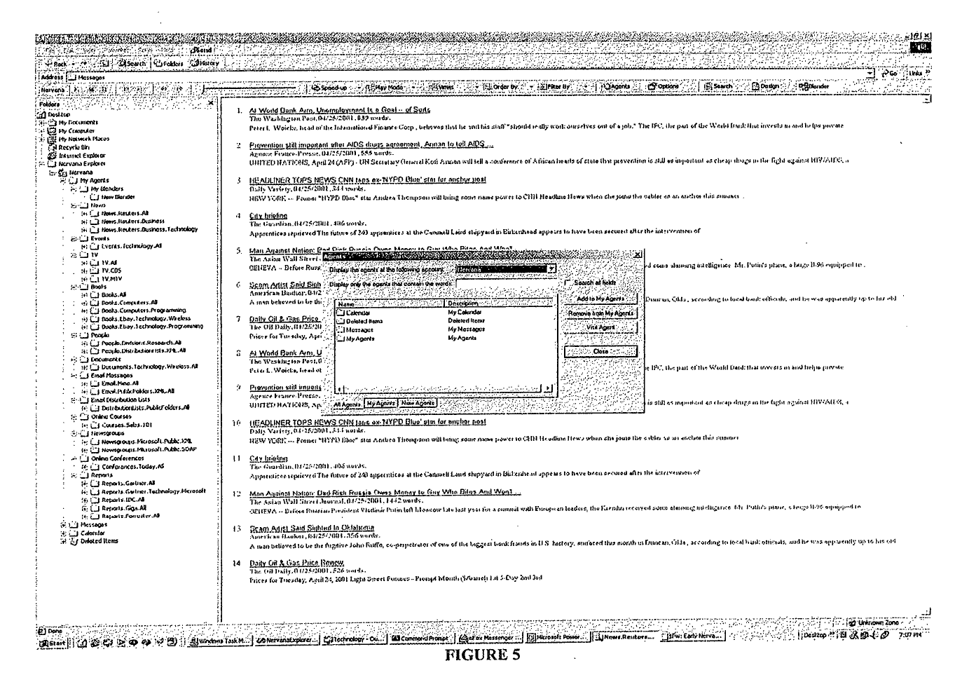

Results Pane™. Trademarked name for the graphical display area within the Information Agent (semantic browser) that displays results of an SQML query. See FIG. 5, showing a sample Information Agent screenshot illustrating server-side Agents, an optional player control/navigation/filter toolbar, a “Server-Side Agents Dialog” (which allows users to browse and open server-side Agents), and sample results (with the “Documents” information object type) from a server-side Agent.

Semantics. Connotative meaning.

Semantic Environment™. This refers to all the data stored on users' local machines, in addition to user-specific data on an Agency server (e.g., subscribed server-side Agencies, server-side Favorite Agents, etc.). Client-side state includes favorite and recent Agents and authentication and authorization information (e.g., user names and passwords for various Agencies), in addition to the SQML files and buffers for each client-side (user-created) Agent. The Information Agent is preferably configured to store Agents for a set amount of time before automatically deleting them, except those that have been added to the “favorites” list. For example, users may configure the Information Agent to store Agents for two weeks. In this case, Agents older than two weeks are automatically purged from the system and the Semantic Environment is adjusted accordingly. The Semantic Environment is employed for Context Palettes (Context Palettes use the Agencies in the “recent” and “favorites” list in order to predict what default Agencies users want to view context from).

Semantic Environment Manager™. Trademarked name for a software component that manages all the local state for the Semantic Environment (in the Information Agent). This includes storing and managing the metadata for all the client-side Agents (and the history and favorites Agent sub-lists), per-Agent state (e.g., Agent Skins, Agent preferences, etc.), notification management, Agency browsing (on Agency directories), listening for Agencies via multicast and peer-to-peer announcement protocols, services to allow users to browse the Semantic Environment via the semantic browser (via the Tree View, the “Open Agent” dialog, and the Results Pane), etc.

Semantic Data Gatherer™ (SDG). Trademarked name for XML Web Service used by the Knowledge Integration Server (KIS) and which is responsible for adding, removing and updating entries in the Semantic Network via the Semantic Metadata Store (SMS).

Semantic Metadata Store™ (SMS). Trademarked name for a software component on the KIS that employs a database (e.g., SQL Server, Oracle, DB2) having tables for each primary object type to store all the metadata on the KIS.

Semantic Network. System and method of linking objects associated with schemas together in a semantic way via the database tables on the Semantic Metadata Store.

Semantic Network Consistency Checker™. Trademarked name for a software component that runs on an Agency of the present invention that is tasked with maintaining the integrity and consistency of the Semantic Network. The checker runs periodically and ensures that entries in the “SemanticLinks” table exist in the native object tables, that entries in the “objects” table exist in the native object tables and that all entries in the Semantic Metadata Store still exist at the repositories from where they were gathered.

Semantic Queries. Queries that incorporate meaning, context, time-sensitivity, context-templates, and richness that approach natural language. Much more powerful than simple, keyword-based queries in that they are context and time-sensitive and incorporate meaning or semantics.

Semantic Query Markup Language (SQML). A proprietary XML-based query language used by this invention to define, store, interpret and execute client-side semantic queries. SQML includes tags to define a query that gets its data from diverse resources (that represent data sources) such as files, folders, application repositories, and references to Agency XML Web Services (via resource identifiers and URLs). In addition, SQML includes tags that enable semantic filtering (via custom links and predicates) which indicate how data is to be queried and filtered from the resources, and arguments that indicate how the resources are to be queried and how the results are to be filtered. In particular, the arguments can include references to local or remote context. The context arguments are then resolved by the client-side SQP at run-time to XML metadata. The XML metadata is then passed to the appropriate resource (e.g., an Agency's XML Web Service) as a method call along with the reference to the resource and the semantic links and predicates that indicate how the query is to be resolved by the resource (e.g., the Agency's XML Web Service). SQML is to the Information Nervous System as HTML is to Today's Web. The main difference is that SQML defines the rules for semantic querying while HTML defines the rules for Hypertext presentation. However, SQML is superior in that it enables the client to recursively create new semantic queries from existing ones (by creating new SQML with new links derived from an existing SQML query), e.g., via drag and drop and smart copy and paste, the Smart Lens, Context Templates and Palettes, etc. In addition, because SQML does not define the rules for presentation, the results of the semantic query can be presented in multiple ways, using a “skin” that takes the results (in SRML) to generate presentation based on the user's preferences, interests, condition, or context. Furthermore, SQML can contain abstract links and predicates such as those that refer to or employ Context Templates. The resource (e.g., the Agency's XML Web Service) then resolves the SQML to an appropriate query format (e.g., SQL or the equivalent in the case of an Agency's XML Web Service) and then invokes the “actual” query in order to generate the results (which will then account for the user's context or Context Template). Also, an SQML buffer or file can refer to multiple resources (and Agencies), thereby empowering the client to view results in an aggregated fashion (e.g., based on context or time-sensitivity), rather than based on the source of the data—this is a powerful feature of the invention that enables user-controlled browsing and information aggregation (see the sections on both below). Lastly, every client-side Agent has an SQML definition and file, just as every Web page has an HTML file.

Semantic Query Processor™ (SQP). Trademarked name for the server-side semantic query processor (XML Web Service in the preferred embodiment) that takes SQML and converts it to SQL (in the preferred embodiment) and then returns the results as XML. On the Knowledge Integration Server (KIS), the SQP is the main entry point to the Semantic Network of the present invention responsible for responding to semantic queries from clients of the KIS. On the server, this is the software component that processes semantic queries represented as SQML from the client. On the client, the client-side SQP takes aggregate SQML and compiles or maps it to individual SQML queries that can be sent to a server (or Agency) XML Web Service.

Semantic Results Markup Language (SRML). A proprietary XML-based data schema and format used by this invention to define, store, interpret and present semantic results. On the client, SRML is returned from the SQP via semantic resource handlers that interpret, format, and issue query requests to semantic data sources. Semantic data sources will include an Agency's XML Web Service, local files, local folders, custom data sources from local or remote applications (e.g., a Microsoft Outlook email application inbox), etc. The XML Web Service will return SRML to a client, in response to the client's semantic query. This way, the XML Web Service will not “care” how the results are being presented at the client. This is in contrast with Today's Web and the Semantic Web where servers return already-formatted HTML for a client to present and where clients merely present presentation data (as opposed to semantic data) and cannot customize the presentation of the data. In this invention, two clients can render the same SRML in completely different ways, based on the current “skin” that has been selected or applied by the user of either client. The “skin” then converts the SRML to a presentation-ready format such as XHTML, DHTML+TIME, SVG, Flash MX, etc.

SRML is a meta-schema, meaning that it is a container format that can include data for different information object types (e.g., documents, email, people, events, etc.). An SRML file or buffer can contain intertwined results for each of these object types. Well-formed SRML will contain well-formed XML document sections that are consistent with the schema of the information object types that are contained in the semantic result the SRML represents. See Sample A of the Appendix hereto.

Semantic Web. Extension of Today's Web in which information is given well-defined meaning, better enabling computers and people to work in cooperation. See Tim Berners-Lee, James Hendler, Ora Lassila, The Semantic Web, Scientific American, May 2000.

Facilities to put machine-understandable data on Today's Web are becoming a high priority for many communities. The Web can reach its full potential only if it becomes a place where data can be shared and processed by automated tools as well as by people. For the Web to scale, tomorrow's programs must be able to share and process data even when these programs have been designed totally independently. The Semantic Web is a conceptual vision: the idea of having data on the Web defined and linked in a way that it can be used by machines not just for display purposes, but for automation, integration and reuse of data across various applications. See also http://www.w3.org/2001/sw/.

Session Announcement Protocol (SAP). In order to assist the advertisement of multicast multimedia conferences and other multicast sessions, and to communicate the relevant session setup information to prospective participants, a distributed session directory may be used. An instance of such a session directory periodically multicasts packets containing a description of the session, and these advertisements are received by other session directories such that potential remote participants can use the session description to start the tools required to participate in the session.

In its simplest form, this involved periodically multicasting a session announcement packet describing a particular session. To receive SAP, a receiver simply listens on a well-known multicast address and port. Sessions are described using the Session Description Protocol (ftp://ftp.isi.edu/in-notes/rfc2327.txt). If a receiver receives a session announcement packet it simply decodes the SDP message, and then can display the session information for the user. The interval between repeats of the same session description message depends on the number of sessions being announced (each sender at a particular scope can hear the other senders in the same scope) such that the bandwidth being used for session announcements of a particular scope is kept approximately constant. If a receiver has been listening for a set time, and fails to hear a session announcement, then the receiver can conclude that the session has been deleted and no longer exists. The set period is based on the receivers' estimate of how often the sender should be sending.

See, generally, http://www.faqs.org/rfcs/rfc2974.html, http://www.video.ja.net/mice/archive/sdr_docs/node1.html, ftp://ftp.isi.edu/in-notes/rfc2327.txt.

Simple Mail Transfer Protocol (SMTP). Protocol designed to transfer mail reliably and efficiently. SMTP is independent of the particular transmission subsystem and requires only a reliable ordered data stream channel. An important feature of SMTP is its capability to relay mail across transport environments. See http://www.ietf.org/rfc/rfc0821.txt.

Skins. Presentation templates that are used to customize the user experience on a per-Agent basis or which customizes the presentation of the entire layout (independent of the Agent), or object (based on the information object type), context (based on the Context Template), Blender (for Agents that are Blenders), for the semantic domain name/path or ontology, and other considerations. Each Agent will include a Skin which in turn will have an XML metadata representation of parameters to customize the layout of the XML results that represent information objects (the layout Skin), for example, whether or not those results are animated, the manner in which each result is displayed, including a representation of the object type (the object Skin), styles, colors, graphics, filters, transforms, effects, animations (and so on) that indicate the ontology of the current results (the ontology Skin), styles that indicate the Context Template of the current results (the context Skin) and styles that indicate how to view and navigate results from Blenders (i.e., the Blender Skin).

Smart Lens™. Trademarked name for a proprietary feature of this invention that allows users to select a Smart Agent or an object as a context with which to view another object or Agent. The lens then displays metadata, links, and result previews that give users an indication of what they should expect if the context is invoked. Essentially, the Smart Lens displays the results of a “potential query.” The Smart Lens allows users to quickly preview context results without actually invoking queries (thereby increasing their productivity). In addition, the Smart Lens can display views that are consistent with the context, using pivots, templates and preview windows, thereby allowing users to analyze the context in different ways before invoking a query.

Smart Virtual Web™. Trademarked name for the property of the present invention to integrate semantics, context-sensitivity, time-sensitivity, and dynamism in order to empower users to browse a dynamic, virtual, “on-the-fly,” user-controlled “Web” that they control and can customize. This is in contrast with Today's Web and the conceptual Semantic Web, both of which employ a manually authored network wherein users are at the mercy of the authors of the information on the network.

Structured Query Language (SQL). Pronounced “ess-que-el.” SQL is used to communicate with a database. According to ANSI (American National Standards Institute), it is the standard language for relational database management systems. SQL statements are used to perform tasks such as update data on a database, or retrieve data from a database. Some common relational database management systems that use SQL are: Oracle, Sybase, Microsoft SQL Server, Access, Ingres, etc. Although most database systems use SQL, most of them also have their own additional proprietary extensions that are usually only used on their system. However, the standard SQL commands such as “Select”, “Insert”, “Update”, “Delete”, “Create”, and “Drop” can be used to accomplish almost everything that one needs to do with a database.

SQL works with relational databases. A relational database stores data in tables (relations). A database is a collection of tables. A table consists of a list of records, each record in a table preferably includes the same structure, and each has a fixed number of “fields” of a given type.

See, generally, http://www.sqlcourse.com/intro.html and http://www.dcs.napier.ac.uk/˜andrew/sql/0/w.htm.

Scalable Vector Graphics (SVG). Language for describing two-dimensional graphics in XML. SVG allows for three types of graphic objects: vector graphic shapes (e.g., paths consisting of straight lines and curves), images and text. Graphical objects can be grouped, styled, transformed and composited into previously rendered objects. Text can be in any XML namespace suitable to the application, which enhances searchability and accessibility of the SVG graphics. The feature set includes nested transformations, clipping paths, alpha masks, filter effects, template objects and extensibility. SVG drawings can be dynamic and interactive. The Document Object Model (DOM) for SVG, which includes the full XML DOM, allows for straightforward and efficient vector graphics animation via scripting. A rich set of event handlers such as onmouseover and onclick can be assigned to any SVG graphical object. Because of its compatibility and leveraging of other Web standards, features like scripting can be done on SVG elements and other XML elements from different namespaces simultaneously within the same Web page. See http://www.w3.org/Graphics/SVG/Overview.htm8.

Taxonomy. An organizational structure wherein divisions are ordered into groups or categories.

Time-Sensitivity. Property of an information medium to deliver and present information based on when the information would be most relevant in time. For instance, freshness is an attribute that denotes time-sensitivity. In addition, the delivery and presentation of upcoming events (which, by definition, are time-sensitive) and the manner in which the time-criticality of the events are displayed are properties of a time-sensitive medium.

Today's Web. This refers to the World Wide Web as we know it today. Today's Web is a universe of hypertext servers (HTTP servers), which are the servers that allow text, graphics, sound files, etc. to be linked together. Hypertext is simply a non-linear way of presenting information. Rather than reading or learning about things in the order that an author, or editor, or publisher sets out for us, readers of hypertext may follow their own path, create their own order or meaning out the material. This is accomplished by creating “links” between information. These links are provided so that user may “jump” to further information about a specific topic being discussed (which may have more links, leading each reader off into a different direction). The Hypertext medium can incorporate pictures, sound, and video present a multimedia approach to presenting information, also referred to as hypermedia. See, generally, http://www.w3.org/History.html and http://www.umassd.edu/Public/People/KAmaral/Thesis/hypertext.html.

Multicast Time to Live (TTL). Multicast routing protocol uses the field of datagrams to decide how “far” from a sending host a given multicast packet should be forwarded. The default TTL for multicast datagrams is 1, which will result in multicast packets going only to other hosts on the local network. A setsockopt(2) call may be used to change the TTL. As the value for TTL increases, routers will expand the number of hops they will forward a multicast packet. To provide meaningful scope control, multicast routers typically enforce the following “thresholds” on forwarding based on the TTL field:
0 restricted to the same host
1 restricted to the same subnet
32 restricted to the same site
64 restricted to the same region
128 restricted to the same continent
255 unrestricted
   See http://www.isl.org/projects/eies/mbone/mbone27.htm.

User State. This refers to all state that is either created by a user or which is needed to cache a user's preferences, favorites, or other personal information on a client or server. Client-side User State includes authentication credential information, users' Agent lists (and all the metadata including the SQML queries for the Agents), home Agent, configuration options, preferences such as Skins, etc. Essentially, client-side User State is a persisted form of users' Semantic Environment. Server-side User State includes information such as users' Favorite Agents, subscribed Agents, Default Agent, semantic links to information objects on the server (e.g., “favorites” links) etc. Server-side User State is optional for servers but support for it is preferred. Servers preferably support user logon and a “people” object type (even without server-side Agents) because these are needed for features such as favorites, recommendations, and for Context Templates such as “Newsmakers,” “Experts,” “Recommendations,” “Favorites,” and “Classics.”

Virtual Information Object Type™. Trademarked name for object types that do not map to distinct object types, yet are semantically of interest to users.

Virtual Parameter™. Trademarked name for variables, parameters, arguments, or names that are dynamically interpreted at runtime by the semantic query processor. This allows the Agency administrator to store Agents that refer to virtual names and then have those names be converted to actual relevant terms when the query is invoked.

Web of Trust. Term coined by members of the Semantic Web research community that refers to a chain of authorization that users of the Semantic Web can use to validate assertions and statements. Based on work in mathematics and cryptography, digital signatures provide proof that a certain person wrote (or agrees with) a document or statement. Users can preferably digitally sign all of their RDF statements. That way, users can be sure that they wrote them (or at least vouch for their authenticity). Users simply tell the program whose signatures to trust. Each can set their own levels of trust (or paranoia), and the computer can decide how much of what it reads to believe.

By way of example, with a Web of Trust, a user can tell a computer that he or she trusts his or her best friend, Robert. Robert happens to be a rather popular guy on the Net, and trusts quite a number of people. All the people he trusts in turn trust another set of people. Each of these measures of trust is to a certain degree (Robert can trust Wendy a whole lot, but Sally only a little). In addition to trust, levels of distrust can be factored in. If a user's computer discovers a document which no one explicitly trusts, but no one has said it has totally false either, it will probably trust that information a little more than one which many people have said is false. The computer takes all these factors into account when deciding the trustworthy of a piece of information. Preferably, the computer combines all this information into a simple display (thumbs-up/thumbs-down) or a more complex explanation (a description of all the various trust factors involved). See http://blogspace.com/rdf/SwartzHendler.

Web Services-Interoperability (WS-I). An open industry organization chartered to promote Web services interoperability across platforms, operating systems, and programming languages. The organization works across the industry and standards organizations to respond to user needs by providing guidance, best practices, and resources for developing Web services solutions. See http://www.ws-i.org.

Web Services Security (WS-Security). Enhancements to SOAP messaging providing quality of protection through message integrity, message confidentiality, and single message authentication. These mechanisms can be used to accommodate a wide variety of security models and encryption technologies. WS-Security also provides a general-purpose mechanism for associating security tokens with messages. No specific type of security token is required by WS-Security. It is designed to be extensible (e.g. support multiple security token formats). For example, a client might provide proof of identity and proof that they have a particular business certification. Additionally, WS-Security describes how to encode binary security tokens. Specifically, the specification describes how to encode X.509 certificates and Kerberos tickets as well as how to include opaque encrypted keys. It also includes extensibility mechanisms that can be used to further describe the characteristics of the credentials that are included with a message. See http://msdn.microsoft.com/library/default.asp?url=/library/en-us/dnglobspec/html/ws-security.asp.

Extensible Markup Language (XML). Universal format for structured documents and data on the Web. Structured data includes things like spreadsheets, address books, configuration parameters, financial transactions, and technical drawings. XML is a set of rules (you may also think of them as guidelines or conventions) for designing text formats that let you structure your data. XML is not a programming language, and one does not have to be a programmer to use it or learn it. XML makes it easy for a computer to generate data, read data, and ensure that the data structure is unambiguous. XML avoids common pitfalls in language design: it is extensible, platform-independent, and it supports internationalization and localization. XML is fully Unicode-compliant. See http://www.w3.org/XML/1999/XML-in-10-points.

XML Web Service (also known as “Web Service”). Service providing a standard means of communication among different software applications involved in presenting dynamic context-driven information to the user. More specific definitions include:
1. A software application identified by a URI whose interfaces and binding are capable of being defined, described and discovered by XML artifacts. Supports direct interactions with other software applications using XML based messages via Internet-based protocols.
2. An application delivered as a service that can be integrated with other Web Services using Internet standards. It is an URL-addressable resource that programmatically returns information to clients that want to use it. The major communication protocol used is the Simple Object Access Protocol (SOAP), which in most cases is XML over HTTP.
3. Programmable application logic accessible using standard Internet protocols. Web Services combine aspects of component-based development and the Web. Like components, Web Services represent black-box functionality that can be reused without worrying about how the service is implemented. Unlike current component technologies, Web Services are not accessed via object-model-specific protocols, such as DCOM, RMI, or IIOP. Instead, Web Services are accessed via ubiquitous Web protocols (ex: HTTP) and data formats (ex: XML).
   See http://www.xmlwebservices.cc/, http://www.perfectxml.com/WebSvc1.asp and http://www.w3.org/2002/ws/arch/2/06/wd-wsa-reqs-20020605.html.

XQuery. Query language that uses the structure of XML to intelligently express queries across all these kinds of data, whether physically stored in XML or viewed as XML via middleware. See http://www.w3.org/TR/xquery/ and http://www-106.ibm.com/developerworks/xml/library/x-xquery.html.

XPath. The result of an effort to provide a common syntax and semantics for functionality shared between XSL Transformations (http://www.w3.org/TR/XSLT) and XPointer (http://www.w3.org/TR/xpath#XPTR). The primary purpose of XPath is to address parts of an XML [XML] document. In support of this primary purpose, it also provides basic facilities for manipulation of strings, numbers and Booleans. XPath uses a compact, non-XML syntax to facilitate use of XPath within URLs and XML attribute values. XPath operates on the abstract, logical structure of an XML document, rather than its surface syntax. XPath gets its name from its use of a path notation as in URLs for navigating through the hierarchical structure of an XML document.

In addition to its use for addressing, XPath is also designed so that it has a natural subset that can be used for matching (testing whether or not a node matches a pattern); this use of XPath is described in XSLT. XPath models an XML document as a tree of nodes. There are different types of nodes, including element nodes, attribute nodes and text nodes. XPath defines a way to compute a string-value for each type of node. Some types of nodes also have names. XPath fully supports XML Namespaces (http://www.w3.org/TR/xpath#XMLNAMES). Thus, the name of a node is modeled as a pair consisting of a local part and a possibly null namespace URI; this is called an (http://www.w3.org/TR/xpath#dt-expanded-name). See http://www.w3.org/TR/xpath#XPTR.

XSL. A style sheet language for XML that includes an XML vocabulary for specifying formatting. See http://www.w3.org/TR/xslt 11/.

XSLT. Used by XSL to describe how a document is transformed into another XML document that uses the formatting vocabulary. See http://www.w3.org/TR/xslt11/.

B. Overview

1. Invention Context

There is a misconception that the Holy Grail for information access is the provision of natural language searching capability. Prior technologies for information access have focused principally on improving the interface for searching for or accessing information to optimize information retrieval. The presumption has largely been that providing a natural language interface to information will perfectly solve users' information access problems and end the frustration users have with finding information.

In truth, however, many axes of analysis are involved in how people acquire knowledge in the real world. One example is context. There are many things people know only because of where they were at a certain place and time. If they were not at that place at that time, they would not know what is in fact known or, indeed, might not care to know. Having the ability to search for what is presently known with natural language does not assist in uncovering the knowledge related to that particular time and place. There are simply no natural parameters that form the correct query to retrieve the desired information.

The conundrum is that a person cannot ask for what he or she might not even know would have value until after the fact. Stated differently, one cannot query for what they do not know they do not know, or for what they do not know that they might want to know. Context-sensitivity, time-sensitivity, discovery, dynamic linking, user-controlled browsing, users' “Semantic Environment,” flexible presentation, Context Skins, context attributes, Context Palettes (which bring up relevant, context and time-sensitive information based on Context Templates) and other aspects of this invention recognize and correct this fundamental deficiency with existing information systems.

For example, people may have many CDs in their library (thereby adding to the “knowledge” of music) because they attended certain parties and spoke with certain people. Those people at those parties mentioned the CDs to the person, thereby increasing the person's knowledge of music. As another example, a person may purchase a book (if read, increasing the person's knowledge on the particular topic of the book), based on a recommendation from a hitherto unknown stranger the person happened to sit beside on an airplane flight. In the real world, people acquire knowledge based not just on what they read and search for, but also based on the friends they keep, the people with whom they interact and the people whose judgment they trust. The “knowledge environment” is arguably as critical if not more critical for knowledge dissemination and acquisition as the model for retrieval (whether digital or analog).

The present invention mirrors virtually every real-world knowledge-acquisition scenario in the digital world. The resulting Information Nervous System™ is the medium doing most of the work but the scenarios map very cleanly to the analog (real) world. The inability of efforts such as natural-language search techniques of Today's Web as well as the Semantic Web to recognize the many ways in which knowledge is disseminated and acquired render them ultimately ineffective. The present invention accounts for the variety of ways in which humans have always acquired knowledge—independent of the actual technology used for information delivery.

By way of example, there has always been context and there has always been time. Likewise there has always been the notion of discovery and the need to link information dynamically and with user control. There have always been certain Context Templates, albeit in different mediums that presented herein, including “classics,” “history,” “timelines,” “upcoming events,” “headlines.” These templates existed before the creation of the Internet, Today's Web, Email, e-Learning, etc. Nevertheless, prior to the present invention, there was no ability in the electronic medium to focus on the mode, protocol and presentation of knowledge delivery which maps to real-world scenarios (for example, via Context Templates, context-sensitivity, time-sensitivity, dynamic linking, flexible presentation, Context Skins, context attributes, etc.) as opposed to actual information types, semantic links, metadata, etc. There will always be new information types. But the dissemination and acquisition axes of knowledge (e.g., Context Templates) have always and will always remain the same. The present invention captures this reality.

In addition, the present invention provides the ability to disseminate knowledge via serendipity. Serendipity plays a large part in knowledge acquisition in the real world and it is a first-class mode of knowledge delivery. The present invention enables a user to acquire information serendipitously (albeit intelligently) by its support for context, time, Context Templates, etc.

Information models or mediums that employ a strict, static structure like a “Web” break down because they assume the presence of an authored “network” or “Web” and fail to account for the various axes of knowledge formation. Such information models are not user-focused, do not incorporate context, time, dynamism and templates, and do not map to real-world knowledge acquisition and dissemination scenarios. The present invention minimizes information loss and maximizes information retained, even without the presence of a “Web” per se, and even if no natural language is employed to find information. This is possible because, unlike existing mediums for information access, a preferred embodiment of the present invention focuses on the knowledge dissemination models that incorporate context, time, dynamism, and templates (for the benefit of both the end-user and the content producer) and not on the specifics of the access interface, or the linking (semantic or non-semantic) of information resources based on static data models or human-based authoring. In many scenarios, a “Web” (semantic or non-semantic) is necessary as a means of navigation, but is far from being sufficient as a means of knowledge dissemination and acquisition. The Information Nervous System of the present invention incorporates “knowledge axes” described in the invention (including but not limited to link-based navigation) and intelligently and seamlessly integrates them to facilitate the dissemination and acquisition of knowledge and to benefit all parties involved in the transfer of knowledge.

2. Value Propositions

Today, knowledge must be “manually hard-coded” into the digital fabric of an information structure, whether it be for an enterprise, a consumer or the general inquiring population. If it is not authored and distributed properly, no one knows of its existence, knows how it relates to other sources of intelligence, or knows how to act on it in real-time and in the proper fashion. This is largely because Today's Web was not designed to be a platform for knowledge. It was designed to be a platform for presentation and is intentionally dumb, static, and reactive. Today, knowledge-workers—those who seek to use information by adding context and meaning—are at the mercy of knowledge-authors.

A significant aspect of knowledge interaction is to have knowledge-workers be able to navigate their way through a knowledge space in a very intuitive manner, and at the speed at which they wish to make decisions and act on the knowledge. In other words, knowledge-workers do not have to “think” about an e-Learning island as being separate from documents in their organizations, e-mail that contains customer feedback, media files, upcoming video-conferences, a meeting they had recently, information stored in newsgroups, or related books. The preferred situation is to relegate the information “type” and “source” and to create a “seamless knowledge experience” that cuts across all those islands in a semantic way.

In creating a knowledge experience, it is also preferred to be able to integrate knowledge assets across content-provider, partner, supplier, customer and people boundaries. In the enterprise scenario, for example, no single organization has all the knowledge it needs to remain competitive. Knowledge is stored in industry reports, research documents from consulting firms and investment banks, media companies like Reuters™ and Bloomberg™, etc. All this constitutes “knowledge.” It is not enough to deploy an e-Learning repository to train users on a one-time or periodic basis. Users should have always-on access to knowledge from a variety of sources, in-place, and in an intelligent context that is relevant to their current task.

All this requires a layer of intelligence and pro-activity that is not available today. Today, for example, enterprises use information portals, such as intranets and the Internet, as a way of disseminating information to their employees. However, this is far from being enough, as it provides only presentation-level integration. This is akin to subscribing to newsletters to keep updated with information, as opposed to having an Agent that manages your information for you, helps you discover new information on-the-fly, helps you capture and share information with colleagues, etc.

To accomplish the desired level of knowledge interaction requires Agents working in the background, reasoning, learning, inferring, matching users together based on their profiles, capturing new knowledge and automatically deducing new knowledge, and federating knowledge from external sources so that they become a seamless part of the knowledge experience. This in turn requires the semantic integration of knowledge assets so that they all make sense in a holistic fashion, rather than merely providing the basis for presentation-level integration and document searching. The implementation framework and resulting medium must provide real-time, agile discovery and recommendation services so that context and time-sensitive information is “honored” and such that knowledge-workers can be more productive and get more done faster and with less. And lastly, the system must work with existing information sources in a plug-n-play manner, must seamlessly and automatically classify and integrate known knowledge assets, and must embed the knowledge tools in the knowledge themselves, thereby adding another “dimension” into knowledge assets.

The present invention is designed to be an intelligent, proactive, real-time knowledge platform that co-exists with Today's Web (or any other layer of presentation). Incorporation and use of the present invention will allow knowledge-workers to be in control of their knowledge experiences because authoring (via “connections”) will be done intelligently, dynamically, automatically, and at the speed of thought.

3. Today's “Information” Web vs. the Information Nervous System of the Present Invention

With Today's Web environment, the semantics of information presented are lost upon conversation of the structured data to HTML at the server, meaning that the “knowledge” is stripped from the objects before the user has an opportunity to interact with them. In addition, Today's Web is authored and “hard-coded” on the server based on how the author “believes” the information will be navigated and consumed. Users consume only information as it is presented to them.

The present invention adds a layer of intelligence and layers of customization that Today's HTML-based Web environment cannot support. The present invention provides an XML-based dynamic Web of smart knowledge objects rather than dumb Web pages wherein the semantics of the objects are preserved between the server and the client, thereby giving users much more power and control over their knowledge experience. In addition, with the Web of the present invention, knowledge-workers are able to consume and act on information on their own terms because they will interactively author their own knowledge experiences via “dynamic linking” and “user-controlled browsing.”

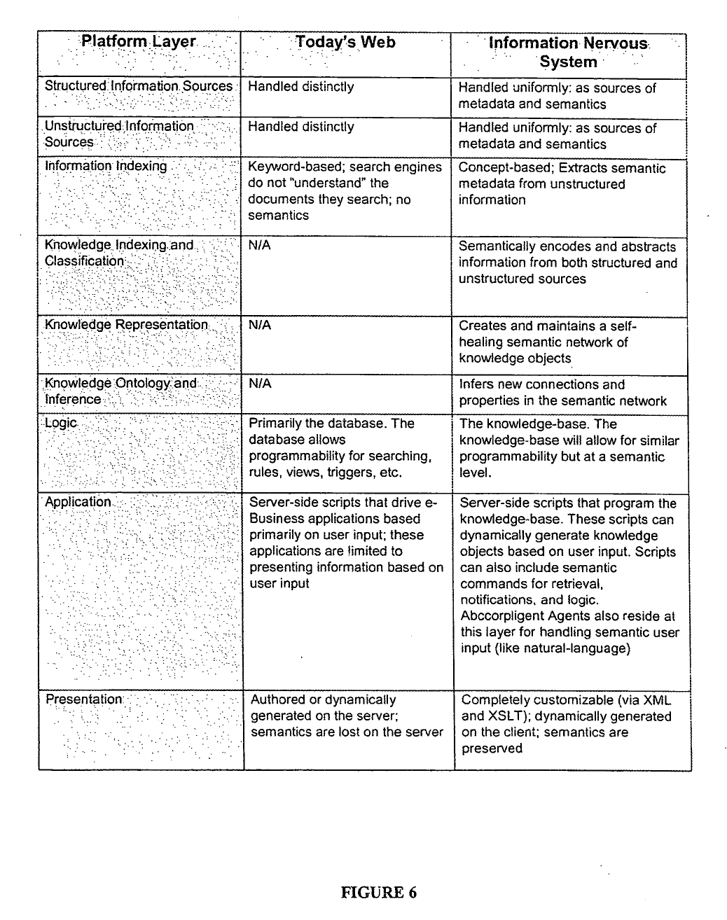

The Information Agent (semantic browser) of the present invention is designed to co-exist with Today's Web and to integrate with and augment all facets of private and public intranets as well as the Internet. The technology platform stacks of Today's Web and the Information Nervous System of the present invention are summarized in FIG. 6. With reference to FIG. 6, the stack for the Today's Web has at the bottommost layers Structured Information Sources, including such information as the data stored in databases, and Unstructured Information Sources, including such information as documents, email messages, etc. Information in both of these layers is handled distinctly. No semantics are used at the Information Indexing Layer; rather, search engines based on keywords are used. The Logic Layer consists primarily of a database that allows programmability for searching, rules, view, triggers, etc. The Application Layer consists of server-side scripts that drive e-Business applications based on user input. At the topmost or Presentation Layer, Today's Web has presentation information (in the form of Web pages) that is exposed via portals with a Web platform (e.g., browser).

Apart from overlapping layers of processing, the present invention uniquely handles information from the bottommost level of operation in a manner that preserves the semantics of the underlying information sources. At both the Structured and Unstructured Information Sources Layers, the system 10 handles information uniformly, taking into account metadata and semantics associated with the information. At the Information Indexing Layer, information metadata and semantics are extracted from unstructured. The system 10 adds three additional platform layers not present in Today's Web: Knowledge Indexing and Classification Layer, wherein information from both structured and unstructured sources are semantically encoded; Knowledge Representation Layer, wherein associations are created that allows maintenance of a self-correcting or healing Semantic Network of knowledge objects; and Knowledge Ontology and Inference Layer, wherein new connections and properties are inferred in the Semantic Network. At the Logic Layer a knowledge-base is created that allows for programmability at a semantic level. At the Application Layer, server-side scripts are used in association with the knowledge-base. These scripts dynamically generate knowledge objects based on user input, and may include semantic commands for retrieval, notifications and logic. This Layer may also include Smart Agents to optimize the handling of semantic user input. The Presentation Layer of the system 10 preserves the semantics that are tracked from the bottommost layers. Presentation at this Layer is dynamically generated on the client computer system and completely customizable.

By the maintenance, integration and use of semantics in all technology layers, the present invention creates a virtual Web of actionable “objects” that directly correspond to “things” that humans interact with physically or virtually or, in other words, as familiar “Context Templates.” As opposed to Today's Web, which is a dumb Web of documents, the present invention provides for a smart virtual Web of actionable objects that have properties and relationships, and in which events can dynamically cause changes in other parts of the virtual Web.

The present invention provides a programmable Web. Unlike Today's Web which is a dumb Web of documents, the Web of the present invention is programmable akin to a database—it is able to process logic and rules, and will be able to initiate events.

While Today's Web is encoded for human, and thus is focused primarily on presentation of static information, the virtual Web of the present invention is encoded primarily for machines, albeit ultimately presented to humans as the end of the knowledge delivery chain. The present invention provides an intelligent, learning Web. This means that the virtual Web of the present invention will be able to learn new connections and become smarter over time. The Web is dynamic, virtual and self-authoring, thereby providing much more power to knowledge-workers by intelligently and proactively making semantic connections that Today's Web is unable to provide, thereby leading to a reduction in and eventual elimination of information loss.

The Web of the present invention is a self-healing Web. Unlike Today's web which has to be manually maintained by document authors, the present invention provides a Web that is self-maintained by machines. This feature rectifies broken links because the Web will fix disconnections in the network automatically.

Finally, as will be set forth in greater detail below, the various embodiments of the present invention incorporate some or all of the axes of knowledge acquisition described above to provide substantial advantages over existing systems directed to Today's Web or the conceptual Semantic Web.

C. System Architecture and Technology Considerations

1. System Overview

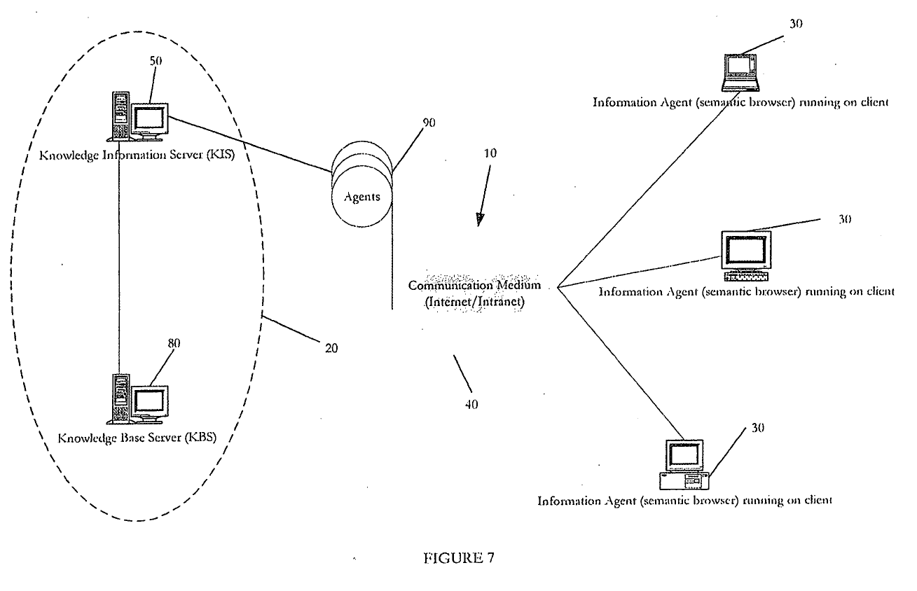

The present invention is directed to a system and method for knowledge retrieval, management and delivery. This system and method is referred to herein by the trademarked term Information Nervous System™. With reference to FIG. 7, at its highest level the system 10 includes a server 20 comprised of several components that work together to provide context and time-sensitive semantic information retrieval services to clients 30 operating a presentation platform (e.g., a browser) via a communication medium 40, such as the Internet or an intranet. The server components preferably include a Knowledge Integration Server (KIS) 50 and a Knowledge Base Server (KBS) 80, which may be physically integrated or separate. Within the system, all objects or events in a given hierarchy are active Agents 90 semantically related to each other and representing queries (comprised of underlying action code) that return data objects for presentation to the client according to a predetermined and customizable theme or “Skin.” This system contemplates wide variety of applications, as well as various means for the client to customize and “blend” Agents and the underlying related queries to optimize the presentation of the resulting information. Each of the preferred components of the system 10 of the present invention, as well as the interaction among the components, is described in greater detail below.

2. System Architecture

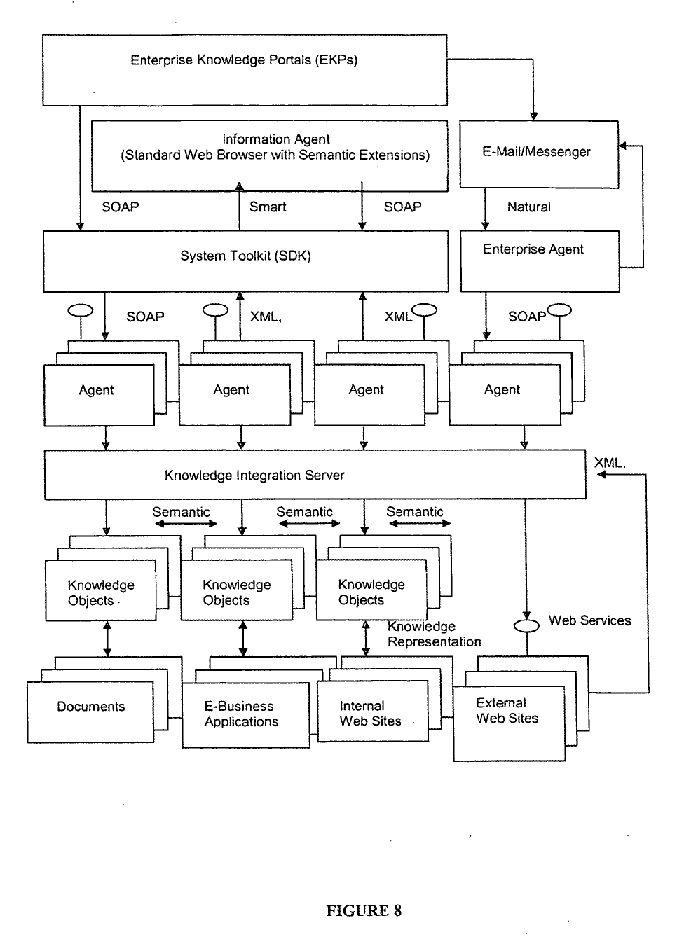

The end-to-end system architecture for the Information Nervous System of the present invention is shown with reference to FIG. 8. FIG. 8 illustrates how the present invention provides multiple client access means of communication between the Information Nervous System XML Web Service (KIS) and Smart Agents. In the preferred embodiment, this occurs via the Information Agent. In an alternative embodiment, the communication may occur programmatically via an Enterprise Knowledge Portal (e.g., Today's Web access browser) or via an SDK layer that enables programmatic integration with a custom client.

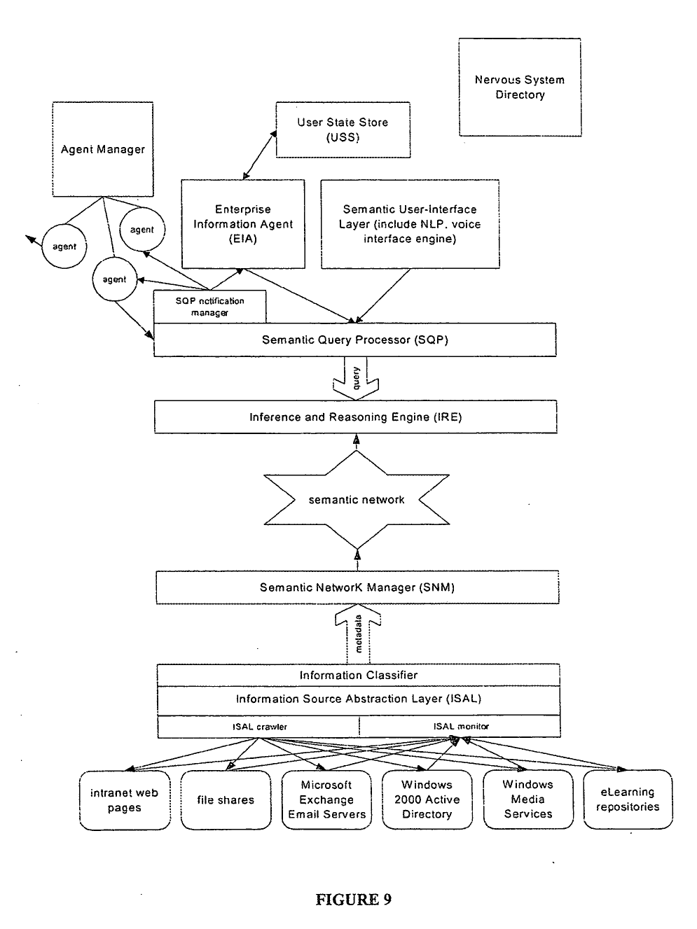

The system architecture for the KIS of the Information Nervous System, including components thereof, are shown with reference to FIG. 9. These components are described in greater detail below.

3. Technology Stacks

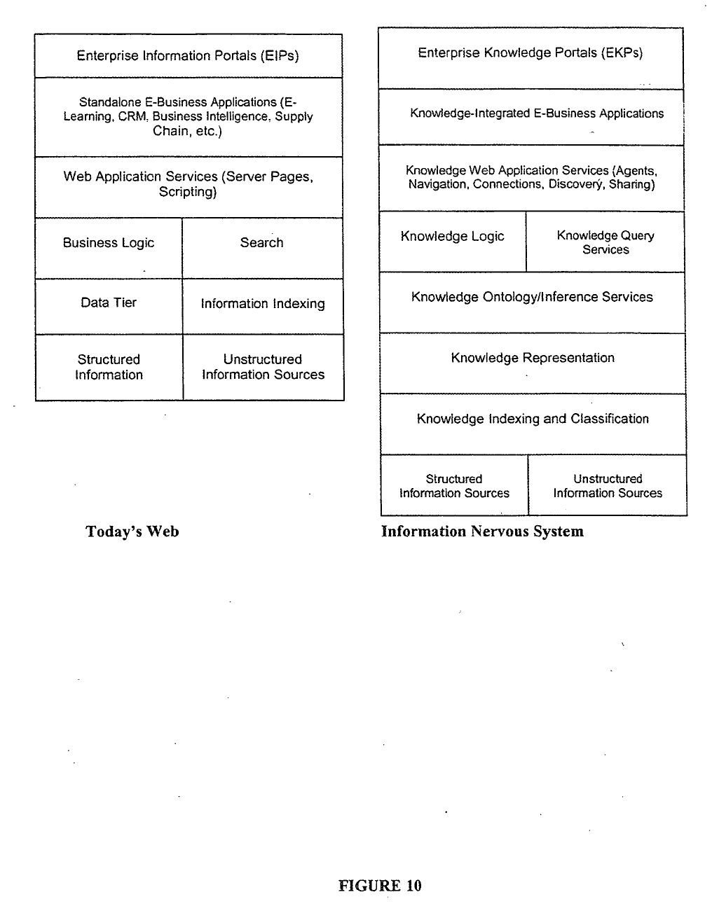

The significant differences between Today's Web and the conceptual Semantic Web are further highlighted by reference to the technology stacks of each as shown with reference to FIG. 10. FIG. 10 is a side-by-side comparison of the high-level descriptive platform layers of Today's Web and the equivalents (where applicable) in the Information Nervous System of the present invention. FIG. 10 illustrates how scenarios in Today's Web map to scenarios in the Information Nervous System in certain instances, thus providing users with a logical migration path, but also highlights aspects of the Information Nervous System that do not exist in Today's Web.

4. System Heterogeneity

Heterogeneity is an advantage of the present invention. In the preferred embodiment, the KIS Agency XML Web Service is portable. This means that it supports open standards such as XML, XML Web Services that are interoperable (e.g., that employ the WS-I standard for interoperability), standards for data storage and access (e.g., SQL and ODBC/JDBC) and standard protocols for the information repositories from which the DSAs gather data (e.g., LDAP, SMTP, HTTP, etc.), etc.

For example, in a preferred embodiment, a KIS (on which an Agency is running) is able to:
Gather its “people” metadata from an LDAP store (using an LDAP DSA). This allows it to support Microsoft's Windows 2000 Active Directory, Sun's Directory Server, and other Directory products that support LDAP. This is preferable to having a platform-specific Active Directory DSA that uses platform-specific APIs to gather “people” metadata.
Gather its email metadata from an SMTP store (for email from any source or for the system inbox). This allows it to support Microsoft Exchange, Lotus Notes, and other email servers (which support SMTP). This is preferable to having a platform-specific Microsoft Exchange Email DSA or a Lotus Notes Email DSA.
Gather its “event” metadata from a calendar store supporting an open standard like iCalendar and use a protocol such as Calendar Access Protocol (CAP). This allows it to support any event repository that supports the iCalendar or CAL protocol standard. This is preferable to having a platform-specific Microsoft Exchange Calendar (or Event) DSA, a Lotus Notes Calendar DSA, etc.

In an alternative embodiment, the KIS Agency may be configured to extract metadata stored in a proprietary repository (via an appropriate DSA).

To achieve heterogeneity, in the preferred embodiment, for client-server communications, the system 10 uses XML Web Service standards that work in an interoperable manner (across platforms). These include appropriate open and interoperable standards for SOAP, XML, Web Services Security (WS-Security), Web Services Caching (WS-Caching), etc.

In the preferred embodiment of the present invention, the semantic browser (also referred to by the trademarked term Information Agent™) is able to operate cross-platform and in different environments, such as Windows, .NET, J2EE, Unix, etc. This ability is consistent with the notion of a semantic user experience in that users do not and should not care about what “platform” the browser is running on or what platform the Agency (server) is running on. The semantic browser of the present invention provides users with a consistent experience regardless whether they are “talking” to a Windows (or .NET) server or a J2EE server. Users are not required to take any extra steps while installing or using the client based on the platform on which any of the Agencies they are interacting with is running.

The Information Agent preferably uses open standards for its Skins and other presentation effects. These include standards such as XSLT, SVG, and proprietary presentation formats that work across platforms (e.g., appropriate versions of Flash MX/ActionScript).

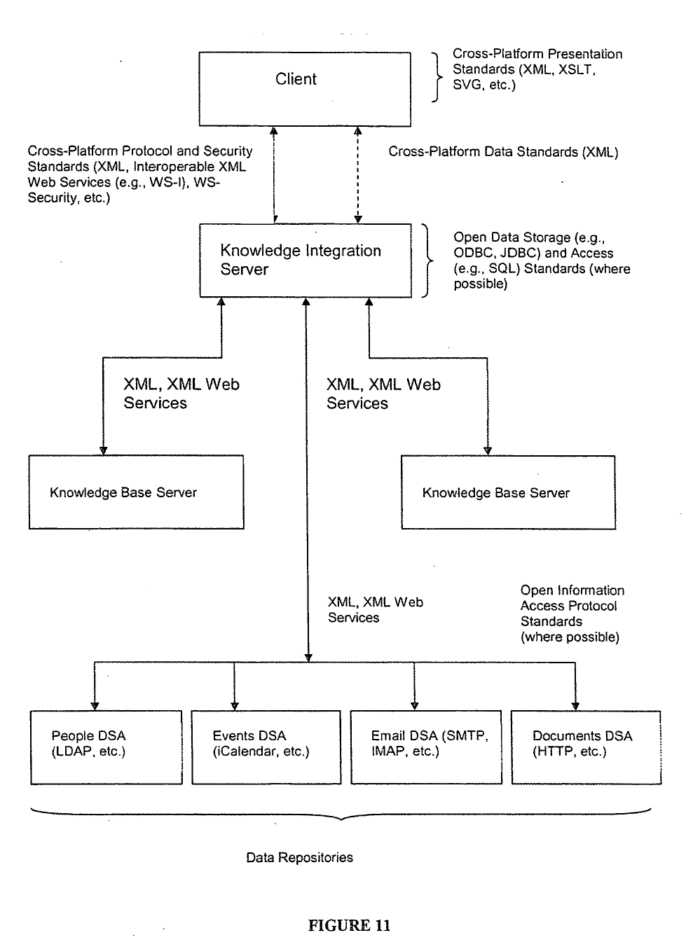

A sample, heterogeneous, end-to-end implementation of a preferred embodiment of the Information Nervous System of the present invention is shown with reference to FIG. 11. FIG. 11 illustrates the preferred embodiment of the Information Nervous System and illustrates the heterogeneous, cross-platform context for the present invention. The components shown in FIG. 11 are described in greater detail below.

5. Security

The preferred embodiment of the Information Nervous System provides support for all aspects of security: authentication, authorization, auditing, data privacy, data integrity, availability, and non-repudiation. This is accomplished by employing standards such as WS-Security, which provides a platform for security with XML Web Service applications. Security is preferably handled at the protocol layer via security standards in the XML Web Service protocol stack. This includes encrypting method calls from clients (semantic browsers) to servers (Agencies), support for digital signatures, authenticating the calling user before granting access to an Agency's Semantic Network and XML Web Service methods, etc.

The preferred embodiment that the present invention supports local (client-side) credential management. This is preferably implemented by requiring users to enter a list of their usernames and passwords that they use on multiple Agencies (within an Intranet) or over the Internet. The semantic browser aggregates information from multiple Agencies that may have different authentication credentials for the user. Supported authentication credentials optionally include common schemes such as basic authentication using a username and password, basic authentication over SSL, Microsoft's .NET Passport authentication service, the new Liberty Alliance authentication service, client certificates over SSL, digest authentication, and integrated Windows authentication (for use in Windows environments).

In the preferred embodiment, with the users' credentials cached at the client, the semantic browser uses the appropriate credentials for a given Agency by checking the supported authentication level and scheme for the Agency (which is part of the Agency's schema). For example, if an Agency supports integrated Windows authentication, the semantic browser invokes the XML Web Service method with the logon handle or other identifier for the current user. If the Agency supports only basic authentication over SSL, the semantic browser passes either the username and password or a cached copy of the logon handle (if the client was previously logged on and the logon handle has not expired) in order to logon. The preferred embodiment employs techniques such as logon handle caching, aging and expiration on the KIS in order to speed up the authentication process (and logon handle lookups) and in order to provide more security by guarding against hijacked logon handles.

The Agency XML Web Service preferably supports different authentication schemes either implicitly (if the feature is natively supported by the server operating system or application server) or at the application-level by the XML Web Service implementation itself. Alternative embodiments of the KIS Agency's XML Web Service preferably employ a variety of authentication schemes such as basic authentication, basic over SSL, digest, integrated Windows authentication, and client certificates over SSL, and integrated .NET passport authentication.

6. Efficiency Considerations

Client-Side and Server-Side Query and Object Caches. The present invention provides for query caches, which are responsible for caching queries for quick access. On the client, the client-side query cache caches the results of SQML queries with specified arguments. The cache is preferably configured to purge its contents after a predetermined amount of time (e.g., a few minutes). The amount of time is preferably set by modeling system usage and arriving at an optimal value for the cache time limit. Other parameters may also be considered, such as the data arrival rate on the Agency (in the case of per-Agency caches, which is another implementation option), the usage model (e.g., navigation rate) of the user, etc.

Caching improves performance because the client does not have to needlessly access recently used servers as the user navigates the semantic environment. In the preferred embodiment, the client employs standard XML Web Service Caching technologies (e.g., WS-Caching). In addition, on the client, there is preferably an object cache. This cache caches the results of each SQML resource and is tagged with the resource reference (e.g., the file path, the URL, etc.). This optimizes SQML processing because the client can get the XML metadata for an SQML resource directly from the object cache, without having to access the resource itself. The resource may be the local file system, a local application (e.g., Microsoft Outlook), or an Agency's XML Web Service. Like the query cache, the object cache may be configured to purge its contents after a set amount of time (e.g., a few minutes).

In an alternative embodiment, on the server, the server-side query cache caches the category results for XML arguments. This speeds up the query response time because the server does not have to ask the KDM to categorize XML arguments (via the one or more instances of the KBS that the KIS is configured to get its domain knowledge from) on each query request. In addition, the server can cache the SQL equivalents of the SQML arguments it receives from clients. This speeds up the query response time because the server would not have to convert SQML arguments to SQL each time it receives a request from a client. In the preferred embodiment, aggressive client-side caching is employed and server-side caching is avoided unless it clearly improves performance. This is because client-side caching scales better than server-side caching since the client caches requests based on its local context.

Virtual, Distributed Queries. The present invention employs virtual, distributed queries. This is consistent with its “dynamic linking” and “user-controlled browsing” functionality. The system does not require static networks that link—or massive individual databases that house—all the metadata for the system. This precludes the need for manual authoring and maintenance on a local or global scope. In addition, this precludes the need for integrated (or universal) storage, wherein all the metadata is required to be stored on a single metadata store and accessible through one database query interface (e.g., SQL). Rather, the present invention employs the principle of “Dynamic Access” via its use of XML Web Services to dynamically distribute queries across various Agencies (in a context and time-sensitive manner), and to aggregate the results of those queries in a consistent and user-friendly manner on the client.

D. System Components and Operation

1. Agencies and Agents

The present invention introduces a unique approach to using Agencies and Agents to retrieve, manage and deliver knowledge.

a. Agencies

In a preferred embodiment of the present invention, the Agency is an instance of the Knowledge Integration Server (KIS) 50 and is the invention's equivalent of a Web site. An Agency is preferably installed as a Web application (on a Web server) so as to expose XML Web Services. An Agency will preferably include an Agency administrator. In a preferred embodiment of the present invention, an Agency has the following primary components:
A flag indicating whether the Agency supports or requires authentication (or both). If the Agency requires authentication, the Agency will require basic user information and a password and will store information on the type of authentication it supports. For Agencies that store user information, the Agency will also require user subscription information (for subscription to Agents on a specific Agency).
Structured stores of semantic objects (documents, email messages, etc.)—Corresponding to schemas for the respective classes.
Runtime components that respond to semantic queries—Components return XML to the calling application and provide system services for all the information retrieval features of the semantic browser.

Server-Side User State. In the preferred embodiment of the present invention, Agencies support server-side User State, which associates related concepts including “people” metadata and user authentication. Server-side User State facilitates many of the implementation details of the present invention, including the storage of user favorites (by semantic links between people objects and information objects), the inference of favorites in order to generate new links (e.g., recommendations), Annotations (that map users' comments to information objects), and the inference of “experts” based on semantic links that map users to information (e.g., posted emails, annotations, etc.). Server-side User State is preferably used with some Context Templates like “Experts,” “Favorites,” Recommendations,” and “Newsmakers.”

Client-Side User State. The Information Agent (semantic browser) preferably supports roaming of local client-side User State. This includes users' Semantic Environment and users' credentials (securely transferred). In the preferred embodiment, users are able to easily export their client-side User State to another machine in order to replicate their Semantic Environment onto another machine. This is preferably achieved by transferring users' Agent list (recent and favorites), the metadata for the Agents (including the SQML buffers), users' local security credentials, etc. to an XML format that serializes all this state and enables the state to be easily transferred. Alternatively, an XML schema may be developed for all the local client-side User State. Caching the User State on a server and synchronizing the User State using common synchronization techniques can also facilitate roaming. The semantic browser preferably downloads and uploads all client-side User State onto the server, rather than storing the state locally (in an XML file or a proprietary store like the Windows registry).

b. Agents

An Agent is the main entry point into the Semantic Network of the present invention. An Agent preferably consists of a semantic filter query that returns XML information for a particular semantic object type (e.g., documents, email, people, etc.). In other words, an Agent is preferably configured with a specific object type (described below). Agents can also be configured with a Context Template (described below). In this case, the query will return an object type, but it will incorporate the semantics of the Context Template. For example, Agents configured with a “Headlines” Context Template will be sorted by time and relevance, etc. Agents are also used to filter notifications, alerts and announcements. Agents can be given any name. However, in the preferred embodiment of the present invention, the naming format for most Agents is:

<Agentobjecttype>.<semanticqualifier>.<semanticqualifier>

Agents can be named arbitrarily. However, examples of Agent names include:

All.All

Email.All

Documents.Technology.Wireless.80211B.All

Events.Upcoming.NextThirtyDays.All

There will also be Domain Agents (see below) that may follow a different naming convention (see below). At the semantic browser of the present invention, a fully qualified Domain Agent name will have the format:

<Agentobjecttype>.<semanticdomainname>.<categoryname>

[Agency=<Agency url>, kb=<kb url>]

For example, the Email Domain Agent on the Agency http://research.Agency.asp configured with the category wireless.all from the knowledge-base ABC.com/kb.asp with the semantic domain name industries.informationtechnology will be fully named as:

Email.Industries.InformationTechnology.Wireless.All

[Agency=http://research/Agency.asp, kb=“http://abccorp.com/kb.asp”

The semantic browser of the present invention is preferably configurable to use only the Agent name or to include the “Agency” and “kb” qualifiers.

Agent Types. There are three primary types of Agents created on server 20: Standard Agents, Compound Agents, and Domain Agents. A Standard Agent is a standalone Agent that encapsulates structured, non-semantic queries, i.e., without domain knowledge (or an ontology/taxonomy mapping). For example, on the server, the Agent All.PostedToday.All is a simple Agent that is resolved by filtering all objects based on the CreationTime property. Standard Agents can also be more complex. For example, the Agent All.PostedByAnyMemberOfMyTeam.All may resolve into a complicated query that involves joins and sub-queries from the Objects table and the Users table (see below).

A Compound Agent contains other Agents and allows the Agency administrator to create queries that generate results that are the UNION or the INTERSECTION of the results of their contained Agents (depending on the configuration). Compound Agents can also contain other Compound Agents. In the presently preferred embodiment, Compound Agents contain Agents from the same Agency. However, the present invention anticipates the integration of Agents from different Agencies. By way of example, a Compound Agent All.Technology.Wireless.All might be created by compounding the following Agents:
Documents.Technology.Wireless.All
Email.Technology.Wireless.All
People.Experts.Technology.Wireless.All

As described above, a Domain Agent is an Agent that belongs to a semantic domain. A Domain Agent is initialized with an Agent query, just like any other Agent. However, this query includes the CATEGORIES table, which is populated by the Knowledge Domain Manager (see below). While the preferred embodiment of the present invention utilizes a KBS 80 having proprietary ontologies corresponding to a private Semantic Environment, the present invention contemplates integrated support of ontology interchange standards that will enable an Agency to connect to one or more custom private KBS, for example within an organization where the Agency was previously initialized with a proprietary ontology for that organization.

An example of a Domain Agent is Email.Technology.Wireless.All. This Agent is preferably created with a knowledge source URL such as:

category://technology.wireless.all@ABC.com/marketingknowledge.asp

This knowledge source URL corresponds to the Technology.Wireless.All category for the default domain on the knowledge base installed on the ABC.com/marketingknowledge.asp Web service. This is resolved to the following HTTP URL: http://ABC.com/marketingknowledge.asp?category=“technology.wireless.all.” In this example, a fully qualified version of the category URL may be:

category://technology.wireless.all@abccorp.com/marketingknowledge.asp?semanticdomainname=“InformationTechnology”

In this case, the category URL is qualified with the domain names.

Domain Agents are preferably created via a Domain Agent Wizard, and the Agency administrator is able to add Domain Agents from the KBS 80 to the Semantic Network of the present invention. The Domain Agent Wizard allows users to create Domain Agents for specific categories (using a category URL) or for an entire semantic domain name. In the latter case, the Agency is preferably configured to automatically create Domain Agents as new categories are added to the semantic domain on the KBS. This feature allows domains and categories to remain dynamic and therefore easily adaptable to the user's needs over time. When Domain Agents are managed in this fashion, the Agency is configurable so as to remove Agents that are no longer in the semantic domain. Essentially, in this mode, the Domain Agents are synchronized with the CATEGORIES table (which in turn is synchronized with the CATEGORIES list at the relevant KBS by the Knowledge Domain Manager, described below).

A Domain Agent is initialized with a structured query that filters the data the Agent manages based on a category name or URL. In this situation, the structured query is identical to the queries for Standard Agents. An example of a resultant query for a category Agent is:
SELECT OBJECT FROM OBJECTS WHERE OBJECTID IN (SELECT OBJECTID FROM SEMANTICLINKS WHERE PREDICATETYPEID=50 AND SUBJECTID=1000 AND OBJECTID IN (SELECT OBJECTID FROM CATEGORIES WHERE URL LIKE category://technology.wireless.all@ABC.com/kb.asp?domain=“marketing”))
   In this example, the “belongs to the category” predicate type ID is assumed to have the value 50, and the category objectid is assumed to have the value 1000. This query can be translated to English as follows:
Select all the objects in the Agency that belong to the category whose object has an objectid value of 1000 and whose URL is category://technology.wireless.all@abccorp.com/kb.asp?domain=“marketing”
   This in turn translates to:
Select all the objects in the Agency of the category category://technology.wireless.all@abccorp.com/kb.asp?domain=“marketing”

The Domain Agent Wizard asks the user whether he or she wants to name the Agent based on the short category name or a friendly version of the fully qualified category name. An example of the latter is: Marketing.Technology.Wireless.All [@ABC]. The fully qualified Domain Agent naming convention is:

<objecttypename>.<semanticdomainname>.<categoryname>. all [@KB Name].

In this example, the Domain Agent name is:

Email.Marketing.Technology.Wireless.All [@ABC].

Blenders. Blenders are users' personal super-Agents. Users are able to create a Blender and add and remove Agents (across Agencies) to and from the Blender. This is analogous to users having their own “Personal Agency”. Blenders are preferably invoked only on the system client since they include Agents from multiple Agencies. The client of the present invention aggregates all objects from a Blender's Agents and presents them appropriately. Blenders preferably include all manipulation characteristics of other types of Agents, e.g., drag and drop, Smart Lens (see below). A Blender can contain any type of Agent (e.g., Standard Agents, Search Agents, Special Agents, as well as other Blenders).

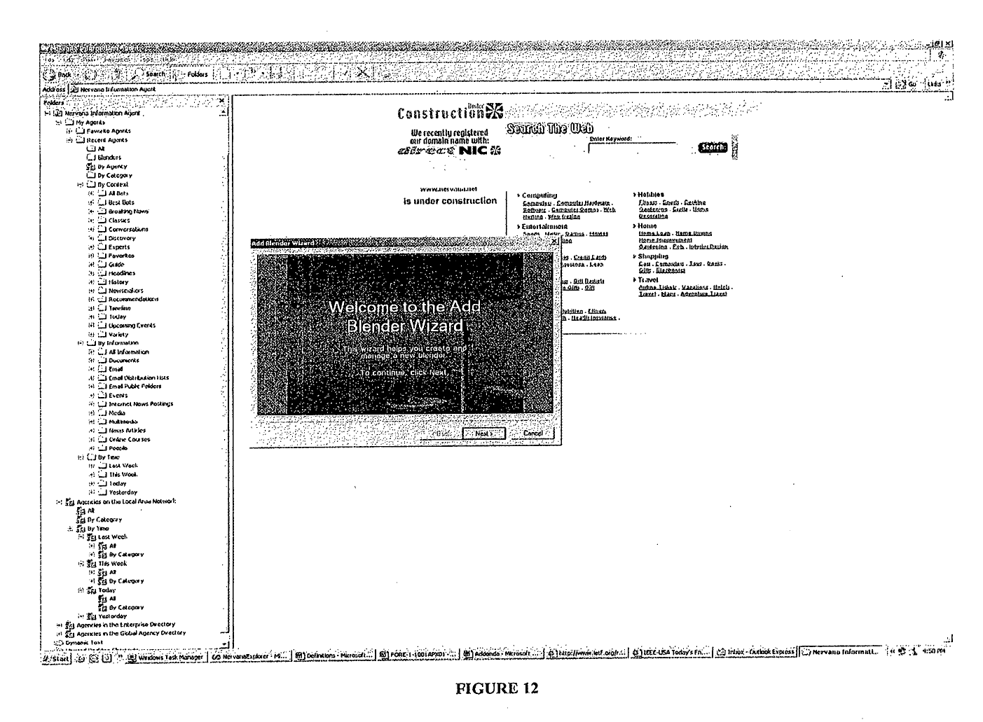

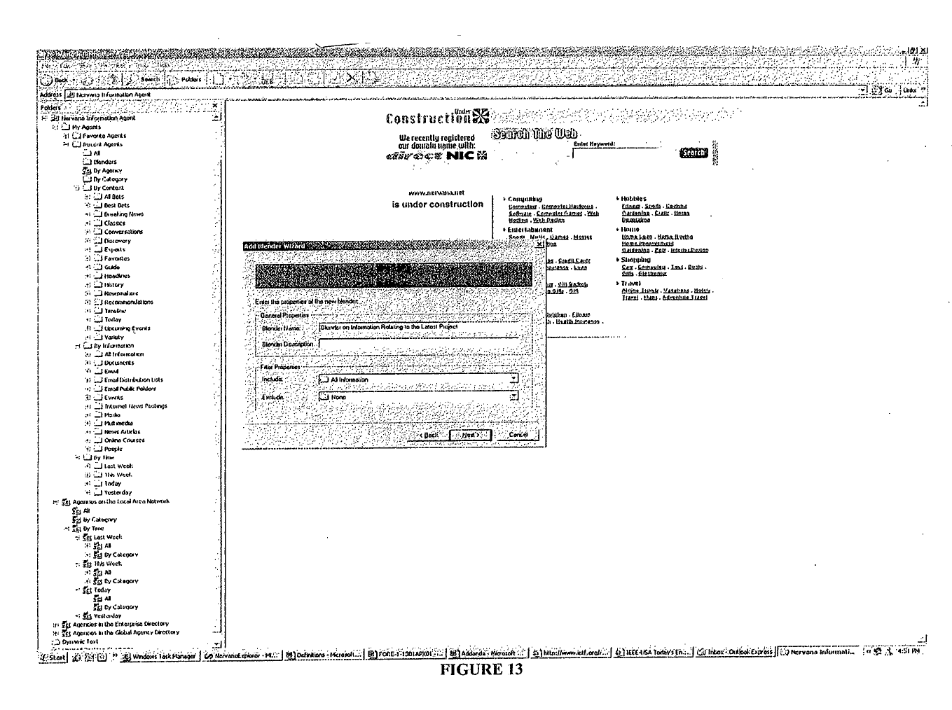

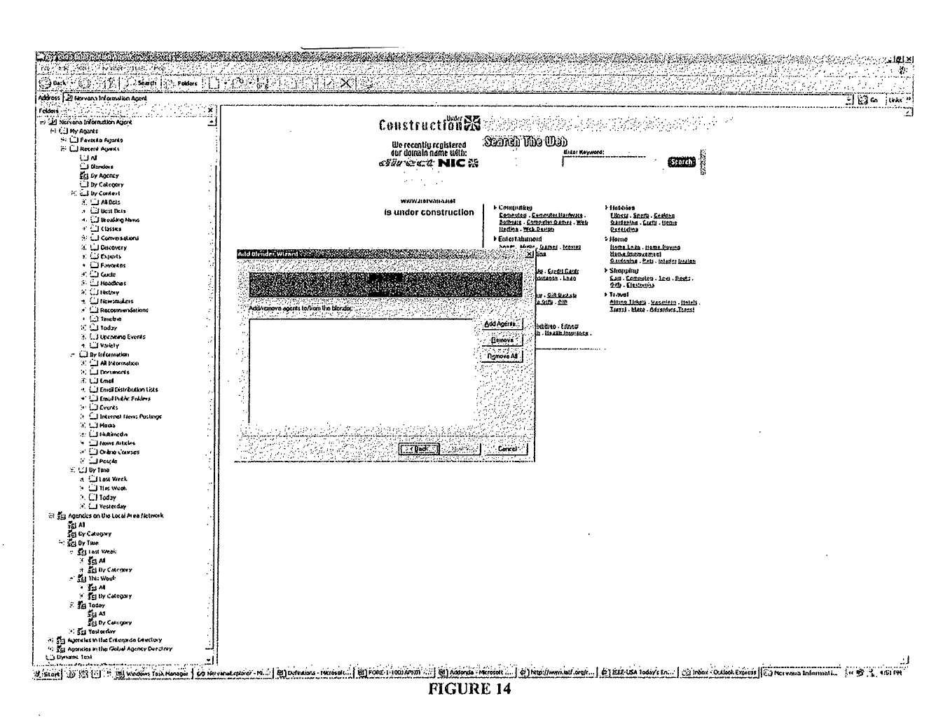

The present invention provides for a Blender Wizard, which is a user interface designed to facilitate users in creating Blenders. FIGS. 12-14 show exemplar screenshots of aspects of the Blender Wizard user interface according to a preferred embodiment of the present invention. FIG. 12 is a sample Information Agent screenshot showing a Tree View of a sample Semantic Environment and a sample of the “Add Blender” wizard that allows users to create and manage a new Blender. FIG. 13 shows the second page of the Add Blender wizard where users enter the name and description of the Blender and optionally select information object type filters. FIG. 14 shows the third page of the sample Add Blender wizard in accordance with a preferred embodiment of the present invention. In this example, users add and remove Agents from the Semantic Environment to or from the Blender. When the “Add Agents” option is selected, the “Open Agent” dialog is displayed from which users can add a new Agent, Blender or Agency to the new Blender.

Breaking News Agents. A Breaking News Agent is a specially tagged Smart Agent. In addition to the option of having time-criticality being defined by the Agency administrator, the user has the option of indicating which Agents refer to information that he or she wants to be alerted about. Any information being displayed will show alerts if there is breaking news that relates to it on a Breaking News Agent. For example, a user will be able to create an Agent as: “All Documents Posted on Reuters today” or “All Events relating to computer technology and holding in Seattle in the next 24 hours” as Breaking News Agents. This feature functions in an individual way because each Breaking News Agent is personal (“breaking” is subjective and depends on the user). For example, a user in Seattle perhaps would want to be notified on events in Seattle in the next 24 hours, events on the West Coast in the next week (during which time he or she can find a cheap flight), events in the United States in the next 14 days (the advance notice for most U.S. air carriers to get a modestly priced cross-continental flight), events in Europe in the next month (likely because he or she needs that amount of time to get a hotel reservation), and events anywhere in the world in the next six months.

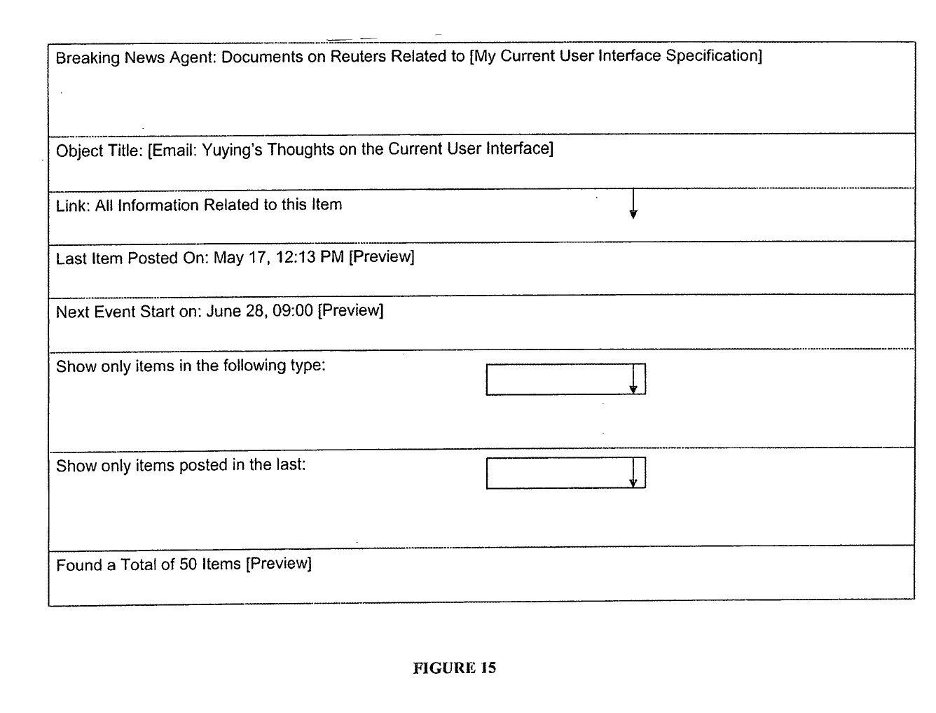

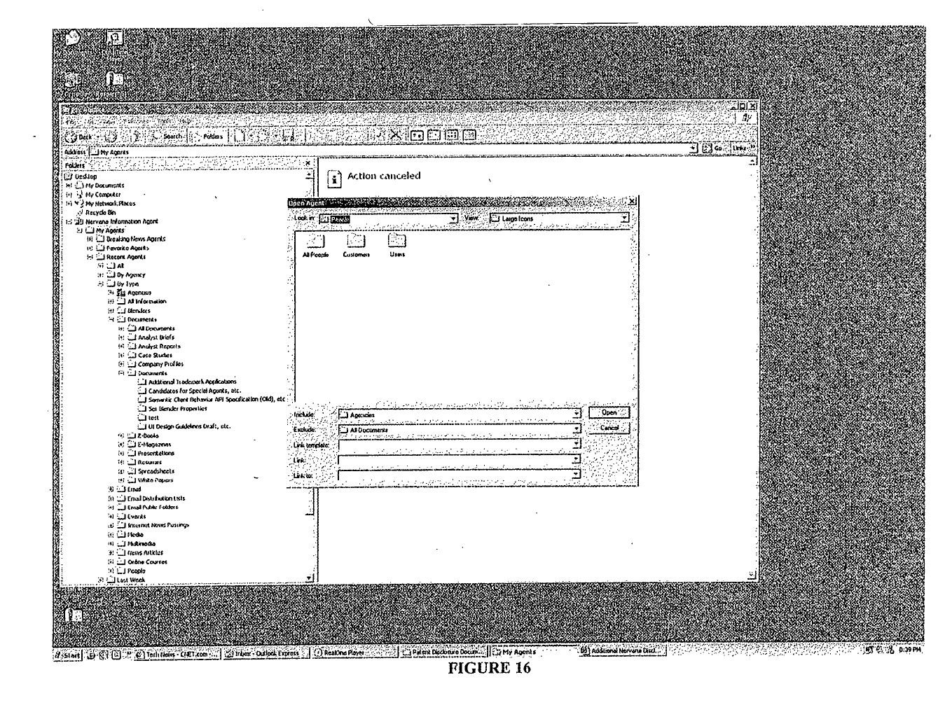

In a preferred embodiment, the present invention automatically checks the Semantic Environment for breaking news by querying each Breaking News Agent or by querying the “Breaking News” Context Template. It will do this for all objects displayed in the semantic browser window. If a Breaking News Agent indicates that there is breaking news, the Information Agent object Skin so indicates by flashing the window or by showing a user interface that clearly indicates that there is an alert that relates to the object. When the user clicks on the breaking news icon, a breaking news pane or a Context Palette for the “Breaking News” Context Template is displayed allowing the user to see the breaking news, select the Breaking News Agent (if there are multiple with breaking news), select predicates, and select other options. An exemplar pane of a Breaking News Agent user interface is shown in FIG. 15. This sample user interface illustrates the popup menu in the context Results Pane. The sample shows a similar context pane as a Smart Lens (Agent-Object) popup context Results Pane (discussed below) except that the Agent is a Breaking News Agent.

Default Agents. In an alternative embodiment, each Agency exposes a list of default Agents. Default Agents are similar to the default page on a Web site; authors of the Agency determine which Agents they want users to always sees. Alternatively, on the client, Default Agents may be invoked when users click on the root of the Information Agent's Environment (which preferably corresponds to a “Home Agent,” for example, the equivalent of the “Home Page” on Today's Web browser). Combined Default Agents may also be configured by users.

Default Special (or Context) Agents. In the preferred embodiment, the client or the Agency support a Default Special or Context Agent that maps to each Context Template (discussed below). These Agents preferably use the appropriate Context Template without any filter. For example, a Default Special Agent called “Today” returns all items on all Agencies in the “recent” and “favorites” lists (or on a configured list of Agencies) that were posted today. In yet another example, the Default Special Agent called “Variety” shows random sets of results for every Agency in the Semantic Environment corresponding to the “variety” Context Template.

Default Special Agents preferably function as a starting point for most users to familiarize themselves with the Information Nervous System of the present invention. In addition, Default Special Agents retain the same functionality as Smart Agents, such as use of drag and drop, copy and past, Smart Lens, Deep Information, etc.

Horizontal Decision Agents. In the preferred embodiment, Agents utilized by the client to assist with user interaction, including:
Schedule Agent: The Schedule Agent intelligently ranks events based on the probability that particular users would want to attend the event.
Meeting Follow-up Agent: The Meeting Follow-up Agent intelligently notifies users when the time has come to have a follow-up meeting to one that occurred in the past. The Inference Engine (see below) monitors relevant semantic activity to determine whether enough change has occurred to warrant a follow-up meeting. Users preferably use the previous meeting object as an Information Object Pivot to find the relevant knowledge changes (such as new documents, new people that might want to attend, etc.)
Task Follow-up Agent. The Task Follow-up Agent sends recommendations to users in response to tasks users perform (such as reading a document, adding an event to their calendar, etc.). The Agent ensures that users have constant follow-up. The recommendations are based on users' profile, and the Agent preferably uses collaborative filtering to determine recommendations.
Customer Follow-up Agent. The Customer Follow-up Agent sends notifications to users based on customer activity. The Agent intelligently determines when the user needs attention (based on email received from the user, new documents that might aid user service, etc.)

Public versus Local Agents. Agents that are created by the Agency administrator are “Public Agents.” Agents created and managed by users are “Local Agents.” Local Agents can refer to remote Agencies via SQML that includes references to Agency XML Web Service URLs, or can refer to local Agencies that run a local instance of the KIS with a local metadata store.

Saved Agents—Users' My Agents List. In the preferred embodiment, users are able to save a copy of an invoked Agent or a query result as a local Agent. For example, users may drag and drop a document on their hard drive to an Agent folder to generate a semantic relational query. Users could save that result as an Agent named “Documents.Technology.Wireless.RelatedToMyDocument.” This will then allow the user to navigate to that Agent to see a personalized semantic query. Users would then be able to use that Agent to create new personal Agents, and so on. Personal Agents can also be “published” to the Agency. Other users are preferably able to discover the Agent and to subscribe to it.

In the preferred embodiment, a local Agent is created by a “Save as Agent” button that appears on the client anytime a semantic relational query result is displayed. This is analogous to users saving a new document. Once the Agent is saved, it is added to the users' My Agents list. An Agent responds to a semantic query based on the semantic domain of the Agency on which it is hosted. Essentially, a semantic query to an Agent is analogous to asking whether the Agent “understands the query.” The Agent responds to a query to the best of its “understanding.” As a further illustration, an Agent that manages “People” responds to a semantic query asking for experts for a document based on its own internal mapping of people in its semantic domain to the categories in that domain.

Alternatively, the system client may be configured to use non-semantic queries. In this case, the Agency will use extracted keywords for the query. All Agents support non-semantic queries. Preferably only Agents on Agencies that belong to a semantic domain will support semantic queries. In other words, semantic searches degrade to searches.

Each Agent has an attribute that indicates whether it is “smart” or not. A Smart Agent is preferably created on an Agency if that Agency belongs to a semantic domain. In addition, a Smart Agent only returns objects it fully “understands.” In the preferred embodiment, when an Agency is installed, there are several default Smart Agents that the Agency administrator may optionally choose to install, including:
All.Understood.All
Documents.Understood.All
Email.Understood.All

For example, Email.Understood.All only returns email objects that the Agency can semantically understand based on its semantic domain (or ontology).

The present invention preferably includes the capability for users to display all objects and only those the Agency understands

Search Agents. A Search Agent is an Agent that is initialized with a search string. In the preferred embodiment, on invocation, the client issues the search request. A Search Agent is configurable so as to search any part of the Semantic Environment, including:
Frequently Used Agents
Recently Used Agents
Recently Created Agents
Favorite
All [Saved] Agents
Deleted Agents
Agents on the local area network
Agents on the Global Agency Directory
Agents on any user-customized Agency directories
All Agents in the entire Semantic Environment
   The client issues the search request based on the scope of the Search Agent. If users indicate that they want the search to cover the entire Semantic Environment, the client issues the request to all Agents in the Semantic Environment Manager (see below) and all Agents on the local area network, the Global Agency Directory and user-customized Agency Directories.

Server-Side Favorite Agents. In yet an alternative embodiment, the Agency supports User States support Favorite Agents. In the analogous context of Today's Web, a Web site allows users to customize their favorite links, stocks, etc. When initially queried, an Agency displays both its Default Agents and the Favorite Agents of the calling user (if there is a User State).

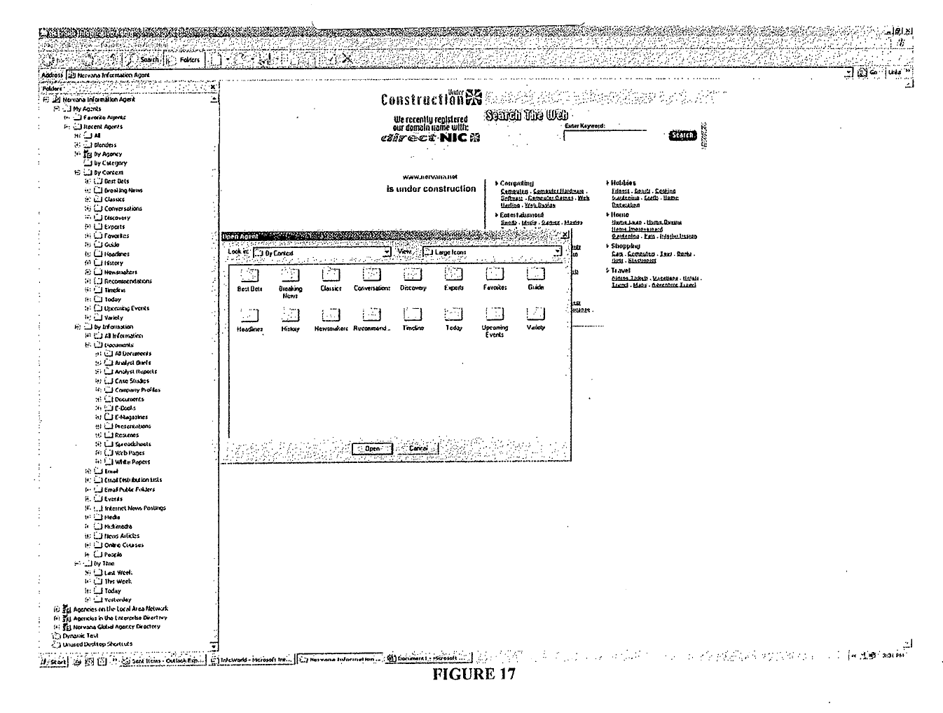

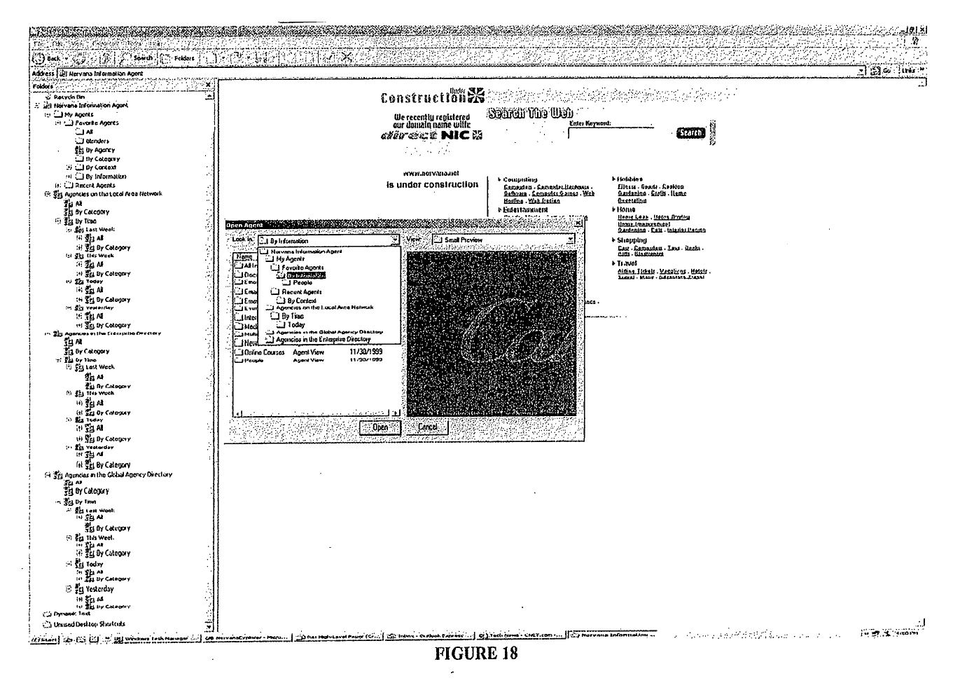

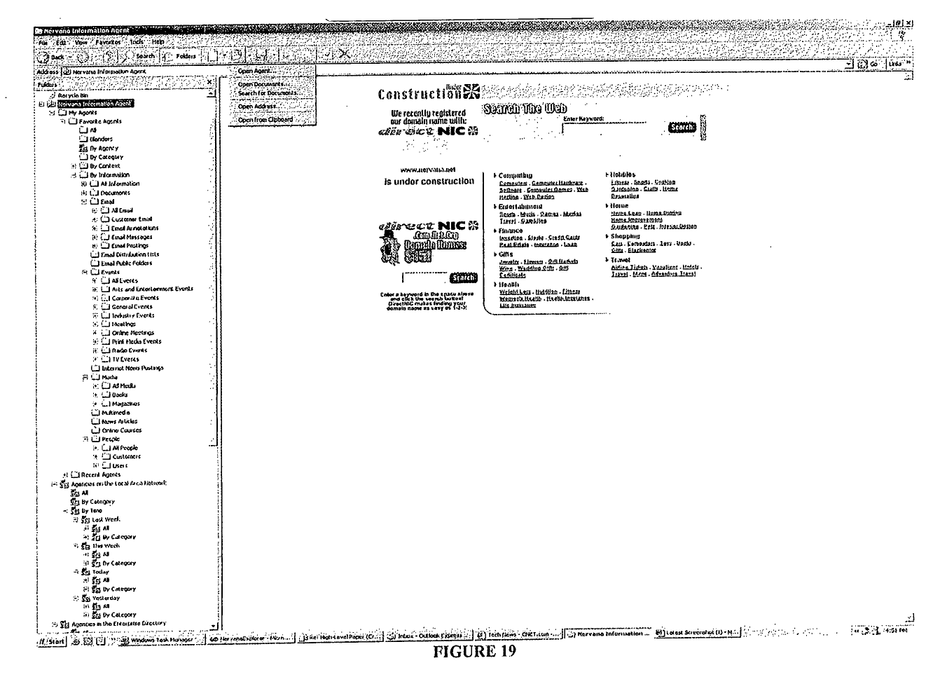

Smart Agents. A Smart Agent is a standalone Agent that encapsulates structured, semantic queries that refer to an Agency via its XML Web Service. In the preferred embodiment, user on the client are able to create and edit Smart Agents via a “Create Smart Agent” wizard that allows them to browse the Semantic Environment via the Open Agent dialog, and add links from specified Agencies. Essentially, this corresponds to users creating the SQML query from the user interface. In the preferred embodiment, the user interface only allows users to add links from the same Agency resource. However, users can create Agents of the same categories across Agencies, in addition to Special Agents and Blenders (which are also preferably cross-Agency). The user interface allows the user to add links using existing Smart Agents as Information Object Pivots provided that the Smart Agent refers to the same Agency for the current query. FIG. 16 illustrates a preferred embodiment showing the Open Agent dialog with the user interface controls for selecting link (predicate) templates, the links themselves, and the objects. FIGS. 17-19 illustrate the Tree View of a sample Semantic Environment involving the Open Agent dialog. FIG. 17 shows the Open Agent dialog allowing users to browse the Semantic Environment and open an Agent. FIG. 18 illustrates a way of navigating Agencies in the Semantic Environment and the “Open Agent” dialog with the “Small Preview” view. FIG. 19 illustrates an “Open” tool on the toolbar showing new options to open Agents form the Semantic Environment or to import regular information (e.g., from the file system) to the Semantic Environment by creating Dumb Agents.

The link templates essentially allow the user to navigate predicate for the current object type using predefined filters, thus allowing the user to avoid going through all the predicates for the object type. Examples of link templates include:
All
Breaking News (links that refer to time-sensitivity, e.g., “posted in the last”)
Categorization
Definite (non-probabilistic links)
Probable (probabilistic links)
Annotations

In the preferred embodiment, the Open Agent dialog allows the user to select the object to “link to” and, depending on the type of the object, allows the user to browse the object (e.g., from a calendar control if it is a date/time, from a text box if it is text, from the file system if it is a file or folder path, etc.) The wizard user interface also allows the user to preview the results of the query. A temporary SQML entry is created with the current predicate list and that is loaded in a mini-browser window within the wizard dialog box. The user is able to add and remove predicates, and will also have the option of indicating whether he or she wants a union (an “OR”) or an intersection (an “AND”) of the predicates. The user interface will also check for duplicate predicates.

Once the user finishes the wizard to create the Smart Agent, the Smart Agent is added to the Semantic Environment and the SQML is also saved with the associated object entry. In the preferred embodiment, the user can later browse the Smart Agent using the Agent property inspector property sheet. This allows the user to view the simple Semantic Environment properties (e.g., name, description, creation time, etc.) and also to view the resource URL (the WSDL URL to the XML Web Service of the Agency being queried) and the predicate list. The user can edit the list from the property sheet.

Default Smart Agent. A Default Smart Agent is similar to a Default Special Agent except that it is based on information object types and not on Context Templates. By way of example, “Documents” would return all documents on all Agencies in the users' Semantic Environment; “Email” would return all email messages in user's Semantic Environment, etc.

Special Agent. A Special Agent is a Smart Agent created by users based on a Context Template (see below). A Special Agent is preferably initialized with an Agent name, albeit without a specific Agent reference. For example, a Special Agent “Email.Technology.Wireless.All” may be created even if there are no Agents of that name in the Semantic Environment. Like a Search Agent, a Special Agent is scoped to search for any Agent with its name on any part of the Semantic Environment. In the preferred embodiment, when a Special Agent is invoked by users, the client searches for any Agents that bear its name. If or when it finds any Agents with the name, the client invoke the Agent.

In the preferred embodiment, users enter parameters consistent with a Context Template, indicating the category fillers (if required) and what Agency(ies) to query. These can be manually entered using the Open Agent dialog, or users can indicate that they want to query the “recent” Agencies, “favorite” Agencies, or both. In an alternative embodiment, users have the choice of selecting categories (if required) that are in the union or intersection of the selected Agencies, or all categories known to the Global Agency Directory. In yet an alternative embodiment, users are able to select the information type (as opposed to a Context Template) and keywords to search (as opposed to predicates or categories).

Default Special Agents. In the preferred embodiment, the system client installs Default Special Agents that map to all supported Context Templates. By way of example, in the preferred embodiment, Default Special Agents including the following:

Headlines

Breaking News

Conversations

Newsmakers

Upcoming Events

Discovery

History

All Bets

Best Bets

Experts

Favorites

Classics

Recommendations

Today

Variety

Timeline

Upcoming Events

Guide

Custom Special Agents. In contrast to user-created Special Agents, Custom Special Agents are Special Agents specially developed and signed in order to guarantee that the Special Agents are safe, secure, and of high-performance. The present invention provides for a plug-in layer to allow organizations and developers to create their own custom blenders. An example of a custom blender is “All.CriticalPriority.All that relates to my most recent documents or email.” This Custom Blender may be implemented by an SQML file with a resource entry as follows:

| | |
|---|---|
| <resource | type= “nervana:url” |
| | agent://all.criticalpriority.all@localhost> |
| <link | predicate= “nervana:relevantto” |
| | type= “nervana:localsemanticref” |
| | recentdocuments > |
| </link> | |
| <link | operator= “or” |
| | type= “nervana:localsemanticref” |
| | recentemail> |
| </link> | |
| </resource> | |

In the preferred embodiment, the Presenter (see below) resolves the “link” entry locally and initiates XML Web Service requests to the target resource with XML arguments corresponding to the newest documents or email messages. This allows the target Agent to focus on responding to semantic queries purely with XML filters without knowing the semantics related to filter origination. In an alternative embodiment, a Custom Blender such as the above example is a Default Agent.

Vertical Decision Agents. Vertical Decision Agents are Agents that provide decision-support for vertical industry scenarios.

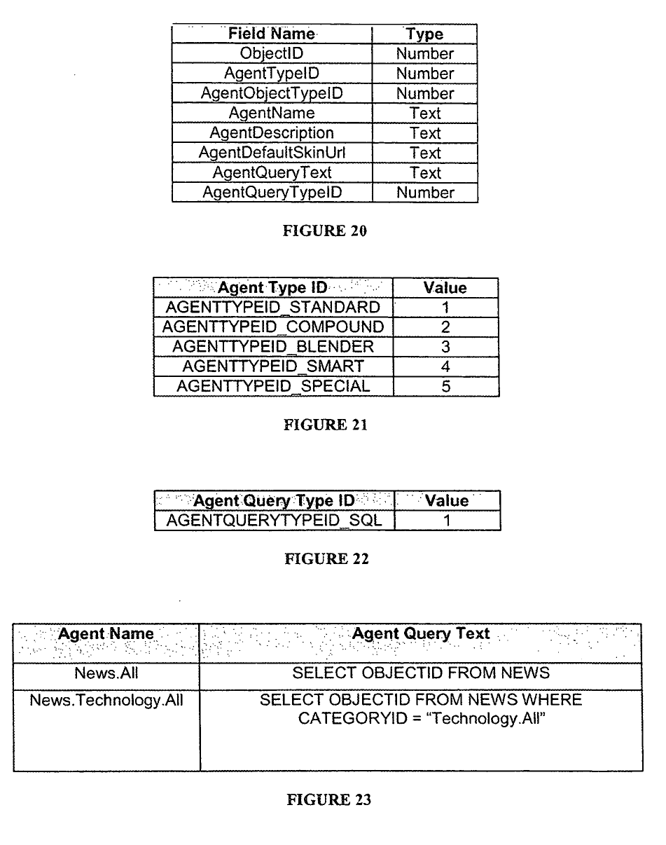

Agent Schema. Agents operate within specified parameters and exhibit predetermined characteristics that comprise the Agent schema. Agent schemas may vary widely with being equally applicable within the technology of the present invention. By way of example only, the Agent schema of the preferred embodiment of the present invention is shown in FIG. 20. The present invention specifically contemplates the addition of further fields. For example, fields for category URL (or path) and Context Template name can be added to the Agent schema to provide the client and server quick access to the category and Context Template the Agent represents (if applicable). This is helpful for the Semantic Environment Manager to provide different views of Agents (by category, by context, etc.). This complements the existence of these fields in the SQML for the Agent (expressed via attributes and/or predicates). The AgentTypeIDs included in the preferred embodiment are shown in FIG. 21. The AgentQueryTypeIDs included in the preferred embodiment are shown in FIG. 22.

In the preferred embodiment, SQL query formats are used. However, multiple query formats, for example XQL, XQuery, etc., are contemplated within the scope of the present invention.

The KIS 50 preferably hosts an Agents table (for server-side Agents) in its data store corresponding to this schema. FIG. 23 illustrates sample semantic queries that correspond to Agent names showing how server-side Agents are preferably configured on the KIS of the present invention.

As explained in greater detail below, Agents may optionally include their own Skins. An Agent Skin is represented as an URL to an XSLT file or equivalent Flash MX or ActionScript. If the Agent's Skin URL is not specified, a default Skin for the Agent's object type is presumed.

Agent Query Rules. Each server-side Agent query must be specified to return the OBJECTID column. Each table has this column for it is what links the Objects table with the tables for the derived object type. Objects and other tables are described in greater detail below.

Because each Agent query can form the basis of a sub-query, cascaded query or a join, it is preferable that each query follow this format. By way of example, the query for News.All will be may appear as “SELECT OBJECTID FROM NEWS” (where “NEWS” is the name of the table hosting metadata for news articles, with the “news” schema). As a result, the server 10 can then use this query as part of a complex query. For example, if the user drags and drops a document onto the Agent, the server might execute this query as:
SELECT OBJECTID FROM NEWS WHERE OBJECTID IN (SELECT OBJECTID FROM SEMANTICLINKS WHERE SUBJECTID IN (50, 67, 89) AND LINKSCORE>90)

This example assumes that the document is classified to belong to categories in the CATEGORIES table with object identifiers 50, 67, and 89 and that a link probability of 0.9 is the threshold to establish that a document belongs to a category. In this example, the document is used as a filter for the News.All query and the query text is used as part of the complex query.

Having a consistent standard for queries allows the semantic query processor to merge queries until they finally have to be presented. For example, each call to the semantic query processor must indicate what object type in which to return the results. The query processor then returns XML information consistent with the schema for the requested object type. In other words, the query processor preferably returns schema-specific results for presentation. Each query is stored at the semantic layer (to return an OBJECTID). To use the last example, when the user invokes the News.All Agent, the browser calls the query processor on the Agency XML Web Service. The query processor will then invoke the query and filter it with the ‘News Article’ object type, as such:
SELECT * FROM NEWS WHERE OBJECTID IN (SELECT OBJECTID FROM NEWS)
   This returns all the fields for the News schema. The browser (via the Presenter) displays the information using the XSLT (or a presentation tool such as Flash MX or ActionScript) for either the Agent Skin or for a user-specified Skin (which will override the Agent Skin).

Query Virtual Parameters. Agent queries preferably contain special Virtual Parameter. A typical example may include: ‘% USERNAME %. In this example, the Semantic Query Processor (SQP) resolves the Virtual Parameter to a real argument before invoking the query. An Agent People.MyTeam.All is configured with the SQL query:
SELECT * FROM USERS WHERE Division IN (SELECT Division FROM USERS WHERE Name LIKE % USERNAME %)

In this example, the Agent name includes “MyTeam” even though the Agent can apply to any user. The % USERNAME % variable is resolved to the actual calling user's name by the SQP. The SQL call is resolved to as follows:
SELECT * FROM USERS WHERE Division IN (SELECT Division FROM USERS WHERE Name LIKE JohnDoe)
   In this example, JohnDoe is assumed to be the user name of the caller.

Simple Agent Search. Each Agent will support simple search functionality. In the preferred embodiment, a user is able to right-click on a Smart Agent in the Information Agent and hit “Search.” This will bring up a dialog box where the user enters search text. This creates the appropriate SQML with the associated predicate, e.g., “nervana:contains”. The present invention provides a simple, fast way for users to search Agents (and create Smart Agents from there) without going through the “Create Smart Agent” wizard and selecting the “contains text” predicate (which alternatively achieves the same result).

Agency Agent Views. An alternative embodiment of the present invention includes Agency Agent Views. An Agency Agent View is a query that filters Agents based on predefined criteria. For example, the Agent view “Documents” returns only Agents that manage objects of the document semantic class. The Agent view “Reuters News” returns a list of Agents that manage news objects with “Reuters” as the publisher. Agency Agent Views are important in order to give users an easy way to navigate through Agents. The Agency administrator is able to create and delete Agent views.

Agent Publishing and Sharing. The preferred embodiment makes it easy for Agents to be published and shared. This is preferably implemented by serializing the Semantic Environment into an XML document containing the recent and Favorite Agents, their schema, their SQML buffers, etc. and publishing the document to a publishing point. This XML document may also be emailed to colleagues, friends, etc. in order to facilitate the propagation and sharing of local (user-created) Agents. This is analogous to how Web pages are published today and how web URLs and links are shared by sending links and attachments via email.

2. Knowledge Integration Server

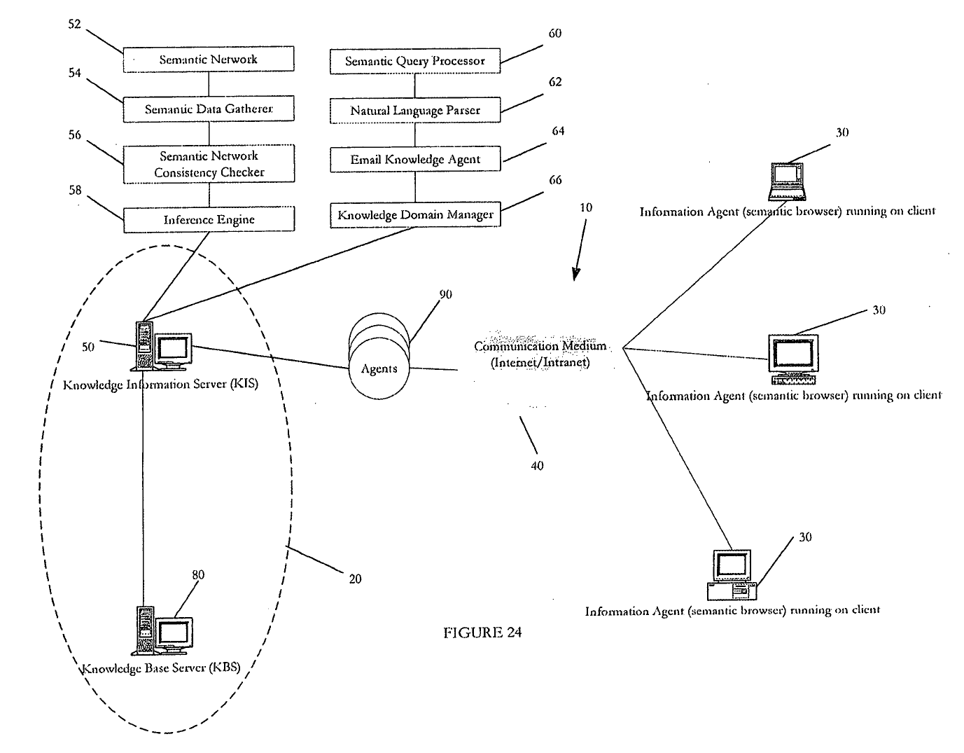

The Knowledge Integration Server (KIS) 50 is the heart of the server-side of the system 10. The KIS semantically integrates data from multiple diverse sources into a Semantic Network and hosts Agents that provide access to the network. The KIS also hosts semantic XML Web Services to provide clients with access to the Semantic Network via Agents. To users, a KIS installation may be viewed as an Agency. The KIS is preferably initialized with the following properties:
Agency Name. Name of the Agency (e.g., “ABC”)
Agency Friendly Name. Full name of the Agency (e.g., “ABC Corporation”)
Agency Description. Description of the Agency
Agency System User Name. User name of the Agency. Each Agency is represented by a user on the directory of the enterprise (or Web site) on which it is installed. The system user name is used to host the system inbox (through which users will publish documents, email and annotations to the Agency). For authentication, the Agency must be installed on a server that has access to the system user account.
Agency Authentication Support Level. Indicates whether the Agency supports or requires user authentication. An Agency can be configured to not support authentication (in which case it is open to all users and does not have any User State), to support but not require authentication, and to require authentication, in which case it preferably indicates the authentication encryption type.
Agency User Directory Type. This indicates the type of user directory the Agency authenticates users against and where the Agency gets its user information from. For example, this could be an LDAP directory, a Microsoft Exchange 2000 User Directory, or a Lotus Notes User Directory on the Windows 2000 Active Directory, etc.
Agency User Directory Name. This indicates the server name of the Agency user directory (e.g., a Microsoft Exchange 2000 server name).
Agency User Domain Name. This indicates the name of the user domain for authentication purposes. This field is optional and included only if the Agency supports authentication.
Agency User Group Name. This indicates the name of the user group for authentication purposes. For example, an Agency might be initialized with the domain name “US Employees” and the group name “Marketing.” In such a case, the Agency will first check the user name to ensure that the user is a member of the user group, and then forward authentication requests to the user directory authenticator indicated by the user directory type. If the calling user is not a member of the user group, the authentication request is denied. This field is only valid if the Agency supports authentication.
Data Store Connection Name. This indicates the name of the connection to a database store. This could be represented as, say, an ODBC connection name on Windows (or a JDBC name, etc.). The KIS will use the database referred to by the connection name to store, update, and maintain its tables (see below).
Dynamic Properties Evaluation. The Agency XML Web Service preferably exposes methods to return dynamic properties such as the list of semantic domain paths the server currently supports or “understands.” This allows users to browse Agencies on the client using their supported semantic domain paths or ontologies/taxonomies.
   As illustrated with reference to FIG. 24, the KIS 50 preferably includes the following main components: a Semantic Network 52, a Semantic Data Gatherer 54, a Semantic Network Consistency Checker 56, an Inference Engine 58, a Semantic Query Processor 60, a Natural Language Parser 62, an Email Knowledge Agent 64 and a Knowledge Domain Manager 66.

a. Semantic Network

The Semantic Network is the core data component of the KIS. The Semantic Network links objects of the defined schemas of the present invention together in a semantic way via database tables. The Semantic Network consists of schemas and the Semantic Metadata Store (SMS). The Semantic Network is preferably comprised of two data schemas: Objects and SemanticLinks. Additional data schemas may be included based on system requirements and enterprise needs. The SMS is preferably a standard database (SQL Server, Oracle, DB2, etc.) where all semantic data is stored and updated via database tables. The SMS preferably includes tables for each primary object type (described below).

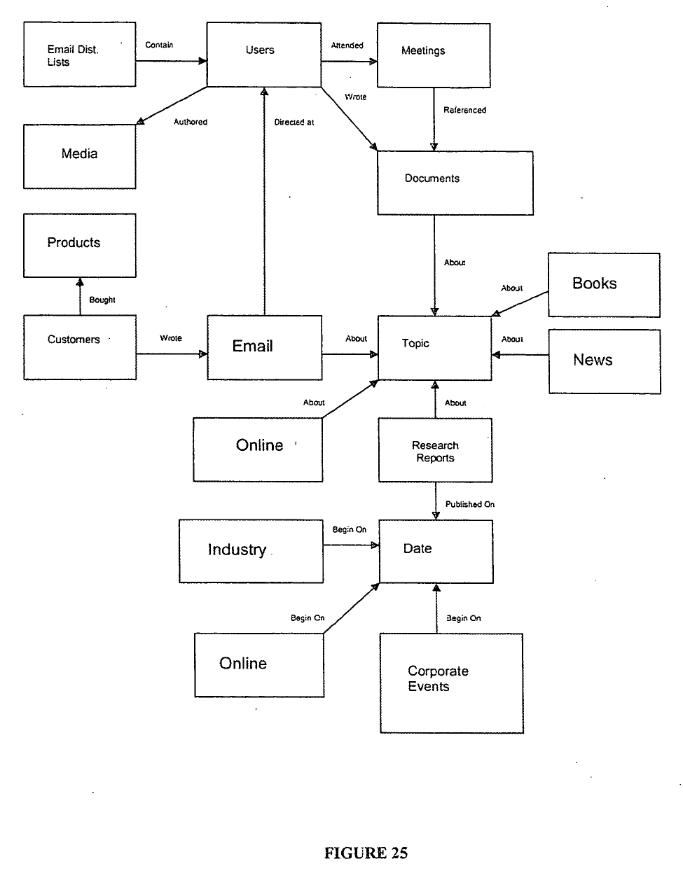

By way of example, a sample Semantic Network directed towards an enterprise situation is shown with reference to FIG. 25, which illustrates the relationship between business users of the present invention and the various sources of and results of knowledge retrieval, management, delivery and presentation.

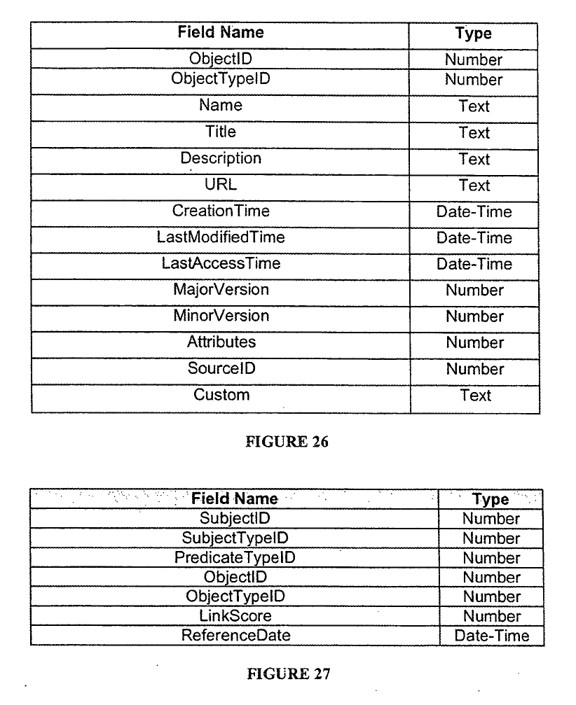

Objects. The Objects table contains every object in the Semantic Network. The “Object” can be thought of as the “base class” from which every semantic object type will be derived. The preferred schema of the Object type is shown with reference to FIG. 26. The ObjectID is a unique identifier that tags the object in the Semantic Network. Every object in the system will have a schema that is an extension of the Object schema. Alternatively, semantic object types (e.g., document, email, event, etc.) will have only the ObjectID field. When a query is invoked, the query processor can then aggregate information from the Object table and the specific semantic table to form the final results. The former approach (having each schema be an extension of the Object schema) results in better runtime performance since joins are avoided. However, the latter approach, while computationally more expensive, results in less wasted storage. The ObjectTypeID is preferably a number that resolves to a string that describes the hierarchy of the object type, e.g., “documents\documents”; “documents\analyst briefs”; and “events\meetings.”

The SourceID refers to the identifier for the Semantic Data Adapter (SDA) from which the object was gathered. The Semantic Data Gatherer (SDG) uses this information to periodically check whether the object still exists by requesting status information from the SDA from which the object was retrieved.

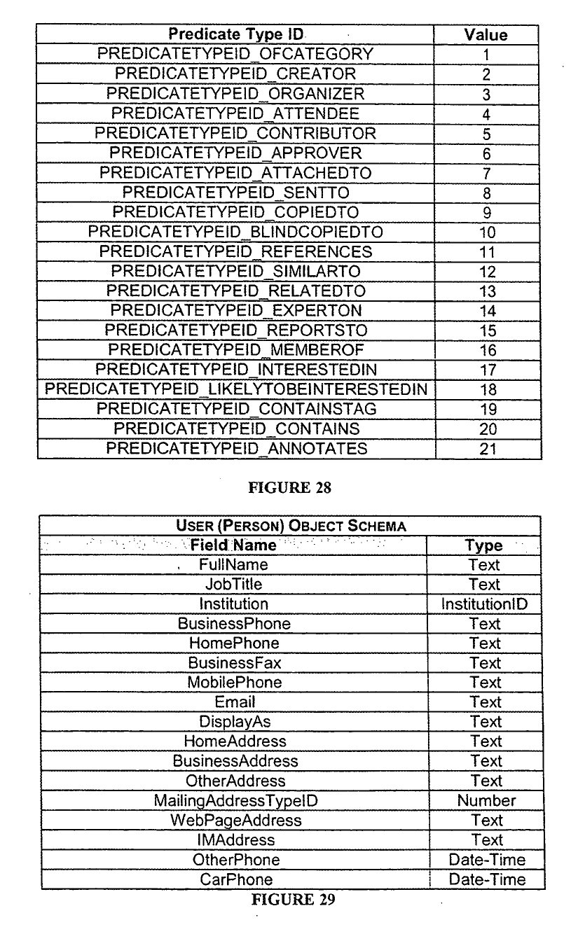

SemanticLinks. The SMS preferably includes a SemanticLinks schema (and corresponding database table) that will store semantic links. These links will annotate the objects in the other data tables of the SMS and will preferably constitute the data model for the Semantic Network. Each semantic link will have a semantic link ID. The SemanticLinks table preferably includes the field names and types as shown with reference to FIG. 27. The SubjectID and SubjectTypeID are the object ID and object type ID of the object being linked from. The ObjectID and ObjectTypeID are the object ID and object type ID of the object being linked to. The LinkScore preferably ranges from 0 to 100, and represents the semantic strength of the link as a probability. These fields are exemplary only; more predicates are contemplated based on the particular object type as well as the user's desire to semantic links. The preferred embodiment of the present invention provides the predicate type IDs shown in FIG. 28. The present invention contemplates the addition of further predicate type IDs.

By way of example, the semantic link “Steve reports to Patrick” will be represented in the table with a subject ID corresponding to Steve's ID in the Users table, a predicate type of PREDICATETYPEID_REPORTSTO (see table below), Patrick's object ID in the Users table, a link score of 100 (indicating that it is a “truth” and that the link is not probabilistic) and a Reference Date that qualifies the link.

The KIS creates, updates, and maintains database tables for each object type (via the SMS). The following illustrates preferred but nonexclusive list of primary and derived object types:
Person
   User
   Customer
Category
Document
   Analyst Brief
   Analyst Report
   Case Study
   White Paper
   Company Profile
   E-Book
   E-Magazine
Email Message
   Email Annotation
   Email News Posting
Email Distribution List
Email Public Folder
   Email Public Folder Newsgroup
News Article
Event
   Meeting
   Corporate Event
   Industry Event
   TV Event
   Radio Event
   Print Media Event
   Online Meeting
   Arts and Entertainment Event
Online Course
Media
   Book
   Magazine
Multimedia
   Online Broadcast
   Online Conference
      Object types are preferably expresses as hierarchical paths. The path can be extended, e.g., “events\meetings” can be extended with “qualified Meetings,” e.g., “events\meetings\company meetings.” This schema model is indefinitely extensible and configurable.

Virtual Information Object Types. Virtual Information Object Types are object types that do not map to distinct object types, yet are semantically of interest to users. An example is the “Customer Email” object type, which derives from the “Email” object type. This object type is “virtual” in that it does not have a distinct schema and, as a consequence, does not have a distinct table in the SMS on the KIS. Rather, it uses the “Email” table on the SMS, since it derives from the “Email” object type. Even though it is not a distinct object type, users will be interested in browsing and searching for “Customer Email” as though it were indeed distinct.

In the preferred embodiment, Virtual Object Types are implemented by storing the metadata in the appropriate table on the SMS (in this case, the “Email” table, since the object type derives from “Email”). However, the resolution of queries for the object type is accomplished differently from regular queries for distinct object types. When the server SQP receives a semantic query request (via the XML Web Service) for a virtual information object type (such as “Customer Email”), it resolves the request by joining the tables that together form the object type. For instance, in the preferred embodiment, in the case of “Customer Email,” the server will resolve in query with the SQL sub-query:
SELECT OBJECTID FROM EMAIL WHERE OBJECTID IN (SELECT OBJECTID FROM CUSTOMERS WHERE EMAILADDRESS IN (SELECT EMAILADDRESS FROM EMAIL)
   This query corresponds to “Select all objects from the Email table that have an email address value that is also in the Customers table.” This assumes that “Customer Email” refers to email that is sent by or to a customer. Other definitions of the virtual object type are also possible and the query resolution is preferably consistent with the definition. The SQP preferably applies this sub-query to all queries for “Customer Email.” This sub-query essentially filters the Email table for those email messages that are from customers. This returns the desired result to the user with the illusion that there is a “Customer Email” table when there really is not.

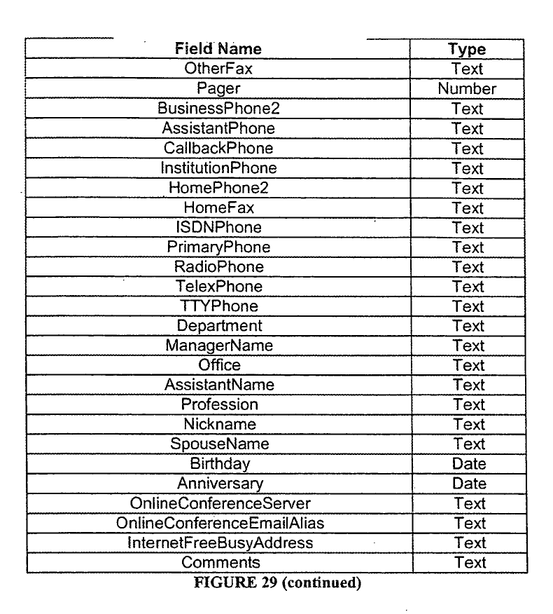

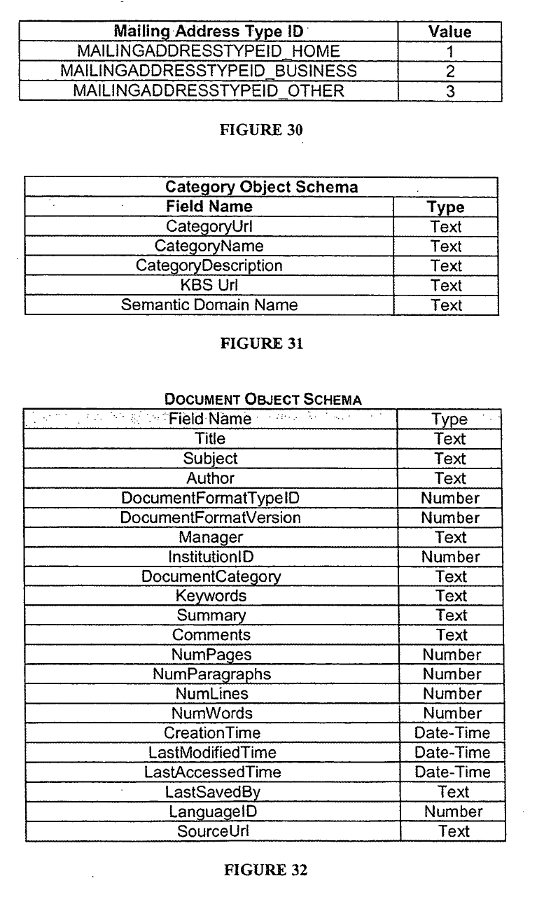

The present invention contemplates a variety of schemas associated with each object type. Other schemas are in development that will have comparable applicability to the present invention. The “Document” schema, for example, may be extended with fields from the Dublin Core schema (http://www.cis.ohio-state.edu/cgi-bin/rfc/rfc2413.html) and other industry standard schemas. In yet another example, “News Article” schema may be an extension of the NewsML schema (http://www.newsml.org). By way of example only, preferred user object schema made in accordance with the present invention are shown with reference to FIG. 29. All schemas preferably have as an identical subset the fields of the Object schema. MailingAddressTypeIDs preferably associated with the User (person) object schema includes those shown with reference to FIG. 30.

By way of example only, the preferred category object schema made in accordance with the present invention is shown with reference to FIG. 31.

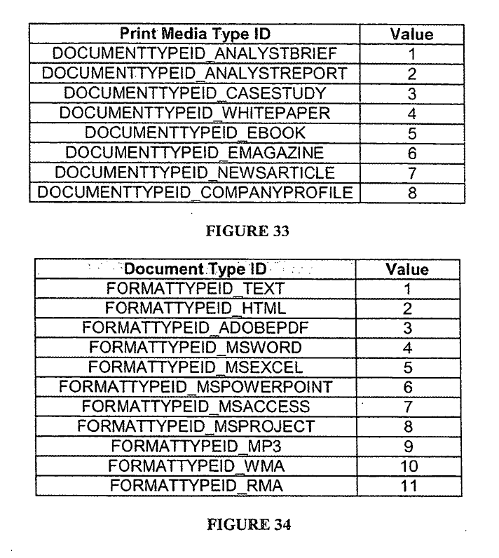

By way of example only, the preferred document object schema made in accordance with the present invention is shown with reference to FIG. 32. The “DocumentCategory” field refers to a proprietary category that is tagged with the document (by the document data source) and not to a semantic category managed by the KIS itself. The “DocumentFormatTypeID” field refers to the type of document. The Print Media Type IDs of the preferred embodiment are shown in FIG. 33, and the preferred FORMATTYPEID are shown in FIG. 34.

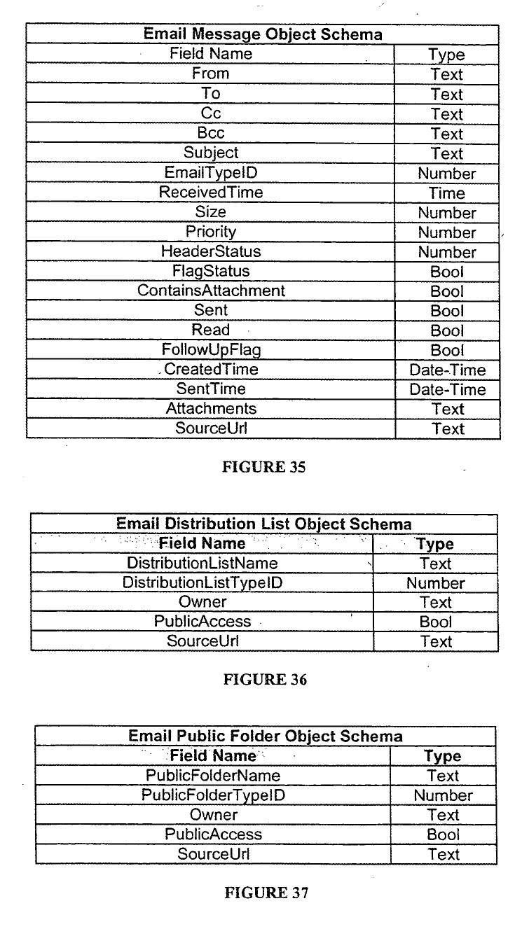

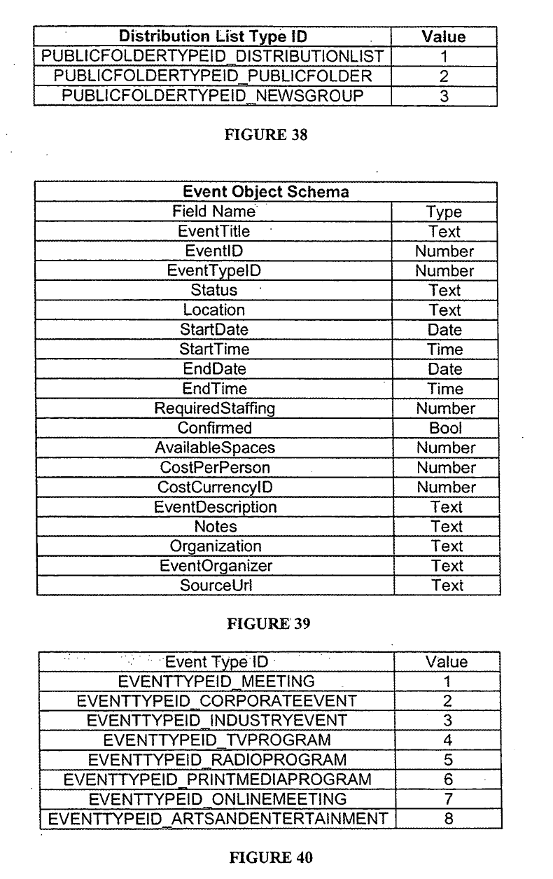

By way of example only, the preferred email message list object schema made in accordance with the present invention is shown with reference to FIG. 35. Email Priorities are preferably 0, 1, or 2, corresponding to low, medium, and high priority. The EmailTypeID preferably includes EMAILTYPEID_EMAIL, EMAILTYPEID_NEWSPOSTING and EMAILTYPEID_EMAILANNOTATION (values 1, 2 and 3). Exemplar tables showing the email distribution list and email public folder object schemas of a preferred embodiment of the present invention are shown in FIGS. 36 and 37, respectively. In the preferred embodiment, the PublicFolderTypeID includes those shown in FIG. 38.

By way of example only, the preferred event object schema message list object schema made in accordance with the present invention is shown with reference to FIG. 39. FIG. 40 shows the events types of a preferred embodiment of the present invention.

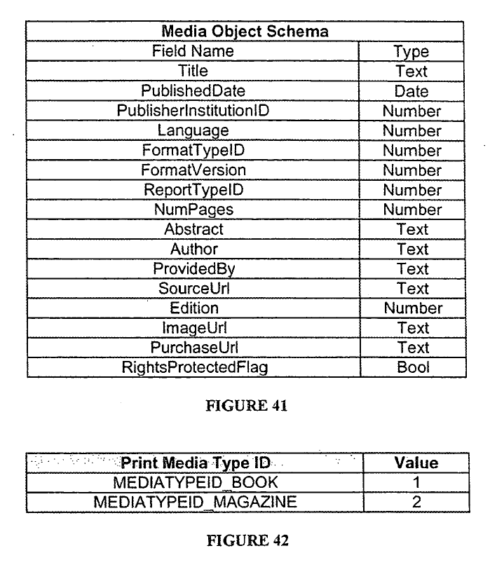

By way of example only, the preferred media object schema message list object schema made in accordance with the present invention is shown with reference to FIG. 41. FIG. 42 shows the media types of a preferred embodiment of the present invention.

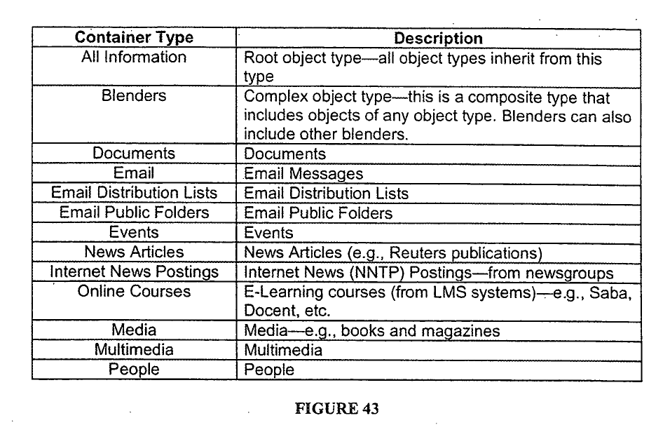

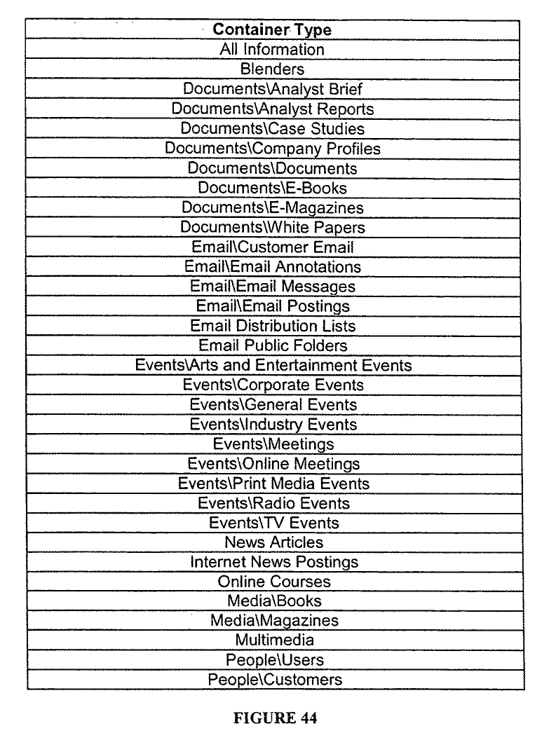

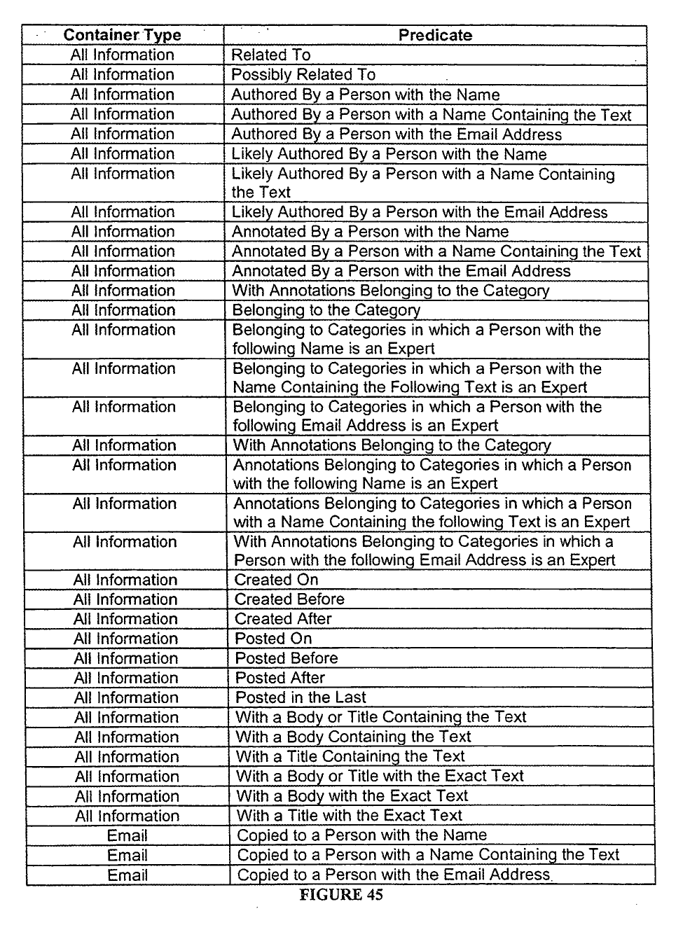

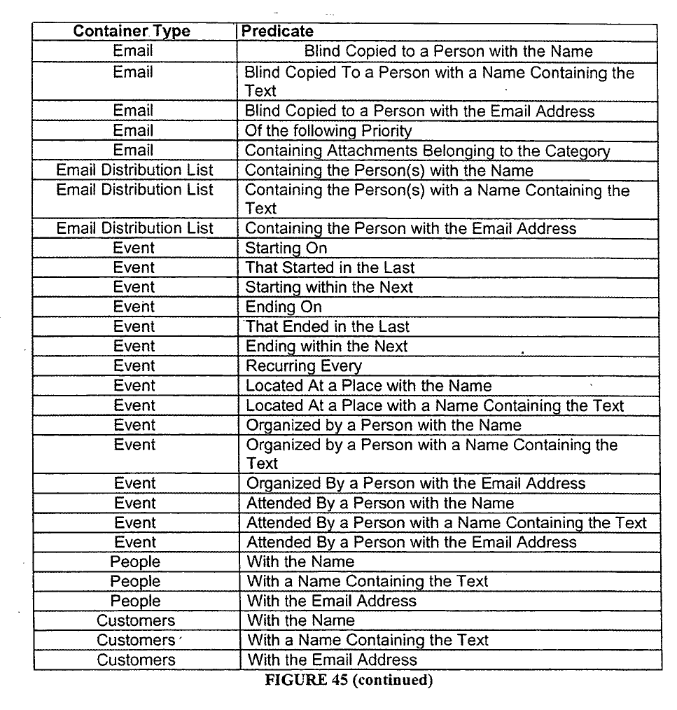

By way of example, FIGS. 43-45 illustrate additional samples showing how objects are categorized and utilized in the preferred embodiment of the present invention. FIG. 43 illustrates root object container types. FIG. 44 illustrates a hierarchical schema for qualified object types. FIG. 45 illustrates samples of native container object type predicates. All types except the Person and Customer types preferably inherit all predicates from the root type “All Information.” The present invention provides for native container object type predicate templates, for example including for: All; Breaking News; Categorization; Author; Annotations; Definite Links; Probabilistic Links; and Popular.

b. Semantic Data Gatherer

In the preferred embodiment, the Semantic Data Gatherer (SDG) is responsible for adding, removing, and updating entries in the Semantic Network via the SMS. The SDG consists of a list of XML Web Service references. These form an Information Source Abstraction Layer (ISAL). Each of these references is initialized to gather data from via a Data Source Adapter (DSA). A data source adapter is an XML Web Service that gathers information from a local or remote semantic data source for a give object type. It then returns the XML corresponding to object entries at the data source. All DSAs preferably support the same interface via which the SDG will gather XML data. This interface includes methods to:
Retrieve the XML metadata for objects for a given start and end index (e.g., objects 0 through 49).
Check whether there any objects have been added or deleted since a particular date/time (on the DSA's time clock).
Fetch the XML metadata for objects added or deleted since a particular date/time (on the DSA's time clock)
Check whether an object still exists in the semantic data source—by examining the XML metadata for the object (passed as an argument)

If each call to the DSA XML Web Service will be stateless, the API should include information, preferably via a string with command parameters, which qualifies the request. For example, a DSA for an email inbox includes parameters such as the name of the user whose inbox is to be gathered. A DSA for a Web site or document store will have to include information on the URL or directory path to be crawled.

Each DSA is required to retrieve information in the schema for its object type. Because a DSA must be implemented for a particular object type, the SDG will expect XML for the schema for that object type when it invokes a gather call to the DSA.

The SDG is responsible for maintaining the integrity and consistency of all the database tables in the SMS (the Semantic Network). In this embodiment, the SDG is also referred to as a Semantic Network Manager (SNM). The database tables preferably do not contain redundant or stale entries. Because the SDG retrieves objects with well-known schemas the semantics of each of the object types is understood, and the SDG maintains the consistency of the tables accordingly. For example, the SDG preferably does not add redundant Document XML metadata to the DOCUMENTS table. The SDG uses the semantics of documents to check for redundancy. In the preferred embodiment this is accomplished by comparing the author name, creation date/time, file path, etc. The SDG also performs this check for other tables (e.g., EVENTS, CUSTOMERS, NEWS, etc.). For example, the SDG will perform redundancy checking for events by examining the title, the location, and the date/time. Other tables are maintained accordingly. The SDG will also update objects in the database tables that have been changed.

The SDG is also preferably responsible for cleaning up the database tables. The SDG periodically queries the DSA to determine whether all of the objects in each table managed by the DSA still exists. For example, for a DSA that retrieves documents, the SDG will pass the XML metadata to the DSA Web service and query whether the object still exists. The DSA attempts to open the URL for the document. If the document does not exist anymore, the DSA will indicate this to the SDG. Individual DSAs, and not the SDG, are responsible for object validation to avoid security restrictions that are data source specific. For example, there might be data source restrictions that prevent remote access to local resources. In such a case, only the DSA XML Web Service (which is preferably running locally, relative to the data source) will have access to the data source. Alternatively, some DSAs might run on the Agency server, alongside the SDG and other server components, and retrieve their data remotely.

Having the DSAs handle object validation also provides additional efficiency and security in that the DSA prevents the SDG from knowing the details of how to open each data source to check whether an object still exists. Since the DSA needs to know this (since it retrieves the XML data from the data source and therefore has code specific to the data source), it is more appropriate for the DSA to handle this task.

The SDG preferably maintains a gather list that will point to DSA XML Web Service URLs. The KIS administrator is able to add, delete, and update DSA entries from the SDG gather list. Each gather list entry is preferably configured with:
1. The name and XML Web Service reference of the DSA. This essentially will refer to a combination of the data source, the object type, and a reference to the XML Web Service that implements the DSA (e.g., via a WSDL web service URL). Examples include:
   a. Microsoft Exchange 2000 Email DSA. This DSA will gather email XML metadata from a Microsoft Exchange 2000 Inbox or Public Folder
   b. Microsoft Exchange 2000 Calendar DSA. This DSA will gather event XML metadata from a Microsoft Exchange 2000 Calendar
   c. Microsoft Exchange 2000 Users DSA. This DSA will gather users/people XML metadata from a Microsoft Exchange 2000 Directory
   d. Microsoft Exchange 2000 Email Distribution List DSA. This SDA will gather email distribution list metadata from a Microsoft Exchange 2000 Directory
   e. Lotus Notes Inbox. This DSA will gather email XML metadata from a Lotus Notes Inbox or Public Folder
   f. Siebel CRM Database. This DSA will gather customer XML metadata from a Siebel CRM system
   g. Web site. This DSA will gather document XML metadata from a Web site
   h. File Directory or Share. This DSA will gather document XML metadata from a file directory or share
   i. Saba E-Learning LMS Repository. This DSA will gather E-Learning XML metadata from a Saba Learning Management System (LMS) repository
   j. Microsoft Sharepoint Document DSA. This DSA will gather document XML metadata from a Microsoft Sharepoint server workspace
   k. Reuters News Repository. This DSA will gather News Article XML metadata from a Reuters news article repository
2. The description of the DSA gather entry.
3. A string indicating initialization information for the DSA.
4. The gather schedule—this indicates how often the SDG should ‘crawl’ the DSA to gather XML metadata.

In a preferred embodiment, the Agency is initialized with a user directory domain and group name. In this case, the SDG preferably automatically enters a gather list entry for the user directory DSA. For example, if the Agency is configured with a Exchange 2000 User Directory with Domain Name “Foo” and Address Book or group name “Everyone,” the SDG creates a gather list entry with the Exchange 2000 Users DSA (initialized with these parameters). Alternatively, the Agency can be configured to obtain its user directory from any email application server (e.g., Microsoft Exchange or Lotus Notes). The SDG initializes gather list entries with an Email Inbox and Calendar DSA for the system user (and Email Knowledge Agent, described below). These three gather list entry DSAs (Users, Inbox, and Calendar) are initialized by default. The Inbox is preferably used to store Agency email postings and annotation and the Calendar DSA is used to store events posted to the Agency by users. Other custom DSAs can be added by the Agency administrator.

The SDG also keeps track of the last time the SDA reported to it that objects have been added or deleted to or from the data source. This date/time information is preferably based on the SDA's clock. Each time the SDA reports that there is new or deleted data, the SDG will update the date/time information in its entry for the SDA and gather all the new or deleted information in the SDA. The SDG will then update the database tables.

The SDG preferably maps the XML information it receives from the SDAs to the Semantic Network of the present invention. The SDG stores all the XML metadata in the database tables in the SMS. In addition, the SDG parses the XML it receives from the SDA and, where necessary, maps semantic links to specific XML fields. The SDG adds or updates semantic links in cases where the XML includes information that “links” objects together. For example, the schema for an email object preferably includes fields including “From,” “To,” “Cc,” “Bcc,” and “Attachments.” In the case of the “From,” “To,” “Cc” and “Bcc” columns, the fields in the XML refer to email addresses (separated by delimiters such as “;” or “,” or a space). In the case of the “Attachments” column, this field will refer to the file paths of the files that are attached to the email message (separated by delimiters such as “,”). This raw XML is stored in the EMAIL database table, along with the other columns. In addition, the SDG parses the fields of the email object and adds semantic links to other objects that are identified by the contents of those fields. For example, if the “to” field contains “john@foo.com” and the attachments field contains the string “c:\foo.doc, c:\bar.doc,” the SDG will process the email as follows:
1. Find any object in the USERS table with the email address “john@foo.com.” Also, search for other USER objects with email addresses in the FROM, TO, CC, and BCC fields.
2. If any objects are found, add a semantic link entry to the SEMANTICLINKS table with the email object id as the subject and the appropriate predicate type id. In this case, the predicate PREDICATETYPEID_CREATOR refers to the originator of the email message. The predicate PREDICATETYPEID_SENTTO is used to link the email object and the USER objects referred to by the contents of the “to” field in the email XML metadata. The predicate PREDICATETYPEID_COPIEDTO and PREDICATETYPEID_BLINDCOPIEDTO are used to link objects in the “cc” and “bcc” fields in similar fashion.

In the case of attachments, the SDG extracts the XML metadata for the attached documents. If an XML object with the file path already exists in the SMS (or, in other words, the Semantic Network), the SDG will update the metadata. If the XML object does not already exist, the SDG creates a new document object with the XML metadata. The SDG will adds an entry to the SEMANTICLINKS table with the email object ID as the subject, the new document's object ID as the subject, and the predicate PREDICATETYPEID_ATTACHEDTO. This allows the user to be able to navigate from an email message to its attachments and then use the attachments as pivots to continue to browse the Semantic Network, for example using semantic tools like the Smart Lens (discussed below).

The SDG does not create any objects in the event for which it does not find user objects that match the entries in the XML fields. Preferably, the SDG gathers information from a Directory SDA when a user is manually added to the Agency. The Agency administrator preferably adds users to the Agency via the user group on the Agency properties.

The following illustrates an example of mapping raw email XML metadata to the Semantic Network.

```
<email from=“john@foo.com“
    to=“nosa@nervana.net“
    cc=“steve@nervana.net“
    bcc=“patrick@nervana.net”
    subject=“Meeting this Friday”
    body=“Let us meet on Friday at 2pm”
    attachments=“c:\foo.doc; c:\bar.htm”>
</email>
```

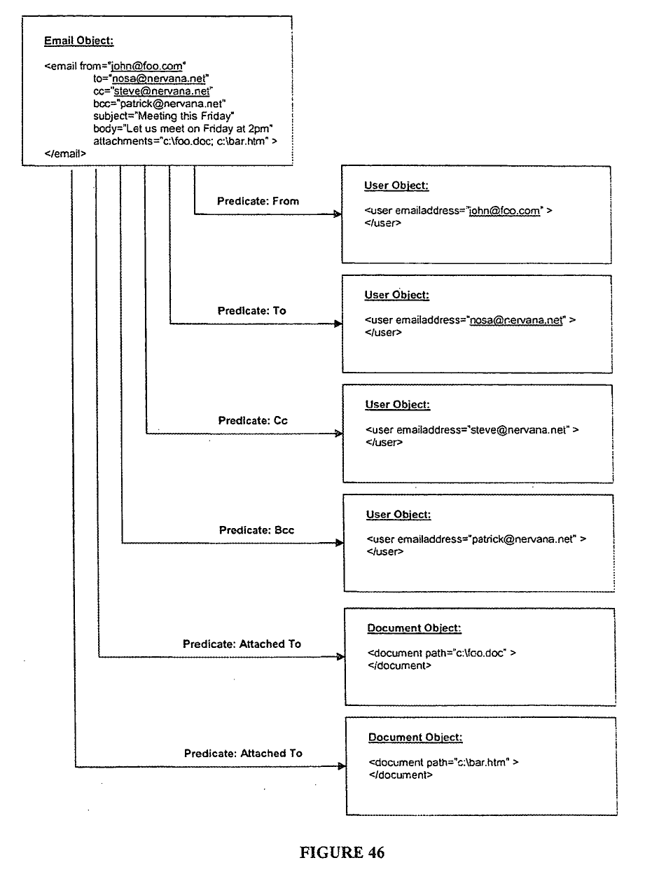

is converted to the object graph illustrated in FIG. 46.

C. Semantic Network Consistency Checker

The Semantic Network Consistency Checker (CC) complements the consistency checking that is performed by the SDG. As described above, the SDG maintains the integrity of the database tables by precluding the addition of redundant entries into the Semantic Network (from various data sources). The CC also ensures the consistency of the OBJECTS and SEMANTICLINKS tables. The CC periodically checks the OBJECTS table to ensure that each object exists in the native table (preferably by checking the OBJECTID field value). For example, a document object entry in the OBJECTS table preferably also exists in the DOCUMENTS table (with the same object ID). The CC removes any object in the OBJECTS table without a corresponding object in the native table (DOCUMENTS, EVENTS, EMAIL, etc.) and vice-versa.

The CC is also responsible for maintaining the consistency of the SEMANTICLINKS table. The semantics of this table are preferably as follows: A semantic link cannot exist if either its subject (“linked from”) or its object (“linked to”) do not exist. To illustrate this, if object A links to object B with predicate P, and either A or B is deleted, the link should be deleted. The CC periodically checks the SEMANTICLINKS table. If any of the subjects or objects has been deleted, the CC deletes the semantic link entry.

Consistency checks may be implemented in code in the KIS itself or as stored procedures or constraints at the database level.

d. Inference Engine

The Inference Engine is responsible for adding semantic links to the Semantic Network. The Inference Engine employs Inference Rules, which consist of a set of heuristics, to add semantic links based on ongoing semantic activity. The Inference Engine is preferably allowed to remove semantic links. Decision Agents (described below) use the Inference Engine to assist knowledge-workers in making decisions.

The Inference Engine operates by mining the Semantic Network and adding new semantic links that are based on probabilistic inferences. For example, the Inference Engine preferably monitors the Semantic Network and observes patterns in how email is sent, the type of email sent and by whom. The Inference Engine infers from this information background information, such as the expertise of the user, related to various subject matter categories within the monitoring purview of the Inference Engine. For example, the Inference Engine adds semantics links with the predicate PREDICATETYPEID_EXPERTON to indicate that a user is an expert in a particular category. The subject in this case will be a user object and the object will be a category object. To infer this, the Inference Engine is preferably configured to observe semantic activity for at least a certain period of time (e.g., two weeks), or to only infer links after users have sent at least a certain predetermined number of messages or authored a certain number of documents. The Inference Engine infers the new link by keeping statistics on the PREDICATETYPEID_CREATOR and PREDICATETYPEID_CONTRIBUTOR links.

By way of example, the Inference Engine may infer that users are an expert on a category if:
Of all categories of email messages they have written, this category is one of the top N (configurable).
They have written email messages on the same category an average of M times or more per week (configurable).
They have written at least O email messages (configurable) in the past P months (configurable).

More sophisticated inference models with which to accurately infer this data are contemplated. For example, probability distributions as well as statistical correlation models may be employed. Preferably these models will be developed on a per-scenario basis over time.

The Inference Engine is also responsible for removing links that it might have added. For example, if an employee changes jobs, he or she might “cease” to be an expert on a specific category (relative to other employees). Once the Inference Engine detects this (e.g., by observing email patterns), it removes semantic links that indicate that the person is an expert on the category.

Inferred semantic links are important for scenarios that involve probabilistic semantic queries. For example, in one embodiment of the present invention, using the Information Agent, users may drag and drop a document from their file-system onto an Agent (say, People.Research.All). In this case, users will want to know the people in the Research department that are experts on the document. The browser will then invoke an SQML query with the Agent as resource (or subject), the predicate nervana:experton, and the document path as the object. The Presenter will then retrieve the XML metadata for the document and call the XML Web Service, residing on the Agency that hosts the Agent, with the predicate ID and the document's XML metadata as arguments. The server-side semantic query processor on the Agency processes this XML Web Service call and translates the call to a SQL query consistent with the data model of the Semantic Network. In this example, the call is preferably resolved as follows:
1. For all semantic domain entries in the KDM, call the corresponding KBS to categorize the document.
2. Map the returned categories to category objects in the Semantic Network (by comparing URLs)
3. Invoke a query using the query of the People.Research.All Agent as a sub-query.
   In this example, the final query appears as follows:
SELECT * FROM USERS WHERE DEPARTMENT LIKE “RESEARCH” AND OBJECTID IN (SELECT OBJECTID FROM SEMANTICLINKS WHERE OBJECTTYPEID=32 AND PREDICATETYPEID=98 AND SUBJECTID IN (SELECT OBJECTID AS SUBJECTID FROM CATEGORIES WHERE OBJECTID IN (34, 56, 78)) AND LINKSCORE>90)
   This query assumes that the object type ID for the user object type is 32, the predicate type ID value for PREDICATETYPEID_EXPERTON is 98, the document belonged to categories with the object ID 34, 56, and 78 and that the semantic link score threshold is 90.

e. Server-Side Semantic Query Processor

The server-side Semantic Query Processor (SQP) responds to semantic queries from clients of the KIS. The SQP is preferably the main entry point to the Semantic Network on the KIS (or Agency). The SQP is exposed via the Agency's XML Web Service. The SQP processes direct Agent semantic queries and generic (client-generated) semantic queries with semantic link filters (see below). For queries with server-side Agent filters, the Information Agent passes the Agent name and object index arguments to the SQP to be invoked. For example, the browser may ask for objects 0-24 on Agent Documents.Technology.Wireless.All. In this example, the SQP looks up the Agent query in the Agents table and invokes the query onto the database that hosts the Semantic Metadata Store (SMS). The Agent query is preferably stored as SQL or another well-known query format like XQuery or XQL. The SQP may convert the query format to a format that the database (that holds all the tables) understands. Because most commercial databases understand SQL, it will preferably operate as the default Agent query format.

The Agent query preferably follows the query rules described above. Therefore, the query returns the object ID rather than the schema fields for the Agent's object type. In the above-described example, Documents.Technology.Wireless.All invokes the Agent query “SELECT OBJECTID FROM DOCUMENTS WHERE . . . ” The SQP is responsible for issuing a query that is filtered with the Agent query, but which returns the actual metadata for the object type (in this case, the “document” object type). In this example, the query appears as follows:
SELECT * FROM DOCUMENTS WHERE OBJECTID IN (SELECT OBJECTID FROM DOCUMENTS WHERE . . . )

This query returns the data columns for the “document” schema for all the objects with an object ID that matches those in the original Agent query. The SQP reviews the metadata results of the database query and translates them to well-formed XML using the appropriate schema for the object type of the Agent (in this case, “document”). In the event that the database supports raw XML retrieval, the SQP optimizes the query by asking the database to give it XML results. This results in better performance since the SQP does not have to perform the extra translation step. The SQP passes the XML back to the caller via the Agency's XML Web Service.

The SQP preferably handles more complex queries that are passed by the semantic browser (or other client of the XML Web Service). By way of example, such queries may take the form of the following XML Web Service API:

| String | |
|---|---|
| InvokeSemanticQuery( | |
| Integer | BeginIndex, |
| Integer | EndIndex, |
| String | AgentName, |
| Integer | NumberOfLinks, |
| String | OperatorNames[ ], |
| String | LinkPredicateNames[ ], |
| String | LinkTypeNames[ ] |
| String | LinkObjects[ ]); |

In this example, the “[ ]” symbols refer to arrays. The API takes a zero-based begin index, a zero-based end index, an optional Agent name, an integer indicating the number of semantic links, an array of operator names, an array of link predicate names, an array of link type names, and an array of strings that refer to the link objects. If the Agent name is NULL (“ ”), the SQP processes the query “as is”; without any preconceived Agent filter. This will be the case with queries that are wholly generated form the client. The arrays are variable sized because the “NumberOfLinks” parameter indicates the size of each array. The operator names include valid predetermined operators, including logical operators, which can be used to qualify queries in SQL or other query formats. Examples include term:or and term:and. The link predicate names may include one or more predefined predicates (e.g., term:relevantto, term:reportsto, term:sentto, term:annotates, term:annotatedby, term:withcontext, etc.). The link type names indicate the type of link objects. Common examples include term:url and term:object. In the case of term:url, the link object string refers to a well-formed URL comprising objects:// . . . or Agent:// . . . . In the case of term:object, the argument will be a well-formed XML metadata instruction referring to a object defined within the present invention. This object is preferably resolved from the client or from another Agency. The API returns a string that contains the XML results (in addition to the return value for the XML Web Service method call itself).

By way of example, the SQML with the data:

| | |
|---|---|
| <resource | type=“term:url” |
| | Agent://all.criticalpriority.all@abc.com/Agency.asp> |
| <link | predicate=“term:relevantto” |
| | type=“term,:object” |
| | object://4576 > |
| </link> | |
| <link | operator=“or” |
| | predicate=“term:intersects” |
| | type=“term:url” |
| | Agent://email.wireless.all@abc.com/Agency.asp> |
| </link> | |
| </resource> | |

is resolved on the Agency located at the Web service on abc.com/Agency.asp to:

```
InvokeSemanticQuery(
    0,
    24,
    “all.criticalpriority.all”,
    2,
    { “term:and”, “term:or” },
    { “term:relevantto”, “term:intersects” },
    { “term:object”, “term:url” },
    { “object://4576”, “Agent://email.wireless.all@abc.com/
    Agency.asp” } );
```

This is preferably resolved to a SQL query:
SELECT TOP 25 * OBJECTS WHERE OBJECTID IN (SELECT OBJECTID FROM OBJECTS WHERE CREATIONDATETIME=‘02/26/02’ AND (OBJECTID [RELATEDTO] [OBJECT WITH ID 4576]) AND OBJECTID IN (SELECT OBJECTS FROM EMAIL WHERE CATEGORY [IS] ‘WIRELESS’)
   This SQL example uses shorthand to illustrate the type of query that will be generated by the SQP. The SQP retrieves the XML and returns it to the caller. This XML is in the form of SRML (or Semantic Results Markup Language), which is the XML meta-schema definition for semantic query results in the preferred embodiment of the invention. Sample A shown in the Appendix hereto is a sample SRML semantics results buffer or document. This is a sample of the XML that an Agency returns in response to a semantic query. The client Skin takes these results and generates presentation form them (using XSLT and/or script), based on the properties of the Skin and the Agent (object Skin/Context Skin/Blender Skin), the amount of display area available, disability considerations and other Skin attributes.

f. Natural Language Parser

The Natural Language Parser (NLP) preferably converts natural language text to either an API call that the SQP understands or to raw SQL (or a similar query format) that can be processed by the database. The Natural Language Parser is passed text directly from the semantic browser or by email via the Email Knowledge Agent (see below).

g. Email Knowledge Agent

The KIS preferably includes one primary publishing component, referred to as the Email Knowledge Agent (or Enterprise Information Agent (EIA)). This Agent functions, in essence, as a digital employee, and preferably includes a unique email address (e.g., a custom name selected by the Agency administrator). The Email Knowledge Agent complements existing publishing tools such as Microsoft Office, SharePoint, etc. by adding a “Fire and Forget” method of publishing information and sharing knowledge. This is especially useful in cases where the person publishing the information does not know who might be interested in it.

In a preferred embodiment of the present invention, users send email to the Email Knowledge Agent to publish comments, annotations, documents, attachments, etc. The Email Knowledge Agent extracts meaning from the email and properly adds it to the Semantic Network. Other users are able to access published information via Agents of other platform presentation tools such as drag and drop, the Smart Lens, etc. (discussed below).

The Email Knowledge Agent is a system component that is created by the Agency administrator. The system user name is indicated when the server is first installed. The system user preferably corresponds to an email user in the enterprise email system (e.g., Microsoft Exchange, Lotus Notes, etc.) In this embodiment, the Email Agent has its own mailbox, calendar, address book, etc. These in turn correspond to the objects on the Email Server for the system user. When the server is installed, the KIS installs the appropriate DSA for the system inbox (depending on the email application). The KIS preferably automatically adds a gatherer list entry in the SDG indicating that the system inbox should be periodically crawled for email.

Because the Email Knowledge Agent is a first-class email address, it also serves as a notification source and a query source (for natural-language and instant messaging). Notifications from an Agency are preferably sent by the Email Knowledge Agent (indicating that there is new and relevant information the user might be interested in, etc.). The Email Knowledge Agent may also receive email from users as natural language queries. These messages are parsed by the SQP and processed. The XML results are preferably sent to the user as an HTML file (with the appropriate default Skin) generated with XSLT processed over the XML results of the natural-language query.

Because the Email Knowledge Agent is a regular familiar component or “employee,” the Agency administrator preferably adds the address to distribution lists. This step allows the SDG to semantically index all the email in these distribution lists, thereby populating the Semantic Network by seamlessly integrating the Email Knowledge Agent into distribution lists useful to users. This is a very seamless way of integrating the digital Information Nervous System of the present invention with the way people already work in an organization.

Annotations. The Email Knowledge Agent is preferably used to publish annotations. In the present invention, annotations are preferably email messages. In the preferred embodiment, the annotation object type is a subclass of the email object type. This allows users to use email, typically the most common publishing tool, to annotate objects in the semantic browser. Users are able to annotate objects and add attachments to the annotations. These attachments are semantically indexed by the SDG on the KIS. This makes possible scenarios where a user is able to navigate from, say, a document, to an annotation, to its document attachment, to an article on Reuters, to an industry event that starts next week.

The process described for semantically indexing email (by mapping the email XML schema to the Semantic Network) also applied to annotations. However, in the case of annotations in a preferred embodiment of the present invention, additionally processing is desirable. Specifically, when the user clicks “Annotate” on an object in the Presenter window in the semantic browser (described below), the browser loads the registered email client on the local machine (e.g., Microsoft Outlook, Microsoft Outlook Express, etc.). The “to”’ field is populated with the address of the system user for the Agency that hosts the object. The subject field is populated with a special string, for example, “annotation: object=[objectid]”. When the email arrives in the Email Knowledge Agent's inbox, the DSA for the email inbox will pick it up (e.g., via a server event). The SDG retrieves the new email XML metadata from the DSA by receiving an event, or from the DSA the next time it asks the DSA for more data. In a preferred embodiment, this polling process occurs frequently. The DSA returns the XML metadata of the email object, oblivious to the fact that the email object refers to an email object type or an annotation object type. The SDG processes the email XML metadata, and examines the “subject” field. If the SDG “sees” the “annotation:” prefix, it knows that the email is actually an annotation, and proceeds to extract the object ID argument from the subject text. The SDG updates the Semantic Network for remaining email messages (adding each message to the OBJECTS and EMAIL tables, adding semantic links for the “from,” “to,” “cc,” “bcc,” and “attachments” fields, where necessary, etc.). In the preferred embodiment, the SDG performs an extra step. Specifically, it adds a semantic link entry that links the email object with the object indicated by the object ID argument in the subject text (with the PREDICATETYPEID_ANNOTATES predicate).

With the present invention, an annotation is treated as another semantic link with a special predicate. As a result, all the semantic features apply to annotations, such as semantic navigation via semantic links, semantic queries, etc. For example, a user can query for all annotations written by every member of his of her team in the last six months. This can be accomplished in the semantic browser by dragging, for example, the Agent Annotations.All on top of the Agent People.MyTeam.All and then sorting the results, or by creating a Smart Agent, which in turn invokes the “Create Smart Agent” wizard to create the query.

h. Knowledge Domain Manager

The Knowledge Domain Manager is the component on the KIS that is responsible for adding and maintaining domain-specific intelligence on the Semantic Network. The KDM essentially “annotates” the Semantic Network with domain-intelligence. The KDM is initialized with URLs associated with one or more instances of the Knowledge Base Server (KBS), which in turn effectively stores “knowledge” for one or more semantic domains. The KBS has ontology and categories corresponding to taxonomy for each semantic domain that it supports. In addition, an Agent with a semantic domain (connected to a KBS) responds to semantic queries. If an Agent does not belong to a semantic domain, it cannot correspond to semantic queries (that require an ontology or taxonomy). Rather, it only responds to keyword-based queries (albeit it will still provide context and time-sensitive retrieval services, but the available contexts will be limited).

Each entry in the KDM is a semantic domain entry. The semantic domain entry has the URL to the KBS and a semantic domain name. The semantic domain name maps to a specific ontology on the KBS. In the preferred embodiment of the present invention, semantic domain names follow the convention:

<Top Level Domain Name>\<Secondary Level Domain Name> . . .

Examples of semantic domain names include:

Industries
Industries\Pharmaceuticals\LifeSciences
Industries\InformationTechnology
General\Sports.Basketball\NBA
General\Sports.Basketball\CBA

Alternatively, semantic domains names can be referred to as “domain paths” as long as they are fully qualified. Full qualification is achieved by adding an Internet domain name prefix to the beginning of the path. This indicates the “owner” or “source” of the semantic domain. For example, “Nervana.NET\Industries\Pharmaceuticals” refers to “Industries\Pharmaceuticals” semantic domain according to the “NERVANA.NET” Internet domain name. In another example, “Reuters.com\Sports\Basketball” refers to “Sports\Basketball” on “Reuters.com.” Using this approach, domain names and paths are maintained globally unique.

The Knowledge Domain Manager (KDM) periodically requests each KBS in its domain entry list for the categories in the knowledge domain. The KDM is preferably implemented as an XML Web Service on the KIS. The KDM includes configuration options for each semantic domain entry. One of these options may include the schedule with which the KDM will update the Semantic Network with domain-specific intelligence corresponding to the semantic domain entry. For example, the Agency administrator may configure the KDM (via the KIS) to crawl a semantic domain on a KBS every day at 1 pm. The update schedule should be consistent with how often the administrator believes the ontology or taxonomy on the KBS changes.

The KIS preferably invokes the KDM periodically and asks it to update the CATEGORIES table. In the preferred embodiment, the KDM calls the KBS (via an XML Web Service API call) to obtain updated categories for the semantic domain name in the semantic domain entry, which corresponds to a particular taxonomy. An example of an API call follows: GetCategoriesForSemanticDomain (String SemanticDomainName). The KBS returns an XML-based list of all the categories in the semantic domain referred to by the semantic domain name. This XML list is consistent with the CATEGORIES schema shown above (category URL, name, description, the KBS URL and the semantic domain name). The KDM updates the CATEGORIES table with this information. For category entries that already exist in the table, the KDM updates the name and description. For new entries, the KDM requests a new object ID from the object manager and assigns that to the category entry. Since, in the preferred embodiment, a category is an “object,” it inherits from the Object type and therefore has an object ID.

The KDM synchronizes the CATEGORIES table to the CATEGORIES list on the KBS (for a particular semantic domain) by deleting entries in the CATEGORIES table not present in the new list after examining the URL of the category entries and obtaining the relevant KBS URL and semantic domain name. If a semantic domain entry is deleted from the KIS, the KDM deletes all category entries with a corresponding semantic domain name and KBS URL. Essentially, this will be akin to ridding the Agency of existing knowledge.

The KDM periodically categorizes all “knowledge objects” in the Semantic Network based on its semantic domain entries. When new objects are added to the Semantic Network by the SDG, the SDG requests that the KDM categorize the objects. The KDM enumerate all KBS instances in its semantic domain entries and invokes XML Web Service calls with the XML of the object as the argument. In the preferred embodiment, the KBS returns a result in an XML buffer similar to:

```
<results>
    <result categoryurl=“category://foo”
        score=“91” >
    <result categoryurl=“category://bar”
        score=“93” >
    <result categoryurl=“category://foobar”
    score=“100” >
</results>
```

This information indicates the semantic categorization weights of the XML object for the categories in the semantic domain on the KBS. In a preferred embodiment of the present invention, the semantic domain entry is initialized with a threshold (0-100) indicating the minimum weight that the KDM should request from the KBS. The KBS returns scores that exceed the predetermined threshold. The KDM annotates the Semantic Network based on these categorization results. This is preferably accomplished by adding or updating a semantic link with the predicate type ID of “belongs to category” with the object ID of the category in the result. The KDM will update the SEMANTICLINKS table. Assuming by way of example that the object that is categorized has an object ID value of 56, the update query appears as follows:
UPDATE SEMANTICLINKS SET LINKSCORE=91 WHERE OBJECTID=56 AND PREDICATETYPEID=67 AND SUBJECTID IN (SELECT OBJECTID AS SUBJECTID FROM CATEGORIES WHERE URL LIKE “CATEGORY://FOO”)

The KDM periodically scans and categorizes all the “knowledge objects” (documents, news articles, events, email, etc., preferably not including objects like people). This process preferably occurs even if an object in the Semantic Network has previously been categorized as the KBS might have become “smarter” and therefore provides superior categorization. In such a case, the results could change even if the same categorization request is repeated. This will occur, for example, if the ontology on the KBS has been updated. Thus, in the preferred embodiment, categorization will be performed both when an object is added to the Semantic Network by the Semantic Data Gatherer and periodically to ensure that the Semantic Network has the most up-to-date domain knowledge.

i. Other Components

The Favorite Agents Manager. On Agencies that support User States, a Favorite Agents Manager manages a list of per-user favorite Agents. In the preferred embodiment, the Favorites Agent Manager stores a mapping of user names to favorite Agents in a UserFavoriteAgents table.

Compound Agent Manager. A Compound Agent Manager manages the creation, deletion, and update of compound Agents. As described above, compound Agents are Agents that are comprised of other Agents in the system, and are initialized to return the union or intersection of the query results in the contained Agents. The Compound Agent Manager manages all compound Agents in the system and maps compound Agents to the Agents they contain via the CompoundAgentMap table.

The Compound Agent Manager exposes functions to create compound Agents, delete, rename, add to and remove Agents from them, and indicate whether a union or an intersection is desired. Compound Agents can be added to other compound Agents. On invocation, the semantic query processor asks the Compound Agent Manager for its compound query. The Compound Agent Manager navigates through its Agent map graph and returns a complex query of all the queries of all Agents that it contains. If Agents are deleted, compound Agents “pick up” the new state when they are invoked, ignoring the Agent query. In other words, the compounding of queries is only done for Agents that still exist. If the compound Agent observes that one of its Agents has been deleted, it will delete the entry from its map.

User Profile Manager. The User Profile Manager (UPM) preferably uses the Inference Engine to infer the user's profile on an ongoing basis. The UPM annotates the Semantic Network based on feedback from users as to their explicit preferences. In the preferred embodiment, this process involved use of the PREDICATEID_ISINTERESTEDIN predicate. The UPM infers semantic links and annotate the Semantic Network with the PREDICATEID_ISLIKELYTOBEINTERESTEDIN predicate. All query results to the user will be qualified (out-of-band) with a query to the Semantic Network for the PREDICATEID_ISLIKELYTOBEINTERESTEDIN predicate. Query results are based on the user's habits, as the Inference Engine learns them over time.

Alternatively, the UPM may be configured with user profile information stored in the User State Store (USS). This is information manually entered at the client indicating the user's preferences. This information is transferred and stored at the server that the user is interacting with. These preferences are tied to different schema. For example, for documents, the schema may be based on the preferred categories. For email messages, the schema may be based on preferred categories, authors, or attachments. These are two of many possible examples. The UPS annotates the Semantic Network based on the manually entered information in the USS.

Server Notification Manager. The Server Notification Manager (SNM) is responsible for batching server-side notifications and forwarding them to users. In the preferred embodiment, users register for server-side notifications at the Agent level. Each Agent is capable of firing notifications of its query results. The Server Notification Manager determines how to filter the query results and format them for delivery via email, voice, pager or any other notification mechanism, e.g., the Microsoft .NET Alerts notification services. The Server Notification Manager maintains information on the last time users “read” the notification. This is preferably indicated from the client via a user interface. The SNM preferably only notifies a user when there is new information on the Agent since the last “read” time for the particular user.

Agent Discovery. Using multicast-based Agent discovery, each Agency sends multicast announcements indicating its presence on the local multicast network. The Agency administrator sets the multicast TTL. The present invention preferably uses either use the Session Announcement Protocol (SAP) with a well-known port of 9875 and a TTL of 255, or a proprietary announcement port with a customizable TTL. For details on SAP, see http://sunsite.cnlab-switch.ch/ftp/doc/standard/rfc/29xx/2974, which is incorporated by reference.

The Information Agent preferably includes a listener component that receives SAP announcements. In the preferred embodiment, the announcements are sent as XML and will include the following information
The server ID (this is a unique identifier)
The server URL (this is the HTTP URL to the Agency's XML Web Service)
The announcement period (T)—this indicates the time between each announcement
Whether there are any new Agents in the Agency since the last announcement and the last Agent creation time (on the Agency's clock)

Each Agency sends the XML announcement and uses Forward Error Correction (FEC) or Forward Erasure Correction to encode the packet. This makes the system robust to dropped packets. Alternatively, the Agency can be configured to send the XML announcements several times in succession (per announcement).

The Information Agent multicast listener exposes directory-like semantics to the Semantic Environment Manager. The listener aggregates all the XML announcements from the Agencies from which it receives announcements. It will also cache the last time it received an announcement from each Agency. The listener flags Agencies that it thinks might be dead or inactive. It does this when it has not heard from the Agency for a time longer than the Agency's announcement period. The listener might be configured to wait for several periods before flagging the Agency as inactive. This will handle the case of dropped announcements (due, perhaps, to traffic congestion). The listener will update the Agency list in the Semantic Environment Manager each time it receives announcements.

The Semantic Environment Manager periodically inquiries of the listener whether there are any new Agents. The Semantic Environment Manager checks the Agency list and asks each Agent that is active whether it has new Agents. The Semantic Environment Manager qualifies this request with the Agency's last Agent creation time maintained locally and the current time based on the Agency's clock. The Agency responds and also sends the new value of the last Agent creation time. The Semantic Environment Manager caches this value in the Agency entry. If there are new Agents, the browser inform the user via a dialog box and asks the user whether he or she wants to view the new Agents.

The present invention_also supports Agency announcements using a peer-to-peer Agent discovery. In this model, announcements are sent either to a directory server that all clients check or directly to the clients via a standard peer-to-peer publishing protocol.

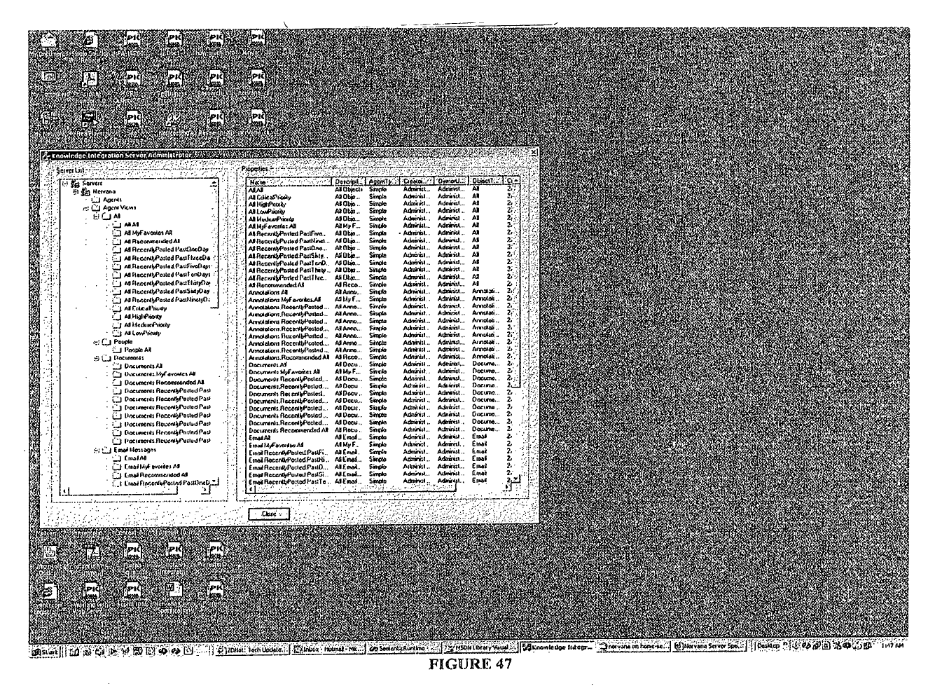

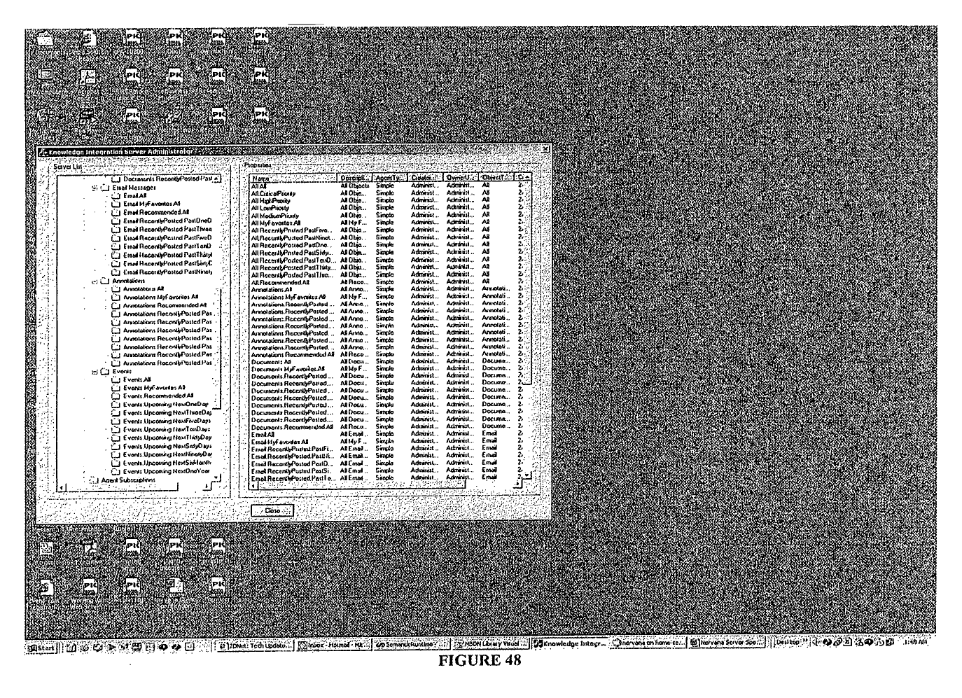

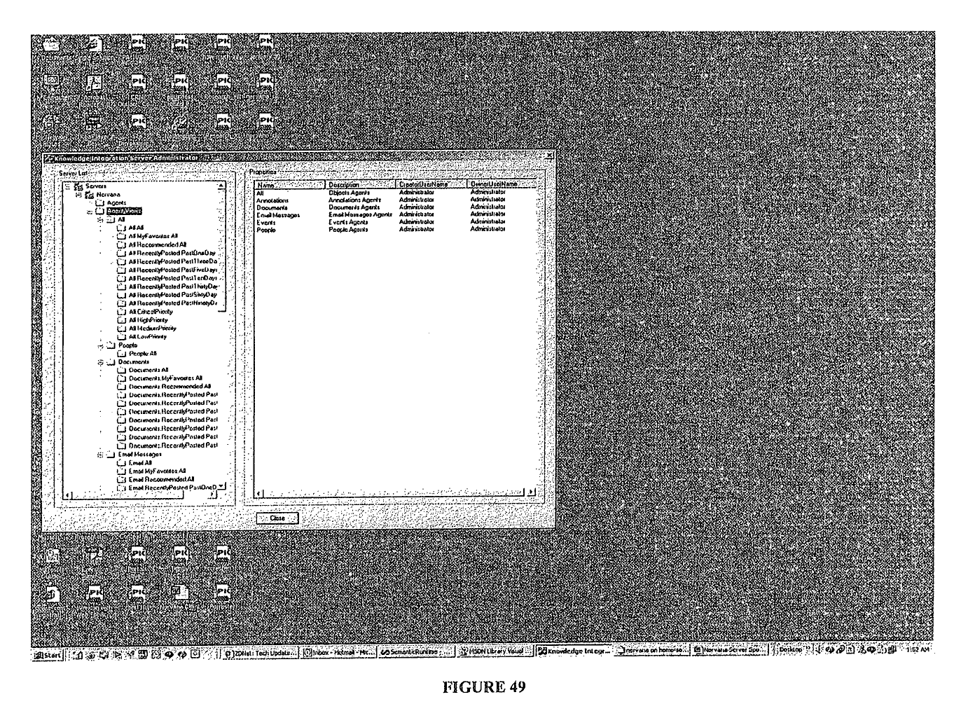

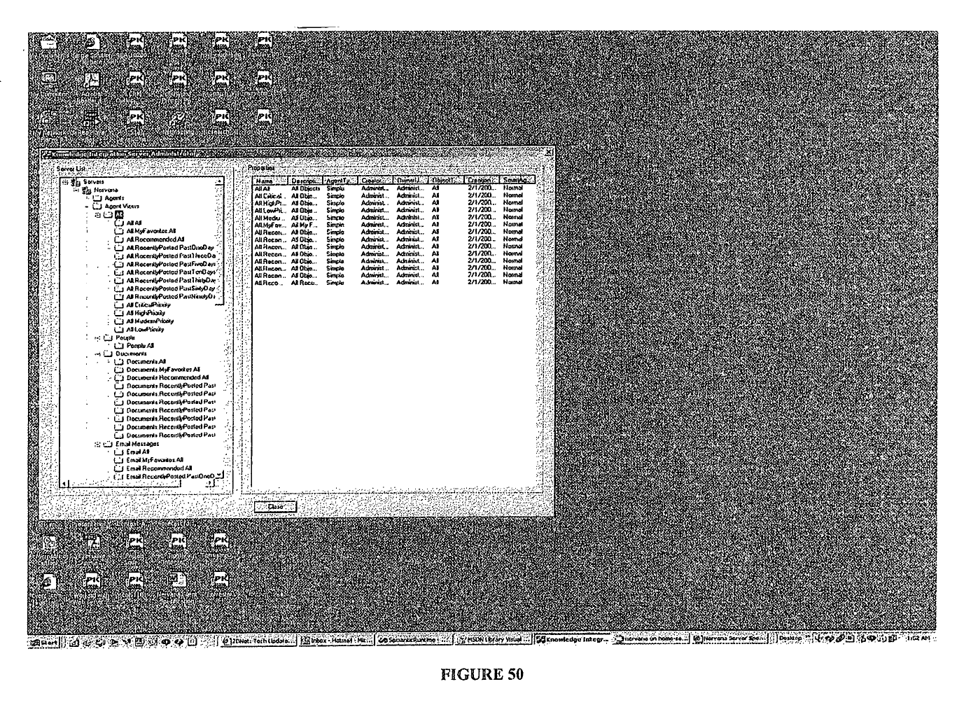

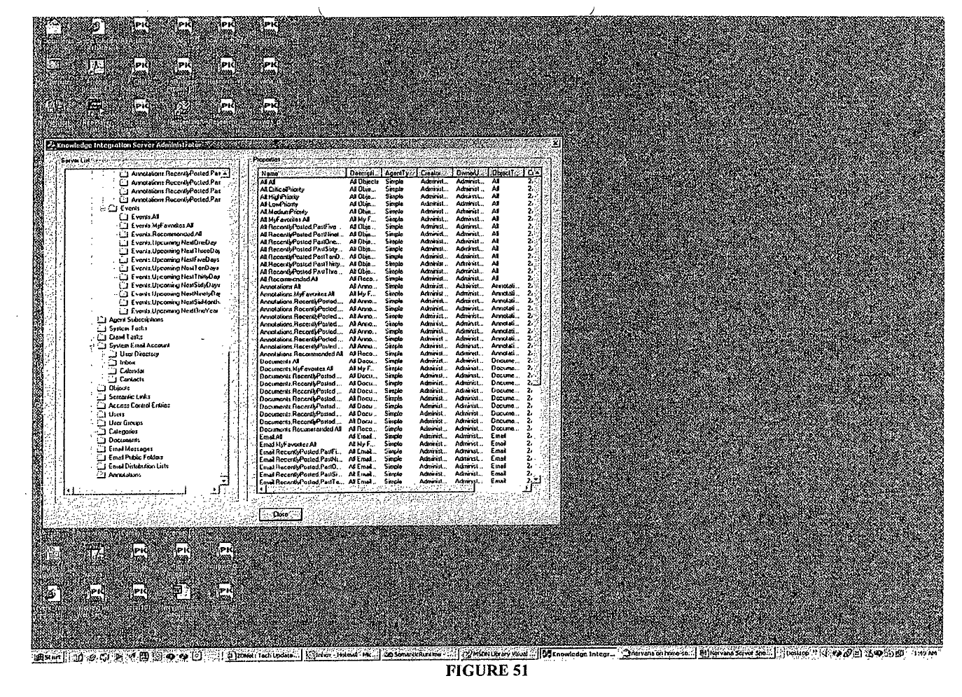

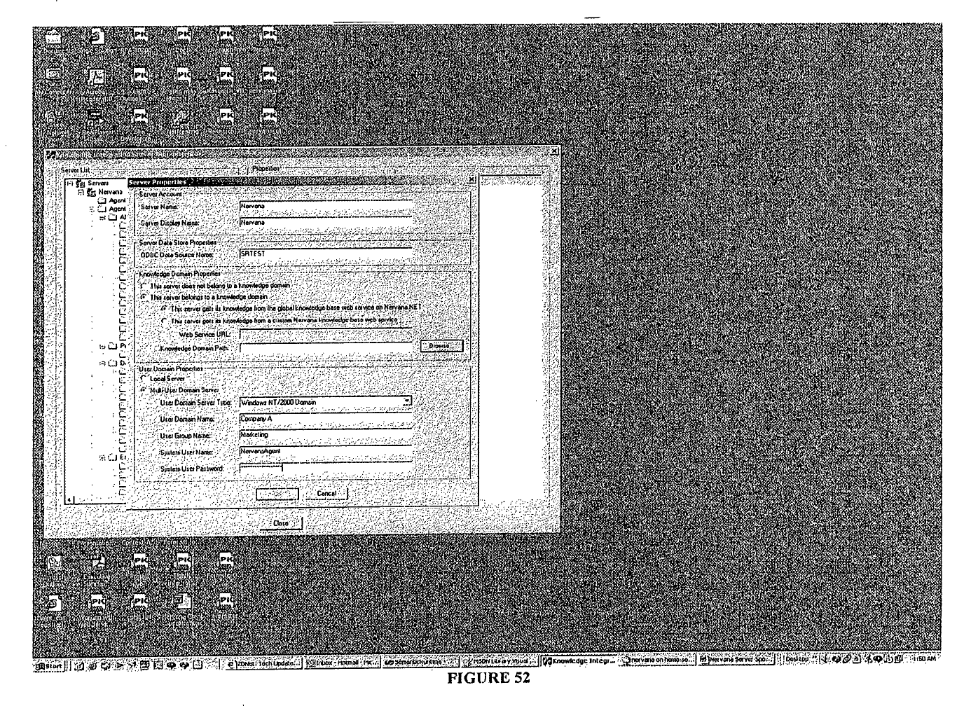

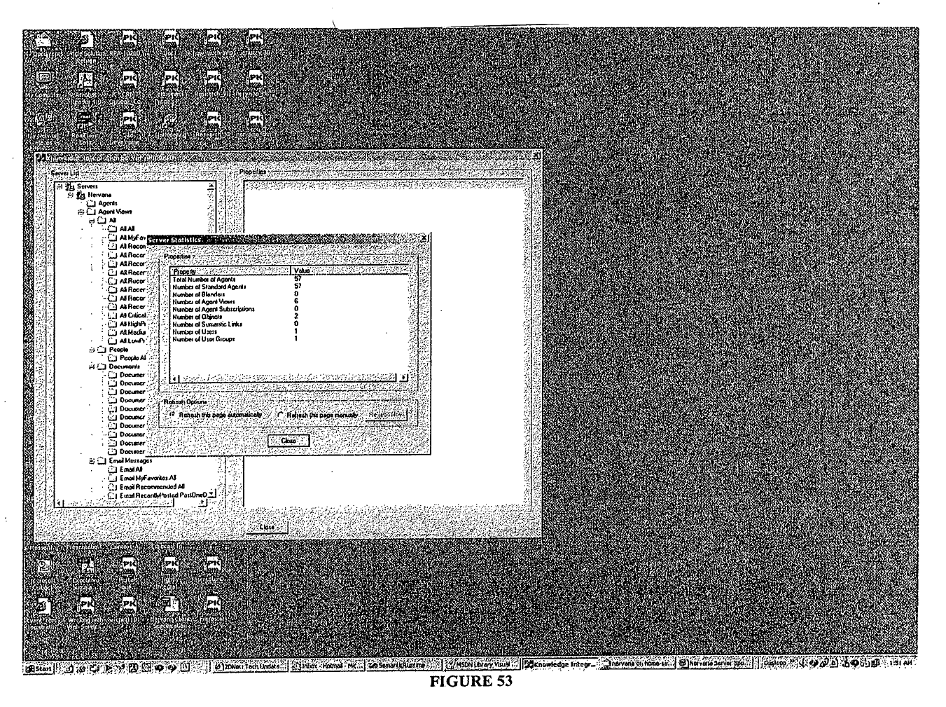

FIGS. 47-53 are exemplar screenshots showing aspects of Agent management by the KIS. FIGS. 47-50 illustrate a sample KIS Agency administration manager showing server-side Agent views and server-side Agents. FIG. 51 further illustrates sample administration user interface elements for managing SDG (crawl) tasks, system tasks (e.g., the Inference Engine), the system Agent Email (e.g., inbox), calendar and contacts DSA and all the SMS data tables (objects, semantic links, categories, etc.). FIG. 52 illustrates a sample of the “Server Properties” dialog of the present invention in the KIS Agency administration manager. The dialog illustrates how the server administrator can set server properties such as the server name, the display name, the SMS Data Store properties, the KDM properties (e.g., the knowledge domain path) and the user DSA properties. FIG. 53 illustrates a sample of the “Server Statistics” dialog in the KIS Agency administration manager of the preferred embodiment. The dialog illustrates the display of statistics such as the total number of server-side Agents (Standard Agents and Blenders), the total number of server-side Standard Agents, the total number of server-side Blenders, the total number of server-side Agent-views, the total number of server-side Agent subscriptions, the total number of information objects stored on the server, the total number of semantic links, the total number of users on the server (Agency) and the total number of user groups.

3. Knowledge Base Server

The Knowledge Base Server (KBS) is the server that hosts knowledge for the KIS. In most applications, many instances of the KIS will be deployed, but only few (or one) KBS will be deployed for any given organization. This is because KBS can be reused (they are domain-specific but data-independent). For example, a pharmaceutical firm might deploy one KBS initialized with a pharmaceuticals ontology, but have several KIS installations; perhaps per employee division or per employee group. The KIS preferably includes the following components:
1. One or more ontologies that correspond to one or more semantic (knowledge) domains. A semantic domain is referred to using a semantic domain name. This is a name that refers to a domain path within a semantic hierarchy. Examples are Industries.Technology, Industries.Pharmaceuticals.LifeSciences, and General.Sports.Basketball. These names or paths may also be globally and uniquely qualified (e.g., with Internet domain names) as previously discussed.
2. One or more taxonomies that correspond to the supported semantic domains.

These taxonomies contain a hierarchy of category names.
3. A categorization engine that take a piece of text or XML and the semantic domain name with which the categorization is to be performed, and returns the categories in that domain that the text or XML belong to, along with the categorization scores (on a scale of 0-10 or, preferably, 0-100).
4. An XML Web Service that exposes APIs to add new supported semantic domains (and corresponding ontologies and taxonomies), to enumerate the categories for a given semantic domain, and to categorize a text or XML data blob.
5. An XML Web Service reference to another KBS from which the KBS gets its knowledge. In this mode, the KBS acts as a proxy. The KBS can be initialized to act as a proxy and to get its supported semantic domains, ontologies, and taxonomies from another KBS.

As explained above, the KIS (via the KDM) periodically sends XML objects to the KBS to categorize them for a given semantic domain.

4. Information Agent (Semantic Browser Platform)

a. Overview

The system client, in the preferred embodiment the Information Agent of the present invention, includes the semantic browser components and user interface that provide a semantic user experience. In the preferred embodiment, the Information Agent provides the following high-level services:
Allow users the power of context and time-sensitive semantic information retrieval via local and remote Information Agents.
Allow users to discover information on local and remote Agencies that are exposed via Agents through the XML Web Service of the present invention. This information is preferably classified into well-known semantic classes such as documents, email, email distribution lists, people, events, multimedia, and customers.
Allow users to browse a semantic view of information found via Agents of the present invention.
Allow users to publish information to an Agency.
Allow users to dynamically link information on their hard-drive, local network or a specific Agency with information found on Agents from another Agency. This facilitates dynamic e-linking and user-controlled browsing.

An advantage of the Information Agent of the present invention is that users open up Agents similar how users open up documents from their file-system namespace. The Information Agent will have its own environment that opens up semantic “worlds” of information. For example, ABC company may have an internal KIS Agency that has Agents for internal documents, email, etc. In addition, third-parties may host Agencies on the Internet to hold information on industry reports, industry events, etc. In a preferred embodiment of the present invention, ABC company employees open Agents to discover information on the Internet that relates to their work as well as to semantically relate information that is internal to ABC company to information that is external but relevant to ABC company.

b. Client Configuration

In the preferred embodiment, the system client is able to semantically link information found locally as well as on remote Agencies. This is preferably accomplished through the use of an exposed Semantic Environment comprised of Agencies from a Global Agency Directory, Agencies on the local area network (published via multicast or a peer-to-peer publishing system) and Agencies from a custom Agency Directory using Agent Discovery. The preferred client configuration is based on a framework having Agents and local Agencies, and includes a Semantic Environment Manager, which manages locally saved Agents and Favorite Agents, essentially integrating the history and favorites metaphors. The Semantic Environment Manager uses Semantic Query Documents within the Semantic Environment to present knowledge to users via the Semantic Environment Browser. The client configuration will also include the Agent Discovery information (e.g., Agency lists, Agency directory information, etc.).

c. Client Framework Specification

Overview. The client framework specification provides the service infrastructure for the Information Agent user interface, and defines basic services and interfaces, includes core user interface components, and provides an extensible, configurable environment for the main building blocks of the user interface of the Information Agent. This section described the client framework specification according to a preferred embodiment of the present invention. The Framework Core defines base services, configuration, preferences and security mechanisms. The Core User Interface Components define the user interface services and modules that support server and Agent configuration, control and invocation, and some configuration for the Semantic Browser Framework. The Core User Interface Components are implemented as a Windows Shell extension and associated user interface (described below). The Semantic Browser Framework provides base query and results management services, and the framework for results presentation. The specifics of the user interface related to semantic object presentation are preferably configurable and extensible; even default presentation support is provided as a pre-installed “extension.” The Semantic Browser Framework is preferably implemented as a set of behavior extensions to existing platforms used in Today's Web (e.g., Internet Explorer), and leverages the supported XML, XSLT, HTML/CSS and DOM functionality.

Context. The client framework builds upon semantic services components of the present invention including semantic query support, context and time-sensitive semantic processing and linking of information, etc. The client framework is preferably built as a shell extension and platform (e.g., Internet Explorer) extensions, which provides functionality to users in the context of their existing tools and environment. For example, the Information Agent may be implemented as a Shell Extension (which extends the Windows Shell and employs the standard Explorer view and user interface models). In an alternative embodiment, the present invention is equally applicable in a standalone semantic browser application.

Requirements. The preferred requirements for the client framework relate to flexibility and extensibility. This ensures that the user interface can be easily and quickly adapted as there are more information object types, user profiles, etc. Included are the following:
Provide support for Skins to manage the entire set of query results.
   Allow for a wide range of approaches, include lists, tables, timed slides, etc.
Provide a screen-saver (or equivalent) mode.
   Provide support for Skins that can be associated with an object class.
   Ensure that there is a default Skin that can handle all classes.
   Skins should be as simple as XSLT, but should allow script support, and possibly even code (with appropriate security restrictions).
   Provide support for browsing the Semantic Environment in the results view (to complement the Agent Tree View), including Agents (Smart, Dumb, and Special), Agencies, and Blenders.
Provide well-defined interfaces between components, and ensure that all communication must occur via the framework.
Provide a solid security model throughout the framework

Framework Core

Semantic Environment Manager (SEM). The SEM manages the creation, deletion, updating and browsing of Agents, Blenders, and Agencies on users' local machines. In addition, the SEM is responsible for listening to Agency multicast announcements, browsing Agencies on the enterprise directory (e.g., via LDAP), browsing Agencies on a custom directory, and browsing Agencies on the Global Agency Directory.

The SEM includes a storage layer that stores the metadata of every Agent on the system, including all the Agent attributes (such as the Agent name, description, creation time, last usage time, the Agent type (Smart, Dumb, Special, etc.), the information object type the Agent represents (for Agents created based on information type), the context type the Agent represents (for Special Agents or Agents created based on a Context Template), the attributes of the Agent, a reference to the XSLT or other script file that represents the Agent's Skin (including filter/sort preferences and other presentation schemes), the notification information and method (if requested for the Agent), and the buffer or file-path/URL to the Agent's SQML query. The Information Agent (semantic browser) may store this Agent metadata in a local database, a store like the Windows registry, or in an XML file store on the local file-system.

The SEM also uses the Agent attribute to indicate whether an Agent is a Favorite Agent. In addition, the SEM automatically deletes Agents that are not favorites and which are older than a configurable age limit (e.g., two weeks).

The Information Agent's Shell Extension and other components (such as the toolbar and the Open Agent dialog) employ the SEM to provide Agent creation, deletion, browsing, updating, and management of Agents via its user interface.

Preferences Manager. This component manages all client-side preferences, providing services to persist the preferences, communicates with servers as needed to share preferences or support roaming, and supports setting and obtaining preference values from other components. This component has associated user interface as well as some more specific preferences user interface components. The preferences are divided into sub-components, and may abstract the preferences for associated client classes. These include:
Core Preferences. This includes basic configuration such as user profile and persona information.
Skin Preferences. This also associates preferred Skins with object classes, as well as the preferred list Skin and screen saver Skins. There may be additional Skin-related preferences settings.
   This component also manages the set of locally available Skins. Downloadable Skins are preferably managed through this component.

Notification Manager. Notifications provide a means to indicate to users that there is new information available on a given Smart Agent. Users optionally configure a specific Smart Agent to support or provide notifications (it will be OFF by default for most Smart Agents), and will also configure how to present notifications to users. These notifications are presented by the Notification user interface component.

The Notification Manager is responsible for managing background, polling queries for the appropriate set of Smart Agents. The Live Information Manager is a parallel component that provides similar services to the Results Browser.

The Notification Manager gathers the list of Smart Agents marked for notification, and periodically polls the associated servers for new information. “New” is defined as “since the last poll [or query].” Each time the poll responds, it includes a timestamp indicator that the Notification Manager must persist, associated with the Agent.

The user interface associated with configuring the Notification Manager is preferably implemented in coordination with the Agent Tree View. This enables notifications (e.g., a “Notify” popup menu option of each Smart Agent). The Notification Manager may also support alternatives for notifying the user when there are new results available. Some options include a display style (e.g. bold, colored, etc.) for the Agent in the Agent Tree View, a reminder dialog, audio notification, or more exotic actions like email, IM or SMS notification.

Client-Side Security. Client-side security issues relate to extension code and Skins. The Skins are preferably XSLT, but may also support script. In addition, the generated HTML may include references to ActiveX components and behaviors. The presentation sandbox may include security restrictions that prevent Skins from running potentially malicious code via script. For example, the implementation may completely disallow any unsigned code (including ActiveX and DHTML behaviors).

All client-server communication with Agencies are preferably hidden from the published interfaces (for Skins), which third parties will customize to provide custom Skins. By isolating the functionality outside of the primary client runtime, the risk of security compromise can be reduced.

Core User Interface Components

Agent Tree View. This is a Shell Extension Tree View that supports much of the core user interface for controlling and invoking Agents.

Semantic Environment Browsing User Interface. This provides user interface to allow users to browse the Semantic Environment. An example of this is the “Open Agent Dialog.” This complements the Agent Tree View, which also displays a hierarchical view of the namespace (see screenshots).

Agent Inspector. This provides user interface to view the properties or edit (in the case of user-created Smart Agents) an individual Agent, Blender or Agency.

Browser Host. This is preferably a “wrapper” on the semantic browser core (e.g., the Internet Explorer browser runtime), which allows the presentation of a custom view of the Agents, Agencies, and Blenders in the Agent Tree View. It preferably does not have any user interface itself, but is a bridge component between the Shell Extension and the Browser Framework. This component is also preferably responsible for coordinating certain browser functionality with the Windows Shell user Interface, including in particular the navigation (“back/forward”) mechanism, in order to provide a seamless “back/forward” user experience (wherein the user only has to deal with one “back/forward” history list).

Core Preferences UI. This provides a user interface for preferences related to Semantic Environment, server, persona and Agent management, as well as any other miscellaneous preference settings. This preferably includes primitive property sheet dialog, possibly divided up into separate sheets by functional area. In the preferred embodiment, this should be a tabbed dialog user interface.

Skin Preferences UI. This provides a user interface for preferences related to Skin management. This is preferably a property sheet dialog. The list of available Skins should be presented as a list, for selection. This user interface allows users to set the current Skins, as distinct from the default Skins. It preferably allows users to make the current Skin be the default. For per-Agent Skin preferences, this preferably allows users to select a Skin for the currently selected or opened Agent.

Notification UI. The user interface associated with configuring the Notification Manager is preferably implemented in coordination with the Agent Tree View. The Notification Manager may also support alternatives for notifying users when there are new results available. Some options include a display style (e.g. bold, colored, etc.) for the Agent in the Agent Tree View, a reminder dialog, audio notification, or more exotic actions like email, IM or SMS notification. In the preferred embodiment, the user interface should include a tabbed dialog (or equivalent) to allow users to select out of the aforementioned notification schemes (and the like).

Screen Saver. The user interface preferably provides a special modality to the Results Browser that function like a screen saver, filling the screen in a theater-mode display. In the preferred embodiment, special Skins should be used for the screen-saver mode. These Skins could emphasize a dynamic display that can leverage a larger screen area, but could also use larger fonts and more widely spaced layout.

Browser Framework

Results Browser. The Results Browser is responsible for displaying the results of queries, and the information on any local resources opened. The Results Browser preferably obtains one or more XML files from the Query Manager and merges these into a single XML file that represents a list of objects. The list itself may be filtered or sorted as an initial step. The list as a structure is transformed by a special class of Skin (an XSLT transform sheet, possibly including some script) that handles lists. The list-Skin creates the primary DHTML (or the like) structure, e.g., a list, a table or perhaps a timed sequence. Object Skins manage the individual DHTML items that present the information for each object instance. List-Skins may handle the dispatch of individual object Skins (mapping object class to Skin), but the Results Browser preferably provides default mappings of class to Skin for simplicity.

Users may prefer a given form of presentation, and may choose default Skins (both for the list as well as for object classes). The original query (i.e. the SQML) may also include parameters that indicate which Skins should be used (especially which list-Skin). These will be passed to the Results Browser along with the results. The Results Browser uses the facilities of the Skin Manager to select the right Skin to apply. Different rules may be employed for how user preferences and Agent (author) preferences are combined and prioritized.

When query results are composed of multiple distinct XML files, the Results Browser must merge these into a single XML document to provide a seamless user experience. The preferred embodiment provides for handling additional results dynamically. This dynamic update mode is preferably implemented by using a different template or perhaps a script method within the XSLT template. Alternatively, the list Skins may require a behavior (or local runtime component) to manage the logic of adding to the document without disturbing user context.

Query Manager (or Client-Side Semantic Query Processor). The Query Manager is responsible for handling the communication with the server(s), executing the requests for information and gathering the XML results. The resulting XML is passed to the Results Browser for presentation to users.

The Query Manager preferably provides the services to support the Smart Lens functionality. When a Smart Lens request is made, the results are returned as XML and are passed to the Results Browser, preferably marked to indicate that they are Smart Lens results for a given object. The Query Manager preferably includes the following sub-components that provide individual services to fulfill the query requests.
SQML Interpreter. This component must decompose passed SQML into a set of requests, possibly with linked resources. Each request or resource link resolves to a resource with an associated protocol (e.g. HTTP, or one of a number of local pseudo-protocols like outlook: or document:), and is dispatched to the associated protocol handler. A given SQML file may include a mix of network and local resource types.
Resource Handler Manager. This is preferably a central registration mechanism for resource handlers. It is a minimal layer that associates protocols and pseudo-protocols with handlers, and simplifies the dispatch of resource requests.
Resource Handlers. These are components that encapsulate the specifics of accessing the resources from a given “server.” A resource handler does not resolve any linked resources. This is preferably the responsibility of the SQML Interpreter (i.e. the SQML Interpreter will have already resolved linked resources and provided the associated meta data as part of the resource request to this handler). When the resource is a Semantic Web service, the component preferably bundles up the request and issues it via http. When the resource is a local resource (e.g. a document: or Outlook: resource), the resource handler handles the resource directly. For documents, the resource handler passes the document (a file: URL) to the semantic meaning extraction, summarization, and categorization engine to extract meta-data. For email, the resource handler extracts messages from the exchange server, or local .PST files. Note that when there are links on a local resource, the local resource handler must perform the processing that filters results for semantic relatedness. This may be custom to the handler for efficiency, but a central, generic Relatedness Engine will provide services for most cases.
Relatedness Engine. This provides a place to gather the logic for comparing objects for relatedness. The comparison is preferably dependent on the mix of schemas involved, but is otherwise a simple operation—given two objects, provide a measure of relatedness.

Filter/Sort Manager. The Filter/Sort Manager supports the application of filters and sorts to the lists of results provided to the Results Browser. The Filter/Sort Manager leverages the services of the Filter/Sort Preferences component to obtain user preferences for current settings. The main function of this component is to resolve general preferences, per-Agent preferences, and any settings defined in the actual results (this may or may not be supported). This component is notified by the Filter/Sort Preferences component when users change the currently applied filters and sorts. Because the associated user interface is part of a tool bar associated with the Shell Extension (i.e. its right-pane View), but the application of the functions happens in the Results Browser space, the control is typically indirect.

Lens Mode. When a Smart Lens is invoked, the Results Browser must generate Lens requests (queries) for objects that users choose. The queries are asynchronous so that users can select Smart Lens queries for various objects and view the results as they are returned. A suggested user interface for this is to reserve some real-estate for a Smart Lens icon. When in Smart Lens mode and the user clicks (or hovers) over the Smart Lens icon, a query is issued, and the icon changes to indicate that the query is in progress. When results are returned, they are handled by the Results Browser and dedicated Smart Lens templates in the Skins, and the Smart Lens icon for an object changes to indicate that results are available. Clicking or hovering over the icon again will display the Smart Lens results in a Skin specific manner (see sample Smart Lens pane user interface). If the query is returned quickly enough, then the whole function preferably feels like a popup activated by a hover or single click.

Deep Info View. If Deep Information is not available in the original results, this component generates the associated query. The query is preferably asynchronous. When results are returned to the Results Browser, they are processed through the appropriate Skin (using a special Deep Information template for each Skin), and the resulting HTML is incorporated into the results document under the associated object. The primary Skin for the schema inserts a Deep Information element in the HTML for the object so that the Results Browser knows where to incorporate the results. When Deep Information is available (whether as part of the original results or in response to a Deep Information query), the Skin either displays it directly or will indicate that it is present, and some Skin-defined user interface will allow users to enable the display (e.g. as a popup window).

Context Info Manager. For objects currently displayed in the Results Browser, certain notifications are preferably provided by default. Two classes of new or additional info will be provided to users:
1. Additional results that were added to the server since the user made the original request. This is especially useful for things such as headlines or active email threads. The results are handled by the Results Browser, by inserting the new objects into the view.
2. Context Templates and related information that would be of interest to the user.

This is generated by additional queries to a specific Agent (Smart Agent, Special Agent, Blender or Agency), using a particular object as context. The results are handled similarly to the way that Deep Information View and Smart Lens Mode results are handled, by processing the XML returned from the query, and inserting the resulting HTML into the existing HTML for the object. The Skin controls the display mechanisms and UI. An example of related information is “Breaking News” associated with the object.

Skin Manager. Maintain user preferences for list Skins, object Skins, and dependencies between list and object Skins (certain object Skins may only make sense for a given list-Skin). The Skin Manager also maintains parameters for each Skin that indicate constraints for the Skin, e.g. how much screen real-estate it requires, or modalities it best applies to. Considerable intelligence is preferably built in that assists the Results Browser to choose Skins for a range of screen and window size constraints, as well as for modalities, accessibility, language and other constraints. Initial versions will likely be much simpler.

Skin Templates. This describes the structure of a Skin and how it is applied from within the Results Browser. A Skin is preferably XSLT templates that convert the results XML to XHTML (and/or other languages like SVG) or proprietary presentation platforms like Flash MX and ActionScript. The templates can also insert styling information, e.g. for CSS styling. The resulting presentation code (e.g., XHTML) can restrict the inclusion of code, for security reasons. Framework code in the Results Browser invokes the Skins. The preferred embodiment includes the following classes of Skins:
List Skins (or layout Skins). A list Skin is used to transform a list of objects returned from a query into some overall presentation structure. This may be a simple list, a table, or a timed sequence of slides. List Skins are not schema or object specific, although they may only support certain Skins, which can work within the constraints that the associated presentation form defines. E.g., a list Skin that defines a table layout may require, or prefer, object Skins that can produce information in a small rectangular format.
Object Skins. Object Skins are schema specific, and generate the presentation for an individual object of a given information object type (or information class). It is possible to define a Skin for the generic super-class (or any other super-class) that can serve as a default Skin for a range of derived classes or subclasses (presumably by omitting some details).
Context Skins. Context Skins are tied to a particular Context Template, and generate the presentation that will most effectively convey the context indicated by the template.
Blender Skins. Blender Skins are designed to present the results from Blenders.

These Skins should allow the user to view the results via the Agents contained in the Blender, via information object type, or via a merged view that displays all the results as though they came from one source.

Skins preferably model constraints such as modality and presentation display area by handling the constraints (passed as parameters either statically or dynamically by events within the browser core itself). This is preferably supported by imposing a restriction that list Skins must specify only acceptable object Skins. In an alternative approach, object Skins may be designed for a given list Skin, and the Results Browser/Skin Manager chooses object Skins for the current list Skin.

List Skin Details. Users may choose a single list Skin for the current view and make it the default. List Skins may also be associated with individual Agents, in which case the generic default is overridden. The Results Browser invokes the list Skin to process the list of results, although the list Skin preferably does not actually handle the individual objects. It creates some per-object instance in the framework presentation (e.g., a timed entry in a sequence, or a cell in a table, or an item in a list), and then the object Skins will fill in the details.

Object Skin Details. The object Skins convert a particular schema to XHTML. Support for asynchronous query results for things like Deep Information and Context Template information are provided by invoking associated templates from the Results Browser (through the DOM) on the query results XML, and then inserting the resulting XHTML into the results document through DOM interfaces. There are preferably several individual templates within an object Skin, including:
Primary schema template. This is the main piece that generates XHTML, for default display. This must create the wrappers for Deep Information, Smart Lens information, Context Template information content, and any script that provides user control over the associated display.
Deep Information template. This template handles the meta-information for Deep Information. It may be called for inline deep info provided with original results, or it may be called to handle asynchronously requested Deep Information. Either way, it preferably generates XHTML in some form, which is inserted under the wrapper element for Deep Information. The insertion probably happens in XSLT for inline deep info, and is effected through DOM insertion for Deep Information query results.
Context information template. This template handles the results-information for context information query results. It generates XHTML in some form, which is inserted under the wrapper element for live info. The insertion is effected through DOM insertion for Deep Information query results.
Smart Lens information template. This template handles the results-information for Smart Lens query results. It generates XHTML in some form, which is inserted under the wrapper element for live info. The insertion is effected through DOM insertion for Deep Information query results.

In the preferred embodiment, the template cannot modify the other contents of the XHTML (even for the same object), so it will be up to the Results Browser to coordinate the user interface changes that indicate when Deep Information, live information or Smart Lens results are available. The framework requires certain icons to be used (also for consistency), and for these to have regular names or element types, which will allow the Results Browser to find and modify them as needed. In addition, the Results Browser can create and raise events to indicate the state changes. The template-generated script can respond to these events, and display the associated information as desired.

Default Skins. In the preferred embodiment, a set of default Skins is provided. This preferably includes Skins for the basic object classes and a small set of list-Skins that allow a variety of views of query results. Preferable list-Skins include:
A detailed list display (like the Windows Explorer details view)
A tabular Icon view (again, like the Windows Explorer Icon view, but somewhat richer)
A timed presentation view.

e. Client Framework

In the preferred embodiment, the system client includes Shell Extensions, a Presenter, and Skins used by the Presenter to display information with context and meaning.

Shell Extension. An Explorer Shell Extension is a Microsoft Windows software component that extends the Windows Shell with custom code. Shell Extensions allow applications to use the Shell as a custom client, and also provide services such as clean integration with the desktop, the file-system, Internet Explorer, etc. Examples of default shell extensions include “My Documents,” “My Computer,” “My Network Places,” “Recycle Bin,” and “Internet Explorer.”

The use of a Shell Extension in the preferred embodiment of the present invention has several advantages:
1. It provides a very clean way to provide a user experience that seamlessly integrates with how knowledge-workers currently browse for information. In turn, this obviates the need to develop a proprietary client and allows for non-standard integration with Microsoft's Internet Explorer, “My Documents,” etc.
2. It embraces Today's Web and provides a migration path for the transfer of content in Today's Web to the Information Nervous System of the present invention. For example, users preferable drag and drop documents from their hard drive (via Microsoft Explorer) or from the Internet (via Internet Explorer) into remote Agents on the Shell Extension of the present invention. This is difficult and non-intuitive with a proprietary client. Nevertheless, the present invention contemplates portability to a proprietary client or to the equivalent of Shell Extension on non-Windows operating system and operating systems for non-personal computer devices.

The Shell Extensions of the present invention provide a view of users' Semantic Environment (e.g., history, favorites and other views). In the preferred embodiment, the Shell Extension provides for the following:
1. Allows users to open an Agent, a document, a folder, or an address on the semantic browser's Semantic Environment. For an Agent, the client displays a custom “Open Agent” dialog box that allows users to browse the semantic browser's Semantic Environment. This preferably includes Agents in users' My Agents list, Agencies on the Global Agency Directory, Agencies on the local area network (announcing via multicast), and Agencies on any custom Agency Directory that users have configured. [INSERT RELEVANT SCREEN SHOTS ON UI] Opening an Agent results in the client displaying the results of the query of that Agent. Opening a document opens the XML metadata for that document, consistent with the schema for the document object type. Opening a folder opens the XML metadata for a file-system folder. Users are able to open the immediate or deep contents of the folder via the folder itself. Opening an address allows users to enter any address to be opened by the client framework. This includes URLs (which open the XML metadata for the document), documents on the file-system, Agents, or objects (see “URL Naming Conventions” below). In the case of Agents, the Agent URL is preferably entered as follows: Agent://<Agent name>@<Agency name>.<domain name>. This is analogous to the http://<URL> naming convention for HTTP URLs. The Agent:// prefix is required in this case because the Open Address option can open any address. In the case of the “Open Agent” option, users preferably do not need to add the prefix; the client framework automatically canonicalizes the URL to include the prefix. This is similar to how users are able to enter “www.foo.com” into Today's browser without the qualifying http:// prefix.
It is anticipated that the client allows users the ability to open other objects, for example, Microsoft Outlook .PST files.
2. Allows users to browse, subscribe, and unsubscribe to or from Agents on a given Agency that supports User State.
3. Allows users to save invoked Agents or semantic query results into the My Agents list.
4. Allows users to create Blenders and to add and remove Agents to and from Blenders (including via drag and drop).
5. Notifies users when there are new Agencies on any of the Agency directories (for example, the Global Agency Directory, the Local Area Multicast Network or any custom Agency Directories) since the last time they checked
6. Notifies users when there are any new Agents on any particular Agency since the last time they checked
7. Provides drag and drop access to relational semantic queries for objects in the Semantic Environment. The Shell Extension allows users to drag and drop a document from the Semantic Environment (either on a local drive, the network neighborhood, the Intranet, or the Internet) to a shell folder representing an Agent. This triggers a remote procedure call to the XML Web Service for the given Agency with the document metadata as the argument.
8. Provides “paste” access to objects copied to the system clipboard. The present invention uses the system clipboard to allow users to copy any object for later access. In addition, the clipboard allows users to copy objects from other applications, for example, Microsoft Office applications (e.g., email items from Outlook), from multimedia applications, and to copy data from any application.
9. Allows users to select an Agent as a Smart Lens. A Smart Lens allows users to view objects in the results view based on context from an Agent or any object that can be copied to the system clipboard. For example, ordinarily, if a document object is in the results view and users hover over the link representing the object, the object metadata is displayed. If, however, a Smart Lens is selected (for example by pasting it onto the results sheet), and users hover over the object, information that relates the object in the Smart Lens and the object underneath the cursor is displayed. For example, if users copy “People.Research.All” to the clipboard and paste it as a Smart Lens, then hover over a document, metadata may be displayed in a balloon popup as follows: “Found 15 people in People.Research.All that are experts on this document.” Other examples are “Found 3 people that might have written this document” and “Found 78 email messages relating to this object posted by people in People.Research.All”. Users decide whether to invoke any of the links in the metadata in the balloon popup. In an alternative embodiment, the popup may be displayed in a sidebar and does not require a balloon. When a Smart Lens is pasted onto the clipboard, the Shell Extension preferably communicates with the system and changes the mouse cursor to reflect the name of the selected Agent. The Smart Lens preferably has global scope because it is copied from the clipboard. In other words, for example, all instances of Windows Explorer and Internet Explorer “see” the Smart Lens and respond to its actions. In the preferred embodiment there is a Smart Lens tool in the Information Agent toolbar that applies to the current object on the clipboard (e.g., Agent or other object). By default the Smart Lens tool will be deselected once a link is clicked in the system. Users are preferable able to “pin” the Smart Lens. When the Smart Lens is pinned, the Smart Lens remains active until users explicitly deselect it. In the preferred embodiment, to pin a Smart Lens, users select the “Paste as Smart Lens and Pin” tool on the toolbar.
10. Allows users to “tear-off” the results of an Agent from the Shell Extension and display it in docked view on the desktop. In this view, the Agent results browser window acts as a semantic ticker. This feature allows users to continuously display the semantic information while continuing to do other work.
11. Allows users to enable an Agent to be used as a screen-saver.
12. Allows users to browse and invoke available Skins on the Global Agency Directory.

Presenter. The Presenter is a set of local components (e.g., browser plug-ins) that take semantic queries from scripts (or other plug-ins) and pass them off to a KIS Agency XML Web Service. The present invention translates the results of semantic queries and passes XML to other behaviors or scripts for eventual presentation to users.

In the preferred embodiment, the Presenter is invoked by the Shell Extension with an SQML file. The system preferably communicates with the XML Web Service directly. The system resolves the SQML file and invokes calls to open XML information sourced locally or remotely (via XML Web Services on Agencies referred to in the SQML file). Alternatively, if an Agent URL is passed to the system, the Presenter directly opens the URL by invoking it via a call to the XML Web Service of the Agency on which the Agent is hosted. In the preferred embodiment, the system calls the appropriate method with the appropriate semantic object type. Examples of default semantic object types are SEMANTICOBJECTYPEID_EVENT, SEMANTICOBJECTTYPEID_EMAILMESSAGE, etc, which are defined in the header file (semanticruntime.h). The preferred embodiment allows registration of new semantic object types via the RegisterSemanticObjectType API. This semantic query processor on the Agency returns the appropriate XML results using the semantic object type as a filter.

In the preferred embodiment, a Skin according to the present invention (see below) uses XSLT (and/or script) to transform the XML returned from the framework (en-route from the XML Web Service) into DHTML. The Shell Extension allows users to select a new Skin for the current query.

Skins are preferably object-type specific, Context Template specific (for Special Agents) or Blender specific (for Blenders). Skins can also be customized based on the semantic domain name/path or ontology of the Agent, and based on other attributes such as the user's persona, condition, location, etc. Each Agent is configured on an Agency with a default Skin. The present invention further contemplates custom Skins that may be published onto the root Agency (e.g., on the Global Agency Directory). The client preferably downloads the Skin either from the Agency for the declared Agent or from a central server (e.g., the Global Agency Directory), and applies it to the current presentation. The client optionally includes user preferences to ignore Agent Skins or to confine them to a portion of the user interface.

Aside from the Skin type (e.g., object Skin, list/layout Skin, Context Skin, Blender Skin, etc.), in the preferred embodiment, Skins are categorized as follows:
Design template Skins
Color template Skins
Animation template Skins

Semantic Skins are preferably required to be interactive, except when they are displayed as part of a tear-off (see above) or screensaver. Each Skin allows users to seek to a particular point in the “semantic presentation.” For example, if the Skin initially displays only the first 25 items, the Skin must have a seek-bar (or other user interface mechanism) to allow the user to seek to the next 25 items, to fast-forward, to rewind, etc. Some Skins have a “Real-Time Mode” option. In this mode, the Skin continuously fetches new objects from the XML Web Service (via pull). Skins are responsible for polling the XML Web Service for new information based on the schema of the desired objects. In the preferred embodiment there are no notifications to the client since the Agency does not maintain any client-specific state for scalability reasons.

Skins optionally include a real-time mode. These Skins are required to be intelligent in that they must cycle through (i.e., present, order or highlight) objects based on priority. For example, if the Presenter relays information indicating that a new object is posted on the Agency, the Skin immediately displays/reorders/highlights this and continues the presentation of the remaining objects. The Presenter determines the ordering and the Skin deals with dynamism given various sort and filter settings. This creates the perception that the semantic presentation is occurring in real-time. In the preferred embodiment, this occurs when there is new data that users are allowed to access using Skins. If the list is time-sorted, the real-time presentation may confuse users due to jumping the user interface into an interactive mode. A user preference option in some modes (e.g., screen saver mode) automatically resets the Skin to display the new data (e.g. scrolling to the top of a sorted list when new data is inserted at the top of the list).

In an alternative embodiment, Skins are designed to customize their presentation based on the amount of available presentation window. For example, a Skin may change from static mode to dynamic mode by displaying information using fade-in and fade-out if, for example, the presentation window is relatively small. Skins are preferably modal depending upon the expected level of user interaction. For example, a screen saver works differently from a browser; a docked view is similarly different (not only because it is smaller, but because it is assumed to be a kind of background view rather than a focus of user interaction). When a view is minimized or hidden, an alternate mode may be used (especially to indicate new information). Examples are audio notification, reminder-like alerts, start-bar show and blink (like outlook reminders). Agents may be used to send email, telephony or Instant Messenger (IM) notifications. In an alternative embodiment, the present invention contemplates an Agent that posts to a Web site (e.g., automatic HTML content generation for event calendars).

Alternatively, Skins may generate audio-visual information. For example, a text-to-speech Skin may read out an email object. This feature has great potential value for disabled users and for users of auto-PCs, etc., as well as other uses.

In the preferred embodiment, the Skins framework exposes the following services:
1. Methods to open an SQML-based semantic query. This can be a local SQML document, an Agent, etc.
2. Methods to open an Agent URL directly.
3. Methods to browse the Information Agent Semantic Environment.
4. Methods to interface with the system clipboard using customizable clipboard formats.
5. Methods to persist the current Skin for a given query or for a given semantic class ID.

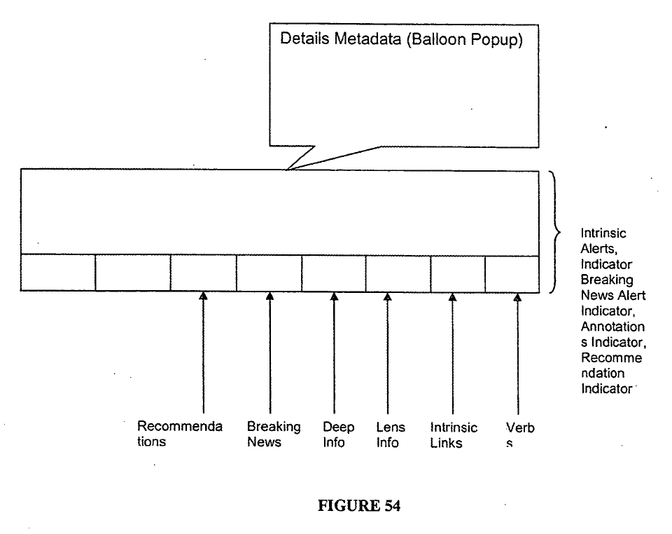

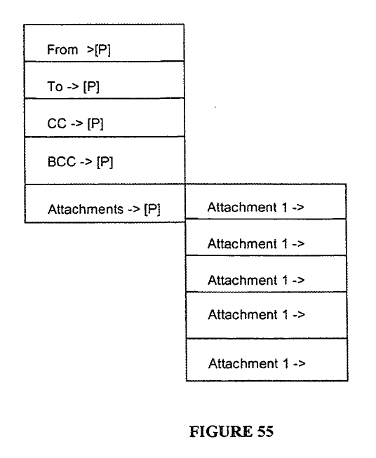

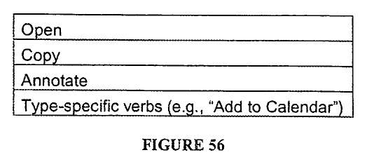

Skins. As introduced above, Skins are presentation templates that are used to customize users experience on a per-Agent basis. In the preferred embodiment, Skins are XSLT templates and/or scripts that are hosted on a centralized server. Skins according to the present invention preferably generate XHTML+TIME code (e.g., for Presenter display, text-to-speech, Structured Vector Graphics (SVG) via a plug-in, etc.) and access various system services. In the preferred embodiment, Skins support the following features:
1. Display some or all of the fields corresponding to the XML schema of the object(s) being displayed. The Skin optionally provides users a way to uniquely distinguish objects in a returned set or provides users with any conventional access means, for example, filename, URL or personal name (for people).
2. Display a user interface indicating whether the object is understood by the host Agency. Each object preferably includes an “understood” field that indicates this information.
3. For the semantic object type SEMANTICOBJECTTYPE_OBJECT, the Skin optionally displays the raw object metadata or displays the metadata for the XML schema for the class-specific objects that the raw objects represent. For Skins that display class-specific XML schema for queries that refer to raw objects, the Skins must be “smart” to display the class-specific information in different panes. Preferred ways of accomplishing this uses frames, tabbed boxes, or other user interface techniques. Since every semantic query points to raw objects, the Skin preferably either loads the query with the filter SEMANTICOBJECTTYPE_OBJECT (which simply returns raw objects) or the required object type ID. In the preferred embodiment, in order to prepare the presentation of an object list with raw objects of many classes, the Skin should first:
   Get the object query
   For each semantic object type, determine how many objects exist in the Agent resource for the given object type. This is preferably obtained by calling the Agency XML Web Service method GetNumObjectsOfClassInAgent with the Agent URL and the object type ID name (email, document, event, etc.) as argument. The XML Web Service returns the number of objects in the Agent, satisfying the object type ID filter.
   Depending on how many object types there are in the Agent query, the Skin displays frames or other user interface that are appropriate for the number of object types. In the preferred embodiment, when the Skin is ready to load the object type-specific metadata, it calls the Agency's XML Web Service method ExecuteSemanticQuery with the Agent URL and the semantic object type as the arguments
4. When users hover over an object, more metadata for the object is displayable.
5. If a Smart Agent Smart Lens is selected, the Information Agent of the present invention displays contextual metadata that maps the object in the Smart Lens with the object underneath the mouse. In one embodiment, the Smart Lens applies to objects displayed within the Presenter. In alternative embodiment, the present invention allows the Smart Lens to be invoked in other applications (e.g., Microsoft Office applications, the desktop, etc.). This involve installing system hooks to track the mouse and invoke a Smart Lens application when the mouse moves anywhere in the system. The “hook” is called on all mouse events and the hook will also capture the mouse. The Smart Lens may alternatively be invoked asynchronously. In this embodiment, anytime the Presenter displays new results, it checks the clipboard to see if there is any semantic Smart Lens information present. In the asynchronous embodiment, the Presenter automatically caches all the Smart Lens results for all objects in its view. It displays an icon beside each object it presents indicating that there is context-specific related information therein. In a preferred embodiment, users are able to invoke a Smart Lens for any object in the view.
6. Breaking Information. Each object preferably displays a user interface indicating whether there is “breaking information” relating to the object. This is the semantic equivalent of “breaking news.” The user interface is preferably presented to indicate the criticality of the information, yet must not be too intrusive in case users do not want to see the information. For example, the user interface may be shown as an icon that slowly blinks at a corner of the object display window. When users hover over the icon, metadata on the “breaking information” is displayed. In the preferred embodiment, “breaking information” is implemented by an implicit Special Agent that invokes calls to all Agents using the Breaking News Context Template.
7. Each object is preferably displayable with a user interface indicating whether the object has any Annotations. This information is included as a field in all query results for all objects.
8. Preferably, each object is displayable with a user interface indicating whether there is related information on any predefined Context Template or Special Agent on the client. This preferably includes Special Agents created by users, as well as default Special Agents (e.g., installed by the client). In the preferred embodiment, Context Palettes for the Context Templates are displayed with the user having the option of displaying one or more of the Context Palettes, hiding them, scrolling them (in order to navigate the Context Palettes), etc. Context Templates and Context Palettes are discussed in further detail below. In an alternative embodiment, Agency priorities preferably include the following:
   Critical priority. This is the highest priority. For example, for a given document, this flag will be TRUE (on the Agency) if a related email message was just posted (in this example with a few minutes) or if there is an upcoming event that is imminent.
   High Priority. This is the next highest priority. The user interface feedback preferably makes it clear that the priority is high enough to warrant users' attention, albeit the feedback must not be very intrusive. The priority is optionally different for different Users, e.g., if there is an event that is local to users the priority might be higher than if the event is remote (particularly if there is no way for the remote user to participate in the event).
   Medium Priority. This may merely indicate that there is information that users should look at if they have the time. The user interface feedback must make this clear.
   Low Priority. This may indicate that there is related information that is germane but not recent.
The four priority virtual Blenders are preferably installed by default on the client. These Blenders automatically aggregate information from corresponding priority Agents on each Agency in the My Agencies list. There is preferably default priority Agents on every Agency. In the preferred embodiment, relational semantic queries take the context and the user into consideration.
In the preferred embodiment for each Context Template (or the currently selected Context Template), the Presenter enumerates the Agencies that users add to their My Favorite Agencies list or the recent Agencies, and queries appropriate Agencies using dynamically generated SQML to find out if there are any objects that relate to the current object based on the Context Template. If any of the Agencies in the favorites or recent lists are not accessible, the user interface preferably transparently handles this by ignoring the Agency. In the preferred embodiment, by default, the dynamically generated SQML is created by indexing the SQML of the currently selected object's SRML and inserting the resource in the SQML as a link filter in the SQML of the Context Template (preferably using the default predicate “relevant to”). This intelligently handles the mapping of the object type of the currently selected object to the semantics of the displayed Context Palette. For example, if the currently selected object is a document, the Headlines Context Palette uses the SQML based on a derivation of the SQML for the Headlines Context Template. Each Agency in the Semantic Environment semantically processes the resulting SQML appropriately using the default predicate. In another example, if the selected object is a person, the Headlines Palette shows the Headlines relevant to the person, e.g., the “Headlines” authored or annotated by the person, etc. Alternatively, if the currently selected object is a document or email message, the SQML (with the default predicate) produces semantic results that represent semantically related Headlines on each Agency. These results are preferably displayed in the Context Palette. The same applies to other Context Palettes (e.g., Classics, Newsmakers, etc.).
For a person object, the priority flag preferably refers either to objects the person has posted or to objects the person authored or is hosting. In this example, only metadata fields with semantic uniqueness are preferably used to make this determination (e.g., the person's email address).
9. Each object preferably displays a user interface including a number of manipulation options. By way of example only, a sample user interface illustrating an information object displayed in the Information Agent (semantic browser) Results Pane is shown in FIG. 54. FIG. 54 shows a balloon popup (for the object's metadata) and user interface icons on the object allowing the users to invoke tool options such as a Recommendations context pane, a Breaking News context pane, a verbs popup menu, etc. Additional and other user interface options include the following:
   Intrinsic Semantic Links. These are links that are intrinsic to the semantic class of the object. If there are no Intrinsic Semantic Links, nothing needs to be displayed. By was of example, an email object of the preferred embodiment includes the following Intrinsic Semantic Links:
      1. From List->
         1. Person A
      2. To List->
         1. Person B
         2. Person C
      3. Cc List->
         1. Person D
         2. Person E
      4. Bcc List->
         1. Person F
         2. Person G
      5. Attachments->
         1. Document 1
         2. Document 2
         3. Document 3
   In the preferred embodiment, when any of these semantic links are invoked by users, the client fetches the metadata for the associated object (and not the object itself). This allows users to explore the semantic information for aspects of the original object. The Skin preferably calls the XML Web Service of the Agency that hosts the object with the appropriate method. In the preferred embodiment, the form of this method is ISemanticRuntimeService::LoadNativeSemanticLink. This embodiment includes the semantic class ID, the name of the semantic link, the name of the argument, and the string form of the argument. For example, to “navigate” to the third attachment (with a zero-based index), the Skin should call LoadNativeSemanticLink(SEMANTICCLASS_EMAILMESSAGE, “Attachments”, “Index”, 2). This preferably generated the SQML that represents this relational semantic query, creates a new temporary Smart Agent that has this SQML and loads the Smart Agent. This illustrates preferred semantic navigation. The process is optionally recursive. The user can navigate off the new results using any of the new objects and pivots, etc. An example of a balloon popup associated with an Intrinsic Semantic Link showing an email sample according to the present invention is shown in FIG. 55. In this sample user interface, the popup menu is displayed when users selects the “Intrinsic Links” icon on an information object in the Results Pane. This illustration shows what Intrinsic Semantic Links users see for an email object. In the preferred embodiment, the popup menu items invoke a new SQML query (what the proper resource and predicate links) when users hit the menu option. A new temporary Agent is created (with the SQML) showing the results of the query. Users are able to save the Agent in their favorites list. Also, the new results display the Intrinsic Semantic Links, Context Templates, etc., thereby support user-controlled browsing where in users can navigate information semantically. An alternative configuration and functionality for native verbs follows:
   ALL INFORMATION:
      Find Related Information on Agency (only if this came from an Agency)
      Find Possibly Related Information on Agency (only if this came from an Agency)
      Open Annotations->
         All
         Annotation 1
         Annotation 2
         Annotation 2
   EMAIL: +=
      From List->
         Person A
      To List->
         Person B
         Person C
      Cc List->
         Person D
         Person E
      Bcc List->
         Person F
         Person G
      Attachments->
         Document 1
         Document 2
         Document 3
   PERSON:
      Reports To->
      Direct Reports->
      Member of Distribution Lists->
      Information Authored By->
      Information Annotated By->
      Information with categories of which this person is an expert->
   CUSTOMER:
      Information Authored By->
   Annotations. This preferably allows users to navigate to a summary view for all the Annotations for the current object. In the preferred embodiment, the Skin displays all the Annotations by calling the ISemanticRuntimeService::EnumAnnotations (with the object metadata as argument). This returns an XML representation of the property table containing the metadata for the Annotation objects. The Skin preferably displays some representation of the Annotation summary being displayed (e.g., names or titles of the Annotations). When an Annotation link is invoked by users, the Skin displays metadata for the Annotation object. These functions preferably come from filters applied on the client. Alternatively, these functions can be created as an Agent. This aspect of the present invention further illustrates semantic navigation. The Annotations are preferably loaded using an SQML representation of the “Annotations” query. This creates a new Smart Agent with this SQML. The Smart Agent is then added to the “recent” list and loaded (or navigated to). The process is optionally recursive. The user can navigate using the newly displayed Annotation(s) as pivots, etc.

Related Objects. In the preferred embodiment, this optionally allows users to find related information on each Agency included in the users' My Agencies list using the current object as an Information Object Pivot. This is preferably accomplished without resorting to a copy and paste or reliance on the Shell Extension user interface). In the preferred embodiment, the user interface popup shows information in the following format:

```
Find Related Objects →
    All my agencies →
        Agency Foo →
            All.All
            All.Understood.All
                All.CriticalPriority.All
            All.HighPriority.All
            All.MediumPriority.All
            All.LowPriority.All
                All.MyFavorites.All
                All.Recommended.All
        Agencies that understand this object →
            Agency Bar →
            All.All
            All.Understood.All
            All.CriticalPriority.All
            All.HighPriority.All
            All.MediumPriority.All
            All.LowPriority.All
                All.MyFavorites.All
            All.Recommended.All
```

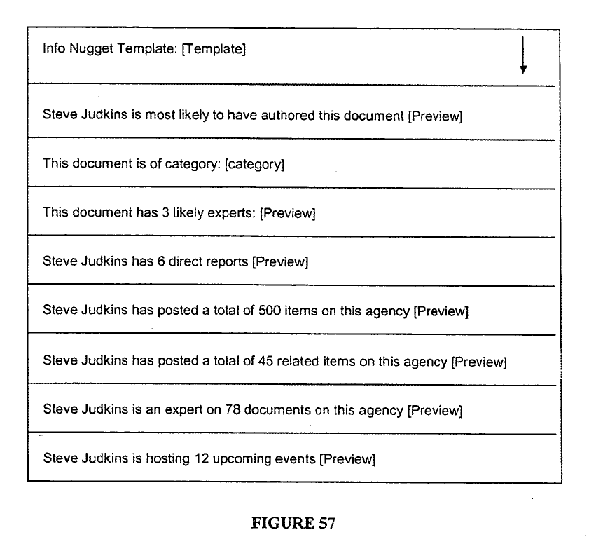

The “All my agencies” list is obtained by the Presenter simply by enumerating the Agencies users have registered locally. The Presenter returns the “Agencies that understand this object” list by “asking” each locally registered Agency whether it understands the object in question. The Presenter passes the XML representation of the object to the Agency, which attempts to semantically process the XML representation. The Agency returns a flag indicating whether it understands the object. The Presenter optimizes the returned list by excluding the Agency on which the object itself is hosted since each object has a field that indicates whether the Agency understands its contents.
Verbs. This allows users to invoke any actions that relate directly to the current object. For example, a document or an email message can have an “Open” verb. This opens the word processor or email client and displays the information. An event can have an “Add to Outlook Calendar” verb. In the preferred embodiment, verbs, preferably class-specific, are invoked on the client by the system framework. The Agency need know nothing about verbs. In the preferred embodiment of the present invention, there are several verbs for every object. These verbs are preferably displayed first in the popup menu. In the preferred embodiment the verbs include:
   1. Annotate. When the user invokes this verb, the Skin preferably communicates with the client runtime and calls the Annotate method. This method initiates the default mail client with the appropriate subject line (which the Agency parses to interpret the Annotation). Users send a regular email message as an Annotation for the object. Email Annotations optionally include attachments that also constitute semantic links. This allows users to navigate from an object (e.g., a document) to its Annotation to its attachment and then to an external content source (e.g., via a Smart Lens). Alternative embodiments are also supported for Annotations, e.g., simple form-based or dialog-based annotations. But email provides the most semantic richness.
   2. Copy. This copies the object XML to the system clipboard.
   3. Hide. This indicates that users have no interest in viewing the object.
   4. Open. This is qualified with the link of what is being opened. In the example of a document, “Open Document” may be displayed. For an email message, “Open Email” may be displayed. The client opens the object with the default application registered in the system for the link's MIME type. In an alternative embodiment, the present invention support other related open verb form, such as “Open with . . . ”, which allows users to open the object with a specific application.
   5. Mark as Favorite. This is preferably displayed if the Agency supports User State and if the object is not a favorite.
   6. Unmark as Favorite. This is preferably displayed if the Agency supports User State and if the object is a favorite.
An example of a balloon popup associated with a Verb user interface according to the present invention is shown in FIG. 56. In this sample user interface, the popup menu is displayed when users hit the “Verbs” icon on a displayed information object in the Results Pane. The menu shows the relevant and supported actions for the information object based on the object type (e.g., document, email, person, etc.). An alternative configuration and functionality for native verbs follows:
ALL INFORMATION:
   Annotate (Opens Outlook; if the object is from an Agency, the Agency's Email Agent address is filled in the “to” field; if not, the “to” field is left blank so the user can indicate the Agency for object annotation association). If the object is not from an Agency, the object should be attached to the email message either as an URL or as a full-blown attachment).
   Copy
   Open
   Mark as Favorite (stored on the client)
   Unmark as Favorite
PERSON AND CUSTOMER: +=“Send Email”
10. When a Skin loads a new query or the metadata for one or more objects, the Skin preferably calls the framework with the query or the metadata. In the preferred embodiment Skins do not perform queries, but passes queries to the Presenter runtime which then managers the results.
11. Deep Information (or Presentation) Mode. An alternative embodiment the present invention provides Skin support for Deep Presentation Mode. In this embodiment, the Skin displays a user interface indicating whether there is related information for the current object. The Skin also displays text describing the information. For example, for a given document object, the Skin may display a popup with the text “Jane Doe posted the most recent email message that relates to this object: <summary of email message>” In this embodiment, the Skin shows details for specific information, such as the last recently posted related object or the most imminent upcoming object. The Skin may optionally display other “truths” or inferred data that might be interesting to users. Examples include:
   Lisa Heilborn recently posted a related document: <summary>
   The most likely author of this document is <foo>
   Steve Judkins reports to Patrick Schmitz. Patrick has posted 54 critical priority objects that relate to this one.
   This document has 3 likely experts: <names>
   Yuying Chen appears to have the most expertise on this document.
The present invention framework exposes several “semantic depth” levels that Skins use to obtain information. Smart Lenses may also be configured to support Deep Presentation Mode. In other words, in the preferred embodiment, invoking a Smart Lens on an object returns the deep information similar to what is shown above. The Skin shows an icon at a corner of the object display window. Users are able to click that icon to display the “deep information.” Metadata for the “deep information” can optionally be fetched asynchronously.
An example of a balloon popup associated with a Deep Information Mode user interface according to the present invention is shown in FIG. 57 as presented in the contexts Results Pane. In this sample, users have the option of selecting a template for the Deep Information that filters what kind of Deep Information to display, of viewing the “stories” of the Deep Information, along with semantic (SQML) links to objects that are in the Semantic Environment (for example, the “Steve Judkins” person object, the “experts” Context Template results objects, the “direct reports” objects using the “direct reports” predicate filter), etc. In addition, users have the option of previewing the results of the semantic queries in-place using the Preview Player/Control.

e. Semantic Query Document From the client's perspective, every thing it understands is a query document. In the present invention, the client opens “query documents” in a way analogous to how a word processor opens “textual and compound documents.” The client is primarily responsible for processing a Semantic Query Document and rendering the results. A Semantic Query Document is preferably expressed and stored in form of the Semantic Query Markup Language (SQML). This is akin to a “semantic file format.” In the preferred embodiment, the SQML semantic file format consists of the following:
Head. The head tag includes tags that describe the document.
   Head: Title—This indicates the title of the document.
Filters. The Presenter filters all returned objects using the entries in the “filters” tag. These entries optionally contain object type names (documents, events, email, etc.) If no filters are specified, no objects are filtered. The tag has a qualifier that indicates whether the entries are to be included or excluded. In the event of redundant entries (indicated with both “include” and “exclude” tags), the interpreter excludes the entries (i.e., in the event of a tie, “exclude” is presumed).
Attributes. This tag indicates the attributes of the document.
Skins. This is the parent tag for all Skin-related entries
   skin:<objecttypename>. This contains information for the Skin to manage objects of the object type indicated in “object type name.” The Presenter uses default and Agent Skins for objects that do not have corresponding Skin entries in the SQML document. Options preferably include the following:
   skin:<objecttypename>:color. This has information on the color template to be used with this document. The primary entry is an XSLT URL.
   skin<objecttypename>:design. This has information on the design template to be used with this document. The primary entry is an XSLT URL.
   skin:<objecttypename>:animation. This has information on the animation template to be used with this document. The primary entry is an XSLT URL.
Query. This is the parent tag for all the main query entries of the query document, and may include:
   Resource. The reference to the resource being queried. Examples include file paths, URLs, cache entry identifiers, etc. These will be mapped to actual resource manager components by the interpreter.
   resource:type. The type of resource reference, qualified with the namespace. Examples of defined resource reference types are: nervana:url (this indicates that the resource reference is a well-formed standard Internet URL, or a custom URL like “agent:// . . . ”) and nervana:filepath (this indicates that the resource reference is a path to a file or directory on the file-system).
   resource:arg. This indicates an optional string which will be passed to the resource when the interpreter converts the resource references to actual resources. It is the equivalent of a command line argument to an executable file. Note that some resources might interpret the arguments as part of the rref, and not as part of the rref argument. For example, standard URLs can pass the rref argument at the end of the URL itself (prefixed with the “?” tag)
   resource:version. See below
   resource:link. All link tags.
   resource:link:predicate. This indicates the type of predicate for the link. For example, the predicate nervana:relevantto indicates that the query is “return all objects from the resource R that relate to the object O,” where R and O and the specified resource and object, respectively. Other examples of predicates include nervana:reportsto, nervana:teammateof, nervana:from, nervana:to, nervana:cc, nervana:bcc, nervana:attachedto, nervana:sentby, nervana:sentto, nervana:postedon, nervana:containstext, etc.
   resource:link. This indicates the reference to the object of the semantic link.
   resource:link:type. This indicates the type of object reference indicates in the “oref” tag. Examples include standard XML data types including xml:string, xml:integer; custom types including nervana:datetimeref (which may refer to object references like “today” and “tomorrow”), and any standard Internet URL (HTTP, FTP, etc.) or system URL (objects://, etc.) that refer to an object that the present invention can process as a semantic XML object.
   resource:link:version. This indicates the version of the resource semantic link. This allows the Agency's semantic query processor to return results that are versioned. For example, one version of the semantic browser can use V1 of a query, and another version can use V2. This allows the Agency to provide backwards compatibility both at the resource level (e.g., for Agents) and at the link level.
Query Type. This indicates the type of query (or Agent) this SQML buffer file represents. In the preferred embodiment, this includes Agents, Agencies, Special Agents and Blenders.
Query Return Type. This indicates the type of objects the query returns (e.g., documents, email, Headlines, Classics, etc.). Alternatively, this may indicate names of information object types, Context Templates, etc.

By way of example, SAMPLE B of the Appendix hereto illustrates a Semantic Query Document in accordance with the present invention.

In the preferred embodiment, the Presenter includes an SQML interpreter. When the Presenter opens an SQML file, it preferably interprets it by first parsing it, validating it, creating a master entry table, and then executing the entries in the entry table. Effectively, it “compiles” the SQML file before “executing” it, not unlike how a language compiler compiles source code into an object module before it is then linked with other modules and executed. In the case of the SQML interpreter, this process optionally involves loading other SQML files via references. This process is preferably not cyclical. The client uses the XSLT templates in the “<skin>” tags (if available and if not overridden by default or Agent Skins) to display the information for each declared object type. Any returned objects that do not have a declared Skin are displayed with the default Skin of the object type or, in the case of a single Agent entry, that of the Agent (if one is specified).

In an alternative embodiment, the client may load a new Skin to display each object type even after the Semantic Query Document is opened. In this embodiment, the “<skin>” tags preferably inform the client which Skin to load the query with initially. In this embodiment, the specified Skin is preferably appropriate for the declared object type.

In the preferred embodiment, the framework executes the document in two phases: the validation phase and the execution phase. For the validation phase, the interpreter first builds a master semantic entry table. The table is keyed with the resource URL and also has columns for the operator, the resource, the resource type, the predicate, the predicate type, and the link. The interpreter excludes all redundant entries as it adds entries into the table. Also, interpreter preferably canonicalizes all URLs before it adds them into the table. For example, the URLs “http://www.abccorp.com” and “www.abccorp.com/” are interpreted as being identical since they both share the same canonical form. The interpreter builds and maintains a separate SQML reference table. This table includes the canonical path to the SQML file. When the interpreter loads the original SQML file, it adds the canonical file path to the reference table. If the SQML file points to itself, the interpreter ignores the entry or returns an error. If the SQML file points to another SQML resource, it adds the new file to the reference table. It then recursively loads the new resource and the process repeats itself. If, during the process, the interpreter comes across an SQML entry that is already in the reference table, the interpreter returns an error to the calling application (indicating that there is a recursive loop in the SQML document). As the interpreter finds more resources in the document graph path, it adds them to the master entry table for the given resource. It dynamically adds links for a given resource to that resource's entry in the entry table. As a result, the interpreter effectively flattens out the document link graph for each resource in the graph.

The interpreter then proceeds to the execution phase. In this phase, the interpreter reviews the semantic entry table and executes all the resource queries asynchronously, or in sequential fashion. Next, it processes each resource based on the resource type. For example, for file resources, it opens the property metadata for the file and displays the metadata. For HTTP resources that refer to understood types (e.g., documents), the interpreter downloads the URL, extracts it, and displays it. For Agent resources, it calls the XML Web Service for each Agent and passes the links as XML arguments, qualifying each link with the operator. In the preferred embodiment, operators for links that cross document boundaries are always AND. In other words, the interpreter will AND all links for identical resources that are not declared together because recursive queries are assumed to be filters. The interpreter issues as many calls to a component representing the resource as there are Agent resources. For each link, the interpreter resolves the link by converting it into a query suitable for processing by the resource. For example, an Agent with a link with the attributes:

<predicate>nervana:relevantto</predicate>

<oref>c:\foo.doc</oref>

<oreftype>nervana:filepath</oreftype>

is resolved by extracting the XML metadata of the object (e.g., c:\foo.doc) and calling the XML Web Service for the Agent resource with the XML as argument. This illustrates how local context is resolved into a generic (XML-based) query that the server can understand and process.

In order to optimize the query, the Agency XML Web Service exposes methods for passing several arguments qualified with operators (and, or, etc.). The interpreter preferably issues one call to the XML Web Service for the Agent resource with all the link arguments.

Semantic Query Implementation Scenarios. The following are exemplar scenarios illustrating the implementation and operation of Semantic Query Documents according to a preferred embodiment of the present invention.

Scenario 1: Loading an SQML Document. The client creates a temporary file and writes into it a buffer containing the attributes of simple, local HTML page. This page includes the client framework component (e.g., an ActiveX control, a Java applet, an Internet Explorer behavior, etc.). The page is initialized with this component opening the SQML file and a unique ID identifying the Information Agent instance. The component itself opens the SQML file. In other words, the client framework tells the plug-in what SQML query document to open. The plug-in opens the Semantic Query Document by interpreting it as described above.

Scenario 2: Open Documents. The client opens the standard dialog box, which allows users to select files to be opened. The dialog box is initialized with standard document file extensions (e.g., PDF, DOC, HTM, etc.). When users select the documents, the dialog box returns a list of all the opened documents. The client creates a new SQML file and adds resource entries with the paths of the opened documents. The new SQML file is given a unique name (preferably based on a globally unique identifier (GUID)). Because this is a temporary file, the name is preferably not exposed to users. The methodology proceeds to Scenario 1 as described above.

Scenario 3: Open Folder in Documents. The client creates an SQML file (as described above) and initializes it with one resource entry: file://<folderpath>?includesubfolders=(true|false). The SQML file is loaded (as in Scenario 1) by enumerating all the documents in the folder and displaying the metadata for the documents.

Scenario 4: Save as Agent. The client opens a dialog box allowing users to set the Agent name. The client renames the Agent in the Semantic Environment (see below) to the new name. The Agent being saved may be temporary or may already have been saved under a different name. The Information Agent preferably suggests an Agent name.

Scenario 5: Save into Blender. The client opens a dialog box that allows users to select a Blender. The dialog box preferably allows users to create a new Blender. When the Blender is selected, the client opens the Blender's SQML file into the SQML object model and adds the new entry (the currently loaded SQML file). It then increments the reference count of the current entry.

Scenario 6: Drag and Drop. The client creates and opens an SQML file with a single resource entry, for example, similar to the following:

```
<resource type=“nervana:url”>
    agent://documents.all@abccorp.com
    <link predicate=“nervana:relevantto”
        type=“nervana:filepath”
        c:\foo.doc
    </link>
</resource>
```

This example assumes that an icon representing “c:\foo.doc” is dragged and drop over an icon in the Information Agent referring to the Agent “agent://documents.all@abccorp.com.”

Scenario 7: Multiple Drag and Drop. The client creates and opens an SQML file with a single resource entry, for example, similar to the following:

```
<resource type=“nervana:url”>
    agent://documents.all@abccorp.com
    <link predicate=“nervana:relevantto”
        type=“nervana:filepath”
        c:\foo1.doc
    </link>
    <link type=“nervana:filepath”
        operator=“or”
        predicate=“nervana:relevantto”
        c:\foo2.doc
    </link>
    <link type=“nervana:filepath”>
        operator=“or”
        predicate=“nervana:relevantto”
        type “nervana:filepath”
    </link>
</resource>
```

This example assumes that multiple icons representing “c:\foo1.doc,” “c:\foo2.doc” and “c:\foo3.doc” are dragged and dropped over an icon in the Information Agent referring to the Agent “agent://documents.all@abccorp.com.” Also, this example assumes that users indicate that they want the UNION of the semantic queries targeted at the Agent resource.

Scenario 8: Smart Lens. When a Smart Lens is selected in the Information Agent, the Information Agent indicates to the Semantic Environment Manager (see below) that a Smart Lens has been selected for the Information Agent identifier. When the Skin notices that the mouse is over an object (e.g., via the “onmouseover” event in the document object model (DOM)), it calls the Presenter first to find out whether the Information Agent is in Smart Lens mode. The client framework determines this by asking the Semantic Environment Manager if an Information Agent with the identifier is in Smart Lens mode. Because the Semantic Environment Manager caches this information from the Information Agent itself, it can answer the question on behalf of the Information Agent. If the Information Agent is in Smart Lens mode, the client framework preferably obtains the SQML buffer from the system clipboard via the Semantic Environment Manager. This is because a Smart Lens is a virtual “paste” in that it obtains its information from the clipboard. In other words, any object or Agent that is copied to the clipboard can be used as a Smart Lens (even regular text). The framework obtains the SQML buffer and instantiates resource components for every resource in the SQML buffer. The client framework calls the resource API GetInformationForSmartLens passing the XML information for the currently displayed object to the resource. All resources preferably return Smart Lens metadata to the client framework. Each resource preferably returns metadata in the form of a list of Smart Lens information nuggets. Each nugget contains a text entry and a list of query buffers (in SQML). The text entry contains simple text or a custom text format, for example, similar to the following:
Steve reports to <A>Patrick</A>. Patrick posted <A>54 critical-priority messages</A> relating to this one.

Each “<A>” tag pair preferably includes a corresponding SQML query buffer in the information nugget. The client framework formats the text into DHTML (or similar presentation format) for display in the Information Agent (e.g., as a balloon popup or other user interface, preferably not to block or conceal the object that the mouse is over). The client framework displays a user interface for links (analogous to HTML links) where the containing “<A>” and “</A>” tags are found. When a link is invoked, the client framework calls the Semantic Environment Manager to create a new cache entry. The Semantic Environment Manager indicates what file-path the entry should be stored in. The client framework writes the SQML buffer for the <A> tag that was clicked into the file. The client framework pushes the SQML document to the Semantic Environment Manager and loads the SQML into the Information Agent (via Dynamic HTML). Because the Semantic Environment Manager includes this SQML document as the current document, users are able to save the document via the “save” button in the Information Agent (e.g., “save as Agent” or “save into Blender”). An example of information that a Smart Lens can display is as follows:
The Agent Email.Technology.All@Marketing has a total of 300 objects that relate to this object. Critical Priority: 5 objects, High Priority: 50 objects, Medium Priority: 100 objects, Low Priority: 145 objects.
   In the preferred embodiment, if users do not click any of the links in the balloon, no SQML document is created and nothing gets added to the Semantic Environment. This is because the Smart Lens preferably represents only a “potential query.”

In the preferred embodiment, any information that can be contained in SQML can be invoked as a Smart Lens (e.g., Agents, people, documents, Headlines, Classics, Agencies, text, HTTP URLs, FTP URLs, files from the file-system, folders from the file-system, email URLs from an email application such as Microsoft Outlook, email folder URLs, etc). For example, users are able to copy regular text from text-based applications to the clipboard. If users enter the Information Agent and select the Smart Lens, the SQML version of the text will be invoked as a Smart Lens (via a “document” resource). If the “text Smart Lens” is then hovered over a document object, the document resource representing the text Smart Lens optionally displays the similarity quotient, indicating to users similarities between the Smart Lens object and the object underneath the mouse. If the object underneath the mouse is a person object, the document resource may decide to “ask” the Agent representing the person object whether the Agent is an expert on the information contained in the text. Alternatively, the Smart Lens might display links to similar documents or email messages the person has authored that relate to the text.

Scenario 9: Copy and Paste.

Copy: On invocation of a Copy command from within the Semantic Environment, the client framework copies an SQML buffer to the system clipboard with a custom clipboard format. This ensures that other applications (e.g., Microsoft Word, Excel, Notepad, etc.) do not recognize the format and attempt to paste the information. The SQML buffer is preferably consistent with the semantics of the object being copied. For example, a copy operation from an object being displayed in the Presenter is copied as a resource with the appropriate resource type and URL from whence the metadata came. Copying an icon representing an Agent copies the URL of the Agent or the cache entry referring to the Agent's entry in the Semantic Environment. Copying information from a desktop application (e.g., Microsoft Outlook) copies SQML with a resource type referring to the source application and URLs pointing to the objects within the application. These URLs are preferably resolvable at runtime by the interpreter to objects within that application. For example, copying an email message from Outlook to be copied into the Semantic Environment may create a resource entry as follows:

<resource type=”nervana:outlookemailmessage”>
outlook://file://c:\temp\foo.html
</resource>

Paste: On the invocation of a Paste command, the client framework creates an SQML file based on the clipboard format of the information being pasted. For example, if the clipboard contains a file path, the SQML file contains a link (from the resource on which the Paste was invoked) to an object with the file path. This file is opened as described above. If the clipboard format is an URL, the object is of the URL object type. If the format is regular text, the object contains the actual text with, in this example, the resource type nervana:text. Alternatively, the client framework creates a temporary cache entry, stores the text there (e.g., as a .TXT file), and stores the SQML object with a reference to the file path and the object type, in this example, nervana:filepath. When the interpreter is invoked, it creates an XML metadata version of the text and invokes the resource with the XML link argument. If the clipboard format is the SQML clipboard format of the present invention, a similar process is performed, except that if a file is created, the extension will be .SQM (or .SQML). This indicates to the interpreter that the object is an SQML file and not just a regular text file.

f. Semantic Environment

A preferred embodiment of the Semantic Environment of the present invention provides a view of every Agent and Agency available to user via the Information Agent. This preferably includes Agents that have been saved locally into the favorites “My Agents” list, recently used Agents, Agents on local Agencies, and Agents on remote Agencies. Remote Agencies include Agencies that announce their presence via multicast on the local area network, Agencies available on a Global Agency Directory, and Agencies available on a custom Agency Directory. Agents can be dynamically added to the Semantic Environment by invoking their URL. In the preferred embodiment, the Semantic Environment hierarchy has the pattern shown in SAMPLE C of the Appendix hereto. “Recently Used,” “Recently Created” Agents are preferably collapsed to “Recent Agents.” Optionally, “All Agents,” “Deleted Agents,” and “Custom View” may be added.

The Agencies view allows users to see the Agents in the main view by Agency. The object type view allows users to see the same Agents, but filtered by object type. Other views operate in similar fashion, e.g., “By Context” (based on Context Templates) and “By Time.” The Semantic Environment merges the notion of “favorites” with the notion of “history.” The Semantic Environment optionally adds dynamically managed views such as “recently used Agents,” etc. These views are preferably updated by code running within the Semantic Environment Manager (see below).

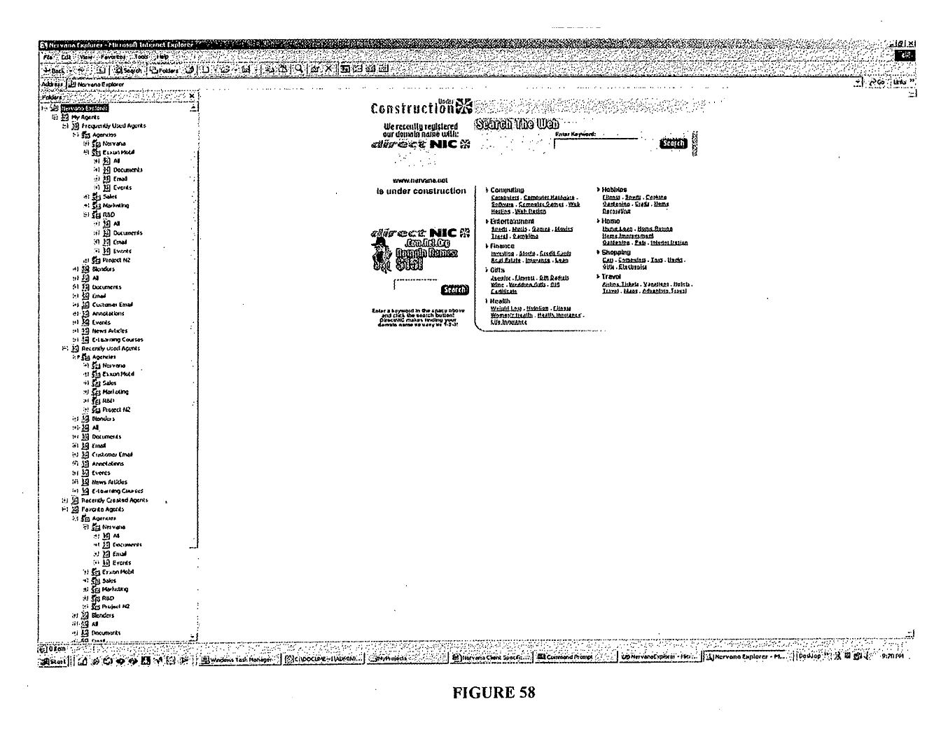

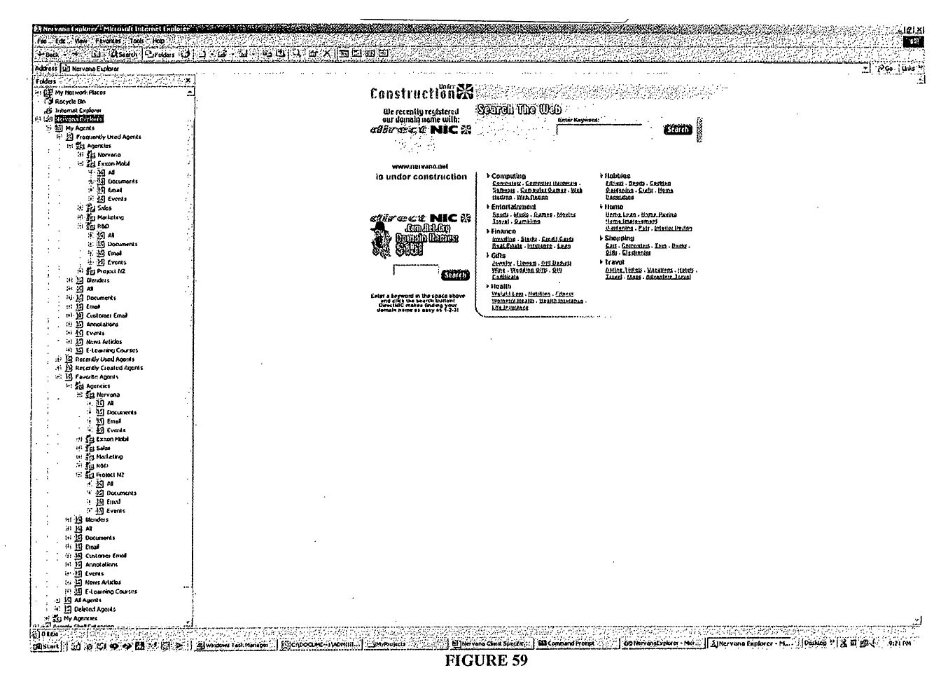

Exemplar Semantic Environment according to the present invention is shown in FIGS. 58 and 59. Icons incorporated into the Semantic Environment may include the following:

Application

All container object types

All document file types

Breaking News Agent Icon Qualifier (e.g., an exclamation point)

Special Agent Icon Qualifier (e.g., a halo)

Standard Agent for each object types

Agency

Agent View Containers
My Agents
Breaking News Agents
Favorite Agents
Special Agents
Recently Used Agents

Snapshots. Users are preferably able to save a snapshot of the Semantic Environment. A Semantic Environment snapshot essentially is a time-based cache of the state of the Semantic Environment. In the preferred embodiment, a snapshot includes locally stored state with the following information:
All the Agencies at the snapshot time that have new Agents.
The last Agent creation time of each Agency (based on the Agency's clock).
The current time of each Agency (based on the Agency's clock).
   Snapshots are preferably accessible to users. The Information Agent filters the Semantic Environment to show only Agencies in the snapshot list, and the Agents in each of those Agencies created between the last Agent creation time and the snapshot time for each Agency.

g. Semantic Environment Manager

The present invention provides a Semantic Environment Manager that exposes APIs to manage the Semantic Environment objects. In the preferred embodiment, the managed Semantic Environment objects are comprised primarily of Agent references via SQML buffers. The Semantic Environment Manager also exposes APIs to navigate the Semantic Environment. In the preferred embodiment, the Semantic Environment Manager allows instances of the Information Agent to:
1. Register itself at the Semantic Environment Manager. The Semantic Environment Manager preferably maintains information on all open Information Agent instances. It does this because a number of services (e.g., clipboard access, Smart Lens access, etc.) are performed across applications such as the shell extension application and the Presenter component running inside a browser control. For example, when the Presenter loads a new SQML document into the display area, it needs to get a cache entry from the Semantic Environment Manager. It asks the Semantic Environment Manager to create a new cache entry for a given SQML buffer. The Semantic Environment Manager creates the cache entry, writes the SQML buffer to the file-path corresponding to that entry, creates a temporary HTML file initialized with an ActiveX control, Dynamic HTML Behavior, Java applet (or an equivalent client runtime engine) pointing to the cache entry, and returns the cache entry identifier and the file-path to the temporary HTML file to the Presenter. For example, in the preferred embodiment, the temporary HTML file may be named as follows:
   c:\windows\temp\nervana_{—}39fc54bc-81e5-4954-8cef-3d1a54935a0d.htm
where 39fc54bc-81e5-4954-8cef-3d1a54935a0d is the cache entry identifier. The containing Information Agent automatically detects new documents being loaded (via events in the contained Information Agent control). The containing Information Agent is able to respond when users hit “save” (e.g., “save as Agent” or “save into Blender”). The Information Agent accomplishes this by getting the current document file path, getting the cache entry identifier from the file path (since the file-path is partially named with the identifier), and displaying the metadata for the cache entry (name, description, etc.) when users hits “save as.” The Information Agent optionally asks the Semantic Environment Manager to resave the cache entry with a new name. The Information Agent registers itself (preferably at startup) with the Semantic Environment Manager with the process ID of its instance. The Semantic Environment Manager allocates a new identifier for the Information Agent and stores metadata for the Information Agent instance (for example, whether it is currently in Smart Lens mode). The Information Agent stores this identifier. The Information Agent preferably passes the identifier to the Semantic Environment Manager each time it makes a call. The Information Agent initializes the Presenter with the identifier. In the preferred embodiment, the client framework calls the Semantic Environment Manager with the identifier each time it needs cross-application services. The Semantic Environment Manager stores the process identifier of the Information Agent instance in order to garbage collect all Information Agent entries when the Information Agent processes have terminated. The Semantic Environment Manager preferably accomplishes this in order to remove the Information Agent entry because the Information Agent may not “know” when it is terminated.
2. Add new Agent references to the Semantic Environment. Agent reference entries are preferably stored in a database, the file-system or a system store (e.g., the Windows registry). In the preferred embodiment, each Semantic Environment entry contains:
   a. Identifier. This uniquely identifies the Agent in the Semantic Environment.
   b. Name. This indicates the name of the Agent. The Information Agent sets a default Agent name when a new Agent is created. This Agent name is set based on the manner of creation. For example, if document “foo” is copied and pasted over Agent “bar,” the Information Agent may create a temporary Agent named “bar” related to “foo” (current time). The current time is stored to uniquely name the Agent (in the event that users reissue the same query. Users are able to rename the Agent as desired.
   c. Query Buffer. This indicates the buffer containing the SQML for the Agent.
   d. Type. This indicates the Agent type (e.g., Standard Agent, Blender, Search Agent, Special Agent, etc.)
   e. CreationTime. This indicates when the Agent entry was created
   f. LastModifiedTime. This indicates when the Agent entry was last modified
   g. LastUsedTime. This indicates when the Agent entry was last used
   h. UsageCount. This indicates the number of times the Agent has been used either standalone, as a filter, or as a Smart Lens.
   i. Attributes. These are the Agent attributes (e.g., normal, temporary, virtual, and marked for deletion). If the entry is temporary, it means users have not explicitly saved it as a local Agent. Temporary entries are preferably used in cases where users compose complex queries using drags and drops, but without saving any of the intermediate queries as Agents. When users save a query as an Agent, the Information Agent resets the temporary flag indicating that the query entry is now permanent.
   j. ReferenceCount. This indicates the number of references to the Agent by other Agents and Blenders. The count is initialized to 0 when a new Agent entry is created.
3. Delete Agents from the Semantic Environment. This is preferably accomplished in two phases. Agents can be marked for deletion, in which case the Semantic Environment Manager sets a flag indicating that the Agent entry is in the “trash can.” The Agent entry can also be permanently deleted, in which case the entry is removed from the cache all together.
4. Change the properties of an Agent in the Semantic Environment (e.g., reset the temporary flag for an Agent when users save the Agent).
5. Rename Agents in the Semantic Environment.
6. Enumerate the cache to retrieve entries preferably corresponding to:
   a. All Agents
   b. Deleted Agents
   c. The most frequently used Agents
   d. The most recently used Agents
   e. The most recently created Agents
   f. Filters for each object type underneath the aforementioned views (e.g., Documents, Email, Events, etc.)
   g. Filters for Agencies that host Agents in the aforementioned views, filters for object types on the Agencies, and the Agents that fit those views (Documents, Email, etc.)
   h. Filters for Special Agents based on the Context Template (e.g., Headlines, Classics, Newsmakers, etc.).
For samples of these enumerations and views, FIGS. 12-14 and 17-19 showing the Semantic Environment Tree View.
7. Filter the Agents list based on counters updated via invocations from instances of the Information Agent. Each instance of the Information Agent preferably communicates with the one Semantic Environment Manager. That way, updates are user-oriented rather than session-oriented. For example, if users open an Agent in one Information Agent, the Agent entry will show up in the recently used Agents view in another Information Agent. The Semantic Environment Manager maintains information on the number of times each Agent has been used, the last time each Agent has been used, etc. It filters the Agents. For example, the most frequently used Agents are filtered based on the N Agents with the highest usage counts, where N is configurable and where the filter is only applied after some stabilization wait period (e.g. after the total usage count is at least Y, where Y is also configurable, for example, based on simple heuristics such as the expected number of Agent uses in a two week period). The recently used Agents are filtered based on the usage time (which is stored on a per-Agent basis and which is updated by instances of the Information Agent each time the Agent is used). The recently created Agents are filtered based on the Agent creation time. The deleted Agents are filtered by examining the “marked for deletion” flag on each Agent. The Favorites Agents are filtered by examining the “marked as favorites” flag on each Agent. For each of the aforementioned parent views, the underlying views are populated using simple filters. The Agencies view is populated by examining each Agent returned in the parent view and extracting unique Agencies there from. The object type views underneath each of the Agencies displayed therein are then populated by filtering the Agents based on the Agent object type (e.g., document, email, event, etc.). The Blenders view is filtered by displaying only Agents that have the “Blender” type. The object type views are directly filtered using the Agent object type. The “My Agencies” view displays local Agencies. Each view underneath this is preferably an object type view filtered using each available Agent on the Agency. The “By Context” view is populated by filtering only for Special Agents (preferably created with a Context Template) and checking for the context name (e.g., Headlines, Classics, etc.).
8. Maintain a reference count for Agents in the Semantic Environment. It is the responsibility of the calling component (the Information Agent) to increment and decrement a document entry's reference count. The Information Agent preferably accomplished this by way of a drag and drop, copy and paste, etc. In other words, actions that create new queries that refer to existing Agents.
9. Empty the Semantic Environment. This deletes all Agents.
10. Perform garbage collection. The Semantic Environment Manager automatically deletes all old (and temporary) Agents. The cache may be configured to keep a history of Agents up to a certain age. For example, if the cache is configured to only maintain information for two weeks worth of Agents, it periodically checks for temporary Agents that are older than two weeks. If it finds any, it automatically deletes Agent entries that have a reference count of zero. This preferably occurs in cases where the Information Agent creates a new cache entry but does not create another entry (Agent or Blender) that refers to it. In other words, the Information Agent performs link-tracking for the immediate link (to avoid complexity). The Semantic Environment Manager optionally performs deep garbage collection. This occurs periodically on a configurable schedule. This applies to entries that have a reference count greater than zero but have no actual references because links were not maintained when other entries were deleted. This feature is incorporated into the preferred embodiment to minimize complexity because the Information Agent preferably does not track references between Agents and Blenders when Agents and Blenders are saved or edited. In an alternative embodiment, the Presenter performs lazy Agent link-tracking when an Agent is invoked. The client framework ignores all references that have been deleted from the Semantic Environment, analogous to how a Web page returns a 404 (file not found) error when one of its links has been deleted. In other words, the present invention provides for the situation of incomplete queries. By way of example, a possible scenario may be as follows:
   Blender B1->refers to Blender B2->refers to Agent A1->refers to Agent A2
In this case, the reference count of each entry will be 1, even though the reference count of the chain is 4. As such, it is possible to have stale entries even though the reference counts are greater than zero. For each entry being garbage collected, the garbage collector searches for any reference to the entry in all SQML documents. If no reference is found, the entry is removed (if it is temporary and older than the age limit).
11. Handle notification management. Users are able to register for notifications from any Agent in the Semantic Environment (e.g., saved or local Agents, Standard Agents, Blenders, etc.). In the preferred embodiment, notification methods include sending email, instant messages, pager messages, telephony messages, etc. The Semantic Environment Manager includes a Notification Manager (see below), which will manage notification requests from users via the Information Agent. The Notification Manager stores a list of notification requests. A notification request preferably includes the Semantic Environment object ID (which identifies the Agent), the type of notification (email, IM, etc.) and the destination, e.g., the email address, etc. The Notification Manager periodically polls each Agent in the notification request list to “ask” if there are any new objects. The Notification Manager also passes the “last requested time” (based on the destination Agent's clock). The Agent responds with the number of new objects (by invoking its stored query and passing back the number of objects in the query results that were created since the “last requested time”). The Agent responds with the current time (on its clock). The Notification Manager stores the Agent's time to avoid time synchronization problems. Alternatively, the client and all Agencies use the same time server (a time Web service) to get their time to ensure that all time comparisons will be on the same scale.

Agency Directories. In the preferred embodiment, the Semantic Environment Manager preferably maintains an Agency list for each Agency “directory.” The multicast network preferably looks to the Semantic Environment Manager as a directory of Agencies. In the preferred embodiment, there is a default Global Agency Directory configured with the URL to an XML Web Service on a public system. This XML Web Service stores a cache of all registered Agencies (preferably with the information described above, including ID, URL, etc.). The XML Web Service exposes methods to allow Agencies to register their presence on the Agency Directory. The XML Web Service filters redundant entries. The XML Web Service also exposes methods to allow users to enumerate all Agencies on the Agency Directory. The Semantic Environment Manager enumerates the directory in this manner. Preferably, the Information Agent considers the Agency Directory as an extension of the Semantic Environment, and allows users to browse and open Agents on the Agencies listed on the Agency Directory. Users are preferable able to add URLs to custom Agency Directories that may be installed on the internal network. The present invention contemplates the creation and integration of customizable Agency Directories. This essentially is an alternative to using multicast for discovery in cases where multicast may not be enabled on the network (for bandwidth conservation reasons) or where certain subnets on the wide area network do not support multicast.

h. Environment Browser (Semantic Browser or Information Agent™)

The Environment Browser, or Information Agent, hosts a regular Web browser component (such as the Internet Explorer ActiveX control), and is primarily responsible for taking an SQML file and rendering the results via the Presenter. In the preferred embodiment, it does this by opening a local HTML file initialized with a reference to the SQML document cache entry of the SQML file. The HTML file loads the Presenter through a control (e.g., ActiveX, Java, Internet Explorer behavior, etc.). This control retrieves the SQML document from the cache (via the Semantic Environment Manager) and loads the SQML file as described above. The control adds objects to the Web browser document object model (DOM) as it received callbacks from resources indicating that objects are available to be converted to XHTML (or equivalent presentation format, preferably via the current XSLT and/or script-based Skin, and pushed into the DOM for presentation. The Information Agent allows users to open an SQML file or an entry in the cache (via the cache ID). The Information Agent also allows users to navigate back and forward, and to navigate the first document in the stack (analogous to the “back,” “forward,” and “home” options in Today's Web browsers, the difference being that in this case SQML documents are being opened for interpretation and display (of the results) as opposed to HTML and other documents).

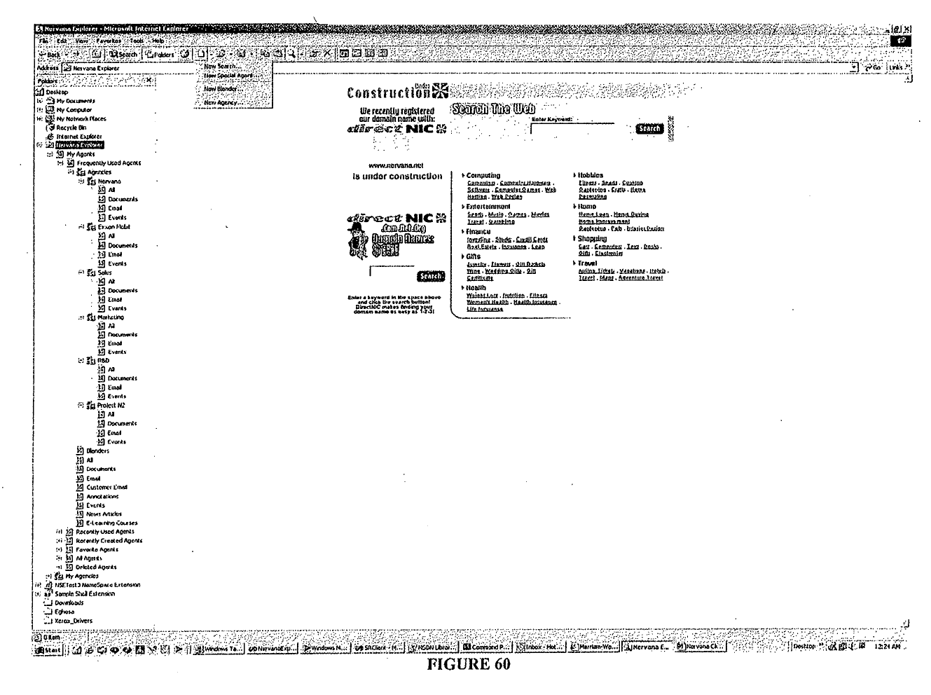

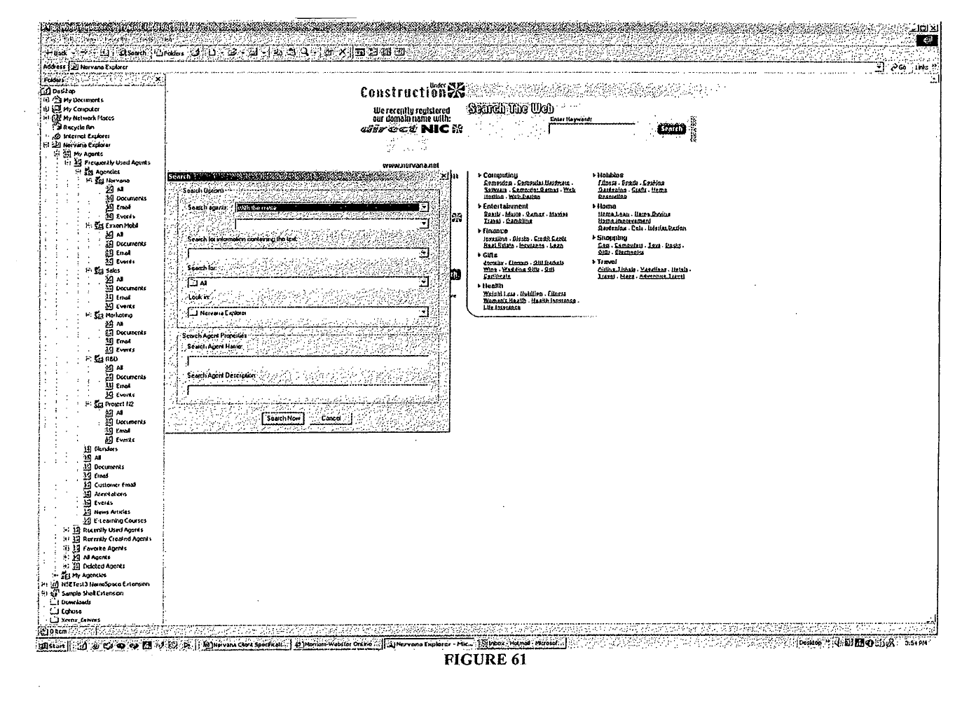

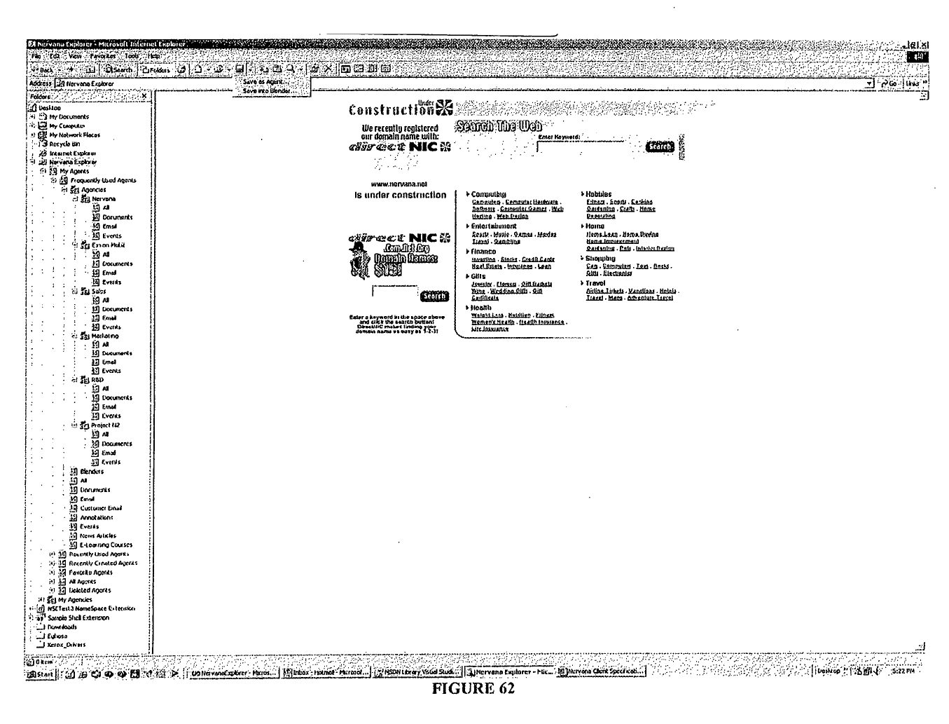

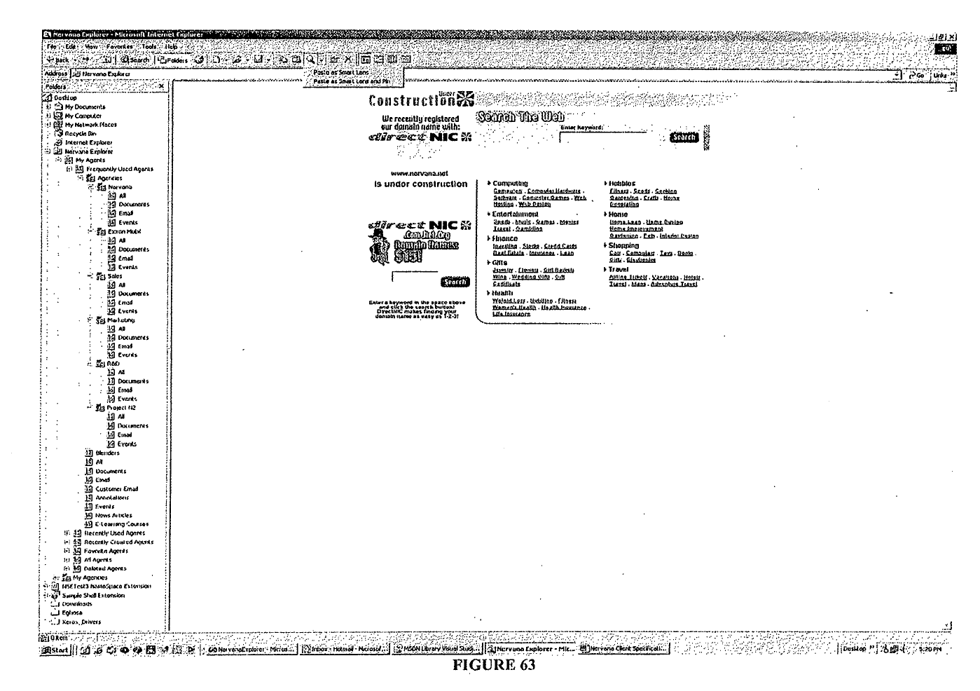

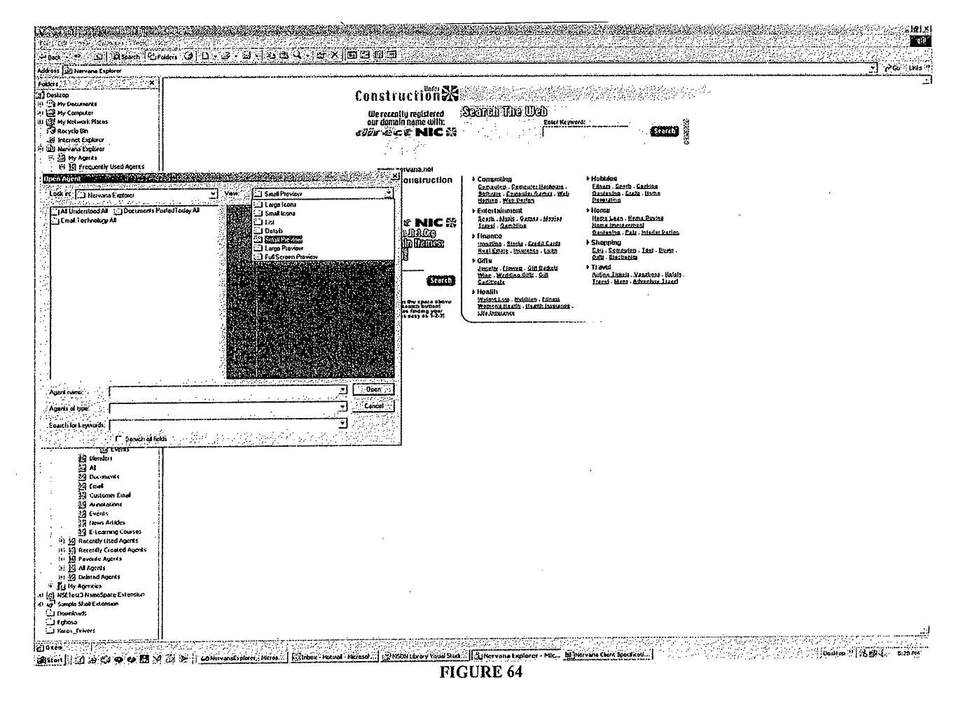

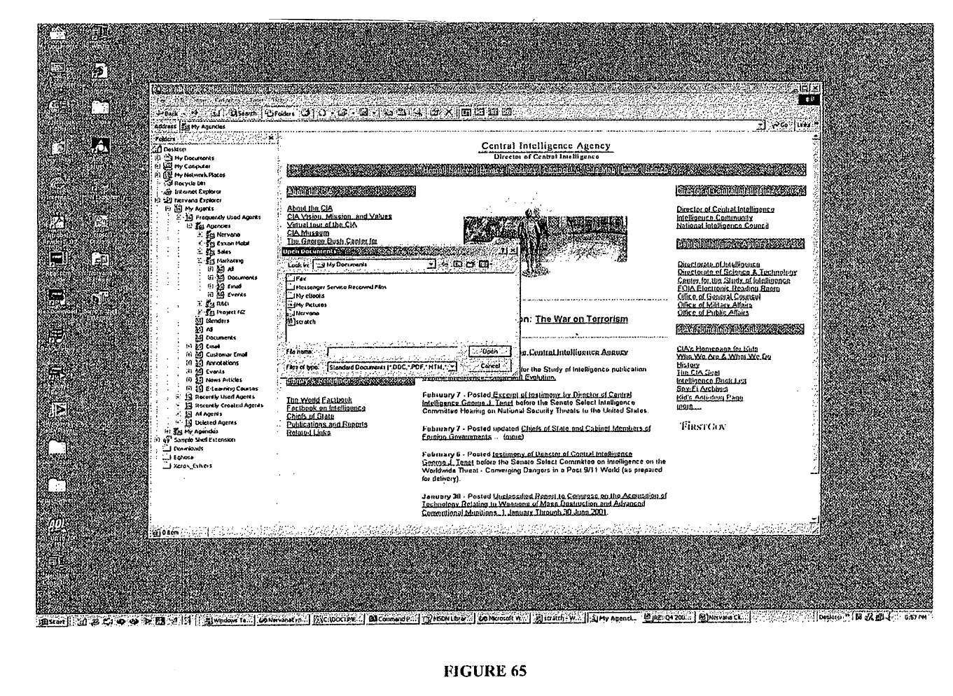

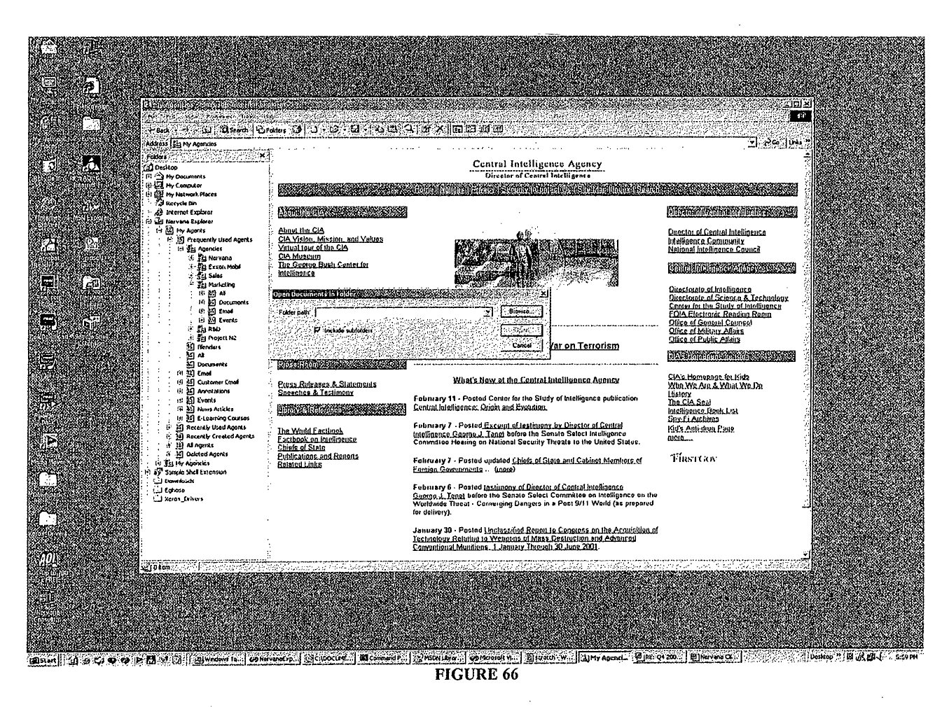

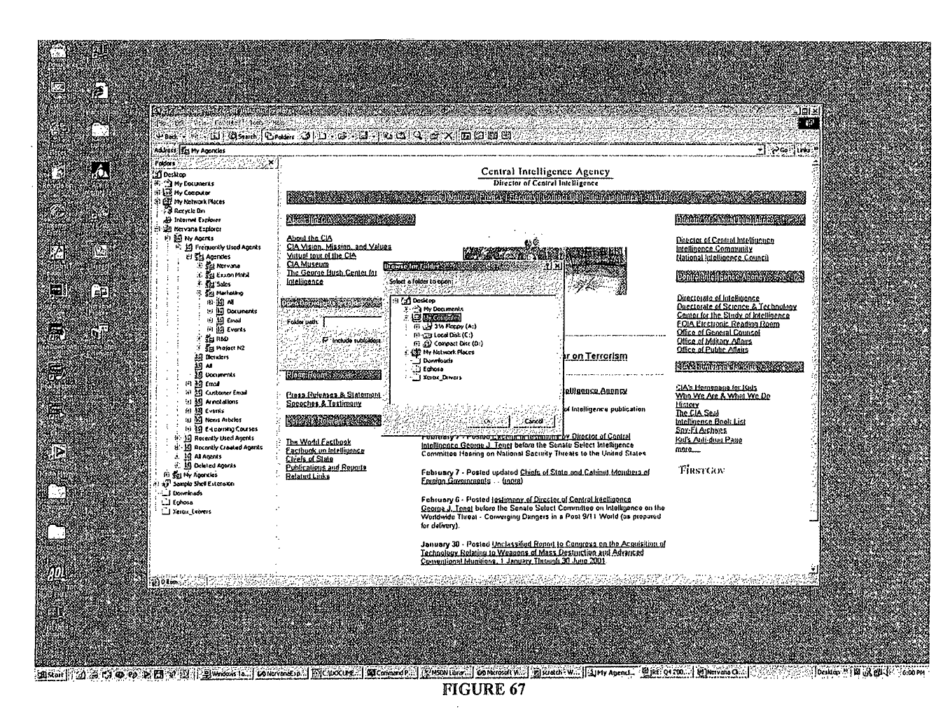

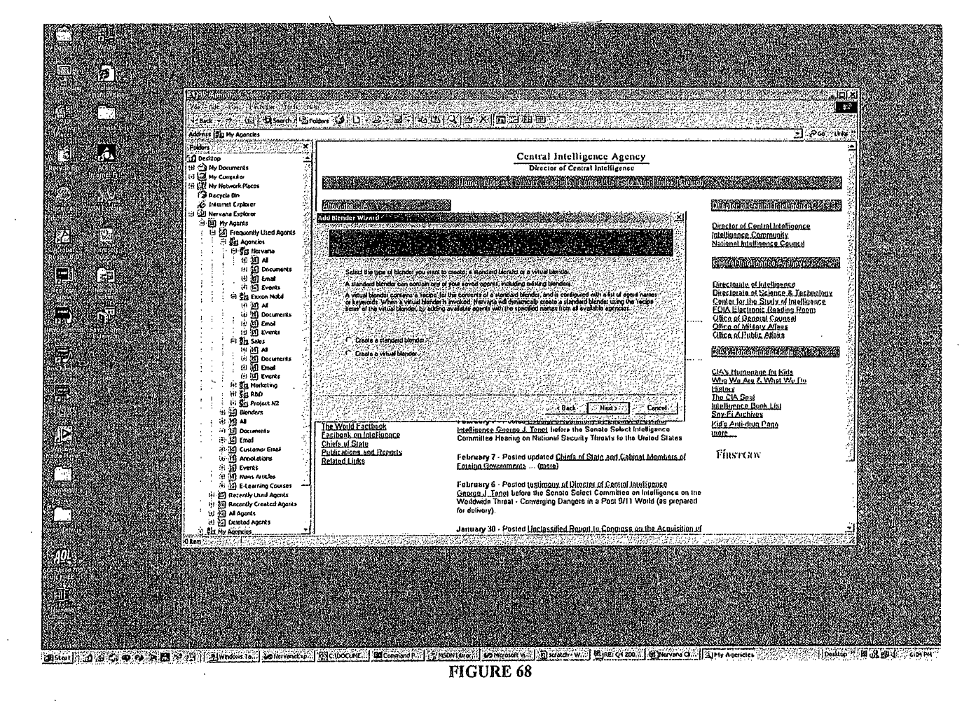

FIGS. 60-68 provide exemplar screenshots of an Information Agent according to a preferred embodiment of the present invention. FIG. 60 illustrates the Semantic Environment showing a toolbar popup menu option having tools allowing users to import local search results into the Semantic Environment, e.g., via a Dumb Agent, to create a new Special Agent, a new Blender, or a new local Agency. Alternatively, these tools can be collapse into one tool button that invokes a wizard from which users can select the kind of Agent (Dumb, Smart, Special) or Agency they wish to create. FIG. 61 shows a sample dialog that allows users to search the Semantic Environment using keywords. This creates a new Smart Agent (with the appropriate SQML). Users are preferably able to customize the name of the new Smart Agent and add an optional description. FIG. 62 shows the “Save” tool popup menu options of the toolbar that allows users to save a newly created or opened Agent permanently into the Semantic Environment (e.g., into the “favorites” list), or to save the Agent into a Blender. FIG. 63 shows Smart Lens tool menu options of the toolbar that allows users to invoke the Smart Lens (based on the Smart Agent or object that is currently on the clipboard). This communicates to the Presenter that the user wishes to use the clipboard contents as a Smart Lens. The Presenter preferably automatically invokes the Smart Lens functionality for any object users hover over (e.g., with the mouse). The menu also shows a “Paste as Smart Lens and Pin” option that keeps the Smart Lens turned on (even across Agent navigations) until the user explicitly turns off the Smart Lens. FIG. 64 illustrates a sample view of the “Open Agent” dialog, showing how users can open server-side Agents from the Semantic Environment and change the “view” of the Environment (e.g., Large Icons, Small Icons, List, etc.). FIG. 65 illustrates the standard Windows “Open” dialog showing how users can import a “regular” document from the file system into the Semantic Environment of the Information Nervous System. A Dumb Agent is created that refers to the document(s). When the Dumb Agent is invoked, the document(s) is opened in the Information Agent and all of the semantic tools (e.g., smart copy and paste, Context Templates, etc.) are enabled with the document(s). This illustrates how the browser can make a regular, “stupid” document on the file system semantically “smart.” FIG. 66 shows a custom “Open Documents in Folder” dialog that allows users to search for documents on a folder on the local file system and import them into the Semantic Environment. This makes the documents “smart” by “exposing” them via the semantic tools of the Information Nervous System (e.g., smart copy and paste, Context Templates, etc.). FIG. 67 shows the “Browse for Folder” dialog box that is shown when users select a browse option. This allows users to select a folder to open (from the local file system). FIG. 68 shows a page from the “Add Blender” wizard that allows users to select whether they want to create a standard Blender or a virtual Blender.

i. Additional Application Features

Application Menu Extensions and other Framework Features. The system client preferably installs a menu extension to applications that support programmatic extensions but that do not already support copying data to the clipboard. These include applications such as Microsoft Windows Media Player and Microsoft Outlook (for email message headers). In the preferred embodiment the menu extension reads “Copy.” The system copies the selected object as an XML object to the Windows system clipboard. For example, the system plug-in for an email Microsoft Outlook copies a selected email object as an Email XML Object. For applications that already support the clipboard, no extension is needed.

Server-Side Favorite Objects. On Agencies that support User State, users are able to mark objects as “favorites.” When an object is marked as a favorite, the Presenter invokes a method on the Agency's XML Web Service. The XML Web Service adds a semantic link between the user object and the object in question. In the preferred embodiment, users are able to view favorite objects via the All.MyFavorites.All Default Agent. This Agent returns all objects that have been marked as favorites. The Agency administrator is able to create sub-Agents such as All.MyFavorites.Technology.XML.All.

The Presenter allows users to mark and unmark favorites, which is also a means of redefining the structure that the servers and Agencies export. The use of “favorites” scenario is especially valuable in cases where users may see objects of interest and not want to navigate them immediately. The favorites feature may optionally be also used by the Agency to recommend objects to users. In the preferred embodiment, these recommended objects are retrievable via the All.Recommended.All Agent. The Agency recommends objects based primarily on objects that users have marked as being favorites. Server-side favorites will also preferably be used with the “favorites,” Classics and Recommendations Context Templates.

Agent Screen Savers. A preferred embodiment of the present invention allows users to select any subscribed Agent as a screen-saver. Users are preferably warned that Agents may expose sensitive data and given an opportunity to determine whether it is safe to use a particular Agent as a screen-saver. In the preferred embodiment, the system client is capable of loading any subscribed Agent as a screen-saver. In an alternative embodiment, users may combine Agents to provide a desired screen-saver presentation. Alternatively, a screen-saver may be a structured Skin that includes displayed parallel Agents, for example, in four quadrants of the screen.

Agent-Agent Smart Lens. In an alternative embodiment, the system client supports the use of a Smart Lens (invoked either through an Agent or a Blender) as a context to invoke another Agent or Blender. For example, users may select All.CriticalPriority.All and want to use that Agent as a Smart Lens to browse All.Understood.All in order to find out all objects that are critical priority and which are also understood by the destination Agency.

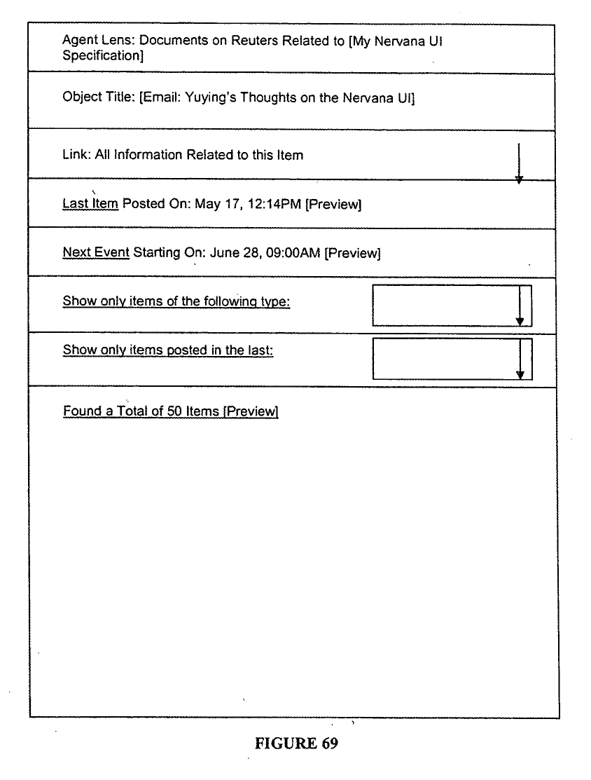

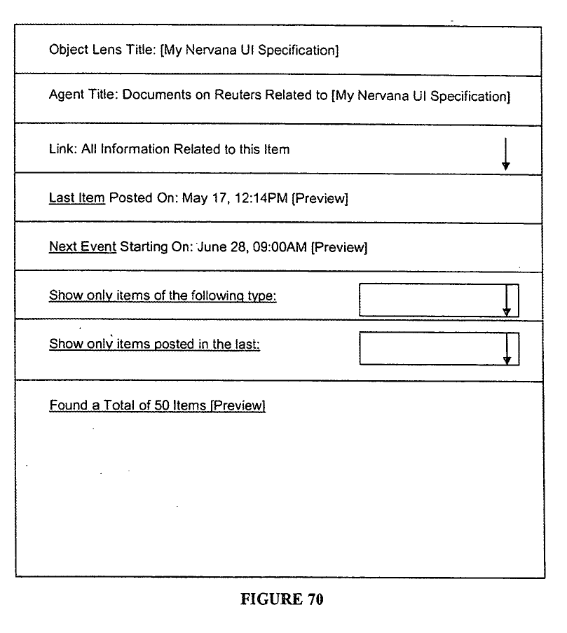

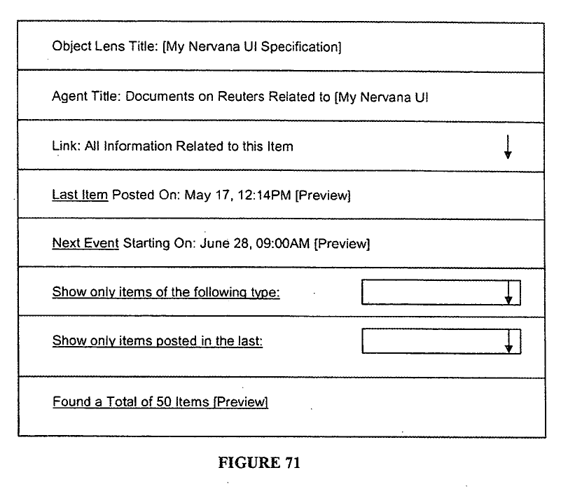

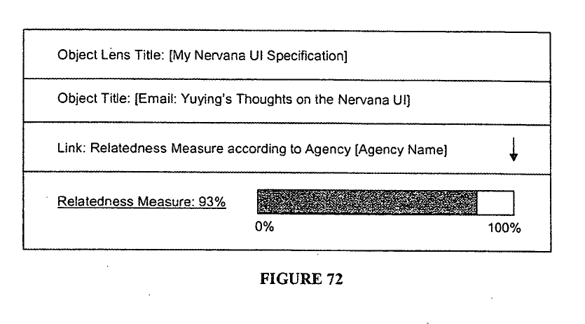

Smart Lens Sample User Interface Illustrations. FIGS. 69-71 provide exemplar balloon popup menus associated with the Smart Lens feature of an Information Agent according to the present invention. FIG. 69 shows a sample of a balloon popup menu in the context Results Pane with a Smart Agent as the Smart Lens. This shows a popup window that is displayed when users select the Smart Lens icon on an information object. This sample shows a case where the Smart Agent titled “Documents on Reuters Related to [My Nervana UI Specification] is on the clipboard and is “posted” as a Smart Lens over an email object titled “Yuying's Thoughts on the Nervana UI.”. FIG. 70 shows a sample of a balloon popup menu in the context Results Pane with an object as the Smart Lens (and “hovered” over an Agent). This sample illustrates that the Smart Lens is connotative (A [SMART LENS] B=B [SMART LENS] A). The results section of the context pane is identical to in the example shown in FIG. 69, indicating that the Smart Lens in the preferred embodiment is connotative. FIG. 71 shows a sample of a balloon popup menu in the context Results Pane with an information object as the Smart Lens and an information object as the item being “lensed over.” In this sample, an object titled “My Nervana UI Specification” has been copied to the clipboard (its SQML representation) and pasted as a Smart Lens over another object (in the Results Pane) titled “Yuying's Thoughts on the Nervana UI” (an email object). In this sample, the user has the option of selecting a predicate that is semantically consistent with the combination of a document to an email message. FIG. 72 shows a sample of a variant of the balloon popup menu of FIG. 71 showing the relatedness measure of the two objects (the Smart Lens object and the “lensed over” object), both as a percentage and graphically, in this example as a bar chart.

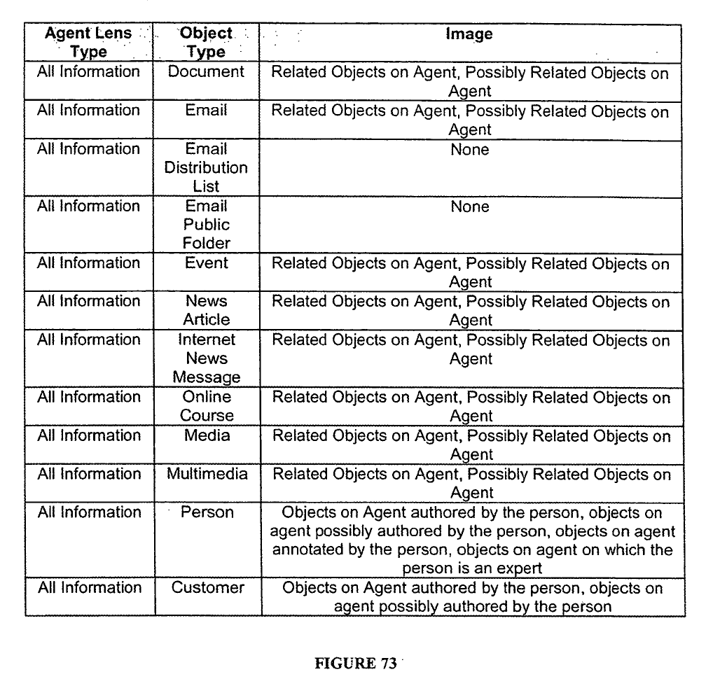

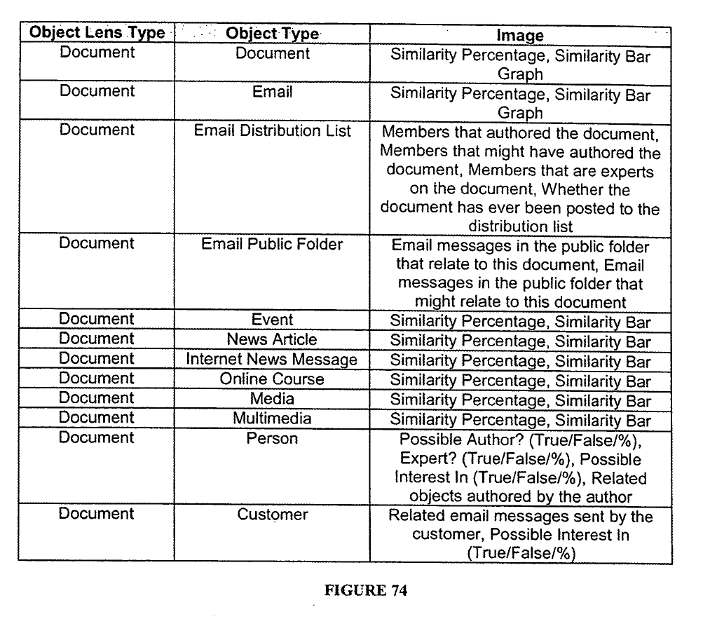

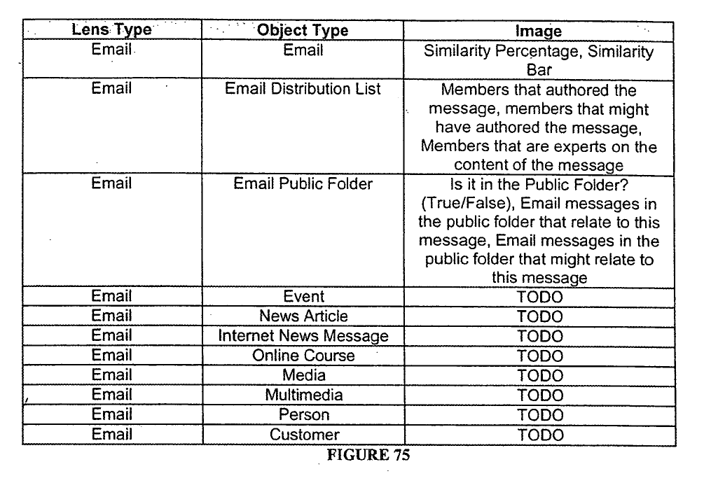

FIGS. 73-75 show sample tables illustrating the behaviors and relational contains objects types predicates when using Smart Lenses. FIG. 73 shows the Agent-Object scenario for all information wherein the Smart Lens behavior is commutative, for example, A[Smart Lens]B=B[Smart Lens]A. FIGS. 74-75 show the Object-Object scenario for document and email, respectively, also wherein the Smart Lens behavior is commutative, for example, A[Smart Lens]B=B[Smart Lens]A.

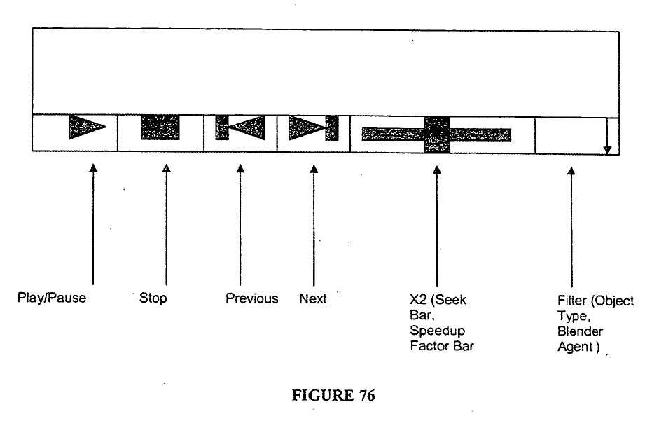

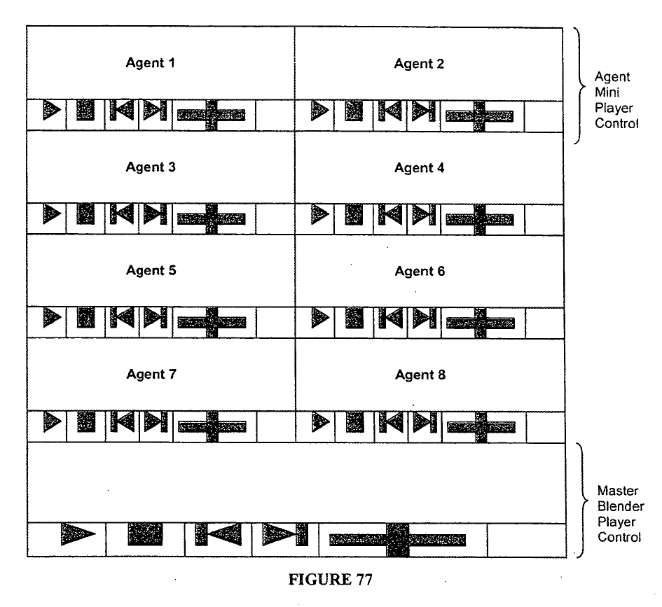

Blender Skin User Interface Illustrations. FIG. 76 is a user interface sample illustrating semantic results Player/Preview Control. The Information Agent Presenter preferably attaches this control to each Results Pane. The Player/Preview Control allows users to navigate the results in the Results Pane, to animate the results (play, stop, pause, change, speed up, etc.) and to filter the results (e.g., in the case of the results of a Blender). FIG. 77 is a user interface sample showing the semantic results of a Blender. In this sample, the Blender Skin has reserved parts of the display area as separate frames for each Agent in the Blender, and attached a Player/Preview Control to each frame, thereby allowing users to individually navigate, control and animate the results of each Agent in the Blender. Alternatively, a Blender Skin can display the merged results from all the Agents in the Blender (with one Player/Preview Control attached), can display the results in frames according to information object type, etc.

Multiple Drag and Drop. In an alternative embodiment, the system client allows users to select multiple documents or folders from the desktop and use them as the basis of relational queries on an Agent or Blender. This allows users to further refine a query using multiple documents as the refining tool. For example, the user may optionally indicate whether they want the union or intersection of the results (using each of the documents as a filter). This creates an SQML file with one resource (the object over which the links were dragged) and multiple links (one per document or dragged object). The client's SQP preferably interprets this by retrieving the XLM metadata for all the object filters and calling the destination Smart Agent's XML Web Service with the XML arguments. In the preferred embodiment, the Agency's XML Web Service categorizes the XML metadata arguments, forms the proper SQL representation of the query and returns the results.

URL Shortcut Conventions. Agencies of the present invention may share the Internet Web since they are optionally installed as Web applications. As a result, Agencies can be referred to using the Web's naming scheme (e.g., a regular HTTP URL). In the preferred embodiment, the present invention exposes shortcut naming conventions and URLs that are specific to the Information Agent's Semantic Environment.
Agent Shortcut URL Convention. The Agent shortcut URL convention is:
   agent://<agentname>@<agencyurl>?start=<start>&end=<end>&skin=<skin urlL>
When invoked, this is preferably mapped to a fully-qualified HTTP URL, for example:
   http://<path to Agency ASP; or
   CGI script>?agentname=<agentname>& start=<start>&end=<end>&skin=<SkinUrl>.
An example of an Agent shortcut URL convention is as follows:
   agent://email.technology.wireless.allmarketing.abccorp.com?start=0&end=25&skin=http://www.nervana.net/skins/email/abcemailskin.xslt
This URL is resolved by the client as follows: Start the Web service proxy, open the WSDL file http://abc.com/nervanaroot/webservice.wsdl and ask the Web service for the statistics of the Agency named “Marketing.” For HTTP access, this will be resolved to a path to the ASP or CGI. For example:
   http://abccorp.com/marketingagency.asp?urltype=agent&agentname=email.technology.wireless.all&start=0&end=25&skin=http://www.nervana.net/skins/email/abccorpemailskin.xslt
The start argument indicates the zero-based starting index of the object to return first. The end argument indicates the end index. The Skin URL is optional. If no Skin URL is specified, the client loads the Agent with the Agent's default Skin. A locally saved Agent may be accessed with agent://<agentname>@localhost. For example: agent://Documents.[Related to My Business Plan]@localhost will load the locally saved Agent (in My Agents) named “Documents.[Related to My Business Plan]”.
Agency URL Convention. An example is as follows:
   agency://<agencyname>.<domainname>?query=getproperties|getstats|getagents@agentviewfilter=<agentviewfilter>&agentnamecontainsfilter=<agentnamecontainsfilter>&agenttypefilter=<agenttypefilter>&agentobjecttypefilter=<agentobjecttypefilter>
In this example, the query argument is “getproperties”. The URL retrieves the properties of the Agency itself (e.g., the name, the display name, whether it is local or remote, etc.). Alternatively, if the property is “getstats,” the URL retrieves the statistics of the Agency (total number of Agents, number of Standard Agents, number of Compound Agents, number of Domain Agents, total number of objects, number of document objects, number of email objects, etc.). In the preferred embodiment, the getproperties flag is the default, meaning that the properties are retrieved if no other argument is specified. If either the getproperties or getstats arguments are specified, preferably no other arguments are specified alongside.
The agentviewfilter argument is optional and allows the caller to specify an Agent view within with to restrict the search. For example, an Agent view “Reuters News” may be installed on the server to only return Agents that manage news objects from Reuters. The agentnamecontainsfilter argument is optional and allows users to filter the results by a search string for the Agent name. The agenttypefilter is optional and allows users to filter Agents based on Agent type (Standard Agent, Compound Agent, or Domain Agent). The agentobjecttypefilter argument is optional and allows users to filter the results with the object type the Agent manages (e.g., email, documents, people, etc.). Examples include the following:
   agency:H/sales.boeing.com?query=getstats (corresponding to the HTTP URL
   http://boeing.com/salesagency.asp?urltype=agency&query=getstats)
   agency://sales.boeing.com?agenttypefilter=standard&agentobjecttypeidfilter=events (corresponding to the HTTP URL
   http://boeing.com/salesagency.asp?urltype=agency&agenttypefilter=standard&agentobjecttypeidfilter=events
Objects URL Convention. Agency objects can be accessed directly from a client. The URL convention is:
   objects://<querystring><agencyname>.<domainname>?querytype=<objectid|searchstring>&objecttypefilter=<objecttypefilter>
The objecttypefilter argument is optional and can be used to filter the returned objects by object type. It is an enumeration of known object types (e.g., document, email, event, etc.). Examples include the following:
   objects://34547848@support.attwireless.com?querytype=objectid will return the object with the objectid 34547848.
   objects://80211 support.attwireless.com?querytype=searchstring&objecttype=email will return the email objects matching the query string “80211”
Category URL Convention. The URL convention is:
   category://<<categoryname>@<kbsurl>?semanticdomainname=<semanticdomainname>
The semanticdomainname argument is optional. In the preferred embodiment, if it is left out, the default domain of the KBS will be selected. An example is as follows:
   category://technology.wireless.all@abccorp.com/marketingknowledge.asp
This corresponds to the “Technology.Wireless.All” category for the default domain on the knowledge-base installed on the abccorp.com/marketingknowledge.asp web service. This will be resolved to the following HTTP URL: http://abccorp.com/marketingknowledge.asp?category=“technology.wireless.all. An example of a fully qualified version of the category URL may be:
   category://technology.wireless.all@abccorp.com/marketingknowledge.asp?semanticdomainname=“/InformationTechnology”

Sharing and Roaming Client Information. In the preferred embodiment, users are able to share Agents (including Blenders) with others by sending them via email, instant messaging, etc. Local information users are preferably able to either store Agent information locally or have the information roam with them (e.g., via AbccorpliMirror support in Windows 2000 for department-wide roaming, via a proprietary XML Web Service on a Global Agency Directory (using passwords for identity), or via integration with Microsoft .NET My Services, which employs Microsoft's Passport identity service).

Local Agencies. The system client preferably also allows users to create and add local Agencies that run a local instance of the KIS to the “My Agencies” list. In this embodiment, the client also allows users to delete a personal Agency.

User-Experience Consistency and Non-Disruptiveness. The Information Agent (semantic browser) of the present invention provides a consistent and undisruptive user experience. In other words, the Information Agent seamlessly coexists with Today's Web browser. Tools such as “Back,” “Forward,” “Home,” “Stop,” “Refresh,” and “Print” preferable work as they do with Today's Web browser so as not to confuse the user. Many of the tools remain the same albeit the functionality is different. In addition, new tools are preferably added to the toolbar and menu options reflecting the new functionality in the semantic browser (these can be seen by observing the toolbar in the screenshots).

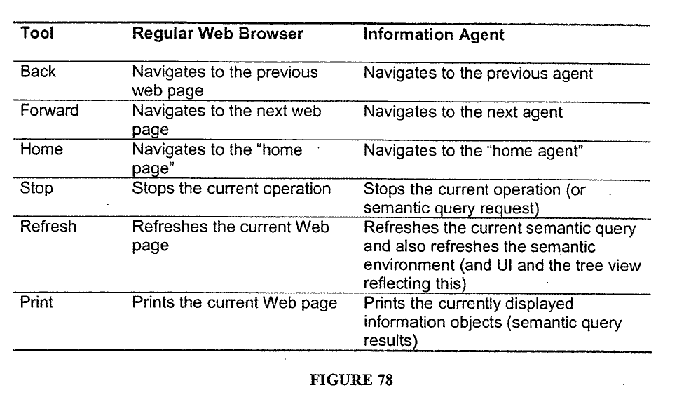

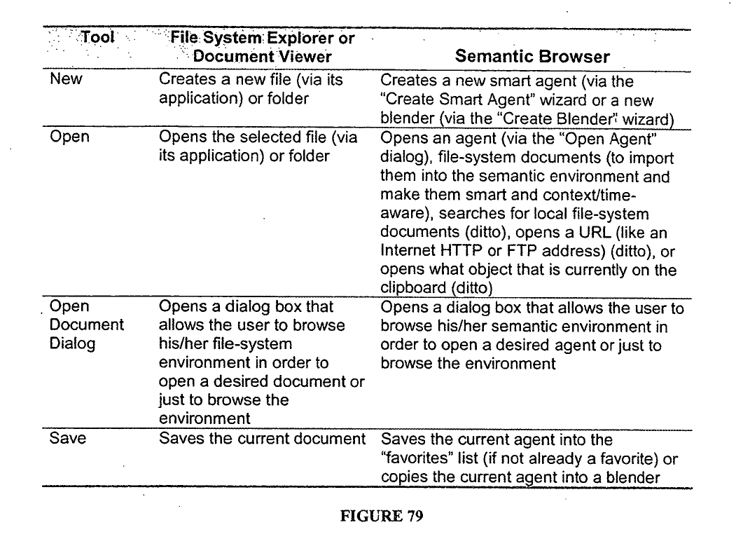

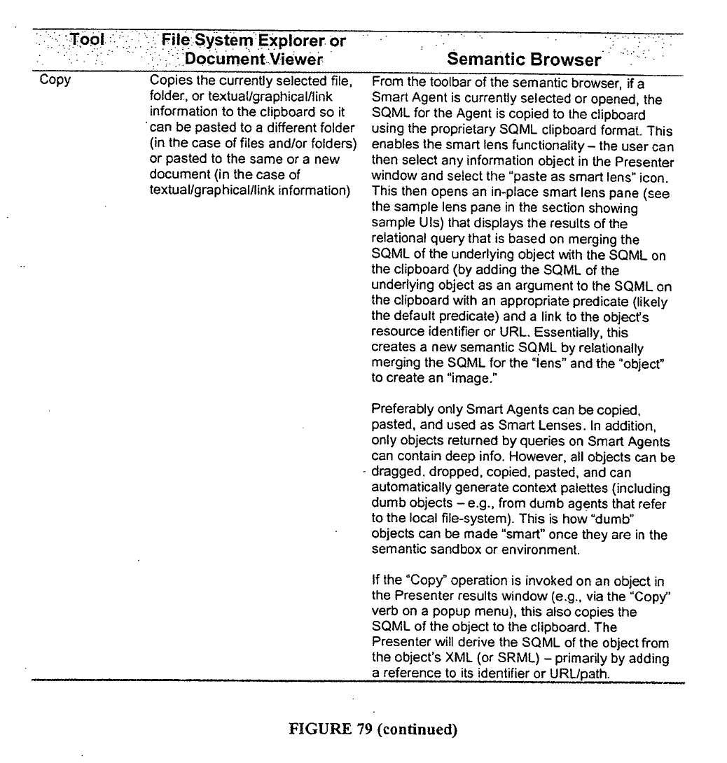

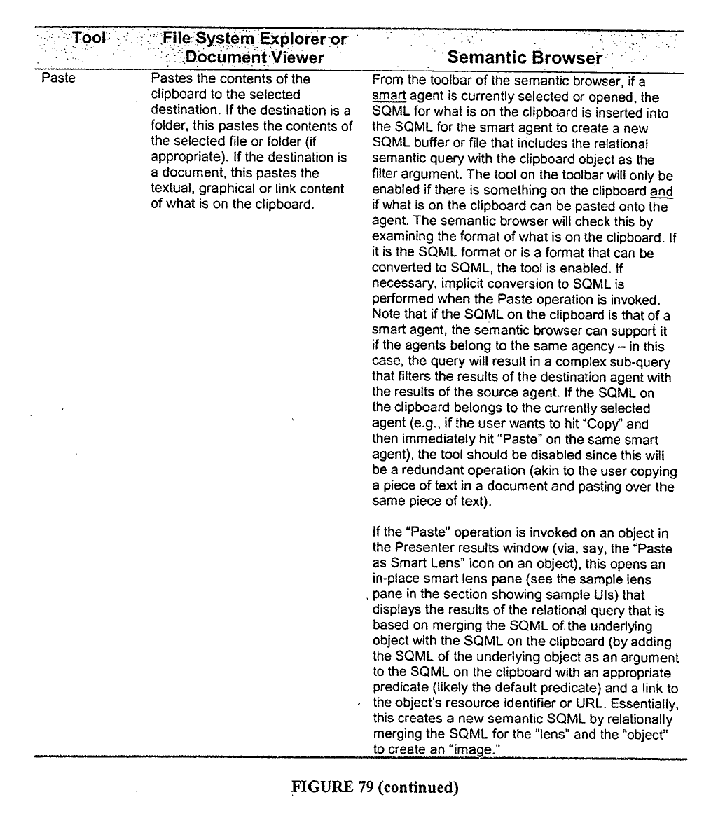

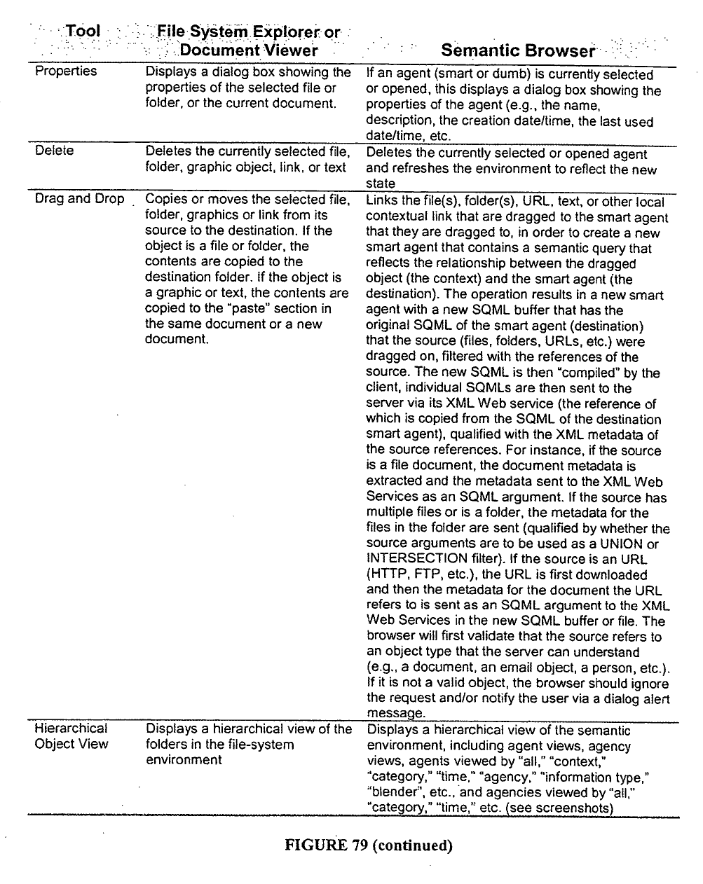

FIGS. 78 and 79 illustrate exemplar functionality mappings of the present invention demonstrating preferred mappings for introducing new functionality to users while maintaining metaphor consistency. FIG. 78 is a comparison of default user interface toolsets for Today's Web browser and a preferred embodiment of the Information Agent of the present invention. FIG. 79 is a comparison of default user interface toolsets for the file system Microsoft Explorer/Document Viewer and a preferred embodiment of the Information Agent of the present invention.

5. Providing Context in the Present Invention

a. Context Templates

The present invention provides Context Templates, or scenario-driven information query templates that map to specific semantic models for information access and retrieval. Essentially, Context Templates can be thought of as personal, digital semantic information retrieval “channels” that deliver information to a user by employing a predefined semantic template. In the preferred embodiment, the semantic browser 30 allows the user to create a new “Special Agent” using Context Templates to initialize the properties of the Agent. Context Templates preferably aggregate information across one or more Agencies.

By way of example only, the present invention defines the following Context Templates. Additional Context Templates directed towards the integration and dissemination of varied types of semantic information are contemplated within the scope of the present invention (examples includes Context Templates related to emotion, e.g., “Angry,” “Sad,” etc.; Context Templates for location, mobility, ambient conditions, users tasks, etc.).

“Headlines” Context Template. The Headlines Context Template (and its resulting Special Agent) can be analogized to a personal, digital version of CNN's “Headline News” program in how it conveys semantic information. The Context Template allows a user to access information headlines from one or more Agencies, sorted according to the information creation or publishing time and a configurable amount of time that defines information “freshness.” For example, CNN's “Headline News” displays headlines every 30 minutes (around the clock). In a preferred embodiment, the Information Agent 30 of the present invention allows users to create a Headlines Special Agent using the following filters and parameters:
Information Object Pivots. The resulting Blender shows result that relate to these object. This is an optional parameter. If it is not specified, headlines are displayed for the entire Agency (without any object-based filter).
Predetermined “freshness” period. For example, 30 minutes, 1 hour, etc.
Predicate. This will define how the Information Object Pivot links to the information to be retrieved. Examples are: “related to,” “possibly related to” (uses a text-based search), “authored” (in the case of a person object), “possibly authored,” “has expertise on,” etc. The default predicate “relevant to” is preferably used by default. This default predicate is resolved by the Agency by intelligently mapping it to specific predicates.
Agency(ies). This includes the Agencies on which to check for headlines. At least one Agency must be specified and there is no limit to the number of Agencies that can be specified. The user may indicate whether all Agencies in the “recent” and/or “favorites” lists should be used.
Category list. For example “Technology.Wireless.All”. This acts as an additional filter for the query.

In addition to freshness, the Headlines Context Template preferably incorporates how “hot” the result items are in order to determine the ranking of the results. This may be accomplished by querying the Agency to find out the number of semantically related objects on the Agency, which is a good indicator of whether an object's topic is “hot.” In addition, returned objects (or items) are preferably sorted by freshness or as new.

By way of example, SAMPLE D of the Appendix hereto illustrates an SQML output from a Headlines Context Template of the preferred embodiment. In this example, the Context Template retrieves all information from four different Agencies (marketing, research, sales, and human resources), with a freshness time span of 30 minutes, and with a “relevant to” predicate (indicating a semantic query). In the preferred embodiment, the SQML of this example, as for all Context Templates, can optionally form the basis of a Smart Lens, smart copy and paste, drag and drop and other tools in the semantic toolbox.

“Breaking News” Context Template. The Breaking News Context Template (and its resulting Special Agent) can be analogized to a personal, digital version of CNN's “Breaking News” program inserts that interrupt regularly scheduled programming in how it conveys semantic information. Like CNN's “Breaking News” inserts, this Context Template allows users to access “breaking,” time-critical information from one or more Agencies, preferably sorted by the information creation or publishing time or the event occurrence time (in the case of event), and with a configurable amount of time that defines freshness and a configurable “deadline” for events to define time-criticality. For example, the Context Template can be defined to filter information objects posted in the last one-hour, or events holding in the next one day.

In the preferred embodiment, the Breaking News Context Template is different from Breaking News Agents. The Context Template is a template that defines static query parameters that are passed to one or more Agencies. A Breaking News Agent is any Smart Agent users may have created and is essentially user-created and user-customizable. By way of example, a Breaking News Special Agent based on the Breaking News Context Template may inform users of information objects posted in the last hour or events holding in the next day that relate to a local document (or any other local context, if specified). But a Breaking News Agent gives users the flexibility of receiving alerts for “Events on wireless technology being given by a member of my team and holding either Seattle or Portland in the next 24 hours and which relate to this document on my hard drive.” The Breaking News Agent provides users much greater flexibility and personalization than the Breaking News Context Template. An advantage of the Breaking News Context Template is that it preferably forms the basis for intrinsic alerts by using parameters that qualify as “breaking” for typical users.

“Conversations” Context Template. The Conversations Context Template (and its resulting Special Agent) can be analogized to a personal, digital version of CNN's “Crossfire” program in how it conveys semantic information. Like “Crossfire,” which uses conversations and debates as the context for information dissemination, in the preferred embodiment, the Conversations Special Agent tracks email postings, annotations, and threads for relevant information. The Conversations Context Template may be thought of as the Headlines Context Template filtered with email object type. In addition to the “Headlines” parameters, the Conversations Context Template preferably (but optionally) contains the following parameters:
Minimum thread length to return. The user optionally indicates that he or she only wants email threads with at least one reply, two replies, etc. In many instances, the number of threats provides an indication of semantic significance. The default is zero.
Distribution list filter. The user optionally restricts the returned email to those that have members of one or more distribution lists on the “from,” “to,” “cc,” or “bcc” lines. This allows the user wants to monitor debates from preferred groups, divisions, etc.
Distribution line filter. The user optionally restricts the returned email to those that have the filter email addresses on the “from,” “to,” “cc,” or “bcc” lines. The returned items are optionally sorted based on freshness or based on the depth of the conversation thread.

“Newsmakers” Context Template. The Newsmakers Context Template (and its resulting Special Agent) can be analogized to a personal, digital version of NBC's “Meet the Press” program in how it conveys semantic information. In this case, the emphasis is on “people in the news,” as opposed to the news itself or conversations. Users navigate the network using the returned people as Information Object Pivots. The Newsmakers Context Template can be thought of as the Headlines Context Template, preferably with the “People” or “Users” object type filters, and the “authored by,” “possibly authored by,” “hosted by,” “annotated by,” “expert on,” etc. predicates (predicates that relate people to information). The “relevant to” default predicate preferably is used to cover all the germane specific predicates. The sort order of the relevant information, e.g., the newsmakers, is sorted based on the order of the “news they make,” e.g., headlines. In addition to the Headlines Context Template parameters, the Newsmakers Context Template preferably contains the following optional parameters:
Distribution list filter. The user optionally restricts the returned email to those that have members of one or more distribution lists on the “from,” “to,” “cc,” or “bcc” lines. This allows the user wants to monitor debates from preferred groups, divisions, etc.
Distribution line filter. The user optionally restricts the returned email to those that have the filter email addresses on the “from,” “to,” “cc,” or “bcc” lines.

“Upcoming Events” Context Template. The Upcoming Events Context Template (and its resulting Special Agent) can be analogized to a personal digital version of special programs that convey information about upcoming events. Examples include specials for events such as “The World Series,” “The NBA Finals,” “The Soccer World Cup Finals,” etc. The equivalent in a knowledge-worker scenario is a user that wants to monitor all upcoming industry events that relate to one or more categories, documents or other Information Object Pivots. The Upcoming Events Context Template is preferably identical to the Headlines Context Template except that only upcoming events are filtered and displayed (preferably using a semantically appropriate “context Skin” that connotes events and time-criticality). Returned objects are preferably sorted based on time-criticality with the most impending events listed first.

“Discovery” Context Template. The Discovery Context Template (and its resulting Special Agent) can be analogized to a personal, digital version of the “Discovery Channel.” In this case, the emphasis is on “documentaries” about particular topics. Unlike in the case of “Headline News,” the primary axis for semantic information access and retrieval is not time. Rather, it is one or more category with an intelligent aggregation of information around those categories. In a preferred embodiment of the present invention, the Discovery Context Template simulates intelligent aggregation of information by randomly selecting information objects that relate to a given set of categories and which are posted within an optionally predetermined, configurable time period. While there is an optional configurable time period, the semantic weight as opposed to the time is the preferred consideration for determining how the information is to be ordered or presented. The present invention allows for different axes to be used, for example, the semantic weight for the category or categories being “discovered,” time, randomness, or a combination of all axes (which would likely increase the effectiveness of the “discovery”). The Discovery Context Template preferably has the same parameters as the Headlines Context Template, except that the freshness time span is replaced by an optional maximum age limit, which indicates the maximum age of information (posted to the Agency) that the Agent should return.

“History” Context Template. The History Context Template (and its resulting Special Agent) can be analogized to a personal, digital version of the “History Channel.” In this case, the emphasis is on disseminating information not just about particular topics, but also with a historical context. For this template, the preferred axes are category and time. The History Context Template is similar to the Discovery Context Template, further in concert with “a minimum age limit.” The parameters are preferably the same as that of the Discovery Context Template, except that the “maximum age limit” parameter is replaced with a “minimum age limit” parameter (or an optional “history time span” parameter). In addition, returned objects are preferably sorted in reverse order based on their age in the system or their age since creation.

“All Bets” Context Template. The All Bets Context Template (and its resulting Special Agent) represents context that returns any information that is relevant based on either semantics or based on a keyword or text-based search. In this case, the emphasis is on disseminating information that may be even remotely relevant to the context. The primary axis for the All Bets Context Template is preferably the mere possibility of relevance. In the preferred embodiment, the All Bets Context Template employs both a semantic and text-based query in order to return the broadest possible set of results that may be relevant.

“Best Bets” Context Template. The Best Bets Context Template (and its resulting Special Agent) represents context that returns only highly relevant information. In a preferred embodiment, the emphasis is on disseminating information that is deemed to be highly relevant and semantically significant. For this Context Template, the primary axis is relevance. In essence, the Best Bets Context Template employs a semantic query and will not use text-based queries since it cannot guarantee the relevance of text-based query results. The Best Bets Context Template is preferably initialized with a category filter or keywords. If keywords are specified, categorization is performed by the server dynamically. Results are preferably sorted based on the relevance score, or the strength of the “belongs to category” semantic link from the object to the category filter.

“Favorites” Context Template. The Favorites Context Template (and its resulting Special Agent) represents context that returns “favorite” or “popular” information. In this case, the emphasis is on disseminating information that has been endorsed by others and has been favorably accepted. In the preferred embodiment, the axes for the Favorites Context Template include the level of readership interest, the “reviews” the object received, and the depth of the annotation thread on the object. In one embodiment, the Favorites Context Template returns only information that has the “favorites” semantic link, and is sorted by counting the number of “votes” for the object (based on this semantic link).

“Classics” Context Template. The Classics Context Template (and its resulting Special Agent) represents context that returns “classical” information, or information that is of recognized value. Like the Favorites Context Template, the emphasis is on disseminating information that has been endorsed by others and has been favorably accepted. For this Context Template, the preferred axes includes a historical context, the level of readership interest, the “reviews” the object received and the depth of the annotation thread on the object. The Classics Context Template is preferably implemented based on the Favorites Context Template but with an additional minimum age limit filter, essentially functioning as an “Old Favorites” Context Template.

“Recommendations” Context Template. The Recommendations Context Template (and its resulting Special Agent) represents context that returns “recommended” information, or information that the Agencies have inferred would be of interest to a user. Recommendations will be inserted by adding “recommendation” semantic links to the “SemanticLinks” table and by mining the favorite semantic links that users indicate. Recommendations are preferably made using techniques such as machine learning and collaborative filtering. The emphasis of this Context Template is on disseminating information that would likely be of interest to the user but which the user might not have already seen. For this Context Template, the primary axes preferably include the likelihood of interest and freshness. In the preferred embodiment, the Context Template is implemented by generating SQML that has the PREDICATETYPEID_ISLIKELYTOBEINTERESTEDIN predicate as the primary predicate filter on the Agencies in the Semantic Environment.

“Today” Context Template. The Today Context Template (and its resulting Special Agent) represents context that returns information posted or holding (in the case of events) “today.” The emphasis with this Context Template is preferably on disseminating information that is deemed to be current based on “today” being the filter to determine freshness. In the preferred embodiment, the Today Context Template results are a subset of the Headlines Context Template results wherein the results posted “today” or events holding “today” are displayed.

“Variety” Context Template. The Variety Context Template (and its resulting Special Agent) represents context that returns random information. The emphasis with this Context Template is preferably on disseminating information that is random in order for the user to get a wide range of possible information items. In the preferred embodiment, the primary axis is randomness, albeit the “random” items will be semantically relevant to the query filter (using the “relevant to” predicate).

b. Context Skins

The present invention includes a special class of Skins called “Context Skins.” Context Skins include presentation information that conveys the semantics of the context that they represent. For example, a Context Skin for the Today Context Template may display a background or filter effects with a clock pointing to midnight, or some other representation of “Today.” In yet additional examples, a Context Skin for the Variety Context Template may show transform effects like bowling balls falling over randomly (indicating the randomness of the results); the Breaking News Context Skin may show effects and light animations with flashing text, ambulance red lights, etc. to indicate the criticality of the context; and the History Context Skin may show graphics that indicate “age”; for example, old cars, clocks, etc.

Context Skins preferably “honor” the presentation template for object types being displayed. For example, email objects may be displayed with a background showing stamps or a post office truck in addition to graphics that indicate the Context Template. Because some Context Templates cut across Agencies—and therefore cut across ontologies—they need not display any information that indicates ontology (e.g., industry information). However, Context Skins that are initialized with a category filter preferably indicate the category or ontology of the Context Template. Typically this will be represented with graphics elements (and filters, transforms, etc.) that indicate the industry or genre of the ontology. For example, a Pharmaceuticals Context Skin may have filter effects showing laboratory equipment; an Oil and Gas Context Skin may show pictures of oil rigs; and a Sports Context Skin may show pictures of sports gear, etc.

c. Skin Templates

The present invention allows a user to select different kinds of Skins, depending on the task at hand. The implication of having flexible presentation is that the user can select the best presentation mode based on the current task. For example, users may select a subtle Skin when working on their main machine and where productivity is most critical and where effects are not. Users may select a moderate Skin in cases where productivity is also important but where effects will also be nice to have as well. Users may select an exciting Skin for scenarios like second machines, for example where users are viewing information in their peripheral vision, and features such as text-to-speech to alert them on breaking news is important. Exciting Skins may feature animations, storyboard like effects for deep information, objects displayed on motion paths, and other effects. Exciting Skins are most likely going to be used with screensavers. The choice of Skins is preferably user-definable.

d. Default Predicates

In the preferred embodiment, each object type includes a default predicate that links it with other object types. This provides users with an intuitive method of dynamically linking objects together without requiring a separate evaluation of the predicate to use for the semantic link. For example, a drag and drop operation from a document object to an Agent that returns documents can have the predicates “Related To” and “Possibly Related To.” When a document object is dragged on top of a document Agent, the semantic browser of the present invention displays a popup menu option that allows users to select the predicate to use for the semantic query. In an alternative embodiment, other related popup menus may be incorporated, e.g., a first popup menu that allows users to select the link or predicate template; child popup menus that display the actual predicates for the selected template. The default predicate is preferably inserted in the dynamically generated SQML from which the query will be invoked.

By way of example, a default predicate may be “relevant to.” This predicate maps to a query that returns information in the document Agent that is relevant to the object being dragged. The advantage of having a default predicate in this case is that the semantic browser of the present invention may display a popup menu option named “Open” that in turn invokes a query using this predicate. The semantic browser may also display a popup menu option named “Open with Link” that has submenu options with specific predicates. The default predicate makes the system easier to use because users are able to browse the system using dynamic linking, knowing that the default predicate will be the sensible option giving the source object and that target Agent or object.

In addition to being used in drag and drop scenarios, Default Predicates are optionally used in Smart Lenses, smart copy and paste, etc. Default Predicates may be analogized to degenerate smart links that return “the right thing” given the context. Preferably the default predicate will be “relevant to,” which may in turn produce “The right thing” as the appropriate query result for a semantic distance of one. In an alternative embodiment, the Default Predicate may be a merger of several specific predicates. For example, the Default Predicate for a document-to-people drag or drop, copy or paste, or Smart Lens may be “relevant to” and may be interpreted by the KIS Agency XML Web Service as, for example, a cascaded query involving “authored,” “expert on,” and “annotated” predicates. In other words, “relevance” is interpreted smartly by the present invention and may involve merging together different predicates.

Default Predicates allow users to navigate the system quickly and efficiently and with little thought. Default Predicates provide the system with simplicity and make it intuitive to use. In addition, users are comfortable with Default Predicates because users are already used to invoking HTML links on Today's Web where there is only one predicate: “invoke”.

e. Context Predicates

Context Predicates are predicates that are defined at a high level of abstraction and which map to a relevant subset of the Context Templates. Context Predicates allow a user to select a predicate filter based on a Context Template, rather than on a low-level system predicate. When the query is invoked with the Context Predicate, filtering the containing SQML with the filter parameters of the Context Template generates a new SQML query. For example, the Context Predicate “Best Bets” maps to the Context Template of the same name and filters a query with those information objects that are “best bets” (typically, these will be those items that are returned from a semantic query and not from a text-based query). Similarly, the Breaking News Context Predicate filters items based on whether they qualify, with the filter conditions of the Breaking News Context Template. In general, Context Predicates are applied for object types that are consistent with the Context Template (for example, the Context Predicates “Experts” and “Newsmakers” will only be valid for queries that return “Person” objects).

f. Context Attributes

Context Attributes are “virtual attributes” that are cached as part of each XML object that an Agency returns to the client. These attributes are dynamic in that they reflect the current context in which the results are being displayed. For example, where relevant, the Context Attribute “Best Bet” is attached to each XML result that satisfies the semantic query filter in the SQML of the current query. The results of a semantic query with default predicates might include both semantic and non-semantic (text-based query) results. The Agency processing the query may cache Context Attributes for the XML results that are “Best Bets” by running a semantic sub-query on the SQML with the result object as a filter. In this case, the schemas for the “Object” and derived types should include attribute fields for each relevant Context Template (e.g., a “Best Bet” attribute, “Headline” attribute, etc.). This is the preferred implementation. Alternatively, the semantic browser calls the Agency, passes each XML object as an argument and “asks” whether the object satisfies the Context Attribute. Other examples are a Headline Context Attribute that indicates whether the object qualifies as a “Headline” in the context of the current query, a “Classics” attribute, etc. The semantic browser should display a user interface indicating whether the context attribute is set or not.

Context Attributes provides further benefits over the prior art systems in that they make the system easier to use. For example, a user can perform a drag and drop operation to generate a relational query that includes both semantic and non-semantic query filters (as processed by the Agency when it receives the SQML arguments from the client). In one embodiment, the browser “asks” the user whether he or she desires a broad query or a “Best Bets” query. In this mode, the user effectively applies for an additional filter before the query is issued. Alternatively, the Agency, in concert with the semantic browser, preferably returns the results of the broad query, and also qualifies each result with a context attribute and corresponding user interface indicating whether each result object is “broad” or a “Best Bet.” The same applies to other object types like the “Person” object type. Rather than having the user indicate whether a relational query to a Person Agent should return “authors,” “experts,” or “annotators,” the browser can issue a broad query and than qualify the results (with help from the Agency) with whether each returned “Person” object is an “author,” “expert,” or “annotator,” for the current context.

g. Context Palettes

Context Palettes are a very powerful feature of the present invention that involves invoking Context Templates dynamically for the currently selected object within the semantic browser. Essentially, Context Palettes are preferably automatically invoked and displayed when users select any object in the Results Pane. Context Palettes enable users to always have the context for the currently displayed results at their disposal. In addition, the semantic browser constantly refreshes the palette for the currently selected object, thereby guaranteeing that the context for the object is always up to date. In a preferred embodiment, this is accomplished via a timer that triggers a refresh action or by querying the SQML query processor for the Context Palette for whether there is any new object since the last time the palette was refreshed.

In the preferred embodiment, results displayed in Context Palettes are “first-class” information objects in the same way as the information objects displayed in the main Results Pane. In other words, Context Palette results are preferably used with all of the present invention's semantic tools, e.g., smart copy and paste, Smart Lens, Deep Information, etc. The same preferably is true for results displayed in other context panes anticipated in the present invention.

The present invention preferably includes the following Context Palettes. In the preferred embodiment, users have the option to “scroll” through the different Context Palettes for a selected object. The incorporation of additional and different Context Palettes is expressly anticipated, and may parallel the addition of Context Templates.

“Headlines” Context Palette. This uses the Headlines Context Template and employs SQML that has the SQML of the Headlines Context Template with an additional link to the currently selected object, and the default predicate for the object-type combination. In particular, the SQML will be keyed off resources that map to all the favorite Agents or recent Agents in the Semantic Environment. The user configures whether he or she wants Favorite Agents, recent Agents, or both to be used when generating the Context Palette. In addition, the Headlines Context Palette is also configurable to show headlines without any filter for the number of objects to be displayed or the “freshness” time limit. In this case, the palette will allow the user to navigate all the relational results sorted by the publication or post time.

“Breaking News” Context Palette. Contains relational results from every Breaking News Agent in the Semantic Environment using the default predicate of the object-type combination, and linked with the currently selected object. In addition, results for the default Breaking News Context Palette are displayed. The semantic browser of the present invention will dynamically generate SQML with as many (and identical) resource or link combinations as there are Breaking News Agents, with additional links that have the default predicate and the resource qualifier of the currently selected object (a file-path, folder-path, object://URL, etc.). The semantic browser of the present invention invokes the generated SQML query and loads the palette windows with the SRML results. The Breaking News Context Palette preferably contains navigation controls to allow users to navigate the results in the Context Palette.

“Conversations” Context Palette. Similar to the Headlines Context Palette except utilizing the Conversations Context Template.

“Newsmakers” Context Palette. Similar to the Headlines Context Palette except utilizing the Newsmakers Context Template.

“Upcoming Events” Context Palette. Similar to the Headlines Context Palette except utilizing the Upcoming Events Context Template.

“Discovery” Context Palette. Similar to the Headlines Context Palette except utilizing the Discovery Context Template.

“History” Context Palette. Similar to the Headlines Context Palette except utilizing the History Context Template.

“All Bets” Context Palette. Similar to the Headlines Context Palette except utilizing the All Bets Context Palette.

“Best Bets” Context Palette. Similar to the Headlines Context Palette except utilizing the Best Bets Context Template.

“Favorites” Context Palette. Similar to the Headlines Context Palette except utilizing the Favorites Context Template.

“Classics” Context Palette. Similar to the Headlines Context Palette except utilizing the Classics Context Template.

“Recommendations” Context Palette. Similar to the Headlines Context Palette except utilizing the Recommendations Context Template.

“Today” Context Palette. Similar to the Headlines Context Palette except utilizing the Today Context Template.

“Variety” Context Palette. Similar to the Headlines Context Palette except utilizing the Variety Context Template.

“Timeline” Context Palette. This Context Palette preferably contains merged results from the Headlines, Best Bets, History, and Upcoming Events Context Templates. The Timeline Context Palette preferably allows the user to navigate all objects on the semantic timeline based on the currently selected object. The timeline may contain information items based on their publish/post time, event items based on their appointment time, etc. Essentially, with the Timeline Context Palette, the user navigates relevant (and perhaps other semantically related) objects using time as the primary axis for information conveyance.

“Guide” Context Palette. The preferred embodiment of the present invention includes a unified Guide Context Palette. This Context Palette combines all Context Palettes. In other words, each window in the Guide Context Palette corresponds to one result from each of the other system Context Palettes. The user interface for the Guide Context Palette allows the user to scroll through the results for each Context Palette in each window or to animate the results using animation techniques, for example, fade-in/fade-out techniques. A preferred use of the Guide Context Palette is to view context for the currently selected object in a minimal viewing space. In the preferred embodiment, the use has the option of viewing all Context Palettes side-by-side (vertically, horizontally, diagonally, etc.), docked, or in other arrangement formats.

Context Palette User Interface. The user interface for Context Palettes is preferably configurable based on the layout Skin for the currently displayed Agent. In the preferred embodiment, Context Palettes may be docked on the left, right, top or bottom of the Results Pane. Context Palettes may be collapsed in order to minimize intrusion into the viewing area and dynamically re-expanded to full view. Skins may also allow Context Palette windows to be resized to variable sizes or preset, fixed sizes. Alternatively, some Skins may also animate Context Palettes results.

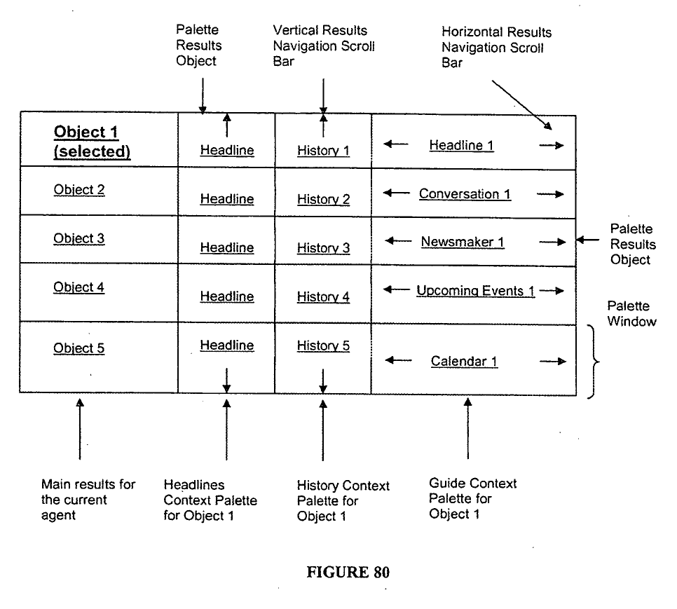

By way of example, FIG. 80 illustrates a user interface showing Agent results and corresponding Context Palettes. In the example, several Context Palettes are collapsed and the Context Palettes are skinned (or presented) to be vertically docked on the right side of the display, or Results Pane.

h. Intrinsic Alerts

In a preferred embodiment, in addition to the Breaking News Agent, the present invention provides for Intrinsic Alerts. While conceptually similar to Breaking News Agents, Intrinsic Alerts are fundamentally different in operation. In the case of Breaking News Agents, the present invention signals the user as to breaking news notifications after polling each Breaking News Agent specified by the user and querying it to find if there is anything related to the current object that is breaking. An Intrinsic Alert does not require the user to specify a Breaking News Agent or otherwise perform any action in order to introduce breaking news notification. An Intrinsic Alert is automatically signaled in the user interface (for all currently displayed objects) when there is an event that relates to the object at issue in a fundamental, intrinsic way. For example, if the current object is a document, the present invention polls the Agency from whence the document came and asks the Agency if there is any recently posted information on the Agency that relates to the object. If the current object is a person, the present invention may poll the Agency and ask if the person recently sent email, recently posted a document, recently annotated a document, recently joined or exited a distribution list, etc. This allows the user to have in-place information within the native context of the object in a time-sensitive manner.

In the preferred embodiment, the default implementation for Intrinsic Alerts will poll only the Agency from whence the object came. This has the advantage of simplifying the user interface; if the user wants to perform cross-Agency queries, he or she has the option to drag and drop, copy and paste, etc. in order to invoke relational queries. In alternative embodiments, Intrinsic Alerts will poll multiple Agencies, including Agencies other than from whence the object came, in an effort to locate breaking news notifications.

In an alternative embodiment, the present invention is configurable to maintain information as to whether a user has accessed an object. This may be analogized to how an email server keeps track of what email messages a user has read. In an embodiment in which the Agency supports per-object, per-user server-side state, Intrinsic Alerts are always accurate because the Agency indicates that there is “intrinsic breaking news” only if there is information on the Agency that relates to the object in question that has not been accessed or read by the user. This alternative is preferably accomplished means of an additional filter on the SQML query.

The alternative of a per-object, per-user server-side state required for this embodiment has disadvantages, especially for Agencies that will hold massive amounts of information and will have a huge number of users (e.g., Internet-based Agencies). In this situation, the system does not scale well if state is maintained per object and per user.

In an alternative embodiment where the Agency does not support per-object, per-user server-side state, the Agency may be configured with a static freshness time limit for Intrinsic Alerts. For example, the server may be configured with a freshness time limit of thirty minutes, in which case the server would respond in the affirmative if an Intrinsic Alert query is received within thirty minutes of the arrival of a new object that relates to the object in the query. In a preferred embodiment, the KIS Agency maintains information on the average information arrival rate. This way, a busy server will have a lower freshness time limit than a server that seldom receives new information. This embodiment is not as accurate as if the server kept per-object, per-User State because the average arrival rate produces only an approximation of whether an alert should be signaled. This embodiment will still result in reduced information loss. In the preferred embodiment, the present invention optionally signals Intrinsic Alerts in a non-intrusive manner that suggests their probabilistic nature (i.e., that an alert is only a best guess).

i. Smart Recommendations

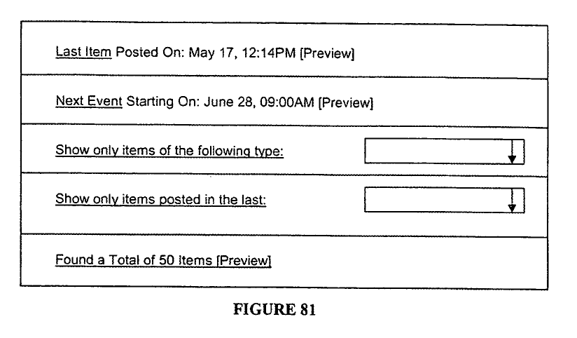

Smart Recommendations represent semantic queries to the Semantic Network, for inferred semantic links, using an object as an Information Object Pivot. For example, the Inference Engine may infer that users would like to attend a certain event, based on events they have attended in the past, the fact that they have been engaged in many email conversations with the presenter of the event, etc. By way of example, in the preferred embodiment, this information is available in a Smart Recommendations popup context Results Pane such as that shown in FIG. 81. This is similar to what users see for a given object against the Recommendations Context Template.

In the preferred embodiment, each link is generated by the object Skin or a special recommendations information pane Skin and will link to SQML containing the predicates for the inferred semantic links.

6. Property Benefits of the Present Invention

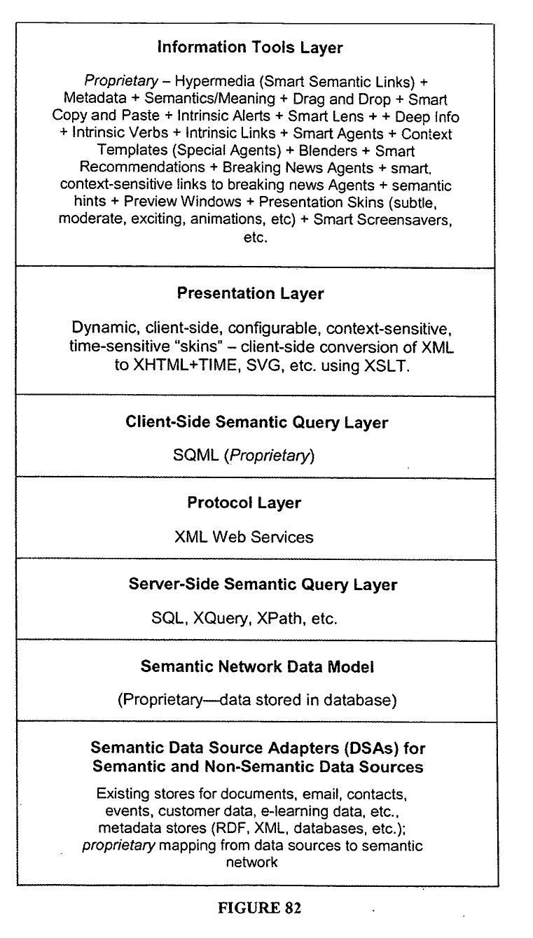

The Information Nervous System of the present invention provides proper context, meaning and efficient access to data and information to allow users to acquire actionable knowledge. Many of the advantages of the Information Nervous System over Today's Web and the conceptual Semantic Web are derived from its use of the technology layers shown in FIG. 82. The various embodiments of the present invention demonstrate the advantages as they relate to the properties required to produce an integrated and seamless implementation framework and resulting medium for knowledge retrieval, management and delivery, which include Semantics/Meaning; Context-Sensitivity; Time-Sensitivity;

Automatic and intelligent Discoverability; Dynamic Linking; User-Controlled Navigation and Browsing; Non-HTML and Local Document Participation in the Network; Flexible Presentation that Smartly Conveys the Semantics of the Information being Displayed; Logic, Inference, and Reasoning; Flexible User-Driven Information Analysis; Flexible Semantic Queries; Read/Write Web; Annotations; “Web of Trust”; Information Packages (“Blenders”);

Context Templates; and User-Oriented Information Aggregation.

Semantics/Meaning

The present invention employs semantic links, ontologies, and other well-defined data models using XML. As a result, an Agency as described above has the power of a semantic Web site in that its information includes semantics. In addition, by providing meaning as an intrinsic part of the XML Web Service, it further provides context-sensitivity, time-sensitivity, etc. associated with the subject matter information.

Context-Sensitivity

Intelligent system Agents described above monitor the private context of users and automatically alert users when there is relevant information on an information source (or sources) related to the specific context. By way of example, these specific contexts may include the following:
My Documents
My Web Portal
My Favorite Web Sites
My Email
My Contacts
My Calendar
My Customers
My Music
My Location
“This” document
“This” Web site/page
“This” email message
“This” contact
“This” event in my calendar
“This” customer
“This” music track, album, or play-list

The present invention provides a context-sensitive user experience via the use of information Agents associated with the server 10 and via the semantic browser 30 and associated XML Web Service. For example, users automatically connect information in “My Documents,”. “My Email,” etc. (from application islands such as the file system, Microsoft Outlook, etc.) to remote information sources that have semantically relevant information. Users have the flexibility to make these connections in real-time via application-level innovations that reside on top of the Semantic Network such as the new query tools described above, for example, drag and drop, Smart Lenses, smart copy and paste, etc. It is also contemplated that such application tools can be used independent of a Semantic Network, for example, integrated into an existing browser of Today's Web.

In a preferred embodiment, the KIS of the present invention pulls semantic information from the Semantic Web or other repository with semantic markup (preferably via RDF plug-ins) into its Semantic Network. Alternatively, the system 10 of the present invention exists without the Semantic Web. In this situation, the KIS builds its own Semantic Network (e.g., a private semantic web) from data sources that the system administrator selects (e.g., email, documents, etc.). The system 10 of the present invention is able to utilize the actual semantic applications with a semantic backend (which can optionally include the Semantic Web). The system 10 thus provides context-sensitivity via integration with client-side applications (including the proprietary semantic browser 30), location-tracking tools, etc. and the proprietary XML Web Service (which the Semantic Web does not describe). More specifically, while the conceptual Semantic Web describes architecture for semantic linking and knowledge representation, it does not address scenarios and innovations using XML Web Services to provide context-sensitivity, time-sensitivity, dynamic linking, Context Templates, Context Palettes, etc. In contrast, the present invention addresses semantic linking via the semantic data model and Semantic Network as well as provides software services for context sensitivity, time-sensitivity, semantic queries, dynamic linking, Context Templates, Context Palettes, etc. via integration with its proprietary XML Web Service.

Time-Sensitivity

The present invention has an intrinsic notion of time-sensitivity. For example, by providing features related to time-sensitivity such as Breaking News Agents, Breaking News Context Templates, Breaking News Context Palettes and intrinsic alerts, the present invention demonstrates the importance of time as an element in semantics and presentation. While not universally true, generally speaking old information is usually not as relevant as new information. For example, when CNN interrupts news broadcast to show breaking news, the interruption is based on a combination of semantics (the relevance of the breaking news about to be displayed) and the fact that the news is indeed breaking. Except is those rare cases where the Web author specifically builds in time-prioritized analysis, this time-sensitivity element as an axis for alerts and presentation is totally lacking in Today's Web and in the conceptual Semantic Web.

The present invention allows users to select Smart Agents as Breaking News Agents. Any information being displayed will show alerts if there is relevant breaking news on a breaking-news Agent. For example, with the present invention, a user is able to create an Agent as: “All Documents Posted on Reuters today” or “All Events relating to computer technology and holding in Seattle in the next 24 hours” as Breaking News Agents. Because these Agents are personal (“breaking” is subjective and depends on the user), the browser provides uniquely individual support. In yet another example, a user in Seattle would be able to schedule notification on events in Seattle in the next 24 hours, events on the West Coast in the next week (during which time he or she can find an inexpensive flight), events in the United States in the next fourteen days (the advance notice for most U.S. air carriers to obtain a competitively priced cross-continental flight), events in Europe in the next month (likely because he or she needs that amount of time to get a hotel reservation), and events anywhere in the world in the next six months.

The present invention further supports a Breaking News Context Template based on which users can create Breaking News Agents. In addition, the present invention supports a Breaking News Context Palette that allows users to view all displayed results in the context of a template-based definition of “breaking news,” thereby seamlessly and intelligently integrating context and time-sensitivity.

The present invention further provides a powerful personal historian tool for performing historical analyses. Using browse history, past events, and document creation times, the system 10 can compensate for faulty memory by recalling details from an event, for example, showing results to the query “The coworkers who attended the design meeting from 6/1/98 through 6/1/99”. Alternatively, the system may seek for a cluster of events. For example, investigators may ask for “All stock market transactions greater than $10M related to the airline stocks from 7/1/01 up to 9/11/01” or “Show all documents created within a ten day window of this event”.

Automatic and Intelligent Discoverability

The system 10 of the present invention has an intrinsic notion of discovery. In a preferred embodiment, the KIS automatically announces its presence on a local multicast network, an enterprise directory (e.g., an LDAP directory or the Windows 2000 Active Directory), a peer-to-peer system or other system. Ideally, the semantic browser 30 periodically listens for multicast or peer-to-peer announcements and checks an enterprise directory or a Global Agency Directory. The browser also allows the user to navigate the system in a hierarchical fashion to locate additional Agencies. This way, users are notified when new Agencies are available and when existing Agencies expire. The semantic browser of the present invention preferably notifies users instantly when new Agencies are available via namespace snapshots and periodic checks for announcements and directory presence.

The peer-to-peer aspect allows the system 10 to scale and automatically populate the enterprise directory without any centralized maintenance (which is a large ongoing cost for organizations). The system preferably uses programmatic queries for new classes of servers, thereby eliminating the needs for Web logs.

Dynamic Linking

The present system 10 provides fundamental advantages over Today's Web and the conceptual Semantic Web by employing smart objects having intrinsic behavior. The system embeds behavioral characteristics in each Agency's XML Web Service, thereby make each node in the Semantic Network much smarter than a regular link or node on Today's Web or the Semantic Web. In other words, in the preferred embodiment, each node in the Semantic Network of the present invention links to other nodes independent of authoring. Each node has behavior that dynamically links to Agencies. Smart Agents also allow for such additional features as drag and drop and smart copy and paste, creating links to Agencies in the Semantic Environment, responding to lens requests from Smart Agents to create new links, including intrinsic alerts that will dynamically create links to time-sensitive information on its Agency, including presentation hints for breaking news (wherein the node can automatically link to breaking news Agents in the namespace), etc. These features dramatically increase the user's ability to, for example, find and navigate new links. Once the user reaches a node in the network, the user has many semantic means of navigating dynamically and automatically using context, time, relatedness to smart Agencies and Agents, etc. By making each node in the network smarter, the entire Semantic Network becomes a smart, virtual, self-healing and self-authoring network.

The dynamic linking technology of the present invention allows users to issue queries across local/remote information boundaries. For example, the present invention (preferably using SQML technology) allows a user to issue a query like: “Find me all email messages written by my boss or anyone in research and which relate to this specification on my hard disk.” The client-side query processing technology (preferably via SQML) allows this flexible query because the processor links the metadata from the client with the remote XML Web Service that processes the relational query.

Smart and Dynamic Information Propagation. Dynamic linking as provided for in the present invention provide for intelligent information propagation. Because the Semantic Network can be navigated from many more axes than Today's Web or the Semantic Web, information sharing and propagation becomes much more efficient and information loss is minimized.

User-Controlled Navigation and Browsing

The dynamic linking property of the present invention allows for continuous semantic browsing as opposed to with Today's Web and the Semantic Web, where static links result in browsing “dead-ends.” With Today's Web and the Semantic Web, the user typically browses to the desired location or effectively reaches an impasse where no further links are available. With dynamic linking, the user can, depending on the nature of the information space at that point in time, continue browsing indefinitely since the node itself includes intelligence to dynamically update links.

For example, via the seamless integration of linking and semantic XML Web Services provided for by the present invention, users drag and drop files, links, etc. to Smart Agents to create new Smart Agents. Preferably this occurs recursively. Smart Agents, in turn, can, where appropriate, be made Breaking News Agents. Other nodes in the presentation display presentation hints indicating whether there is breaking news on any Breaking News Agent. To continue the example, the results of the Breaking News Agent query can be used as a Smart Lens, which shows further results. These results preferably include intrinsic alerts that provide the user with a context and time-sensitive path through the network. Subsequent results can be copied and pasted to any Agency, as well as dragged and dropped on other Smart Agents.

In the preferred embodiment, the dynamic linking of the present invention is applied both to objects within the semantic “sandbox” (objects that are in the system 10 environment and displayed within the semantic browser 30) as well as to external objects that can be dynamically added to the environment. This provides a seamless, dynamic migration path from existing documents (on the file system, Today's Web, or other environments) to the system 10 of the present invention.

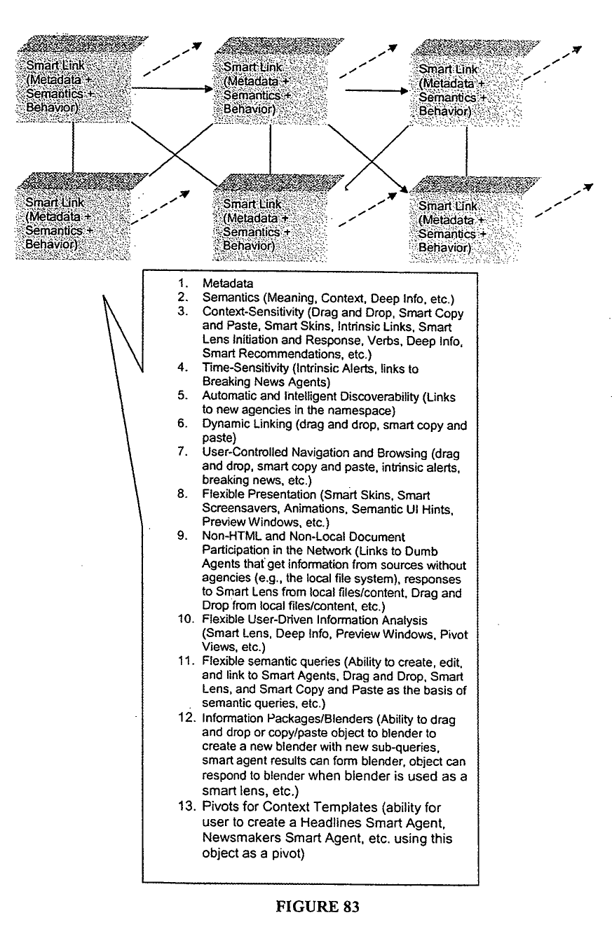

FIG. 83 illustrates dynamic linking and user-controlled navigation and browsing according to a preferred embodiment of the present invention. Note that for purposes of this example, “Smart Links” refer to the dynamic, programmable semantic link of the present invention.

Non-HTML and Local Document Participation in the Network

The present invention does not require that documents be encoded as RDF or XML before inclusion in the network. Rather, the KIS (or Agency server) automatically extracts metadata from all sorts of documents and adds them to the Semantic Network. In addition, client-side dynamic linking, preferably via such features as drag and drop, smart copy and paste and Smart Lens, ensures that local documents of all types are linked to the network, thereby increasing the value and scope of the network. The present invention automatically extracts metadata from local documents and calls the KIS (via its XML Web Service) to retrieve semantically related information. Thus, the local document is not excluded from the network. The present invention empowers a user to drag and drop a document from a dumb environment (e.g., Today's Web or file system) into the system 10, thereby providing it semantic intelligence. Once the metadata is in the system 10, semantic tools such as semantic lenses, smart copy and paste, etc. may be performed to and with the object. Drag and drop is also supported directly from the user's file system and Today's Web into the system 10.

Flexible Presentation that Smartly Conveys the Semantics of the Information Being Displayed

The present invention empowers users with flexible presentation. Because the XML Web Service sends back XML, rather than HTML, and because the presentation is dynamically generated on the client, the user selects different “skins” with which to view semantic information. Skins preferably convert XML to a format suitable for presentation (e.g., XHTML+TIME, SVG, etc.), allowing the user to dynamically select Skins based on the capability of various display technologies. For example, SVG has many features that XHTML+TIME does not, and vice-versa. The user is able to select an SVG Skin for scenarios in which SVG is optimized. Alternatively, the user is able to select XHTML+TIME for other scenarios.

The flexibility of Skins as part of the present invention provide for application in additional situations. In various alternative embodiments, the use is empowered by text-to-speech Skins that may be running the semantic browser 30 on a second machine concurrently with a first or main machine, for example to assist blind users; dynamically resizable Skins that adapt to the size of the current view-port (thereby allowing the user to resize the window and yet retain a pleasant user experience); Skins that check local state to display semantic hints (e.g., the user's calendar in the case of event information, e.g., free/busy information); Skins that display inline preview windows that save user navigation time and increase productivity; Skins that display different customizable hints for intrinsic alerts, breaking news, deep information, smart recommendations, intrinsic links, lens info, etc. Users are also allowed to select Skins to be used with smart screensavers, for example where users desire to view an Agent in screensaver mode. In an alternative embodiment, the system 10 supports Skins for Context Templates (described above), e.g., Headlines, Newsmakers, Conversations, etc.

By virtue of allowing for flexible presentation, the present invention allows the user to select the best presentation mode based on the current task. For example, users can select a subtle Skin when working on their main machine where productivity is a higher priority than aesthetic effect. Users can select a moderate Skin in cases where productivity is important but where effects are desired or allowed. Users can select an exciting Skin for scenarios like wherein secondary machines are utilized—for example, where users are viewing information in their peripheral vision and desires features such as text-to-speech to alert them of breaking news, etc. Exciting Skins may alternatively feature animations, storyboard like effects for deep information, objects displayed on motion paths, and other special effects.

In addition, Skins according to the present invention are optionally configured with include and exclude object type filters. For example, a Skin may be configured to include only “documents” but exclude “analyst reports.” Because the Skin takes XML results to determine the ultimate presentation, the Skin can include or exclude objects in the XML (SRML) results based on an examination of the object type (or other attributes) of the returned objects.

Logic, Inference and Reasoning

The present invention provides for logic, inference, and reasoning. The semantic data model on KIS Agency preferably offers support for logic via database processing of the Semantic Network, conversion of semantic queries to SQL and other database query languages for logic processing, etc. In addition, the system 10 of the present invention preferably includes an Inference Engine for inferring links such as the experts on a particular category or information item, recommendations, probabilistic links (e.g., the probability that a person wrote a document), etc. As described above, an Inference Engine according to the present invention preferably observes the Semantic Network, mines it to infer new semantic links and represents resulting links in the SemanticLinks table.

Flexible User-Driven Information Analysis

The present invention provides native support for flexible information analysis on the client. The Presenter of the present invention preferably utilizes Smart Lenses to allow a user to preview the results of a semantic query prior to issuing the query. The user is able to change relevant predicates and other filters in order to preview the results. In an alternative embodiment, the user has the option of invoking the query and using that as the basis of a new sub-query, if desired.

Flexible Semantic Queries

The present invention allows a user to issue very flexible semantic queries. The user is able to incorporate local context into queries, e.g., by using filters such as “relates to this document on my hard drive.” Neither Today's Web nor the Semantic Web allow for this. In addition, the present invention preferably incorporates Smart Agents, which utilize references to a proprietary semantic query language (SQML) and includes local and remote resources, predicates, category references and objects. The present invention preferably incorporates the easy to use user interface for creating and editing Smart Agents (representing semantic queries) using a simple wizard model. As discussed above, the system 10 allows semantic queries to form the basis of new queries via the recursive drag and drop feature, e.g., a document or an HTML link can be dragged to an existing or new Smart Agents, thereby creating successive new Smart Agents. Smart Agents are alternatively used as lenses, can have objects pasted onto them to form new semantic queries, and can be added to Blenders, which in themselves are semantic query containers and which, in turn, can be filtered thereby creating sub-Blenders or containers of sub-Agents.

Read/Write Support

The system 10 of the present invention offers support for read/write functionality by providing an XML Web Service that allows a user to publish information directly into the Semantic Network. This could be any document, an annotation, or a semantic link that corrects a broken link or provides a new link. This is all subject to security restrictions at the XML Web Service and operating system layer. The system 10 employs authentication, access control, and other services from the operating system and application server that sit underneath the XML Web Service layer. These security services are preferably used to secure read and write access to the Semantic Network.

Annotations

The present invention includes built-in support for Annotations. There is a special predicate “Annotated By” that defines an Annotation semantic link between a person object and any other information object (e.g., a document, email posting, online course, etc.). The system 10 includes presentation-layer support for Annotations by allowing users to navigate to Annotations via intrinsic links, Smart Lenses, etc. The manner in which the present invention incorporates Annotations provides advantages of existing techniques (such as in-place Annotation techniques that embed the Annotation as part of the information object it annotates). In the preferred embodiment of the present invention, Annotations are “first-class” information objects. This means that they can be linked to and from, “lens” over (using Smart Lens), copied and pasted (using smart copy and paste), etc. The present invention exposes Annotations to all of the semantic tools of the present invention, thereby facilitating a user experience more powerful than capable with standard Annotation techniques. In addition, Annotations of the present invention are used with Context Templates. As a result, the Inference Engine is able to employ them to make the system smarter over time. In addition, the system 10 provides a unique and easy means of annotating objects by sending specially formatted email (with a qualified message body) to the email Agent of an Agency.

“Web of Trust”

The present invention provides a “Web of Trust” via the XML Web Service. This service authenticates a user that wants to update the Semantic Network, make assertions, fix/update links, etc. This also allows rich content to be made available via the KIS Agency to registered subscribers for pay-per-view content. The value of the entire network increases when one can utilize the same platform tools to navigate seamlessly across many rich content sources.

Information Packages (Blenders)

The present invention provides for information packages or “Blenders.” Blenders are semantic containers that include references to semantic queries from Smart Agents. This allows a user to deal with related semantic information as a whole unit. The user is able to separately view the individual Agents within the Blenders or view the entire Blender as though the information therein was from one aggregate Agent. This is preferably accomplished by driving each Agent via calls to the XML Web Service. In the preferred embodiment, users drag and drop objects onto Blenders to create sub-Blenders. This is preferably accomplished recursively. Blenders can be created, deleted, and edited. The user is able to add and remove smart Agents to or from Blenders.

Blenders can be thought of as a digital equivalent of a personal newspaper that contains different sections. For example, the USA Today, New York Times, Wall Street Journal, etc. contain different sections such as News, Business, Sports, Life/Entertainment, etc. Each of these sections corresponds to a Smart Agent entry in a Blender and the entire newspaper corresponds to the Blender. The flexible viewing and navigation provided by the present invention can be thought of as the digital equivalent of the user being able to browse each newspaper section completely and sequentially, one at a time, or browse the entire newspaper by starting as page one of each section, followed by page two of each section, etc.

Context Templates

As described in detail above, the present invention provides Context Templates, which are scenario-driven information query templates that map to specific semantic models for information access and retrieval. Essentially, Context Templates can be thought of as personal, digital semantic information retrieval “channels” that deliver information to a user by employing a predefined semantic template. In the preferred embodiment, the semantic browser 30 allows the user to create a new Blender or Special Agent using Context Templates to initialize the properties of the Agent. Context Templates preferably aggregate information across one or more Agencies. In addition, Context Templates are preferably used with Context Palettes to provide intelligent, dynamic, in-place context for any information object that is displayed or selected by the user.

User-Oriented Information Aggregation

The present invention has intrinsic support for user-oriented information aggregation. Scenarios empower a user to view context and time-sensitive information as though they came from one source even if they cut across information repositories. This provides a significantly more productive user experience that with Today's Web and the conceptual Semantic Web by providing user-oriented computing wherein the user is presented with the right information in the right context and at the right time, regardless of the source of the information. The Information Agent aggregates information dynamically, across information sources, using client-side semantic queries via SQML and aggregating the XML results that come from different Agencies' response to SQML.

E. Scenarios

The following provides exemplar scenarios of the operation of preferred and alternative embodiments of the present invention as applied in different pragmatic situations.

1. Examples of Semantic Queries Utilizing the Present Invention

a. Find all Context that Relate to the Specification on the File Path c:\spec.doc

Drag and drop the icon representing a document to the icon representing the Information Agent. The file is opened in the semantic browser and the Context Palettes are displayed. In the preferred embodiment, these include some or all of the following Context Templates: Headlines, Discovery, Newsmakers, Upcoming Events, Timeline, Conversations, Variety, Classics, Best Bets, Today, Breaking News, etc. These palettes include relevant context from Agencies in the “recent” and “favorite” lists in the namespace.

b. Find all Experts on the Agency Titled “R&D” that Have Expertise on Wireless Technology

Start the “New Smart Agent” wizard and select the “Use Context Template” option when creating the Agent. Select the “R&D” Agency from the “Select Agency” dialog and select the category called “wireless” from the category browser. Open the newly created Smart Agent.

c. Find all Information on Reuters that is Relevant to a Link on the Currently Viewed Web Page

Drag and drop the link to the Agency icon representing “Reuters.” A new Smart Agent is created titled “Information on Reuters relevant to [link title]” and opened in the Information Agent.

d. Find all Information on Reuters that is Relevant to a Link on the Current Web Page and Which is Relevant to the Specification on the File Path c:\spec.doc

Drag and drop the icon representing the document to the Agent that was just created above (“All information on Reuters relevant to [link title]”). This creates a new Smart Agent titled “Information on Reuters relevant to [link title] and relevant to spec.doc.” This illustrates user-controlled browsing and dynamic linking.

e. Find all Email on the Internal Agency Titled “Marketing” Relevant to the First Article on Reuters that was Returned in the Previous Query

Highlight the Reuters article object and click on the button for “Verbs.” This displays a popup menu. Select “Copy.” Find the icon representing the Agency titled “Marketing” (on the Shell Extension Tree View). Right-click the icon. Hit “Paste.” This creates and opens a new Smart Agent titled “Information on ‘Marketing’ relevant to [Reuter's article title].” Focus on the frame in the results window showing email objects.

f. Navigate to the Author of the Email

Highlight the email object and click on the button for “Links.” This displays a popup menu showing the intrinsic links. Navigate to the menu item titled “From:” This displays a popup menu showing the person object on the “from” line of the email object. Select the desired object. This opens a new Smart Agent in the Information Agent showing the metadata of the person that authored the email object. The context of the person is also displayed in the Context Palettes. Users are able to continue browsing using the person object or its context (on any of the Context Palettes).

g. Navigate to the Attachments in the Email

Highlight the email object and click on the button for “Links.” This displays a popup menu showing the intrinsic links of the email object. Navigate to the menu item titled “Attachments.” This displays a popup menu showing the titles of the attachments. Select the desired attachment. This opens the attachment as a new Smart Agent in the Information Agent window. The context for the attachment is displayed in the Context Palettes.

h. Find all Events on the “Energy Industry Events” Agency that are Relevant to the Attachment

Highlight the attachment object and click on the button for “Verbs.” This displays a popup menu. Select “Copy.” Find the icon representing the Agency titled “Energy Industry Events” (on the Shell Extension Tree View). Right-click the icon. Hit “Paste.” This creates and opens a new Smart Agent titled “Information on Energy Industry Events relevant to [email attachment title].”

i. Browse the “My Documents” Folder Using Reuters as a Context

In the Information Agent, select “Open Documents in Folder.” Alternatively, drag and drop the “My Documents” folder to the icon representing the Information Agent. Indicate whether sub-folders are to be included. This creates and opens a new Dumb Agent titled “My Documents.” When you click this Agent, the metadata for the documents in this folder are opened in the Information Agent. When one of the documents is selected, the Context Palettes for the document are displayed. To browse the documents using Reuters as a context, the user finds the icon representing the Reuters Agency, right-clicks on the icon and hits “Copy.” The user hovers over any of the results showing the documents metadata in the Information Agent and selects the icon indicating the Smart Lens. A Smart Lens window is displayed showing information on the results of the relational query. The number of items found on Reuters that are relevant to the document is displayed, in addition to information such as the most recently posted item. In addition, a preview control is displayed to allow the user to preview the results in place. The user is able to choose to click on the results to open an Agent representing the new, relational query. If done, the context for the first object in the results is displayed using the Context Palettes.

j. Notify by Email, Voice or Pager when there is Breaking News that Relates to Anything on XML Technology and Which Relates to this Document

Create a new Smart Agent using the “Breaking News” context and using the “XML” category as a category filter. Drag and drop the icon representing this document to the Agent. This creates a new Smart Agent with an appropriate title. Go to the “Options” menu in the Information Agent and enter the proper information in the notification section (your email address, pager number, telephone number, etc.). Right-click the Smart Agent and select “Notify.”

2. Business Problems

a. Information Access

Today's Web. John Head-Master works at FastServe, a marketing consulting services company in San Diego. Everyday, he comes in to work and fires up his Web browser. On this day, he decides to browse the corporate Web to see if he can discover new and interesting information. The browser home page, is set (using an Enterprise Information Portal) to the corporate home page. The corporate home page has links for the home pages for different divisions within the company. John navigates to these links and from there, keeps clicking links. After a while, he gets frustrated because he knows that there are more sources of information that he cannot navigate to, only because he does not know what paths to take. Eventually, he gives up.

Information Nervous System. John fires up his Information Agent (semantic browser). This opens the home Agent. On the page, he sees a list of knowledge links corresponding to products, product groups, reports, corporate events, online courses, and video presentations. He hovers over the “product groups” link. Automatically, a balloon popup appears indicating the number of product groups and other data about the link. He then opens the link. A list of product group objects is then displayed with a customizable look or “skin.” He then hovers his mouse over the first one. A popup menu immediately appears over the link with the actions: “Show Members,” “List Similar Product Groups,” and “Subscribe to Group Events.” He then clicks on “Subscribe to Group Events” and he will now be notified by email (via the Enterprise Information Agent) about all events that relate to this product group. He then clicks “Show Members.” This then opens a new “Knowledge Page” with icons corresponding to people. He then hovers over the icon for Susan Group-Leader. A balloon pop-up then appears showing information on Susan. A right-click menu then appears with the actions, “Reports To,” “List Direct Reports,” “Member Of,” “Authored Documents,” and “Recently Attended Meetings.” John then selects “Recently Attended Meetings.” This opens up a new knowledge page with one meeting object. John then hovers over this and continues browsing.

At some point, John decides to search for a co-worker he met the previous day. He then types in “Wilbur Jones.” This then returns a person object corresponding to Wilbur. John then continues to browse using Wilbur as an Information Knowledge Pivot.

Eventually, John realizes that Wilbur does not seem to have the information he (John) needs. John then types the following query into the search box on his Information Agent: “List all online courses and documents that relate to the upcoming 2002 sales meeting.” The Information Agent (via the Email Agent) then returns a list of actionable online courses and documents that conform to the knowledge query.

b. Knowledge-Driven Customer Relationship Management

Customer Touch-Points. AnySoft is a software manufacturer with 50 products in 100 different languages. They employ their web-site (anysoft.com) to provide up-to-date information to their customers. However, customers have complained that their Web site is very hard to navigate and that they find it very hard to find information on products and to subscribe for notifications.

By deploying an Information Nervous System based on an embodiment of the present invention, AnySoft has deployed an Information Nervous System that co-exists with their existing Web site. The Information Agent is accessible from the home page and from the search bar. Customers now have a much more intuitive way of navigating the Web site for products, relevant white papers, announcements, press releases, corporate events, etc. Customers can now issue natural language queries that return self-navigable and actionable knowledge objects. This feature alone gives customers access to knowledge at their fingertips. Customers can also now use natural language to navigate the AnySoft.com Web site from their handheld devices.

Customer Feedback and Tracking. Comp-Mart is a reseller of computer peripherals with multiple distribution channels. The Company gets customer feedback from its Web site, its call center, its direct sales force, its telemarketing agents, etc. The feedback comes in as documents and email. The Company has identified a problem wherein customer feedback does not get properly routed around the Company to the people that need the information. Employees in product development have complained to management that they find it hard to integrate customer feedback into the product development process because they don't know where to find the information and because critical knowledge is not shared within the organization.

With an Information Nervous System in place, email that contains customer feedback now gets semantically integrated into the Company's Semantic Environment. The KIS of the present invention automatically adds semantic links between customer feedback email and semantic objects like documents, projects, and employees that work on the germane products. Customer feedback intelligently bubbles up in the right places in the knowledge space. The Email Agent sends out periodic notifications to people that are likely be interested in reading customer feedback email.

Also, with the Information Nervous System, the customer becomes an Information Knowledge Pivot. This makes it much quicker and easier to act on customer feedback and to track customer-related knowledge across the organization. The Information Nervous System automatically annotates the customer object with relevant email messages, documents, similar customers, etc. This way, links to the customer can be forwarded via email and co-workers can navigate relevant information from there. The customer object can be searched for, can be browsed, etc.

c. Knowledge-Driven Direct-Sales/Field-Service

Marsha Mindset is a customer service agent for JustInTime Support Services, a computer service firm in Kansas City, Mo. Marsha visits customers around the Kansas City metro area, and always takes her wireless PDA so she can send email to the support headquarters anytime she is in difficulty. JustInTime recently deployed the KIS and the Email Agent. Now, whenever she has support questions, Marsha can now email the Email Agent and ask it questions in natural language. The Email Agent replies to her email with direct answers or with “knowledge links” that allows Marsha to instantly access relevant support email, documents, or people that she could then email or call up on the phone. The JustInTime Direct Sales force also uses the technology of the present invention when in the field selling solutions to customers. The sales representatives also carry wireless PDAs and can issue requests to the Email Agent.

d. Case Studies

Corporate Training, Knowledge Transfer, and Sharing. WaveGen is a biotech company providing “managed care” solutions to doctors around the United States. The company recently deployed the Saba Learning Management System platform for training its employees (especially its sales reps). This reduces travel costs and enables the Company's sales-force to be better prepared to serve physicians in different healthcare regions in the country. It also assists the Company's researchers to be regularly informed of recent discoveries in the biotech research community.

The Company also has other software assets in place that hold valuable sources of knowledge. It has deployed content management solutions that host documents and media files, Microsoft Exchange for email, and collaboration software for online conferences. However, the Company has noticed that knowledge transfer is not very effective because it is not integrated across all these solutions. Sales representatives have indicated that they do not have the tools to discover important sources of knowledge within and outside the organization to assist them in pitching the Company's products to doctors. Enterprise Information Portals are currently used to inform the sales force of upcoming online courses and of important events. However, the sales reps complain that a lot of knowledge (stored in email, documents, etc.) is not brought to their attention because no one knows who else might need them.

In addition, the sales representatives use Microsoft Outlook to add appointments to their calendars for upcoming doctor visits. However, they complain that they only get reminders for the appointments, and that a lot of information that could help them sell products more effectively is not made available to them automatically, ahead of their doctors' appointments.

WaveGen recently deployed an Information Agent based on technology from the present invention. The company deployed the KIS and the Email Agent to facilitate intelligent information connections and routing to help their sales and research teams make better decisions to serve customers and improve the Company's products. Using the Information Agent, the sales force has instant access not just to documents but to “knowledge objects” that are more directly tied to their task at hand. For instance, the sales representatives now have an Agent with “Doctor Jones” as an XML object. This is not a document or a Web page. Rather, it is a semantic representation of the customer. A sales representative can then see semantic links like “Recent Email Messages”, “Relevant Documents,” “Properties,” “Important Dates,” “Relevant upcoming online courses,” etc. This way, the customer becomes the pivot with which the sales agent is navigating the internal Web. These links might generate results from file-shares, Email stores, Microsoft Exchange, etc. But rather than searching or navigating for these knowledge sources as islands, the sales representative can discover new knowledge based on semantic relationships as they relate to the sales representative's task.

This way, the sales representative can have much more powerful knowledge at the sales representative's fingertips, thereby enabling much better customer service. And this knowledge emanates from co-workers, documents that were published by other sales agents, email sent on distribution lists that might not be known to exist, etc. The KIS does the smart thing by automatically making semantic connections from all these disparate sources. The sales representative can then email this “page” to a co-worker. This then becomes a very powerful form of knowledge sharing because the co-worker can then navigate the Information Agent using the same “Dr. Jones” pivot.

The Email Agent also allows the sales representative to issue knowledge queries via natural language. The query results are derived from the Inference Engine and could be based on knowledge that was deduced from existing knowledge. A powerful feature of the Information Nervous System of the present is that knowledge transfer, sharing, discovery all happen automatically based on the Semantic Network.

3. SITUATIONS

a. Semantic Information Discovery, Retrieval, and Navigation

Joe Knowledge-Worker starts the Information Agent (the XML-based semantic browser of the present invention). When he logs in, he is prompted with a dialog box indicating that there are new Agents available on the semantic intranet. He then sees a list of Agents from within and outside the organization that may include the following:
Documents.Technology.All
Documents.Marketing.All
People.Divisions.Sales.All
People.Division.Sales.Managers
OnlineCourses.Sales.101
OnlineCourses.Technology.XML.101
Meetings.ThisWeek.All
Meetings.LastWeek.All
Books.Computers.Programming.All
Newsgroups.Microsoft.Public.Soap
Email.Mine.All
Email.Mine.ProjectX.All
Events.Technology.Wireless.All
Reports.Gartner.Software.All
Reports.IDC.All
Videos.ExecutivePresentations.All

He then selects Meetings.ThisWeek.All. The Information Agent then displays a list of objects that represents meetings that he attended this week. This information comes from Microsoft Exchange but this is not exposed to him. Joe then hovers over a link for the first meeting object. A balloon pop-up is then displayed indicating that a new training course was just made available on the intranet. The balloon also indicates that there is a new report on IDC that might be relevant to Joe. In addition to the balloon, a pop-up menu is displayed to the right of the object. This menu has the following verbs:
List participants
List possible replacement participants
Show Related Objects->
   On News.Reuters.MarketForecasts.All
   On Documents.Technology.All
   On Events.Corporate.Today.All
Subscribe for follow-up

Joe then selects “Subscribe for follow-up.” This contacts the Meeting Follow-up Agent on the server. This Agent then sends periodic updates of relevant information to the participants of the meeting. This could be done either through the browser or through email. Joe then selects related objects on Events.Corporate.Today.All. This then displays a list of event information objects. Joe then hovers over the first object and a pop-up menu gets displayed. Joe then selects “Add to calendar” and the event is added to his calendar. Joe then decides that he wants to find all industry events that relate to the corporate event. He then drags the object to the Agent Events.Technology.All and releases his mouse. When the mouse is released, the browser then loads information objects from Events.Technology.All (across web-sites and other islands) and which are related to the corporate event the object of which he dragged.

The next week, Joe gets email from the Email Agent. In the email, the Agent informs Joe that it has noticed that everyone that added the event to his or her calendar also watched a corporate training video from the corporate media server. The email contains an XML link, which takes Joe back into the Information Agent. The browser then displays the metadata for the video. One of the items on the pop-up is “Watch Video.” Joe then selects it and watches the video.

The next time Joe logs in to his workstation, he notices that there are new Agents. He then subscribes to Books.Ebay.Computers.All and adds it to his My Agent list. Automatically, an embodiment of the present invention adds this Agent into Joe's Semantic Environment. The Information Agent performs implicit queries and provides recommendations (ranked by relevance and time-sensitivity) that include this Agent. He then clicks on this Agent and semantic information objects (representing books) are displayed in the Results Pane. When he hovers over one of the objects, a pop-up balloon is immediately displayed, alerting him to the fact that there is a related industry conference being hosted by the author of the book. When he clicks the pop-up link, the event object is loaded in the browser, complete with verbs that allow him to add the event to his calendar (either Microsoft Outlook or an Internet-based calendar like the MSN Calendar (accessible via Microsoft's HailStorm Web services), AOL Calendar, etc.)

Explanation of the Scenario. This scenario shows how with the present invention, knowledge-workers are able to obtain access to “federated knowledge.” In this example, Joe's company has “imported” knowledge Agents from Gartner, IDC, Reuters, Ebay, etc. into its knowledge space. As such, these Agents automatically add knowledge into the company's Semantic Network. The scenario also showed how Joe was able to get an “object model” view of the entire organization's knowledge-space via intuitively named Smart Agents. Joe was able to use these Agents to “enter” the Semantic Environment, and then navigate his way from there. All the information objects were delivered in real-time and were actionable (with relevant verbs that were displayed in place). This way, Joe did not have to care about what information islands the objects were coming from, or what applications generated them.

The scenario also shows how Joe was able to discover not just new information but also new Agents. And the scenario shows knowledge collaboration in action—via collaborative filtering—wherein the Information Agent gave recommendations to Joe based on what it noticed others in the enterprise were doing.

Lastly, the scenario illustrates how time-sensitive information is automatically brought to the user's attention at the point of context where it makes sense. The Email Agent automatically connected the book from Ebay with the upcoming industry event, inferred and assigned a relevance and time-sensitivity ranking to the event, and decided that the event was critical enough to warrant displaying the information immediately via an alert in the semantic browser.

b. Peer-to-Peer Knowledge Sharing and Capture

Nancy Hard-worker works at a Fortune 500 company with 40,000 employees. She subscribes to a variety of Web sites and has information forwarded to her by email from friends and co-workers. She just got a bunch of documents from someone at a partner company and she would like to share the information within the organization. She sends the documents to all the distribution lists of which she is a member. The Enterprise Information Agent is a member of these lists also (the Agent adds itself to all public distribution lists when the server is installed). When the Agent receives the information, it classifies it and adds it to the Semantic Network. The Inference Engine then picks up the information.

Several thousand co-workers are not members of any of the distribution lists to which Nancy forwarded the documents. However, they all use the Integrator and all of them have subscribed to the Email.Public.All Agent. While they browse other related parts of the knowledge-web, a balloon popup gets displayed indicating that there is new and relevant email on the Email.Public.All Agent. The co-workers then open up the Agent and the email object is displayed. One of the menu items on the email item is “Show distribution lists to which message was forwarded.” The co-workers then select this and the distribution list information objects are then displayed in the browser. The co-worker then hovers over the distribution list and a pop-up menu item gets displayed. The first item is “Show Members.” The second is “Join.” The co-workers then join the distribution list.

Explanation of the Scenario. This scenario illustrates how information was published, shared and captured via email and how, by use of the Semantic Network, other co-workers found out about this information (and about distribution lists the existence of which they were not aware) from different but related “knowledge angles.” The scenario shows peer-to-peer knowledge sharing in a way that is completely seamless and does not require users to public information to repositories, or to classify information themselves. With certain embodiments of the present invention, everything just happens automatically (in the background) and the knowledge gets bubbled up in relevant places.

While the preferred embodiment as well as alternative embodiments of the invention have been illustrated and described, as noted above, many changes can be made without departing from the spirit and scope of the invention. Accordingly, the scope of the invention is not limited by the disclosure of the preferred or alternative embodiments.

The embodiments of the invention in which an exclusive property or privilege is claimed are defined as follows:

1. A system for knowledge retrieval, management, delivery and presentation, comprising:
a first server programmable to add and maintain domain-specific semantic information;
a second server in communication with the first server, the second server programmable to host domain-specific information that is used to classify and categorize semantic information;
a client providing a user interface for a user to communicate with the first and second servers; and
wherein the processors of the first and second servers operate together to perform the steps of:
securing information from information sources;
semantically linking the information from the information sources;
maintaining the semantic attributes of the semantically linked information;
delivering requested semantic information based upon user queries; and
presenting semantic information according to customizable user preferences.

2. The system of claim 1, wherein the first server further comprises structure or methodology directed to providing at least one of the following: a Semantic Network, a Semantic Data Gatherer, a Semantic Network Consistency Checker, an Inference Engine, a Semantic Query Processor, a Natural Language Parser, an Email Knowledge Agent, or a Knowledge Domain Manager.

3. The system of claim 1, wherein:
the information from the information sources consist of objects or events; and
the objects or events are active agents semantically related to each other and representing queries that return data objects for presentation according to a predetermined theme.

4. The system of claim 3, wherein the predetermined these according to which the data objects are presented is customizable by a user.

5. The system of claim 1, wherein the client delivers and presents the semantic information resulting from the user query.

6. A method for knowledge retrieval, management, delivery and presentation for use with a server system programmed to add, maintain and host domain-specific information that is used to classify and categorize semantic information, comprising:
securing information from information sources;
semantically linking the information from the information sources;
maintaining the semantic attributes of the semantically linked information;
delivering requested semantic information based upon user queries; and
presenting semantic information according to customizable user preferences.
